(19) United States
(12) Patent Application Publication
(10) Pub. No.: US 2026/0131320 A1
(43) Pub. Date: May 14, 2026

(54) HYDROCARBYL SILYL-SUBSTITUTED ANSA-METALLOCENES AND PROCESS FOR PREPARING LOW MELT ELASTICITY POLYOLEFINS

(71) Applicant: Formosa Plastics Corporation, U.S.A., Livingston, NJ (US)

(72) Inventors: Michael D. Jensen, Palacios, TX (US); Di You, Rosenberg, TX (US); Congzhi Zhu, Rosenberg, TX (US); Daoyong Wang, Victoria, TX (US); Ying Hao Lo, Richmond, TX (US); Kevin Chung, Port Lavaca, TX (US); Zhiming Wang, Port Lavaca, TX (US); Tieqi Li, Port Lavaca, TX (US); Charles R. Johnson, Port Lavaca, TX (US); Baby Batin, Port Lavaca, TX (US)

(73) Assignee: Formosa Plastics Corporation, U.S.A., Livingston, NJ (US)

(21) Appl. No.: 19/367,489

(22) Filed: Oct. 23, 2025

Related U.S. Application Data
(60) Provisional application No. 63/718,938, filed on Nov. 11, 2024.

(51) Int. Cl. B01J 31/16; C08F 4/76

(52) U.S. Cl. CPC B01J 31/1633; C08F 4/76; B01J 2231/12; B01J 2531/48; B01J 2531/49

(57) ABSTRACT

Disclosed are ansa-metallocene catalysts for the production of polyethylenes. The subject metallocenes comprise a fluorenyl ligand linked to a substituted cyclopentadienyl or indenyl ligand by a one-atom bridge, wherein the cyclopentadienyl or indenyl ligand includes a silyl substituent of the formula —SiR⁵R⁶R⁷, wherein R⁵ and R⁶ are selected independently from a C₁-C₂₀ hydrocarbyl, R⁷ is selected from a C₂-C₂₀ hydrocarbyl. The presence of a C₂₊ hydrocarbyl group on the silyl moiety may provide one or more unexpected features such as high polymerization activities, high comonomer incorporation efficiencies (CIE), low levels of long-chain branching (LCB), and a reverse Short-chain Branching Distribution profile over the molecular weight distribution. Combinations of these properties can provide excellent resin processability, clarity, strength, and other desirable properties, especially for films.

### CROSS REFERENCE TO RELATED APPLICATIONS

This application claims the benefit of and priority to U.S. Provisional Application No. 63/718,938, filed Nov. 11, 2024, which is incorporated herein by reference in its entirety.

### TECHNICAL FIELD OF THE DISCLOSURE

This disclosure relates to metallocenes, metallocene catalyst compositions for producing polyethylene, and processes for preparing and using the same.

### BACKGROUND OF THE DISCLOSURE

The industrial production of linear low-density polyethylene (LLDPE) depends upon the ability of the catalyst to efficiently incorporate alpha-olefin comonomer into the growing polymer chain. Comonomer incorporation advantageously alters the resin density by introducing short-chain branches into the polymer backbone and also imparts beneficial properties to extruded polymer parts made from the resin. To overcome poor comonomer incorporation efficiency (CIE), which is common when using unbridged or “loosely bridged” (for example, two atom-bridged) metallocene catalysts, a high concentration of comonomer relative to ethylene has been introduced in the polymerization zone to achieve the desired resin density and improved properties such as dart impact strength.

The use of high comonomer concentrations, however, presents its own issues. For example, high comonomer concentrations in slurry or gas phase reactors can lead to polymer particle swelling, agglomeration, and eventual fouling of the reactor if polymerization conditions are not carefully controlled. Even when there is no significant fouling, high comonomer concentrations used to address poor catalyst CIE increase process costs due the need to separate and recycle unincorporated comonomer even when there is little fouling.

Single atom-bridged Groups 3 and 4 metallocenes referred to as “ansa-metallocenes”, whether C₁, C₂, or Cₛ symmetric, have been employed for the stereoregular polymerization of propylene. Ansa-metallocenes have also found utility in making various polyalphaolefins, viscosity modifiers, and certain medium density resins. As compared with their unbridged or loosely bridged (two-atom bridged) metallocene analogs, ansa-metallocenes with their single atom bridge are generally considered relatively “tightly bridged” and therefore present less sterically encumbered metal sites for better comonomer incorporation. However, with few exceptions such as some olefin-tethered ansa-metallocenes, and despite their generally high CIE, ansa-metallocenes have still found only limited utility in industrial manufacture of LLDPE resins for blown film.

One reason for the sporadic use of ansa-metallocenes to produce m-LLDPE (Linear Low-Density Polyethylene derived from metallocene catalysts)-type blown film resins derives from the undesirably high levels of long-chain branching (LCB) in the resulting polymer, which may limit the usefulness of the polymer in many commercial processing and resin applications. Even ansa-metallocenes with olefin tethers on the bridge which may suppress LCB formation and preserve high CIE can have limited utility because the pendent olefin may react with co-catalysts and lose its ability to suppress LCB formation.

When ansa-metallocenes are utilized to produce m-LLDPE, the resulting polymers are often used as blend components for blown film, to improve shear thinning or melt strength during processing. Used alone without blending, the higher levels of LCB in such resins result in diminished properties such as poor machine direction (MD) tear strength, and reduced clarity and impact properties. For example, when compared to linear, LCB-free resins of the same molecular weight and molecular weight distribution (MWD), resins containing LCB afford extruded parts with inferior properties and blown films with poor Elmendorf tear characteristics.

Therefore, there remains a need for catalyst systems, catalyst compositions, and catalytic processes for producing LLDPE which provide a high comonomer incorporation efficiency (CIE, defined as [comonomer]/[ethylene]_{polymer}/[comonomer]/[ethylene]_{reactor}) in the polymer) such as ansa-metallocenes can deliver, but which are capable of limiting the amount of LCB incorporation. This need is particularly evident in the production of metallocene-based polyolefins such as high clarity film resins. A low concentration of long-chain branches (e.g. less than 10 branches per million carbon atoms) provides desirable resin properties, such as balanced machine direction (MD) and the transverse direction (TD) tear strength and reduced haze. It would also be desirable if such catalyst systems, compositions and methods could provide a resin with a desirable short-chain branching distribution across its molecular weight distribution. Furthermore, it would be beneficial if these catalyst systems are chemically robust and exhibit long-term storage stability.

### SUMMARY OF THE DISCLOSURE

According to aspects of this disclosure, there are provided new ansa-metallocenes, including non-olefin-tethered ansa-metallocenes, catalyst systems based on these ansa-metallocenes, new processes for making a catalyst composition and processes for polymerizing olefins, and m-LLDPE polyethylenes with improved properties. Surprisingly, it has now been discovered that specific combinations of substituents on an ansa-metallocene core structure provide catalyst compositions which exhibit unexpected results. For example, the specific metallocenes can provide desirable properties such as unexpectedly high polymerization activities, high comonomer incorporation efficiencies (CIE) which exceed those of unbridged metallocenes, low levels of long-chain branching (LCB), preservation of low LCB levels and consistent or even increased activity when the catalyst is aged for weeks or months, a near-zero (“flat”) or positive slope (“reverse”) Short-chain Branching Distribution (SCBD) profile over the molecular weight distribution, and the like. Various combinations of these properties have found to provide excellent resin processability, clarity, strength, and other desirable properties, especially for films.

The non-olefin-tethered ansa-metallocenes that have been discovered to give rise to the highly active catalysts which produce the desirable resin properties can comprise a substituted or unsubstituted fluorenyl ligand, which is linked to a substituted cyclopentadienyl or indenyl ligand by a one-atom bridge, in which the cyclopentadienyl or indenyl ligand includes a silyl substituent. The silyl substituent can have the general formula —SiR⁵R⁶R⁷, and wherein R⁵ and R⁶ are selected independently from a C₁-C₂₀ hydrocarbyl, and R⁷ is selected from a C₂-C₂₀ hydrocarbyl. Thus, at least one silyl hydrocarbyl groups, designated R⁷, is a C₂₊ group, that is a non-methyl “C_{≥2}” group. In a further aspect, in some embodiments, none of R⁵, R⁶, and R⁷ is an alkenyl group. The presence of this silyl group directly bound to the cyclopentadienyl or indenyl ligand has been found to provide not only unexpected combinations of the desirable properties described above but can also provide surprisingly high activities.

In another aspect, in the subject ansa-metallocenes, the bridging group itself or in in combination with the silyl substituent also may impart enhanced catalyst and polymer properties as well. In an aspect, the subject metallocenes can include a linking group between the η⁵-alkadienyl groups with a single-atom bridge of the formula YR³R⁴, wherein Y can be C or Si, and R³ and R⁴ can be selected independently from various hydrocarbyl or monocyclic hydrocarbylidene moieties. In this aspect, R³ and R⁴ also can be absent an alkenyl, that is, R³ and R⁴ are not a tethered olefin.

A further aspect of the ansa-metallocenes and catalyst compositions of this disclosure is the absence of a tethered olefin moiety or alkenyl substituent bonded at any location on the metallocene. For example, the η⁵-alkadienyl ligands themselves also may be absent an alkenyl substituent. The present ansa-metallocenes are therefore distinguished from those metallocenes which include an alkenyl substituent bonded to one of the η⁵-alkadienyl ligands, such as fluorenyl, cyclopentadienyl, or indenyl, or bonded to a bridging atom of the ansa-metallocene.

Accordingly, in an aspect, this disclosure provides a catalyst composition which can comprise the contact product of:
(a) a metallocene compound having the formula:

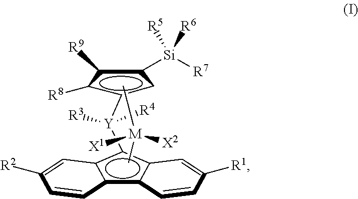

wherein
   (i) M is Zr or Hf;
   (ii) X¹ and X² are selected independently from a monoanionic ligand, or X¹ and X² together are a dianionic ligand (including, for example, a conjugated diene ligand bound to M by delocalized π-electrons, also referred to as a 1,4-diyl-2-ene ligand);
   (iii) R¹ and R² are selected independently from H or a C₁-C₂₀ hydrocarbyl;
   (iv) Y is C or Si;
   (v)(A) R³ and R⁴ are selected independently from a C₁ to C₂₀ hydrocarbyl, or (B) when Y is C, YR³R⁴ is a substituted or an unsubstituted C₃ to C₇ monocyclic hydrocarbylidene moiety, wherein any substituent comprises an independently selected C₁ to C₁₅ hydrocarbyl group, C₁ to C₁₅ heterohydrocarbyl group, C₁ to C₁₅ organoheteryl group, or halide;
   (vi) R⁵ and R⁶ are selected independently from a C₁-C₂₀ hydrocarbyl;
   (vii) R⁷ is selected from a C₂-C₂₀ hydrocarbyl, and wherein optionally (A) any two of R⁵, R⁶, and R⁷, along with Si to which they are bonded form a ring having from 2 to 7 carbon atoms, or (B) R⁵, R⁶, and Si to which they are bonded form a ring having from 2 to 7 carbon atoms; and
   (viii) R⁸ and R⁹ are H₂, fused C₄H₄, or fused C₄H₈;
wherein each of R⁵, R⁶, and R⁷ is independently a non-alkenyl, a non-alkynyl, or a non-alkadienyl hydrocarbyl;
   and
(b) a metallocene activator.

According to a further aspect, this disclosure provides a process for polymerizing olefins, in which the process can comprise contacting at least one olefin monomer, which can comprise ethylene, and a catalyst composition under polymerization conditions to form a polyolefin, wherein the catalyst composition comprises the contact product of:
(a) a metallocene compound having the formula:

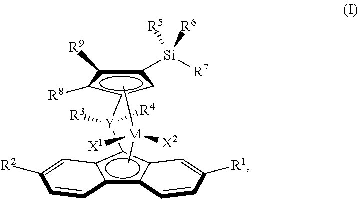

wherein
   (i) M is Zr or Hf;
   (ii) X¹ and X² are selected independently from a monoanionic ligand. or X¹ and X² together are a dianionic ligand (including, for example, a conjugated diene ligand bound to M by delocalized π-electrons, also referred to as a 1,4-diyl-2-ene ligand);
   (iii) R¹ and R² are selected independently from H or a C₁-C₂₀ hydrocarbyl;
   (iv) Y is C or Si;
   (v)(A) R³ and R⁴ are selected independently from a C₁ to C₂₀ hydrocarbyl, or (B) when Y is C, YR³R⁴ is a substituted or an unsubstituted C₃ to C₇ monocyclic hydrocarbylidene moiety, wherein any substituent comprises an independently selected C₁ to C₁₅ hydrocarbyl group, C₁ to C₁₅ heterohydrocarbyl group, C₁ to C₁₅ organoheteryl group, or halide;
   (vi) R⁵ and R⁶ are selected independently from a C₁-C₂₀ hydrocarbyl;
   (vii) R⁷ is selected from a C₂-C₂₀ hydrocarbyl, and wherein optionally (A) any two of R⁵, R⁶, and R⁷, along with Si to which they are bonded form a ring having from 2 to 7 carbon atoms, or (B) R⁵, R⁶, and Si to which they are bonded form a ring having from 2 to 7 carbon atoms; and
   (viii) R⁸ and R⁹ are H₂, fused C₄H₄, or fused C₄H₈;
wherein each of R⁵, R⁶, and R⁷ is selected independently from a non-alkenyl, a non-alkynyl, or a non-alkadienyl hydrocarbyl;
   and
(b) a metallocene activator.

In still a further aspect of the disclosure, there is provided a method of making a catalyst composition which can comprise contacting:
(a) a metallocene compound having the formula:

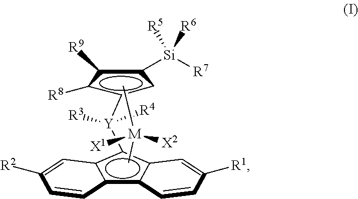

wherein
   (i) M is Zr or Hf;
   (ii) X¹ and X² are selected independently from a monoanionic ligand, or X¹ and X² together are a dianionic ligand (including, for example, a conjugated diene ligand bound to M by delocalized π-electrons, also referred to as a 1,4-diyl-2-ene ligand);
   (iii) R¹ and R² are selected independently from H or a C₁-C₂₀ hydrocarbyl;
   (iv) Y is C or Si;
   (v)(A) R³ and R⁴ are selected independently from a C₁ to C₂₀ hydrocarbyl, or (B) when Y is C, YR³R⁴ is a substituted or an unsubstituted C₃ to C₇ monocyclic hydrocarbylidene moiety, wherein any substituent comprises an independently selected C₁ to C₁₅ hydrocarbyl group, C₁ to C₁₅ heterohydrocarbyl group, C₁ to C₁₅ organoheteryl group, or halide;
   (vi) R⁵ and R⁶ are selected independently from a C₁-C₂₀ hydrocarbyl;
   (vii) R⁷ is selected from a C₂-C₂₀ hydrocarbyl, and wherein optionally (A) any two of R⁵, R⁶, and R⁷, along with Si to which they are bonded form a ring having from 2 to 7 carbon atoms, or (B) R⁵, R⁶, and Si to which they are bonded form a ring having from 2 to 7 carbon atoms; and
   (viii) R⁸ and R⁹ are H₂, fused C₄H₄, or fused C₄H₈;
wherein each of R⁵, R⁶, and R⁷ is selected independently from a non-alkenyl, a non-alkynyl, or a non-alkadienyl hydrocarbyl;
   and
(b) a metallocene activator.

In these Aspects described immediately above, the —SiR⁵R⁶R⁷ substituent can be absent an aryl group, that is, each of R⁵, R⁶, and R⁷ can be selected independently from a non-aryl moiety. Also in these Aspects described immediately above, the linking group YR³R⁴ can be absent an alkenyl moiety, that is, R³ and R⁴ can be selected independently from a non-alkenyl group. In a further aspect, R¹ and R² can be absent an alkenyl moiety, that is, R¹ and R² can be selected independently from a non-alkenyl moiety. In another aspect, R⁸ and R⁹ can be absent an alkenyl moiety, that is, R⁸ and R⁹ can be selected independently from a non-alkenyl moiety. Further, any combination of R¹, R², R³, R⁴, R⁸, or R⁹ can be absent an alkenyl moiety, that is, any combination of R¹, R², R³, R⁴, R⁸, and R⁹ can be selected from a non-alkenyl group. The metallocene compound also can comprise no alkynyl and no alkadienyl hydrocarbyl groups, that is, R¹, R², R³, R⁴, R⁸, and R⁹ can be selected independently from a non-alkynyl moiety or a non-alkadienyl moiety.

These and other aspects, features, and embodiments of the polymers, the catalyst compositions, the methods of making the compositions, the polymerization processes, and the metallocenes and associated compositions and methods are more fully described in the Detailed Description, the Figures, the Examples, and the claims which are provided herein.

### BRIEF DESCRIPTION OF THE FIGURES

FIG. 1 presents a graph of aging times for various metallocenes, as measured by days pre-contacted for sMAO with the metallocene compounds Me(3-buten-1-yl)C(2,7-t-Bu₂Fl)(Cp)ZrCl₂ (CM9), Ph₂C(Fl)(Cp-SiMe₂allyl)ZrCl₂ (CM7), and Ph₂C(Fl)(Cp-SiEt₃)ZrCl₂ (M9) versus the Long Chain Branching (LCB) frequency (LCBf, LCB/10⁶ total carbon atoms) as determined by the Janzen-Colby method (JC-α, 190° C.). FIG. 1 shows data for polymerization runs under substantially similar conditions within each metallocene data set, as recorded in Tables 8 and 9, specifically: CM9, Examples A8, A10, A11, and A12; CM7, Examples A18, A15, and A17; and M9, Examples A22-A27.

FIG. 2 illustrates the CIE (comonomer incorporation index) for the polymerizations using the unsubstituted fluorenyl metallocenes Ph₂C(Fl)(Cp-SiMe₃)ZrCl₂ (CM5, comparative Example 11), Ph₂C(Fl)(Cp-SiMe₂Et)ZrCl₂ (M2, Example 20), Ph₂C(Fl)(Cp-SiMe₂-n-Pr)ZrCl₂ (M4, Example 25), Ph₂C(Fl)(Cp-SiMe₂-n-Bu)ZrCl₂ (M5, Example 30), Ph₂C(Fl)(Cp-SiEt₃)ZrCl₂ (M9, Example 16), and Ph₂C(Fl)(Cp-Si-n-Pr₃)ZrCl₂ (M13, Example 23).

FIG. 3 provides the CIE (comonomer incorporation index) for the polymerizations using the di-t-butyl substituted fluorenyl metallocenes Ph₂C(2,7-t-Bu₂Fl)(Cp-SiMe₃)ZrCl₂ (CM6, Example 12), Ph₂C(2,7-t-Bu₂Fl)(Cp-SiMe₂Et)ZrCl₂ (M1, Example 22), Ph₂C(2,7-t-Bu₂Fl)(Cp-SiMe₂-n-Pr)ZrCl₂ (M3, Example 28), Ph₂C(2,7-t-Bu₂Fl)(Cp-SiMe₂-n-Bu)ZrCl₂ (M5Bu, Example 32), Ph₂C(2,7-t-Bu₂Fl)(Cp-SiEt₃)ZrCl₂ (M8, Example 21), and Ph₂C(2,7-t-Bu₂Fl)(Cp-Si-n-Pr₃)ZrCl₂ (M12, Example 24).

FIG. 4 provides the Long Chain Branching (LCB) frequency (LCB/10⁶ total carbon atoms) as determined by the Janzen-Colby method (JC-α, 190° C.) for polymerizations using the unsubstituted fluorenyl metallocenes Ph₂C(Fl)(Cp-SiMe₃)ZrCl₂ (CM5, comparative Example 11), Ph₂C(Fl)(Cp-SiMe₂Et)ZrCl₂ (M2, Example 20), Ph₂C(Fl)(Cp-SiMe₂-n-Pr)ZrCl₂ (M4, Example 25), Ph₂C(Fl)(Cp-SiMe₂-n-Bu)ZrCl₂ (M5, Example 30), Ph₂C(Fl)(Cp-SiEt₃)ZrCl₂ (M9, Example 16), and Ph₂C(Fl)(Cp-Si-n-Pr₃)ZrCl₂ (M13, Example 23).

FIG. 5 illustrates the Long Chain Branching (LCB) frequency (LCB/10⁶ total carbon atoms) as determined by the Janzen-Colby method (JC-α, 190° C.) for polymerizations using the di-t-butyl substituted fluorenyl metallocenes Ph₂C(2,7-t-Bu₂Fl)(Cp-SiMe₃)ZrCl₂ (CM6, Example 12), Ph₂C(2,7-t-Bu₂Fl)(Cp-SiMe₂Et)ZrCl₂ (M1, Example 22), Ph₂C(2,7-t-Bu₂Fl)(Cp-SiMe₂-n-Pr)ZrCl₂ (M3, Example 28), Ph₂C(2,7-t-Bu₂Fl)(Cp-SiMe₂-n-Bu)ZrCl₂ (M5Bu, Example 32), Ph₂C(2,7-t-Bu₂Fl)(Cp-SiEt₃)ZrCl₂ (M8, Example 21), and Ph₂C(2,7-t-Bu₂Fl)(Cp-Si-n-Pr₃)ZrCl₂ (M12, Example 24).

FIG. 6 presents the aTREF (analytical Temperature Rising Elution Fractionation) scan for the poly(ethylene-co-1-hexene) produced using unbridged metallocene (n-BuCp)₂ZrCl₂ (CM1, comparative Example 4), which provided a Mw/Mn of 2.08.

FIG. 7 presents the GPC-IR Molecular Weight Distribution (MWD) scan for the poly(ethylene-co-1-hexene) produced using unbridged metallocene (n-BuCp)₂ZrCl₂ (CM1, comparative Example 4) and also shows the Short Chain Branching Distribution (SCBD) profile across the molecular weight distribution, plotting the number of Short Chain Branches (SCB) per 1000 total carbon atoms versus log₁₀ of the molecular weight of the poly(ethylene-co-1-hexene) over the range from d85 to d15.

FIG. 8 compares the aTREF (analytical Temperature Rising Elution Fractionation) scans for the poly(ethylene-co-1-hexene) polymers produced using a comparative catalyst with a SiMe₃-substituted cyclopentadienyl ligand versus a series of bulkier SiR₃-substituted cyclopentadienyl ligands, all with di-t-butyl-substituted fluorenyl ligand, specifically, Ph₂C(2,7-t-Bu₂Fl)(Cp-SiMe₃)ZrCl₂ (CM6, Example 12), Ph₂C(2,7-t-Bu₂Fl)(Cp-SiMe₂Et)ZrCl₂ (M1, Example 22), Ph₂C(2,7-t-Bu₂Fl)(Cp-SiMe₂-n-Pr)ZrCl₂ (M3, Example 28), Ph₂C(2,7-t-Bu₂Fl)(Cp-SiMe₂-n-Bu)ZrCl₂ (M5Bu, Example 32), and Ph₂C(2,7-t-Bu₂Fl)(Cp-SiMe₂₋₂-Norbornyl)ZrCl₂ (M6, Example 33).

FIG. 9 illustrates the GPC-IR Molecular Weight Distribution (MWD) scan for the poly(ethylene-co-1-hexene) polymers shown in FIG. 8, namely, Ph₂C(2,7-t-Bu₂Fl)(Cp-SiMe₃)ZrCl₂ (CM6, Example 12), Ph₂C(2,7-t-Bu₂Fl)(Cp-SiMe₂Et)ZrCl₂ (M1, Example 22), Ph₂C(2,7-t-Bu₂Fl)(Cp-SiMe₂-n-Pr)ZrCl₂ (M3, Example 28), Ph₂C(2,7-t-Bu₂Fl)(Cp-SiMe₂-n-Bu)ZrCl₂ (M5Bu, Example 32), and Ph₂C(2,7-t-Bu₂Fl)(Cp-SiMe₂₋₂-Norbornyl)ZrCl₂ (M6, Example 33). The Short Chain Branching Distribution (SCBD) profile, plotting the number of short chain branches per 1000 total carbon (TC) atoms versus log₁₀ of the molecular weight of the poly(ethylene-co-1-hexene) over the range from d85 to d15, is also shown.

FIG. 10 compares the aTREF scans for the poly(ethylene-co-1-hexene) polymers produced using a comparative catalyst with a SiMe₃-substituted cyclopentadienyl ligand versus a series of more bulky SiR₃-substituted cyclopentadienyl ligands, all with an unsubstituted fluorenyl ligand, specifically, Ph₂C(Fl)(Cp-SiMe₃)ZrCl₂ (CM5, Example 11), Ph₂C(Fl)(Cp-SiMe₂Et)ZrCl₂ (M2, Example 20), Ph₂C(Fl)(Cp-SiMe₂-n-Pr)ZrCl₂ (M4, Example 25), Ph₂C(Fl)(Cp-SiMe₂-n-Bu)ZrCl₂ (M5, Example 30), and Ph₂C(Fl)(Cp-SiMe₂₋₂-Norbornyl)ZrCl₂ (M7, Example 31).

FIG. 11 presents the GPC-IR Molecular Weight Distribution (MWD) scans for the same poly(ethylene-co-1-hexene) polymers shown in FIG. 10, which are produced using Ph₂C(Fl)(Cp-SiMe₃)ZrCl₂ (CM5, Example 11), Ph₂C(Fl)(Cp-SiMe₂Et)ZrCl₂ (M2, Example 20), Ph₂C(Fl)(Cp-SiMe₂-n-Pr)ZrCl₂ (M4, Example 25), Ph₂C(Fl)(Cp-SiMe₂-n-Bu)ZrCl₂ (M5, Example 30), and Ph₂C(Fl)(Cp-SiMe₂₋₂-Norbornyl)ZrCl₂ (M7, Example 31). The Short Chain Branching Distribution (SCBD) profiles over the range from d85 to d15 are also shown.

FIG. 12 provides the aTREF (analytical Temperature Rising Elution Fractionation) scans for the polyethylenes produced according to Example 15, Example 16, Example 17, and Example 18, all made using the metallocene Ph₂C(Fl)(Cp-SiEt₃)ZrCl₂ (M9).

FIG. 13 presents the GPC-IR Molecular Weight Distribution (MWD) scans of the poly(ethylene-co-1-hexene) polymers according to Example 15 and Example 16, both made using metallocene Ph₂C(Fl)(Cp-SiEt₃)ZrCl₂ (M9). The Short Chain Branching Distribution (SCBD) profile over the range from d85 to d15, is shown, illustrating how the SCBD slope reverses signs from −1.08 (Example 15) to +0.59 (Example 16).

FIG. 14 compares the aTREF (analytical Temperature Rising Elution Fractionation) scans for the polyethylene copolymers produced using analogous metallocenes having unsaturated versus saturated silyl substituents, namely, Ph₂C(Fl)(Cp-SiMe₂Allyl)ZrCl₂ (CM7, comparative Examples 26 and 27) and Ph₂C(Fl)(Cp-SiMe₂-n-Pr)ZrCl₂ (M4, Example 25).

FIG. 15 illustrates the aTREF (analytical Temperature Rising Elution Fractionation) scans for the polyethylenes copolymers produced using the metallocenes having the same SiEt₃-substituted cyclopentadienyl and unsubstituted fluorenyl ligands, but different bridging groups, namely, Me₂C(Fl)(Cp-SiEt₃)ZrCl₂ (M11, Example 13), Ph₂C(Fl)(Cp-SiEt₃)ZrCl₂ (M9, Example 15), and (cyclopenta-1,1-diyl)(Fl)(Cp-SiEt₃)ZrCl₂ (M16, Example 35.

FIG. 16 and FIG. 17 illustrate the effect of t-butyl fluorenyl substitution on a nominal melt index of 1 and density of 0.93 g/cm³ polymer composition, showing aTREF scans and the GPC-IR Molecular Weight Distribution (MWD) scans, respectively, of the polyethylenes produced with metallocenes having an unsubstituted fluorenyl ligand versus a di-t-butyl fluorenyl substituted fluorenyl ligands.

FIG. 16 presents the aTREF (analytical Temperature Rising Elution Fractionation) scans for the poly(ethylene-co-1-hexene) produced using Ph₂C(Fl)(Cp-Si-n-Pr₃)ZrCl₂ (M13, Example 23) and Ph₂C(2,7-t-Bu₂Fl)(Cp-Si-n-Pr₃)ZrCl₂ (M12, Example 24).

FIG. 17 presents GPC-IR Molecular Weight Distribution (MWD) scans for the poly(ethylene-co-1-hexene) polymers shown in FIG. 16 produced using Ph₂C(Fl)(Cp-Si-n-Pr₃)ZrCl₂ (M13, Example 23) and Ph₂C(2,7-t-Bu₂Fl)(Cp-Si-n-Pr₃)ZrCl₂ (M12, Example 24), along with the Short Chain Branching Distribution (SCBD) profile over the range from d85 to d15.

FIG. 18 compares the aTREF scans for the polyethylenes produced using a comparative metallocene with an unsubstituted cyclopentadienyl ligand versus a SiMe₃-substituted cyclopentadienyl ligand analogs, each containing a cyclopenta-1,1-diyl bridging moiety. Shown in this figure are data for polymer produced using (cyclopenta-1,1-diyl)(2,7-t-Bu₂Fl)(Cp)ZrCl₂ (CM8, comparative Example 34) and (cyclopenta-1,1-diyl)(2,7-t-Bu₂Fl)(Cp-SiEt₃)ZrCl₂ (M15, and Example 36).

FIG. 19 illustrates GPC-IR Molecular Weight Distribution (MWD) scans for the same poly(ethylene-co-1-hexene) polymers of FIG. 18, produced using (cyclopenta-1,1-diyl)(2,7-t-Bu₂Fl)(Cp)ZrCl₂ (CM8, comparative Example 34) and (cyclopenta-1,1-diyl)(2,7-t-Bu₂Fl)(Cp-SiEt₃)ZrCl₂ (M15, and Example 36), along with the Short Chain Branching Distribution (SCBD) profile, plotting over the range from d85 to d15.

FIG. 20 compares the aTREF scans for the polyethylenes produced using metallocenes having Cp-SiEt₃ group versus a Cp-Si-n-Pr₃ group, with each metallocene containing a cyclopenta-1,1-diyl bridging moiety and an unsubstituted fluorenyl ligand, specifically, polyethylenes produced using (cyclopenta-1,1-diyl)(Fl)(Cp-SiEt₃)ZrCl₂ (M16, Example 35) and (cyclopenta-1,1-diyl)(Fl)(Cp-Si-n-Pr₃)ZrCl₂ (M18, Example 37 and Example 38).

FIG. 21 illustrates GPC-IR Molecular Weight Distribution (MWD) scans for the poly(ethylene-co-1-hexene) shown in FIG. 20, produced using (cyclopenta-1,1-diyl)(Fl)(Cp-SiEt₃)ZrCl₂ (M16, Example 35) and (cyclopenta-1,1-diyl)(Fl)(Cp-Si-n-Pr₃)ZrCl₂ (M18, Example 37 and Example 38), along with the Short Chain Branching Distribution (SCBD) profile, plotting the number of short chain branches per 1000 total carbon atoms versus log₁₀ of the molecular weight of the polymer over the range from d85 to d15.

FIG. 22 illustrates theoretical GPC molecular weight distribution curves of polymer molecular weight (Mw) versus the weight fraction of the polymer (top) for an idealized case of two non-equivalent active catalyst sites having equal activity, producing Shultze-Flory distributions that are arbitrarily labeled as a “syn” site representing a lower CIE and hydrogen termination rate kₜH₂, relative to an “anti” site having a higher CIE and termination to H₂ rate. The sequence of chromatograms represents five polymerizations in which hydrogen concentration [H₂] increases from left to right with each run.

### DETAILED DESCRIPTION OF THE DISCLOSURE

It now has been unexpectedly discovered that when certain metallocenes having a specific substitution pattern are activated and used to polymerize ethylene, especially in the presence of an alpha-olefin comonomer, highly active catalysts are formed and polyethylenes are produced that have unexpected properties that make them very useful, for example, as film resins. The metallocenes which provide the high activities and desirable resin properties are non-olefin-tethered ansa-metallocenes, having a single atom bridge, and which are absent an alkenyl substituent on the bridging atom or on any η⁵-cycloalkadienyl ligand. Moreover, these non-olefin-tethered ansa-metallocenes can include a substituted or an unsubstituted fluorenyl ligand, which is linked to a substituted cyclopentadienyl or indenyl ligand by a one-atom bridge, wherein the cyclopentadienyl or indenyl ligand bears a silyl substituent having the general formula —SiR⁵R⁶R⁷. In this silyl formula, two of the silyl hydrocarbyl groups, R⁵ and R⁶, are selected independently from a C₁-C₂₀ hydrocarbyl, and wherein one of the silyl hydrocarbyl groups, designated R⁷, is selected from a C₂-C₂₀ hydrocarbyl. Thus, R⁷ is a C₂₊ group, that is a non-methyl “C_{≥2}” group. In a further aspect, none of R⁵, R⁶, and R⁷ is an alkenyl group.

The presence of the specific —SiR⁵R⁶R⁷ silyl group directly bound to the cyclopentadienyl or indenyl ligand in combination with the other metallocene substituents has been found to provide not only unexpected combinations of the desirable properties described above, but can also provide surprisingly high activities. Moreover, these catalysts are distinguished from those metallocenes having a SiMe₃-substituted η⁵-alkadienyl ligands, for example, a SiMe₃-substituted cyclopentadienyl ligand. For example, the disclosed metallocenes may provide polyethylene resins having low LCB incorporation frequency, SCB distribution (SCBD) profile over the range from d85 to d15 having a slope of about 0 (flat SCBD) or a positive slope (a so-called “reverse” SCBD), and other useful properties. The present disclosure provides metallocenes that avoid the potential problems and associated with the olefin-tethered ansa-metallocenes and yet provide excellent LCB and other properties.

To more clearly define the terms and phrases used herein, the following definitions are provided. To the extent that any definition or usage provided by any document incorporated herein by reference conflicts with the definition or usage provided herein, the definition or usage provided herein controls.

### Definitions and Explanation of Terms

Catalyst composition and catalyst system. Terms such as “catalyst composition,” “catalyst mixture,” “catalyst system,” and the like are used to represent the combination of recited components which ultimately form, or are used to form, the active catalyst according to this disclosure. The use of these terms does not depend upon any specific contacting steps, order of contacting, whether any reaction may occur between or among the components, or any product which may form from contacting any or all of the recited components. The use of these terms also does not depend upon the nature of the active catalytic site, or the fate of any co-catalyst, the metallocene compound(s), or support-activator, after contacting or combining any of these components in any order. Therefore, these and similar terms encompass the combination of initial recited components or starting components of the catalyst composition, as well as any product(s) which may result from contacting these initial recited starting components, regardless of whether the catalyst composition is heterogeneous or homogenous or includes soluble and insoluble components. The terms “catalyst” and “catalyst system” or “catalyst composition” may be used interchangeably, and such use will be apparent to the skilled person from the context of the disclosure.

Catalyst activity. Unless otherwise specified, the terms “activity”, “catalyst activity”, “catalyst composition activity” and the like refer to the polymerization activity of a catalyst composition comprising the contact product of a metallocene disclosed herein or a reference or comparative metallocene with an activator, specifically, solid methyl aluminoxane (sMAO). Activity can be expressed in different ways but is usually calculated in units how much polymer is generated per unit of a catalyst component such as metallocene or support-activator per hour, for example, g/g/hr (grams polymer per gram reaction component per hour) or kg/mol/hr (kilograms polymer per mole reaction component per hour). Specific examples of expressing catalyst activity include the weight of polymer generated per unit amount of metallocene per hour of polymerization (kg PE/mmol metallocene (MCN)/hr), or the weight of polymer generated per unit weight of activator, per hour of polymerization (g PE/g Activator (Activ)/hr). These activities are calculated absent any non-recited catalyst components. For example, the calculated metallocene activity ignores the amounts of activator such as sMAO, and the calculated activator activity ignores the amounts of metallocene.

Terms such as “increased activity” or “improved activity” can be used to describe the activity of a catalyst composition according to this disclosure which is greater than the activity of a comparative catalyst composition that uses the same catalyst components such as solid activator and co-catalyst, except that the comparative catalyst composition utilizes a different metallocene, in which polymerizations are conducted under the same conditions except for the different metallocene.

Contact product. The term “contact product” is used herein to describe compositions wherein the components are combined together or “contacted” in any order, unless a specific order is stated or required or implied by the context of the disclosure, in any manner, and for any length of time. Although “contact product” can include reaction products, the term contact product does not require that the respective components react with one another, and this term is used regardless of any reaction which may or may not occur upon contacting the recited components. To form a contact product, for example, the recited components can be contacted by blending or mixing or the components can be contacted by adding the components in any order or simultaneously, for example, into a liquid carrier. Further, the contacting of any components can occur in the presence or absence of any other component of the compositions described herein, unless otherwise stated or required or implied by the context in which the term is used. Combining or contacting the recited components or any additional materials can be carried out by any suitable method. Therefore, the term “contact product” includes mixtures, blends, solutions, slurries, reaction products, and the like, or combinations thereof. Similarly, the term “contacting” is used herein to refer to materials which may be blended, mixed, slurried, dissolved, reacted, treated, or otherwise contacted in some manner.

Pre-Contact time or Contact time. The terms “pre-contact time”, “pre-contacting time”, “contact time”, “contacting time”, and the like are used to describe the amount of time the components of a “contact product” remain in contact prior to the use of that contact product for the polymerization of ethylene and an optional co-monomer. For example, the “pre-contact time” can refer to the amount of time that a metallocene and an activator, a co-catalyst, a scavenger, or any combination thereof are contacted prior to using the contact product as a catalyst system for the polymerization of olefins. Therefore, in one aspect, “pre-contacting” is related to the contact time prior to use of the contact product as a catalyst system, meaning that there is a time period starting from the initial contact of components such as the metallocene and an activator such sMAO and ending when the contact product is used in the catalytic polymerization of ethylene and an optional co-monomer.

Metallocene compound. The metallocenes described in this disclosure can have specific substituents and substitution patterns, as well as the absence of certain substituents. In those instances when the term “metallocene” or “metallocene compound” is used herein to describe the general class of catalyst components, these terms are used to describe a transition metal or lanthanide metal compound comprising at least one substituted or unsubstituted cycloalkadienyl-type ligand or alkadienyl-type ligand, including heteroatom analogs thereof, regardless of the specific bonding mode, for example, regardless of whether the cycloalkadienyl-type ligand or alkadienyl-type ligand are bonded to the metal in an η₅-, η³-, or η¹-bonding mode, and regardless of whether more than one of these bonding modes is accessible by such ligands. Partially saturated analogs include compounds comprising partially saturated η⁵-cycloalkadienyl-type ligands, examples of which include but are not limited to tetrahydroindenyl, tetrahydrofluorenyl, octahydrofluorenyl, partially saturated indenyl, partially saturated fluorenyl, substituted analogs thereof, and the like. Therefore, a metallocene ligand can be considered in this disclosure to include at least one cyclopentadienyl, indenyl, fluorenyl, tetrahydroindenyl, tetrahydrofluorenyl, octahydrofluorenyl, pentadienyl, allyl, boratabenzenyl, 1,2-azaborolyl, or 1,2-diaza-3,5-diborolyl ligand, including substituted analogs thereof. For example, any substituent can be selected independently from a halide, a C₁-C₂₀ hydrocarbyl, a C₁-C₂₀ heterohydrocarbyl, a C₁-C₂₀ organoheteryl, a fused C₄-C₁₂ carbocyclic moiety, or a fused C₄-C₁₁ heterocyclic moiety having at least one heteroatom selected independently from nitrogen, oxygen, sulfur, or phosphorus. In some contexts, the metallocene is referred to simply as the “catalyst,” in much the same way the term “co-catalyst” is used herein to refer to, for example, an organoaluminum compound. The metallocene may be abbreviated “MCN” or “M”, and comparative metallocenes may be abbreviated, for example, as “CM”.

Co-catalyst. In an aspect, “co-catalyst” may be used herein to refer to a chemical reagent, compound, or composition which is capable of providing a polymerization-activatable ligand to a metallocene compound or imparting a ligand to the metallocene which can initiate polymerization when the metallocene is otherwise activated. Polymerization-activatable ligands include, but are not limited to, hydrocarbyl groups such as alkyls such as methyl or ethyl, aryls and substituted aryls such as phenyl or tolyl, substituted alkyls such as benzyl or trimethylsilylmethyl (—CH₂SiMe₃), hydride, silyl and substituted groups such as trimethylsilyl, and the like. Therefore, in an aspect, a co-catalyst can be an alkylating agent, a hydriding agent, a silylating agent, and the like. In an aspect, for example, the term “co-catalyst” can be used to refer to an organoaluminum compound that may constitute a component of the catalyst composition in combination with an “activator” (metallocene activator), but also may refer activating components of the catalyst composition including, but not limited to, aluminoxanes, organoboron compounds, ionizing compounds, solid oxides treated with an electron-withdrawing anion, and the like. The term co-catalyst may be used regardless of the actual function of the compound or any chemical mechanism by which the compound may operate. For example, there are no limitations as to the mechanism by which the co-catalyst provides a polymerization-activatable ligand to the metallocene compound. For example, the co-catalyst can engage in a metathesis reactions to exchange an exchangeable ligand such as a halide or alkoxide on the metallocene compound with a polymerization-activatable/initiating ligand such as methyl or hydride. In an aspect, the co-catalyst can be an optional component of the catalyst composition, for example, when the metallocene compounds already includes a polymerization-activatable/initiating ligand such as methyl or hydride, or the “activator” can function to provide a polymerization-activatable/initiating ligand and activate the metallocene to polymerize olefins. In another aspect, and as understood by the person skilled in the art, even when the metallocene compound includes a polymerization-activatable ligand, a co-catalyst can be used for other purposes, such as to scavenge moisture from the polymerization reactor or process. According to a further aspect and as the context requires or allows, the term “co-catalyst” may also refer to an “activator” or may be used interchangeably with “activator” as explained herein.

Organoaluminum compounds and organoboron compounds. The terms organoaluminum compound and an organoboron compounds as used herein include neutral compounds such as AlMe₃ and BEt₃ and also include anionic complexes such as LiAlMe₄, LiAlH₄, NaBH₄, and LiBEt₄, and the like. Thus, unless otherwise specified, hydride compounds of aluminum and boron are included in the definitions of organoaluminum and organoboron compounds, respectively, whether the compound is neutral or anionic.

Activator. An “activator” is a term used interchangeably with a “metallocene activator” and as used herein, refers to a substance, composition, or compound which is capable of converting a metallocene compound into an active catalyst system which can polymerize olefins, either alone or in combination with another agent such as a co-catalyst. The term “activator” can be used regardless of any actual activating mechanism. For example, the contact product of a metallocene compound and an activator such as methylaluminoxane alone can form an active catalyst composition. In another example, an activator such as a solid oxide treated with an electron withdrawing anion (e.g. fluorided silica-alumina) in combination with a trialkyl aluminum co-catalyst can convert a dichloro-substituted metallocene compound into an active catalyst composition. Therefore, in one aspect, an “activator” may convert the contact product of a metallocene compound and a co-catalyst which provides an activatable ligand (such as an alkyl or a hydride) to the metallocene, for example when the metallocene compound does not already comprise such a ligand, into a catalyst system which can polymerize olefins. In this example, and while not intending to be bound by theory, the activator may interact in some manner with a ligand on the metallocene such as chloride and may loosely coordinate and/or to form an incipient cationic metallocene, to activate the metallocene to polymerization. Illustrative activators can include, but are not limited to, support-activators, aluminoxanes, organoboron or organoborate compounds, ionizing compounds such as ionizing ionic compounds, and the like. Aluminoxanes, organoboron or organoborate compounds, and ionizing compounds may be referred to as “activators” or “co-activators” when used in a catalyst composition in which a support-activator or other type activator is present. According to an aspect, and as the context requires or allows, the term “activator” may also refer to an “co-catalyst” or may be used interchangeably with “co-catalyst” as explained herein.

Support-Activator. The term “support-activator” as used herein, refers to an activator in a solid form, such as ion-exchanged-clays, protic-acid-treated clays, clay heteroadducts, or pillared clays, solid oxides treated with a fluoride or other electron-withdrawing anion, and similar insoluble supports which also function as activators. When the support-activator is combined with a metallocene with an activatable ligand or optionally with a metallocene and a co-catalyst which can provide an activatable ligand, provides a catalyst system which can polymerize olefins. Solid methylaluminoxane (sMAO or solid MOA) may be referred to herein as either an “activator” or a “support-activator”. Solid MAO can function to both alkylate a metallocene dihalide, dialkoxide, or similar compound and activate the compound to catalytically polymerize olefins.

Hydrocarbyl group. As used herein, the term “hydrocarbyl” group is used according to the art-recognized IUPAC definition, as a univalent, linear, branched, or cyclic group formed by removing a single hydrogen atom from a parent hydrocarbon compound. Unless otherwise specified, a hydrocarbyl group can be aliphatic or aromatic; saturated or unsaturated; and can include linear, cyclic, branched, and/or fused ring structures; unless any of these are otherwise specifically excluded. See IUPAC Compendium of Chemical Terminology, 2^{nd} Ed (1997) at 190. Examples of hydrocarbyl groups include, but are not limited to, aryl, alkyl, cycloalkyl, alkenyl, cycloalkenyl, cycloalkadienyl, alkynyl, aralkyl (also termed “arylalkyl”), alkaryl (also termed “alkylaryl”), aralkenyl (also termed “arylalkenyl”), and aralkynyl (also termed “arylalkynyl”) groups and the like.

Heterohydrocarbyl group. The term “heterohydrocarbyl” group is used in this disclosure to encompass a univalent, linear, branched, or cyclic group, formed by removing a single hydrogen atom from a carbon atom of a parent “heterohydrocarbon” molecule in which at least one carbon atom is replaced by a heteroatom. The parent heterohydrocarbon can be aliphatic or aromatic. Examples of “heterohydrocarbyl” groups include halide-substituted, nitrogen-substituted, phosphorus-substituted, silicon-substituted, oxygen-substituted, and sulfur-substituted hydrocarbyl groups in which a hydrogen has been removed form a carbon atom to generate a free valence. Examples of heterohydrocarbyl groups include, but are not limited to, —CH₂OCH₃, —CH₂SPh, —CH₂NHCH₃, —CH₂CH₃NMe₂, —CH₂SiMe₃, —CMe₂SiMe₃, —CH₂(C₆H₄-4-OMe), —CH₂(C₆H₄-4-NHMe), —CH₂(C₆H₄-4-PPh₂), —CH₂CH₃PEt₂, —CH₂Cl, —C₆H₄-4-OMe, —C₆H₄Cl, —CH₂(2,6-C₆H₃Cl₂), and the like. Heterohydrocarbyl encompasses both heteroaliphatic groups (including saturated and unsaturated groups) and heteroaromatic groups. Therefore, heteroatom-substituted vinylic groups, heteroatom-substituted alkenyl groups, heteroatom-substituted dienyl groups, and the like are all encompassed by heterohydrocarbyl groups.

Organoheteryl group. The term “organoheteryl” group is also used in accordance with its art-recognized IUPAC definition, as univalent group containing carbon, which is thus organic, but which has its free valence at an atom other than carbon. See IUPAC Compendium of Chemical Terminology, 2^{nd} Ed (1997) at 284. An organoheteryl group can be linear, branched, or cyclic, and includes such common groups as alkoxy, aryloxy, organothio (or organylthio), organogermanium (or organylgermanium), acetamido, acetonylacetanato, alkylamido, dialkylamido, arylamide, diarylamido, trimethylsilyl, and the like. Groups such as —OMe, —OPh, —S(tolyl), —NHMe, —NMe₂, —N(aryl)₂, —SiMe₃, —PPh₂, —O₃S(C₆H₄)Me, —OCF₂CF₃, —O₂C(alkyl), —O₂C(aryl), —N(alkyl)CO(alkyl), —N(aryl)CO(aryl), —N(alkyl)C(O)N(alkyl)₂, hexafluoroacetonylacetanato, and the like.

Organyl group. An organyl group is used in this disclosure in accordance with the IUPAC definition to refer to any organic substituent group, regardless of functional type, having one free valence at a carbon atom, e.g. CH₃CH₂—, ClCH₂C—, CH₃C(═O)—, 4-pyridylmethyl, and the like. An organyl group can be linear, branched, or cyclic, and the term “organyl” may be used in conjunction with other terms, as in organylthio- (for example, MeS—) and organyloxy.

Heterocyclyl group. The IUPAC Compendium compares organyl groups to other groups such as heterocyclyl groups and organoheteryl groups. These terms are set out in the IUPAC Compendium of Chemical Terminology, 2^{nd} Ed (1997) as follows, which demonstrates the convention to associate the “-yl” suffix on the portion of the molecule or group that bears the valence from the missing hydrogen. Thus, heterocyclyl groups are defined as univalent groups formed by removing a hydrogen atom from any ring atom of a heterocyclic compound. For example, both a piperidin-1-yl group which is bonded through the piperidine nitrogen atom, and a piperidin-2-yl group which is bonded through the carbon atom adjacent the piperidine nitrogen atom are heterocyclyl groups. However, the piperidin-1-yl group is also considered an organoheteryl group, whereas the piperidin-2-yl group is also considered a heterohydrocarbyl group. Thus, the valence of a “heterocyclyl” can occur on any appropriate cyclic atom, whereas the valence of a “organoheteryl” occurs on a heteroatom and the valence of a heterohydrocarbyl occurs on a carbon atom.

Hydrocarbylene group and hydrocarbylidene group. A “hydrocarbylene” group is also defined according to its ordinary and customary meaning, as set out in the IUPAC Compendium of Chemical Terminology, 2^{nd} Ed (1997), as a divalent group formed by removing two hydrogen atoms from a hydrocarbon, the free valencies of which are not engaged in a double bond. Examples of hydrocarbylene groups include, for example, 1,2-phenylene, 1,3-phenylene, 1,3-propandiyl (—CH₂CH₂CH₂—), cyclopentylene which is bridging (>CC₄H₈) and does not form a double bond (sometimes referred to as a “bridging cyclopentylidene”), or methylene which is bridging (>CH₂) and does not form a double bond. A hydrocarbylene group in which the free valencies are not engaged in a double bond is distinguished from a hydrocarbylidene group such as an alkylidene group. A “hydrocarbylidene” group is also defined according to its ordinary and customary meaning, as stated in the IUPAC Compendium of Chemical Terminology, 2^{nd} Ed (1997), as a divalent group (e.g. R₂C═) formed by removing two hydrogen atoms from the same carbon atom of a hydrocarbon, the free valencies of which are engaged in a double bond. An alkylidene group is an exemplary hydrocarbylidene and is defined as a divalent group formed from an alkane by removing two hydrogen atoms from the same carbon atom, the free valencies of which are part of a double bond. Examples of alkylidene groups such as ═CHMe, CHEt, ═CMe₂, ═CHPh, or methylene in which the methylene carbon forms a double bond (═CH₂).

Heterohydrocarbylene group and heterohydrocarbylidene group. The term “heterohydrocarbylene” group, by analogy to hydrocarbylene group, is used to refer to a divalent group formed by removing two hydrogen atoms from a parent heterohydrocarbon molecule, the free valencies of which are not engaged in a double bond. For example, the hydrogen atoms can be removed from two carbon atoms, two heteroatoms, or one carbon and one heteroatom, such that the free valencies are not engaged in a double bond. Examples of “heterohydrocarbylene” groups include but are not limited to —CH₂OCH₂—, —CH₂NPhCH₂—, —SiMe₂(1,2-C₆H₄)SiMe₂-, —CMe₂SiMe₂-, —CH₂NCMe₃-, —CH₂CH₂PMe-, —CH₂[1,2-C₆H₃(4-OMe)]CH₂—, bridging groups that do not form a double bond, and the like. By analogy to a hydrocarbylidene, a “heterohydrocarbylidene” group is a divalent group formed from a heterohydrocarbon by removing two hydrogen atoms from the same carbon atom, the free valencies of which are part of a double bond. Examples of heterohydrocarbylidene groups include, but are not limited to groups such as ═CHNMe₂, ═CHOPh, ═CMeNMeCH₂Ph, ═CHSiMe₃, ═CHCH₂Cl, and the like.

Alkenyl group. As used herein, the term “alkenyl” group is used according to the art-recognized IUPAC definition, as a univalent, linear, branched, or cyclic group formed by removing a single hydrogen atom from an alkene. Unless otherwise specified, and as the context requires or allows, the single hydrogen atom can be removed from any carbon of the alkene, therefore examples of alkenyl groups include, but are not limited to vinyl (—CH═CH₂), allyl, butenyl, pentenyl, hexenyl, and the like.

Halide and halogen. The terms “halide” and “halogen” are used herein to refer to the ions or atoms of fluorine, chlorine, bromine, or iodine, individually or in any combination, as the context and chemistry allows or dictates. These terms may be used interchangeably regardless of the charge or the bonding mode of these atoms.

Polymer. The term “polymer” is used herein generically to include olefin homopolymers, copolymers, terpolymers, and so forth. Generally, a copolymer is derived from an olefin monomer and one olefin comonomer, while a terpolymer is derived from an olefin monomer and two olefin comonomers, although when the context requires, the term copolymer may be used to describe a polymer from two or more monomers. Accordingly, “polymer” encompasses copolymers, terpolymers, and the like, derived from any olefin monomer and comonomer(s) disclosed herein. Similarly, an ethylene polymer would include ethylene homopolymers, ethylene copolymers, ethylene terpolymers, and so forth. Therefore, an olefin copolymer, such as an ethylene copolymer, can be derived from ethylene and a comonomer, such as propylene, 1-butene, 1-hexene, or 1-octene. If the monomer and comonomer were ethylene and 1-hexene, respectively, the resulting polymer would be categorized an as ethylene/1-hexene copolymer. In like manner, the term “polymerization” includes homopolymerization, copolymerization, terpolymerization, and so forth. For example, a copolymerization process includes contacting one olefin monomer such as ethylene and one olefin comonomer such as 1-hexene to produce a copolymer. Well-known abbreviations for polyolefin types, such as “HDPE” for high-density polyethylene, may be used herein. Furthermore, unless otherwise stated or the context otherwise requires, the term polymer is not limited by molecular weight and therefore encompasses both lower molecular weight polymers, sometimes referred to as oligomers, as well as higher molecular weight polymers. The relative terms “lower” and “higher” or “low” and “high” are understood by those skilled in the art and in the context in which the terms are applied.

Substituted. Various chemical groups or moieties may be described as substituted or unsubstituted, and unless otherwise indicated, a “substituted” group can constitute the named chemical moiety in which one or more hydrogens atom can be substituted independently with a substituent selected from C₁ to C₁₅ hydrocarbyl group, C₁ to C₁₅ heterohydrocarbyl group, C₁ to C₁₅ organoheteryl group, or halide.

Additional Explanations of Terms. The following additional explanations of terms are provided to fully disclosed aspects of the disclosure and claims.

Several types of numerical ranges are disclosed herein, including but not limited to, numerical ranges of a number of atoms, basal spacings, weight ratios, molar ratios, percentages, temperatures, and so forth. When disclosing or claiming a range of any type, Applicant's intent is to disclose or claim individually each possible number that such a range could reasonably encompass, consistent with the written description and the context, and including the end points of the range and any sub-ranges and combinations of sub-ranges encompassed therein. For example, when the Applicant discloses or claims a chemical moiety that has a certain number of carbon atoms, such as a C1 to C12 (or C₁ to C₁₂) alkyl group, or in alternative language having from 1 to 12 carbon atoms, the Applicant's intent is to refer to a moiety that can be selected independently from an alkyl group having 1, 2, 3, 4, 5, 6, 7, 8, 9, 10, 11, or 12 carbon atoms, as well as any range between these two numbers (for example, a C1 to C6 alkyl group), and also including any combination of ranges between these two numbers (for example, a C2 to C4 and C6 to C8 alkyl group). Applicants reserve the right to proviso out or exclude any individual members of any such range or group, including any sub-ranges or combinations of sub-ranges within the group, that can be claimed according to a range or in any similar manner, if for any reason Applicants choose to claim less than the full measure of the disclosure, for example, to account for a reference that Applicants may be unaware of at the time of the filing of the application.

Further, Applicant reserves the right to proviso out or exclude any individual substituents, analogs, compounds, ligands, structures, or groups thereof, or any members of a claimed group, if for any reason Applicants choose to claim less than the full measure of the disclosure, for example, to account for a reference that Applicants may be unaware of at the time of the filing of the application.

In another aspect, any range of numbers recited in the specification or claims, such as that representing a particular set of properties, units of measure, conditions, physical states or percentages, is intended to literally incorporate expressly herein by reference or otherwise, any number falling within such range, including any subset of numbers within any range so recited. For example, whenever a numerical range with a lower limit, RL, and an upper limit RU, is disclosed, any number R falling within the range is specifically disclosed. In particular, the following numbers R within the range are specifically disclosed: R=RL+k(RU−RL), wherein k is a variable ranging from 1% to 100% with a 1% increment, e.g., k is 1%, 2%, 3%, 4%, 5% . . . 50%, 51%, 52% . . . 95%, 96%, 97%, 98%, 99%, or 100%. Moreover, any numerical range represented by any two values of R, as calculated above is also specifically disclosed.

For any particular compound disclosed herein, any general or specific structure presented also encompasses all conformational isomers, regioisomers, and stereoisomers that may arise from a particular set of substituents, unless stated otherwise. Similarly, unless stated otherwise, the general or specific structure also encompasses all enantiomers, diastereomers, and other optical isomers whether in enantiomeric or racemic forms, as well as mixtures of stereoisomers, as would be recognized by a skilled artisan.

Unless otherwise stated, values or ranges may be expressed in this disclosure using the term “about”, for example, “about” a stated value, greater than or less than “about” a stated value, or in a range of from “about” one value to “about” another value. When such values or ranges are expressed, other embodiments disclosed include the specific recited value, a range between specific recited values, and other values close to the specific recited value. In an aspect, use of the term “about” means ±15% of the stated value, ±10% of the stated value, ±5% of the stated value, or ±3% of the stated value. For example, when the term “about” is used as a modifier for, or in conjunction with, a variable, characteristic or condition, it is intended to convey that the numbers, ranges, characteristics and conditions disclosed herein are sufficiently flexible that practice of this disclosure by those skilled in the art using temperatures, rates, times, concentrations, amounts, contents, properties such as basal spacing, size, including pore size, pore volume, surface area, and the like that are somewhat outside of the stated range or different from a single stated value, may achieve the desired results as described in the application, such as the preparation of porous catalyst carrier particles having defined characteristics and their use in preparing active olefin polymerization catalysts and olefin polymerization processes using such catalysts.

The terms “a,” “an,” “the”, and the like (such as “this”) are intended to include plural alternatives such as at least one, unless otherwise specified. For example, the disclosures of “a support-activator,” “an organoaluminum compound,” or “a metallocene compound” are meant to encompass one, or mixtures or combinations of more than one, catalyst support-activator, organoaluminum compound, or metallocene compound, respectively.

The term “comprising” and variations thereof such as “comprises”, “comprised of”, “having”, “including,” and the like, as recited in transitional phrases or the specification, are inclusive and open-ended and do not exclude additional, unrecited elements or method steps. The transitional phrase “consisting of” and variations thereof exclude any element, step, or ingredient not specified in the claim. The transitional phrase “consists essentially of” limits the scope of the claim to the specified components or steps and those that do not materially affect the basic and novel characteristics of the claimed invention. Unless otherwise indicated, describing a compound or composition as “consisting essentially of” should not be construed as “comprising,” as this phrase is intended to describe the recited component that includes materials which do not significantly alter composition or method to which the term is applied. For example, a precursor or catalyst component can consist essentially of a material which can include impurities commonly present in a commercially produced sample of the material when prepared by a certain procedure. When a claim includes different features and/or feature classes (for example, a method step, feedstock features, and/or product features, among other possibilities), the transitional terms comprising, consisting essentially of, and consisting of apply only to feature class to which is utilized, and it is possible to have different transitional terms or phrases utilized with different features within a claim. For example, a method can comprise several recited steps (and other non-recited steps) but utilize a catalyst system preparation consisting of specific or alternatively consisting essentially of specific steps but utilize a catalyst system comprising recited components and other non-recited components. When compositions and processes are described in terms of “comprising” various components or steps, the compositions and processes can also “consist essentially of” or “consist of” the various components or process steps.

Unless otherwise defined with respect to a specific property, characteristic or variable, the terms “substantial” and “substantially” as applied to any criteria such as a property, characteristic or variable, means to meet the stated criteria in sufficient measure that one skilled in the art would understand that the benefit to be achieved, or the condition or property value desired is met. For example, the terms “substantial” and “substantially” serves reasonably to describe the subject matter so that its scope will be understood by persons skilled in the relevant art and to distinguish the claimed subject matter from any prior art. In one aspect, “substantially free” can be used to describe a composition in which none of the recited component the composition is substantially free of was added to the composition, and only impurity amounts such as amounts derived from the purity limits of the other components or generated as a byproduct are present. In an aspect, for example, when a composition is said to be “substantially free” of a particular component, the composition may have less than 15 wt. % of the component, less than 10 wt. % of the component, less than 5 wt. % of the component, less than 3 wt. % of the component, less than 2 wt. % of the component, less than 1 wt. % of the component, less than 0.5 wt. % of the component, less than 0.1 wt. % of the component, or the component may be undetectable using conventional means, as the context allows or requires.

The terms “optionally”, “optional” and the like with respect to a claim element are intended to mean that the subject element is required, or alternatively, is not required, and both alternatives are intended to be within the scope of the claim, and it is envisioned that the claim can encompass either or both alternatives.

References to the Periodic Table or groups of elements within the Periodic Table refer to the Periodic Table of the Elements, published by the International Union of Pure and Applied Chemistry (IUPAC), published on-line at http://old.iupac.org/reports/periodic_table/; version dated 19 Feb. 2010. Reference to a “group” or “groups” of the Periodic Table as reflected in the Periodic Table of Elements using the IUPAC system for numbering groups of elements as Groups 1-18. To the extent that any Group is identified by a Roman numeral according, for example, to the Periodic Table of the Elements as published in “Hawley's Condensed Chemical Dictionary” (2001) (the “CAS” system) it will further identify one or more element of that Group so as to avoid confusion and provide a cross-reference to the numerical IUPAC identifier.

Various patents, publications and documents are disclosed and referenced herein. Each reference cited in this disclosure is incorporated herein by reference in its entirety, whether a patent, a publication, or other document, and unless otherwise indicated.

References which may provide some background information related to this disclosure include, for example, U.S. Pat. Nos. 5,324,800; 6,245,870; 6,316,558; 6,469,188; 6,515,086; 6,800,704; 6,759,499; 6,939,928; 7,026,494; 7,148,298; 7,241,848; 7,449,533; 7,468,452; 7,517,939; 7,652,160; 7,732,542; 7,799,721; 7,879,960; 8,114,946; 8,119,553; 8,227,564; 8,637,691; and 9,340,628; and U.S. Patent Application Publication Numbers 2019/01359960. Each of these patents and published applications is incorporated by reference herein in its entirety.

Throughout this disclosure several standard chemical definitions, terms, and abbreviations are used, which will be clear to the person of ordinary skill in the art. Examples of some of the abbreviations used herein include, but are not limited to:
Fl or Flu, Fluorenyl or substituted fluorenyl when designated;
Cp, Cyclopentadienyl or substituted cyclopentadienyl when designated;
Ind, Indenyl or substituted indenyl when designated;
Me, Methyl;
Et, Ethyl;
Pr, Propyl;
Bu, Butyl;
Hx or Hex, Hexyl;
Hp, Hep, or Hept, Heptyl;
Ph, Phenyl;
Bn, Benzyl;
Cy, Cyclohexyl;
n-, normal as in n-butyl;
t- or tert-, tertiary as in t-butyl;
i-, iso as in iso-propyl;
Nor, Norbornyl;
sMAO, solid methylaluminoxane;
MCN, metallocene;
h or hr, hour;
PE, polyethylene;
LCB, Long Chain Branches, also LCBf, Long Chain Branching Frequency;
SCB, Short Chain Branches; SCBD, Short-Chain Branching Distribution;
CIE, comonomer incorporation efficiency;
MW, molecular weight generally, and if not specified, the weight average molecular weight, Mw as determined by GPC;
MWD, molecular weight distribution;
Mn, number-average molecular weight;
Mw, weight-average molecular weight;
Mw/Mn, polydispersity index, a measure of the molecular weight distribution;
d15, the molecular weight at which 15% of the polymer by weight has higher molecular weight;
d85, the molecular weight at which 85% of the polymer by weight has higher molecular weight;
GPC, gel permeation chromatography, or size exclusion chromatography; GPC IR or GPC-SEC IR, gel permeation chromatography combined with Infrared detection of eluted polymers;
aTREF, analytical temperature rising elution fractionation;
MI, Melt Index;
HLMI, High Load Melt Index; and
HLMI/MI ratio, shear response.

### General Description

Ansa-metallocenes have been useful to address the comparatively low activity and poor comonomer incorporation efficiency (CIE) common in unbridged or loosely-bridged metallocenes when making m-LLDPE resins, even though undesirably high levels of long-chain branching (LCB) in the polymer from such catalysts may persist. Catalyst systems which could afford small amounts of LCB, for example less than about 10-12 LCB/10⁶ or less than about 5-10 LCB/10⁶ total carbon atoms, would be useful and may be beneficial for film clarity. While not intending to be bound by theory, it is thought that these low LCB levels may increase the recoverable shear strain relative to a strictly linear resin of the same molecular weight (MW) and molecular weight distribution (MWD), which may move the melt from a crystallization haze region to an intermediate haze region such that haze is lowered in the blown film product. Therefore, a relatively narrow range of low LCB is desirable to benefit film clarity, but too high LCB can result in extrusion haze and a deterioration of other properties associated with lamellar orientation.

Despite the generally high CIE of some ansa-metallocenes, these metallocene catalysts have still found only limited utility in industrial manufacture of LLDPE resins for blown film due to their high LCB formation. Possible exceptions to this limited utility may be certain ansa-metallocenes which include an olefin-tether (pendent alkenyl group). For example, one series of metallocenes which can make LLDPE-type resins include a tethered alpha-olefin substituent, also termed simply an alkenyl or omega-alkenyl, bonded to the single-atom bridge between the η⁵-alkadienyl ligands, with the double bond distal from the bridging atom. One putative mechanism by which the tethered olefin is thought to reduce LCB frequency postulates the tethered olefin can suppress retention and insertion of the macromer that leads to LCB formation, while maintaining high co-monomer incorporation efficiency (CIE). Tether alkenyl groups incorporated in the structure of ansa-metallocenes have been reported to suppress long chain branching, for example, in U.S. Pat. Nos. 7,517,939; 7,652,160; and 7,732,542.

Other tethered olefin metallocene structures are known which may suppress macromer incorporation and LCB formation. For example, U.S. Pat. No. 7,652,160 describes metallocenes with a tethered alpha-olefin, such as a butenyl, pentenyl, or 5,5-dimethylpentenyl, at the 3-position of a bridged cyclopentadienyl ligand, again with the double bond distal from the ligand to which the tethered olefin is bonded, which are said to mitigate LCB formation.

Silyl-substituted ansa-metallocenes have also been reported, for example, in U.S. Pat. No. 8,637,691, which include a silyl moiety such as —SiMe₃ bonded to an indenyl ligand. This patent reports a comparative ansa-metallocene Me₂C(Ind-SiMe₃)(Cp)ZrCl₂, possessing a trimethylsilyl-substituted indenyl ligand, which has much lower activity than, and incorporates 1-hexene into the polymer at a much lower rate (lower CIE) than, the simple alkyl-substituted indenyl ligand metallocene such as Me₂C(Ind-n-Pr)(Cp)ZrCl₂.

U.S. Pat. No. 7,148,298 discloses a metallocene with an allyl(dimethyl)silyl group on an indenyl ligand of the single-carbon-bridged metallocene Ph(Me)C(2,7-t-Bu₂Fl)(Ind-SiMe₂(CH₂CH═CH₂)ZrCl₂, which affords very low levels of long-chain branching. However, this metallocene catalyst shows a much lower activity than that a metallocene which incorporates a tethered olefin on the bridge, Me(3-buten-1-yl)C(Fl)(Cp)ZrCl₂.

Similar metallocenes with bulky alkyl substituents, such as a tertiary carbon on a cyclopentadienyl ligand as reported in U.S. Pat. No. 7,026,494, also have shown low activity and low comonomer incorporation efficiencies. Moreover, the bulkiness of these substituents such as SiMe₃ has been suggested as a reason for the poor activity and CIE performance of the metallocene catalysts and a reason to avoid silyl substituents. See, for example, Macromol. Chem. Phys. 200, 1542-1553 (1999), which is incorporated herein by reference.

Based upon reports such as these, the skilled person would have been discouraged from placing bulky substituents on an indenyl or cyclopentadienyl ligand in single-atom-bridged metallocenes, which might be expected to decrease co-monomer incorporation efficiency (CIE). However, this application discloses the very unexpected results that metallocene compounds with very bulky silyl groups can afford increased CIE over their SiMe₃-substituted analogs and even over their unsubstituted analogs. For example, Me₂C(2,7-t-Bu₂Fl)(Cp-SiEt₃)ZrCl₂ (M10) in ethylene (C2)-1-hexene (C6) copolymerizations can afford a 1-hexene CIE ([C6]/[C2]_{polymer}/[C6]/[C2]_{reactor}) of 0.127, which is greater than the CIE of even the unsubstituted Me₂C(2,7-t-Bu₂Fl)(Cp)ZrCl₂ (CM3) of 0.107.

Further, and despite conventional wisdom predicting that greater substituent bulk results in lower CIE, it has been quite unexpectedly found that metallocenes with silyl groups which are more bulky than SiMe₃, for example SiEt₃, can show enhanced co-monomer incorporation efficiency (CIE) relative to the SiMe₃-substituted analog. For example, the metallocene catalyst Ph₂C(Fl)(Cp-SiMe₃)ZrCl₂ (CM5) exhibits a 1-hexene CIE of 0.076, whereas the metallocene Ph₂C(Fl)(Cp-SiEt₃)ZrCl₂ (M9) exhibits a 1-hexene CIE of 0.099 under similar conditions. These results are surprising, particularly when the bulky silyl-substituted metallocenes were also found to limit long chain branching in the resulting polymer.

Therefore in an aspect, the bulky trihydrocarbylsilyl substituted metallocene catalysts having at least one C₂₊ hydrocarbyl substituent may afford polymers and processes having one or more than one of the following features, relative to a non-bulky trihydrocarbylsilyl substituted reference metallocene absent a C₂₊ hydrocarbyl substituent: increased catalyst activity; enhanced co-monomer incorporation efficiency (CIE); maintaining low levels of long-chain branches (LCB) in the polymer structure, for example, less than 15 LCB/10⁶ C, less than 12 LCB/10⁶ C, less than 10 LCB/10⁶ C, less than 5 LCB/10⁶ C, or less than 2 LCB/10⁶ C; the majority of the polymer short-chain branches (SCB) occurring in the higher Mw fractions of the polymer rather than the lower Mw fractions (a “reverse” SCB profile), that is, a positive SCB d85-d15 slope); improved reactor operability to achieve high space-time yield in a continuous reactor over a wide operating window without fouling, and without significantly diminishing the final properties of the resin such as machine direction tear, clarity, and the like; or any combination thereof.

### Metallocene Catalyst Compositions and Polymerization Processes

This disclosure provides new ansa-metallocenes, catalyst compositions and systems comprising the ansa-metallocenes, new processes for making catalyst compositions and new processes for polymerizing olefins. The ansa-metallocenes comprise a “bulky” silyl substituent having the general formula —SiR⁵R⁶R⁷, wherein R⁵ and R⁶ are selected independently from a C₁-C₂₀ hydrocarbyl, and R⁷ is selected from a C₂-C₂₀ hydrocarbyl. It has been discovered that such a silyl group on an ansa-metallocene core structure may provide catalyst compositions which exhibit surprising results, for example, improved properties such as unexpectedly high polymerization activities, high comonomer incorporation efficiencies (CIE), low levels of long-chain branching (LCB), preservation of low LCB levels and consistent or even increased activity when the catalyst is aged for weeks or months, a near-zero or positive slope in Short-chain Branching Distribution (“reverse” SCBD) profile over the molecular weight distribution, or any combination of these features. In an aspect, such improved properties may be obtained in metallocenes which include a bulky —SiR⁵R⁶R⁷ group, but are absent an alkenyl substituent on the metallocene.

The catalyst composition of this disclosure can comprise a single metallocene compound or multiple metallocene compounds in which at least one of the metallocenes is selected from a compound disclosed herein. In embodiments, the metallocenes can be absent an alkenyl substituent.

Accordingly, one aspect of the disclosure provides a catalyst composition which can comprise the contact product of:
(a) a metallocene compound having the formula:

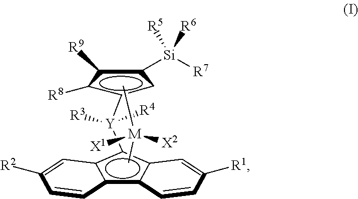

wherein
   (i) M is Zr or Hf;
   (ii) X¹ and X² are selected independently from a monoanionic ligand, or X¹ and X² together are a dianionic ligand (including, for example, a C₄-C₂₅ conjugated diene ligand bound to M by delocalized π-electrons, also referred to as a 1,4-diyl-2-ene ligand);
   (iii) R¹ and R² are selected independently from H or a C₁-C₂₀ hydrocarbyl;
   (iv) Y is C or Si;
   (v)(A) R³ and R⁴ are selected independently from a C₁ to C₂₀ hydrocarbyl, or (B) when Y is C, YR³R⁴ is a substituted or an unsubstituted C₃ to C₇ monocyclic hydrocarbylidene moiety, wherein any substituent comprises an independently selected C₁ to C₁₅ hydrocarbyl group, C₁ to C₁₅ heterohydrocarbyl group, C₁ to C₁₅ organoheteryl group, or halide;
   (vi) R⁵ and R⁶ are selected independently from a C₁-C₂₀ hydrocarbyl;
   (vii) R⁷ is selected from a C₂-C₂₀ hydrocarbyl, and wherein optionally (A) any two of R⁵, R⁶, and R⁷, along with Si to which they are bonded form a ring having from 2 to 7 carbon atoms, or (B) R⁵, R⁶, and Si to which they are bonded form a ring having from 2 to 7 carbon atoms; and
   (viii) R⁸ and R⁹ are H₂, fused C₄H₄, or fused C₄H₈;
wherein each of R⁵, R⁶, and R⁷ is independently a non-alkenyl, a non-alkynyl, or a non-alkadienyl hydrocarbyl;
   and
(b) a metallocene activator.

Accordingly, in a further aspect, this disclosure provides a process for polymerizing olefins which can comprise contacting at least one olefin monomer comprising ethylene and a catalyst composition under polymerization conditions to form a polyolefin, wherein the catalyst composition can comprise the contact product of:
(a) a metallocene compound having the formula:

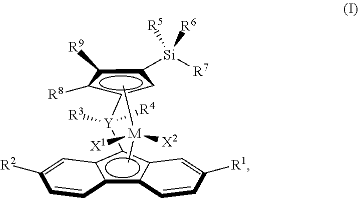

wherein
   (i) M is Zr or Hf;
   (ii) X¹ and X² are selected independently from a monoanionic ligand. or X¹ and X² together are a dianionic ligand (including, for example, a C₄-C₂₅ conjugated diene ligand bound to M by delocalized π-electrons, also referred to as a 1,4-diyl-2-ene ligand);
   (iii) R¹ and R² are selected independently from H or a C₁-C₂₀ hydrocarbyl;
   (iv) Y is C or Si;
   (v)(A) R³ and R⁴ are selected independently from a C₁ to C₂₀ hydrocarbyl, or (B) when Y is C, YR³R⁴ is a substituted or an unsubstituted C₃ to C₇ monocyclic hydrocarbylidene moiety, wherein any substituent comprises an independently selected C₁ to C₁₅ hydrocarbyl group, C₁ to C₁₅ heterohydrocarbyl group, C₁ to C₁₅ organoheteryl group, or halide;
   (vi) R⁵ and R⁶ are selected independently from a C₁-C₂₀ hydrocarbyl;
   (vii) R⁷ is selected from a C₂-C₂₀ hydrocarbyl, and wherein optionally (A) any two of R⁵, R⁶, and R⁷, along with Si to which they are bonded form a ring having from 2 to 7 carbon atoms, or (B) R⁵, R⁶, and Si to which they are bonded form a ring having from 2 to 7 carbon atoms; and
   (viii) R⁸ and R⁹ are H₂, fused C₄H₄, or fused C₄H₈;
wherein each of R⁵, R⁶, and R⁷ is selected independently from a non-alkenyl, a non-alkynyl, or a non-alkadienyl hydrocarbyl;
   and
(b) a metallocene activator.

Accordingly, in an aspect, this disclosure provides a method of making a catalyst composition, in which the method can comprise contacting:
(a) a metallocene compound having the formula:

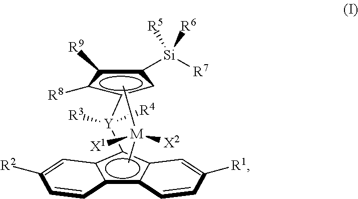

wherein
   (i) M is Zr or Hf;
   (ii) X¹ and X² are selected independently from a monoanionic ligand, or X¹ and X² together are a dianionic ligand (including, for example, a C₄-C₂₅ conjugated diene ligand bound to M by delocalized π-electrons, also referred to as a 1,4-diyl-2-ene ligand);
   (iii) R¹ and R² are selected independently from H or a C₁-C₂₀ hydrocarbyl;
   (iv) Y is C or Si;
   (v)(A) R³ and R⁴ are selected independently from a C₁ to C₂₀ hydrocarbyl, or (B) when Y is C, YR³R⁴ is a substituted or an unsubstituted C₃ to C₇ monocyclic hydrocarbylidene moiety, wherein any substituent comprises an independently selected C₁ to C₁₅ hydrocarbyl group, C₁ to C₁₅ heterohydrocarbyl group, C₁ to C₁₅ organoheteryl group, or halide;
   (vi) R⁵ and R⁶ are selected independently from a C₁-C₂₀ hydrocarbyl;
   (vii) R⁷ is selected from a C₂-C₂₀ hydrocarbyl, and wherein optionally (A) any two of R⁵, R⁶, and R⁷, along with Si to which they are bonded form a ring having from 2 to 7 carbon atoms, or (B) R⁵, R⁶, and Si to which they are bonded form a ring having from 2 to 7 carbon atoms; and
   (viii) R⁸ and R⁹ are H₂, fused C₄H₄, or fused C₄H₈;
wherein each of R⁵, R⁶, and R⁷ is selected independently from a non-alkenyl, a non-alkynyl, or a non-alkadienyl hydrocarbyl;
   and
(b) a metallocene activator.

In another aspect of the catalyst composition, the process for polymerizing olefins, or the method of making a catalyst composition described immediately above, the metallocene compound can be absent an alkenyl group.

In another aspect, X¹ and X² in the structure of Formula (I) can be selected independently from H, a halide, a C₁-C₂₅ hydrocarbyl, a C₁-C₂₅ heterohydrocarbyl, a C₁-C₂₅ organoheteryl, or X¹ and X² together can be a dianionic ligand such as a substituted or unsubstituted C₄-C₂₅ 1,4-diyl-2-ene ligand, also referred to herein as a diene ligand, a neutral diene ligand, a neutral conjugated diene ligand, or a conjugated diene ligand bound to M by delocalized π-electrons. For example, in embodiments, X¹ and X² can be independently selected from H, a halide, a C₁-C₂₀ alkyl, a C₆-C₂₀ aryl, a C₁-C₂₀ hydrocarbyloxide, a C₃-C₂₃ organosilyl, a C₂-C₂₀ alkoxyalkyl, a C₇-C₂₀ alkoxyaryl, a C₄-C₂₅ trihydrocarbylsilyl-substituted alkyl, or X¹ and X² together can be a substituted or unsubstituted C₄-C₂₀ or C₄-C₁₅ 1,4-diyl-2-ene ligand.

In an aspect of the metallocene compound of Formula (I) as described above related to the SiR⁵R⁶R⁷ silyl group, at least one of R⁵, R⁶, and R⁷ can be a C₂₊ group, also termed C_{≥2} group, for example, an ethyl group or larger. That is, R⁵ and R⁶ can be selected independently from a C₁-C₂₀ hydrocarbyl, and R⁷ can be selected from a C₂-C₂₀ hydrocarbyl. In embodiments, all three of R⁵, R⁶, and R⁷ can be selected independently from a C₂-C₂₀ hydrocarbyl.

In some embodiments, all three of R⁵, R⁶, and R⁷ of the SiR⁵R⁶R⁷ silyl group can be the same, for example, all three of R⁵, R⁶, and R⁷ can be an ethyl group, therefore SiR⁵R⁶R⁷ can be SiEt₃. In other embodiments, any two of R⁵, R⁶, and R⁷ can be the same and are different from the other one of the R⁵, R⁶, and R⁷ groups, for example, SiR⁵R⁶R⁷ can be SiMe₂-n-Pr. In other aspects, each of R⁵, R⁶, and R⁷ can be different from the other two of the R⁵, R⁶, and R⁷, that is, none of R⁵, R⁶, and R⁷ is the same. In embodiments: (a) none of R⁵ and R⁶ is methyl group; (b) one of R⁵ and R⁶ is methyl group; or (c) both R⁵ and R⁶ are methyl groups.

Aspects of this disclosure provide that R⁷ of the SiR⁵R⁶R⁷ silyl group can be a cyclic C₃-C₁₈ hydrocarbyl group, a bicyclic C₅-C₁₈ hydrocarbyl group, or a tricyclic C₈-C₂₀ hydrocarbyl group. For example, R⁷ can be a substituted or an unsubstituted cyclic C₃-C₁₈ hydrocarbyl group, a bicyclic C₅-C₁₈ hydrocarbyl group, or a tricyclic C₈-C₂₀ hydrocarbyl group, wherein any substituent is selected independently from a C₁ to C₁₅ hydrocarbyl group, a C₁ to C₁₅ heterohydrocarbyl group, a C₁ to C₁₅ organoheteryl group, or halide. At least one of R⁵, R⁶, and R⁷ of the SiR⁵R⁶R⁷ silyl group can be halide-substituted, C₁-C₆ alkoxide-substituted, or C₁-C₆ alkylamide-substituted, or none of R⁵, R⁶, and R⁷ is substituted.

In embodiments, R⁵ and R⁶ can be selected independently from a C₁ to C₁₂ alkyl, a substituted or an unsubstituted C₃ to C₇ cycloalkyl, a C₆ to C₁₂ aryl, a C₇ to C₁₅ aralkyl (also termed “arylalkyl”), or a C₇ to C₁₅ alkaryl (also termed “alkylaryl”); and R⁷ can be selected from a C₂ to C₁₂ alkyl, a substituted or an unsubstituted C₃ to C₇ cycloalkyl, a C₆ to C₁₂ aryl, a C₇ to C₁₅ aralkyl, or a C₇ to C₁₅ alkaryl. For example, SiR⁵R⁶R⁷ can be selected from SiMe₂Et, SiMe₂(n-Pr), SiMe₂(n-Bu), SiMe₂(n-hexyl), SiMe₂(n-heptyl), SiMe₂(n-octyl), SiMe₂(cyclohexyl), SiMe₂(2-norbornyl), SiMe₂(bicyclo[2.2.2]octanyl), SiMe₂(adamantyl), SiEt₃, SiEt₂(n-Pr), SiEt₂(n-Bu), SiEt₂(n-hexyl), SiEt₂(n-heptyl), SiEt₂(n-octyl), SiEt₂(cyclohexyl), SiEt₂(2-norbornyl), SiEt₂(bicyclo[2.2.2]octanyl), SiEt₂(adamantyl), Si(n-Pr)₃, Si(n-Bu)₃, or Si(n-hexyl)₃.

In an aspect of the metallocene compound of Formula (I) as described above related to the YR³R⁴ group, Y can be a carbon atom, or Y can be a silicon atom. The R³ and R⁴ groups can be selected independently from a C₁ to C₂₀ aliphatic group or a C₆ to C₂₀ aromatic group, a C₁ to C₁₅ aliphatic group or a C₆ to C₁₅ aromatic group, or a C₁ to C₁₀ aliphatic group or a C₆ to C₁₀ aromatic group. In an aspect, R³ and R⁴ can be selected independently from a C₁ to C₂₀ alkyl or cycloalkyl group; or (b) when Y is C, R³ and R⁴ can be selected independently from a C₁ to C₂₀ alkyl or cycloalkyl group.

In embodiments, for example, (a) R³ and R⁴ can be selected independently from a C₁ to C₁₅ alkyl or a C₆ to C₁₅ aryl; or (b) when Y is limited to C, R³ and R⁴ can be selected independently from a C₁ to C₁₅ alkyl or a C₆ to C₁₂ aryl. In embodiments, R³ and R⁴ can be selected independently from a C₁ to C₁₂ alkyl, a C₃ to C₇ cycloalkyl, a C₆ to C₁₂ aryl, a C₇ to C₁₅ aralkyl, or a C₇ to C₁₅ alkaryl. In another aspect, (a) neither R³ or R⁴ is alkenyl, or (b) the metallocene compound itself comprises no alkenyl substituent, that is, the metallocene is absent an alkenyl substituent.

Also in Formula (I), when Y is C and YR³R⁴ is a substituted C₃ to C₇ monocyclic hydrocarbylidene moiety, any substituent on the C₃ to C₇ monocyclic hydrocarbylidene moiety can comprise an independently selected: (a) C₂ to C₁₅ hydrocarbyl group, C₂ to C₁₅ heterohydrocarbyl group, or C₂ to C₁₅ organoheteryl group; (b) C₂ to C₁₂ hydrocarbyl group, C₂ to C₁₂ heterohydrocarbyl group, or C₂ to C₁₂ organoheteryl group; or (c) C₁ to C₁₂ hydrocarbyl group, C₁ to C₁₂ heterohydrocarbyl group, or C₁ to C₁₂ organoheteryl group. In embodiments, the C₃ to C₇ monocyclic hydrocarbylidene can be selected from cyclobutylidene, cyclopentylidene, and cyclohexylidene.

In other aspects and embodiments, in the linking group YR³R⁴, neither R³ or R⁴ is alkenyl, that is, R³ and R⁴ are not alkenyl.

In further aspects of the catalyst composition, the process for polymerizing olefins, or the method of making a catalyst composition, (a) R³ and R⁴ are selected independently from a C₁ to C₂₀ hydrocarbyl other than an aryl group, or (b) when Y is C, R³ and R⁴ are selected independently from a C₁ to C₂₀ hydrocarbyl other than an aryl group. In addition, (a) R³ and R⁴ are selected independently from a C₁ to C₂₀ aliphatic group, or (b) when Y is C, R³ and R⁴ are selected independently from a C₁ to C₂₀ aliphatic group.

In an aspect, the metallocene compound of the catalyst composition, the process for polymerizing olefins, or the method of making a catalyst composition can have the formula:

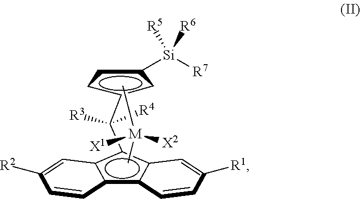

wherein
(i) M is Zr or Hf;
(ii) X¹ and X² are selected independently from H, a halide, a C₁-C₁₂ hydrocarbyl, a C₁-C₁₂ hydrocarbyloxide, or X¹ and X² together are a C₄-C₁₅ 1,4-diyl-2-ene ligand;
(iii) R¹ and R² are selected independently from H or a C₁-C₁₂ hydrocarbyl;
(iv)(A) R³ and R⁴ are selected independently a C₁ to C₁₂ alkyl, a C₃ to C₇ cycloalkyl, a C₆ to C₁₂ aryl, a C₇ to C₁₅ aralkyl, or a C₇ to C₁₅ alkaryl, or (B) CR³R⁴ is a substituted or an unsubstituted C₃ to C₇ monocyclic hydrocarbylidene moiety; wherein any substituent comprises an independently selected C₁ to C₁₂ hydrocarbyl group, C₁ to C₁₂ heterohydrocarbyl group, or C₁ to C₁₂ organoheteryl group;
(v) R⁵ and R⁶ are selected independently from a C₁-C₁₂ hydrocarbyl; and
(vi) R⁷ is selected from a C₂-C₁₂ hydrocarbyl.

In a further aspect, the metallocene compound of the catalyst composition, the process for polymerizing olefins, or the method of making a catalyst composition can have the formula:

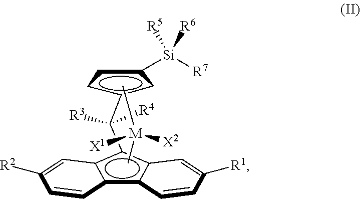

wherein
(i) M is Zr or Hf;
(ii) X¹ and X² are selected independently from a halide, a C₁-C₁₂ hydrocarbyl, or a C₁-C₁₂ hydrocarbyloxide;
(iii) R¹ and R² are selected independently from H or a C₁-C₆ hydrocarbyl;
(iv)(A) R³ and R⁴ are selected independently from a C₁ to C₁₂ alkyl, a C₃ to C₇ cycloalkyl, or a C₆ to C₁₂ aryl, or (B) CR³R⁴ is a C₃ to C₆ monocyclic hydrocarbylidene moiety;
(v) R⁵ and R⁶ are selected independently from a C₁-C₈ alkyl or C₃ to C₇ cycloalkyl; and
(vi) R⁷ is selected from a C₂-C₈ hydrocarbyl.

In further aspects, the metallocene compound of the catalyst composition, the process for polymerizing olefins, or the method of making a catalyst composition can have the formula:

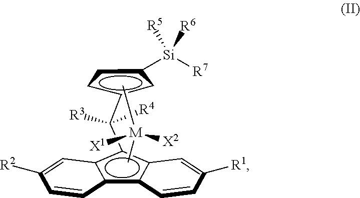

wherein
(i) M is Zr or Hf;
(ii) X¹ and X² are selected independently from a halide, a C₁-C₈ hydrocarbyl, or a C₁-C₈ hydrocarbyloxide;
(iii) R¹ and R² are selected independently from H or a C₁-C₆ hydrocarbyl;
(iv)(A) R³ and R⁴ are selected independently from a C₁ to C₁₀ alkyl, a C₃ to C₇ cycloalkyl, or a C₆ to C₁₂ aryl, or (B) CR³R⁴ is a C₃ to C₆ monocyclic hydrocarbylidene moiety;
(v) R⁵ and R⁶ are selected independently from a C₁-C₈ alkyl or C₃ to C₇ cycloalkyl; and
(vi) R⁷ is selected from a C₂-C₈ hydrocarbyl.

Still further aspects of this disclosure provide that the metallocene compound of the catalyst composition, the process for polymerizing olefins, or the method of making a catalyst composition can have the formula:

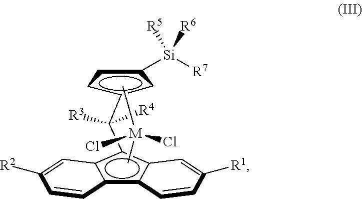

wherein
(i) M is Zr or Hf;
(ii) R¹ and R² are both H or t-butyl;
(iii)(A) R³ and R⁴ are both Me or Ph, or (B) CR³R⁴ is a cyclobutylidene, cyclopentylidene, or cyclohexylidene;
(iv) R⁵ and R⁶ are both Me, Et, or n-Pr; and
(v) R⁷ is Et, n-Pr, n-Bu, n-hexyl, n-heptyl, cyclohexyl, or 2-norbornyl.

Additional aspects of the disclosure provide that the metallocene compound of the catalyst composition, the process for polymerizing olefins, or the method of making a catalyst composition can have the formula:

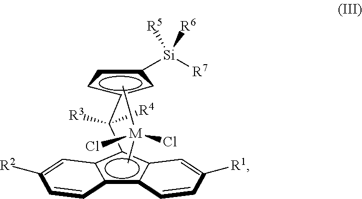

wherein
(i) M is Zr or Hf;
(ii) R¹ and R² are both H or t-butyl;
(iii) R³ and R⁴ are both Me or Ph;
(iv) R⁵ and R⁶ are both Me, Et, n-Pr, or n-Bu; and
(v) R⁷ is Et, n-Pr, n-Bu, n-hexyl, n-heptyl, cyclohexyl, or 2-norbornyl.

According to another aspect, the metallocene compound of the catalyst composition, the process for polymerizing olefins, or the method of making a catalyst composition can have the formula:

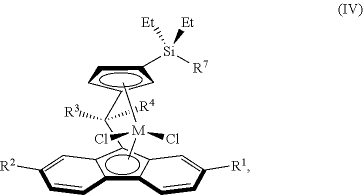

wherein
M is Zr or Hf;
R¹ and R² are both H or t-butyl;
R³ and R⁴ are both methyl or phenyl, or R³ and R⁴ together are cyclopentylidene; and
R⁷ is Et, n-Pr, n-Bu, n-hexyl, n-heptyl, cyclohexyl, or 2-norbornyl.

In other aspects or embodiments, the metallocene compound of the catalyst composition, the process for polymerizing olefins, or the method of making a catalyst composition can have the formula:

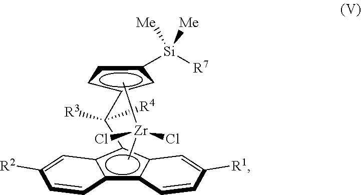

wherein
R¹ and R² are both H or t-butyl;
R³ and R⁴ are both methyl or phenyl; and
R⁷ is Et, n-Pr, n-Bu, n-hexyl, n-heptyl, cyclohexyl, or 2-norbornyl.

Still further aspects of the disclosure provide that the metallocene compound of the catalyst composition, the process for polymerizing olefins, or the method of making a catalyst composition can have the formula:

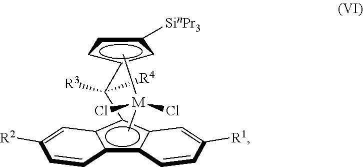

wherein
M is Zr or Hf;
R¹ and R² are both H or t-butyl; and
R³ and R⁴ are both methyl or phenyl, or R³ and R⁴ together are cyclopentylidene.

In any of these aspect of the metallocene compound of the catalyst composition, the process for polymerizing olefins, or the method of making a catalyst composition can have the formula, any of the C₁-C₂₀₋ hydrocarbyl, C₁-C₁₈₋ hydrocarbyl, fused C₄H₄, fused C₄H₈, C₁ to C₁₂₋ alkyl, C₃ to C₇ cycloalkyl, C₆ to C₂₀₋ aryl, C₇ to C₁₅ aralkyl, C₇ to C₁₅ alkaryl, cyclobutylidene, cyclopentylidene, or cyclohexylidene is optionally substituted with one or more C₁ to C₁₅ heterohydrocarbyl group, C₁ to C₁₅ organoheteryl group, or halide.

Examples of the metallocene compounds which can be prepared and used according to this disclosure include, but are not limited to, compounds having the following formulas:

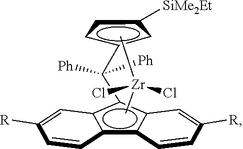

wherein R=^{t}Bu (M1) or H (M2);

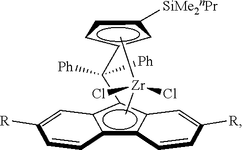

wherein R=^{t}Bu (M3) or R=H (M4);

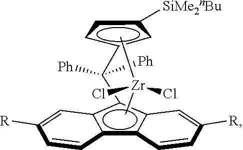

wherein R=^{t}Bu (M5Bu) or H (M5);

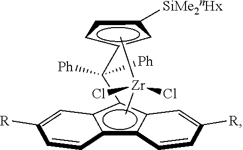

wherein R=^{t}Bu (M22) or H (M23);

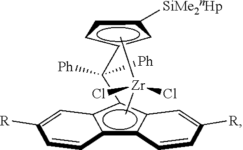

wherein R=^{t}Bu (M24) or H (M25);

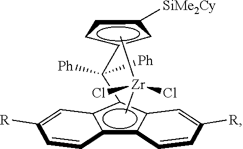

wherein R=^{t}Bu (M20) or H (M21);

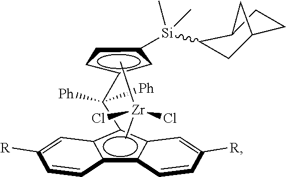

wherein R=^{t}Bu (M6) or H (M7);

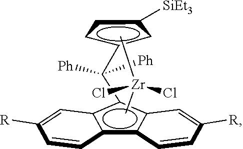

wherein R=^{t}Bu (M8) or H (M9);

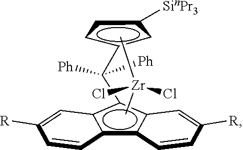

wherein R=^{t}Bu (M12) or R (M13);

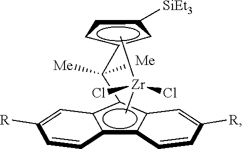

wherein R=^{t}Bu (M10) or H (M11);

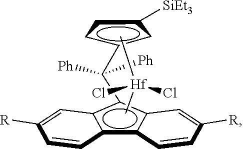

wherein R=^{t}Bu (M14Bu) or H (M14);

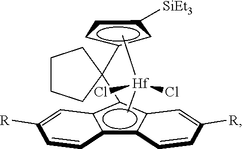

wherein R=^{t}Bu (M15) or H (M16);

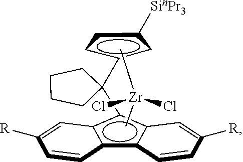

wherein R=^{t}Bu (M18Bu) or H (M18);

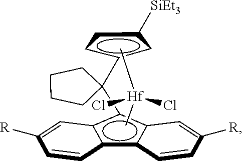

wherein R=^{t}Bu (M17Bu) or H (M17);

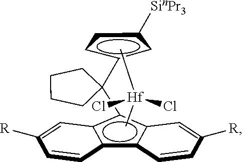

wherein R=^{t}Bu (M19Bu) or H (M19); and combinations thereof.

As seen, the metallocenes prepared and examined according to this disclosure contain a silyl substituent of the formula —SiR⁵R⁶R⁷, wherein R⁵ and R⁶ are selected independently from a C₁-C₂₀ hydrocarbyl, and R⁷ is selected from a non-alkenyl C₂-C₂₀ hydrocarbyl, that is, at least one C₂₊ group is present. The metallocenes of this disclosure are also absent an alkenyl group. The comparative metallocenes include those which do not contain —SiR⁵R⁶R⁷ in which R⁷ is at least one C₂₊ group, which do contain an alkenyl group, or have structures other than the disclosed and claimed metallocenes. The ansa-metallocenes of this disclosure can be absent a tethered olefin moiety that is bonded to a bridging atom or to any portion of a bridging ligand, or bonded directly or indirectly (e.g. through a silyl group) to one of the η⁵-alkadienyl ligands. In one aspect, the absence of an alkenyl substituent in the present catalysts can be advantageous because this avoids certain problems with some tethered olefin (alkenyl-substituted) metallocenes. For example, some alkenyl-substituted metallocenes have a propensity for the alkenyl (tethered olefin) to react with co-catalysts such as aluminum alkyls or activators such as methyl aluminoxane during catalyst formation. While not intending to be bound by theory, it is thought the pendent silyl groups in the metallocenes of this disclosure are not subject to reacting with co-catalysts or activators in the same manner.

### Activators and Support-Activators

The terms “activator” and “support-activator” (both also termed a “metallocene activator”) are defined herein. As understood by the person of ordinary skill in the relevant art, generally, a metallocene activator is a material, composition, substance, or compound, which is capable of converting a metallocene component into an active catalyst system which can polymerize olefins, either alone or in combination with another agent such as a co-catalyst. For example, in an aspect, an activator may convert the contact product of a metallocene compound and a co-catalyst which provides an activatable ligand (such as an alkyl or a hydride) to the metallocene, into a catalyst system which can polymerize olefins. In another example, an activator can both supply a polymerization-initiating ligand to a metallocene compound and further activate the metallocene to polymerization activity. The term “support-activator” as used herein, refers to an activator in a solid form, such as ion-exchanged-clays, protic-acid-treated clays, clay heteroadducts, or pillared clays, solid oxides treated with a fluoride or other electron-withdrawing anion, and similar insoluble supports which also function as activators.

In an aspect, an activator according to this disclosure can comprise, consist essentially of, or be selected from: an aluminoxane; an organoaluminum compound; an aluminate compound; an isolated smectite heterocoagulate comprising the contact product in a liquid carrier of [1] a colloidal smectite clay and [2] a heterocoagulation reagent comprising at least one cationic polymetallate; a smectite heteroadduct comprising or consisting essentially of a contact product of a colloidal smectite clay and a surfactant; an ion-exchanged clay; a protic-acid-treated clay; a pillared clay; an organoboron or organoborate compound; an ionizing ionic compound; a solid oxide treated with an electron withdrawing anion; or any combination thereof. Examples of support activators which can be used in the catalyst compositions of this disclosure includes those described in WO 2021/154204 A1 and WO 2023/239560 A1, each of which is incorporated herein by reference in their entireties.

In aspects of the catalyst composition, the process for polymerizing olefins, or the method of making a catalyst composition the activator can comprise, consist essentially of, or be selected from (a) a cyclic aluminoxane compound having the formula (R—Al—O)ₙ, wherein R is a linear or branched alkyl having from 1 to about 12 carbon atoms, and n is an integer from 3 to about 12; or (b) an aluminoxane having the formula R(R—Al—O)ₙAlR₂, wherein R is a linear or branched alkyl having from 1 to about 12 carbon atoms, and n is an integer from 1 to about 75.

In an aspect, for example the activator can comprise, consist essentially of, or be selected from an aluminoxane, and the aluminoxane can be selected from methylaluminoxane, ethylaluminoxane, n-propylaluminoxane, iso-propyl-aluminoxane, n-butylaluminoxane, t-butylaluminoxane, sec-butylaluminoxane, iso-butylaluminoxane, 1-pentylaluminoxane, 2-pentylaluminoxane, 3-pentyl-aluminoxane, iso-pentylaluminoxane, neopentylaluminoxane, or combinations thereof. In embodiments, the activator can comprise, consist essentially of, or be selected from solid methylaluminoxane (sMAO).

According to another aspect, the metallocene activator can comprise, consist essentially of, or be selected from an organoaluminum compound having the formula:

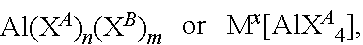

wherein
n+m=3, wherein n and m are not limited to integers;
X^{A} is selected independently from: [1] a hydride, a C₁-C₂₀ hydrocarbyl, or a C₁-C₂₀ heterohydrocarbyl; [2] a hydride, a C₁-C₂₀ aliphatic group, a C₆-C₂₀ aromatic group, a C₁-C₂₀ heteroaliphatic group, or a C₄-C₂₀ heteroaromatic group; or [3] two X^{A} together comprise a C₄-C₅ hydrocarbylene group and the remaining X^{A} is/are selected independently from a hydride, a C₁-C₂₀ hydrocarbyl, or a C₁-C₂₀ heterohydrocarbyl;
X^{B} is selected independently from: [1] a halide or a C₁-C₂₀ organoheteryl; or [2] a halide, a C₁-C₁₂ alkoxide group, or a C₆-C₁₀ aryloxide group; and
M^{x} is selected from Li, Na, or K.

In embodiments, for example, the metallocene activator can comprise, consist essentially of, or be selected from an organoaluminum compound having the formula:

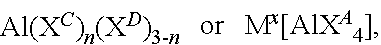

wherein
n is 1, 2, or 3;
X^{C} is selected independently from a hydride or a C₁-C₂₀ hydrocarbyl;
X^{D} is a formal anionic species selected independently from: fluoride; chloride; bromide; iodide; bromate; chlorate; perchlorate; hydrocarbylsulfate; hydrocarbylsulfite; sulfamate; hydrocarbylsulfide, hydrocarbylcarbonate; hydrogen-carbonate (bicarbonate); carbamate; nitrite; nitrate; hydrocarbyloxalate; dihydrocarbylphosphate; hydrocarbylselenite; sulfate; sulfite; carbonate; oxalate; phosphate; phosphite; selenite; selenide; sulfide; oxide; sulfamate; azide; alkoxide; amido; hydrocarbylamido; or dihydrocarbylamido; and
M^{x} is selected from Li, Na, or K.

In embodiments for example, the metallocene activator can comprise, consist essentially of, or be selected from trimethylaluminum, triethylaluminum (TEA), tripropylaluminum, tributylaluminum (for example, tri-n-butylaluminum, tri-t-butylaluminum, tri-sec-butyaluminum), trihexylaluminum, trioctylaluminum, ethyl-(3-alkylcyclopentadiyl)aluminum, diethylaluminum ethoxide, diisobutylaluminum hydride, triisobutylaluminum (TIBAL), diethylaluminum chloride, ethyl-(3-alkylcyclopentadiyl)-aluminum, trioctylaluminum, or any combination thereof.

According to another aspect, the metallocene activator can comprise, consist essentially of, or be selected from an isolated smectite heterocoagulate comprising the contact product in a liquid carrier of [1] a colloidal smectite clay and [2] a heterocoagulation reagent comprising at least one cationic polymetallate and in an amount sufficient to provide a slurry of the smectite heteroadduct having a zeta potential in a range of from about positive (+)25 mV (millivolts) to about negative (−)25 mV prior to isolation of the smectite heterocoagulate from the slurry, as quantified from the Electrokinetic Sonic Amplitude (ESA) Effect. The contact product can optionally include a surfactant, for example, an anionic surfactant, a cationic surfactant, a non-ionic surfactant, or an amphoteric surfactant. These isolated smectite heterocoagulate activators are described in detail in U.S. Pat. No. 11,339,229, which is incorporated herein by reference in its entirety. In aspects, for example, the (a) the smectite clay can comprise montmorillonite, sauconite, nontronite, hectorite, beidellite, saponite, bentonite, or any combination thereof, and (b) the cationic polymetallate can comprise a cationic polyaluminate selected from polyaluminum chloride, aluminum chlorhydrate, aluminum sesquichlorohydrate, or polyaluminum oxyhydroxychloride, or any combination thereof.

According to a further aspect, the metallocene activator can comprise, consist essentially of, or be selected from a smectite heteroadduct comprising or consisting essentially of a contact product of a colloidal smectite clay and a surfactant, wherein: (a) the smectite clay is [1] natural or synthetic, and/or [2] a dioctahedral smectite clay; or [3] the smectite clay is selected from montmorillonite, sauconite, nontronite, hectorite, beidellite, saponite, bentonite, or any combination thereof; and (b) the surfactant comprises or is selected from a cationic surfactant, a nonionic surfactant, an amphoteric surfactant, or any combination thereof. In this aspect, the smectite heteroadduct can be the contact product of the smectite clay and the surfactant in the absence of various other reactant and can be, for example, in the absence of any other reactant. For example, the contact product can occur or can be [i] in the absence of: [A] a cationic polymetallate; [B] a non-layered silicate, a soluble silicate (for example, sodium silicate), a charged inorganic component, a metal oxide, an organic amide, an anionic surfactant, an inorganic acid, an organic acid, an inorganic base, an organic base, an oxidizing agent, or any combination thereof, [C] any one or any two of a cationic surfactant, a nonionic surfactant, or an amphoteric surfactant; or [D] any combination thereof; or [ii] in the absence of any other reactant, except for the surfactant.

According to a further aspect, the metallocene activator can comprise, consist essentially of, or be selected from a smectite heteroadduct as disclosed in U.S. Patent Application Publication No. 2023/0399420, published Dec. 14, 2024, which is incorporated herein by reference in its entirety.

In other examples or embodiments, the metallocene activator of this disclosure can comprise, consist essentially of, or be selected from an aluminum pillared clay. In embodiments, the metallocene activator can comprise, consist essentially of, or be selected from an organoboron compound having the formula:

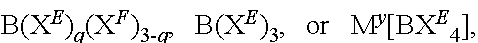

wherein
q is 1, 2, or 3;
X^{E} is selected independently from: [1] a hydride, a C₁-C₂₀ hydrocarbyl, or a C₁-C₂₀ heterohydrocarbyl; [2] a hydride, a C₁-C₂₀ aliphatic group, a C₆-C₂₀ aromatic group, a C₁-C₂₀ heteroaliphatic group, or a C₄-C₂₀ heteroaromatic group; [3] a fluorinated C₁-C₂₀ hydrocarbyl, or a fluorinated C₁-C₂₀ heterohydrocarbyl; or [4] a fluorinated C₁-C₂₀ aliphatic group, a fluorinated C₆-C₂₀ aromatic group, a fluorinated C₁-C₂₀ heteroaliphatic group, or a fluorinated C₄-C₂₀ heteroaromatic group;
X^{F} is selected independently from: [1] a halide or a C₁-C₂₀ organoheteryl; or [2] a halide, a C₁-C₁₂ alkoxide group, or a C₆-C₁₀ aryloxide group; and
M^{y} is selected from Li, Na, or K.

In embodiments, the metallocene activator of this disclosure can comprise, consist essentially of, or be selected from an aluminum pillared clay. In embodiments, the metallocene activator can comprise, consist essentially of, or be selected from:
(a) trimethylboron, triethylboron, tripropylboron, tributylboron, trihexylboron, trioctylboron, diethylboron ethoxide, diisobutylboron hydride, triisobutylboron, diethylboron chloride, di-3-pinanylborane, pinacolborane, catecholborane, lithium borohydride, lithium triethylborohydride, a Lewis base adduct thereof, or any combination thereof,
(b) tris(pentafluorophenyl)boron, tris[3,5-bis(trifluoromethyl)phenyl]boron, N,N-dimethylanilinium tetrakis(pentafluorophenyl)borate, triphenylcarbenium tetrakis(pentafluorophenyl)borate, lithium tetrakis-(pentafluorophenyl)borate, N,N-dimethylanilinium tetrakis [3,5-bis(trifluoro-methyl)phenyl]borate, triphenylcarbenium tetrakis[3,5-bis(trifluoromethyl)-phenyl]borate, and any combination thereof; or
(c) any combination or mixture of (a) and (b).

In other aspects, the metallocene activator of can comprise, consist essentially of, or be selected from an ionizing ionic compound. Examples of ionizing ionic compounds include but are not limited to tri(n-butyl)ammonium tetrakis(p-tolyl)borate, trimethylammonium tetraphenylborate, triethylammonium tetraphenylborate, tripropylammonium tetraphenylborate, tri(n-butyl)ammonium tetraphenylborate, tri(t-butyl)ammonium tetraphenylborate, N,N-dimethylanilinium tetraphenylborate, N,N-diethylanilinium tetraphenylborate, N,N-dimethyl-(2,4,6-trimethylanilinium) tetraphenylborate, tropillium tetraphenylborate, triphenylcarbenium tetraphenylborate, triphenylphosphonium tetraphenylborate triethylsilylium tetraphenylborate, benzene(diazonium)tetraphenylborate, trimethylammonium tetrakis(pentafluorophenyl)borate, triethylammonium tetrakis(pentafluorophenyl)borate, tripropylammonium tetrakis(pentafluorophenyl)borate, tri(n-butyl)ammonium tetrakis(pentafluorophenyl)borate, tri(sec-butyl)ammonium tetrakis(pentafluorophenyl)borate, N,N-dimethylanilinium tetrakis(pentafluorophenyl)borate, N,N-diethylanilinium tetrakis(pentafluorophenyl)borate, N,N-dimethyl-(2,4,6-trimethylanilinium) tetrakis(pentafluorophenyl)borate, tropillium tetrakis(pentafluorophenyl)borate, triphenylcarbenium tetrakis(pentafluorophenyl)borate, triphenylphosphonium tetrakis(pentafluorophenyl)borate, triethylsilylium tetrakis(pentafluorophenyl)borate, benzene(diazonium) tetrakis(pentafluorophenyl)borate, trimethylammonium tetrakis-(2,3,4,6-tetrafluorophenyl) borate, triethylammonium tetrakis-(2,3,4,6-tetrafluorophenyl)borate, tripropylammonium tetrakis-(2,3,4,6-tetrafluorophenyl)borate, tri(n-butyl)ammonium tetrakis-(2,3,4,6-tetrafluoro-phenyl)borate, dimethyl(t-butyl)ammonium tetrakis-(2,3,4,6-tetrafluorophenyl)borate, N,N-dimethylanilinium tetrakis-(2,3,4,6-tetrafluorophenyl)borate, N,N-diethylanilinium tetrakis-(2,3,4,6-tetrafluorophenyl)borate, N,N-dimethyl-(2,4,6-trimethylanilinium) tetrakis-(2,3,4,6-tetrafluorophenyl)borate, tropillium tetrakis-(2,3,4,6-tetrafluorophenyl)borate, triphenylcarbenium tetrakis-(2,3,4,6-tetrafluorophenyl)borate, triphenylphosphonium tetrakis-(2,3,4,6-tetrafluorophenyl)borate, triethylsilylium tetrakis-(2,3,4,6-tetrafluorophenyl)borate, benzene(diazonium) tetrakis-(2,3,4,6-tetrafluorophenyl)borate, trimethylammonium tetrakis(perfluoronapthyl)borate, triethylammonium tetrakis(perfluoronapthyl)borate, tripropylammonium tetrakis(perfluoronapthyl)borate, tri(n-butyl)ammonium tetrakis(perfluoronapthyl)borate, tri(t-butyl)ammonium tetrakis(perfluoronapthyl)borate, N,N-dimethylanilinium tetrakis(perfluoronapthyl)borate, N,N-diethylanilinium tetrakis(perfluoronapthyl)borate, N,N-dimethyl-(2,4,6-trimethylanilinium) tetrakis(perfluoronapthyl)borate, tropillium tetrakis(perfluoronapthyl)borate, triphenylcarbenium tetrakis(perfluoronapthyl)borate, triphenylphosphonium tetrakis(perfluoronapthyl)borate, triethylsilylium tetrakis(perfluoronapthyl)borate, benzene(diazonium) tetrakis(perfluoronapthyl)borate, trimethylammonium tetrakis(perfluorobiphenyl)borate, triethylammonium tetrakis(perfluorobiphenyl)borate, tripropylammonium tetrakis(perfluorobiphenyl)borate, tri(n-butyl)ammonium tetrakis(perfluorobiphenyl)borate, tri(t-butyl)ammonium tetrakis(perfluorobiphenyl)borate, N,N-dimethylanilinium tetrakis(perfluorobiphenyl)borate, N,N-diethylanilinium tetrakis(perfluorobiphenyl)borate, N,N-dimethyl-(2,4,6-trimethylanilinium) tetrakis(perfluorobiphenyl)borate, tropillium tetrakis(perfluorobiphenyl)borate, triphenylcarbenium tetrakis(perfluorobiphenyl)borate, triphenylphosphonium tetrakis(perfluorobiphenyl)borate, triethylsilylium tetrakis(perfluorobiphenyl)borate, benzene(diazonium) tetrakis(perfluorobiphenyl)borate, trimethylammonium tetrakis(3,5-bis(trifluoromethyl)phenyl)borate, triethylammonium tetrakis(3,5-bis(trifluoromethyl)phenyl)borate, tripropylammonium tetrakis(3,5-bis(trifluoromethyl)phenyl)borate, tri(n-butyl)ammonium tetrakis(3,5-bis(trifluoromethyl)phenyl)borate, tri(t-butyl)ammonium tetrakis(3,5-bis(trifluoromethyl)phenyl)borate, N,N-dimethylanilinium tetrakis(3,5-bis(trifluoromethyl)phenyl)borate, N,N-diethylanilinium tetrakis(3,5-bis(trifluoromethyl)phenyl)borate, N,N-dimethyl-(2,4,6-trimethylanilinium) tetrakis(3,5-bis(trifluoromethyl)phenyl)borate, tropillium tetrakis(3,5-bis(trifluoromethyl)phenyl)borate, triphenylcarbenium tetrakis(3,5-bis(trifluoromethyl)phenyl)borate, triphenylphosphonium tetrakis(3,5-bis(trifluoromethyl)phenyl)borate, triethylsilylium tetrakis(3,5-bis(trifluoromethyl)phenyl)borate, benzene(diazonium) tetrakis(3,5-bis(trifluoromethyl)phenyl)borate, and dialkyl ammonium salts such as: di-(i-propyl)ammonium tetrakis(pentafluorophenyl)borate, and dicyclohexylammonium tetrakis(pentafluorophenyl)borate; and additional tri-substituted phosphonium salts such as tri(o-tolyl)phosphonium tetrakis(pentafluorophenyl)borate, tri(2,6-dimethylphenyl)phosphonium tetrakis(pentafluorophenyl)borate, any aluminate analogs thereof, or any combination thereof.

In an aspect, the metallocene activator can comprise, consist essentially of, or be selected from a solid oxide treated with an electron withdrawing anion, and wherein:
(a) the solid oxide comprises, consists essentially of, or is selected from silica, alumina, silica-alumina, silica-coated alumina, silica-zirconia, silica-titania, aluminum phosphate, heteropolytungstates, titania, zirconia, magnesia, boria, zinc oxide, mixed oxides thereof, or any combination thereof, and
(b) the electron-withdrawing anion comprises, consists essentially of, or is selected from fluoride, chloride, bromide, phosphate, triflate, bisulfate, sulfate, fluorophosphate, fluorosulfate, or any combination thereof.

For example, in an aspect, the activator can comprise, consist essentially of, or be selected from a solid oxide treated with an electron withdrawing anion which can be selected from fluorided alumina, chlorided alumina, bromided alumina, sulfated alumina, fluorided silica-alumina, chlorided silica-alumina, bromided silica-alumina, sulfated silica-alumina, fluorided silica-zirconia, chlorided silica-zirconia, bromided silica-zirconia, sulfated silica-zirconia, fluorided silica-titania, or any combinations thereof.

In an aspect, the activator can comprise, consist essentially of, or be selected from any metallocene activator, for example, any activator disclosed herein, any combination of metallocene activators, or any metallocene activator or combination of metallocene activators in combination with any co-catalyst or alkylating agent.

### Co-Catalysts and Alkylating Agents

In an aspect, the catalyst composition can further comprise at least one co-catalyst. In embodiments, the catalyst composition can further comprise at least one co-catalyst comprising, consisting essentially of, or selected from an alkylating agent, a hydriding agent, or a silylating agent. In embodiments, the catalyst composition can further comprise at least one co-catalyst selected from an organoaluminum compound, an organoboron compound, an organozinc compound, an organomagnesium compound, an organolithium compound, or any combination thereof. For example, the catalyst composition can further comprise at least one co-catalyst selected from any organoaluminum compound disclosed herein or any organoboron compound disclosed herein.

In embodiments, the catalyst composition can further comprise at least one co-catalyst comprising, consisting essentially of, or selected from an organoaluminum compound having the formula:

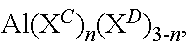

wherein
n is 1, 2, or 3;
X^{C} is selected independently from a hydride or a C₁-C₂₀ hydrocarbyl; and
X^{D} is a formal anionic species selected independently from: fluoride; chloride; bromide; iodide; hydrocarbyloxide, bromate; chlorate; perchlorate; hydrocarbylsulfate; hydrocarbylsulfite; sulfamate; hydrocarbylsulfide, hydrocarbylcarbonate; hydrogen-carbonate (bicarbonate); carbamate; nitrite; nitrate; hydrocarbyloxalate; dihydrocarbylphosphate; hydrocarbylselenite; sulfate; sulfite; carbonate; oxalate; phosphate; phosphite; selenite; selenide; sulfide; oxide; sulfamate; azide; alkoxide; aryloxide, amido; hydrocarbylamido; or dihydrocarbylamido.

For example, the catalyst composition can further comprise at least one co-catalyst selected from trimethylaluminum, triethylaluminum (TEA), tripropylaluminum, tributylaluminum (for example, tri-n-butylaluminum, tri-t-butylaluminum, tri-sec-butyaluminum), trihexylaluminum, trioctylaluminum, ethyl-(3-alkylcyclopentadiyl)aluminum, diethylaluminum ethoxide, diisobutylaluminum hydride, triisobutylaluminum (TIBAL), diethylaluminum chloride, ethyl-(3-alkylcyclopentadiyl)aluminum, trioctylaluminum, or any combination thereof.

According to a further aspect, the catalyst composition can further comprise at least one co-catalyst selected from an organozinc compound or an organomagnesium compound having the formula:

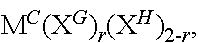

wherein
M^{C} is zinc or magnesium;
r is 1 or 2;
X^{G} is selected independently from: [1] a hydride, a C₁-C₂₀ hydrocarbyl, or a C₁-C₂₀ heterohydrocarbyl; or [2] a hydride, a C₁-C₂₀ aliphatic group, a C₆-C₂₀ aromatic group, a C₁-C₂₀ heteroaliphatic group, or a C₄-C₂₀ heteroaromatic group; and
X^{H} is selected independently from: [1] a halide or a C₁-C₂₀ organoheteryl; or [2] a halide, a C₁-C₁₂ alkoxide group, or a C₆-C₁₀ aryloxide group.

In aspects, for example, the catalyst composition can further comprise at least one co-catalyst selected from: [1]dimethylzinc, diethylzinc, diisopropylzinc, dicyclohexylzinc, diphenylzinc, or any combination thereof, [2]butylethylmagnesium, dibutylmagnesium, n-butyl-sec-butylmagnesium, dicyclopentadienylmagnesium, or any combination thereof, or [3] any combination of any organozinc co-catalyst from group [1] and any organomagnesium co-catalyst from group [2].

According to a further aspect, the catalyst composition can further comprise at least one co-catalyst selected from an organolithium compound or lithium hydride compound having the formula:

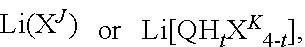

wherein
X^{J} is selected from: [1] a hydride, a C₁-C₂₀ hydrocarbyl, or a C₁-C₂₀ heterohydrocarbyl; or [2] a hydride, a C₁-C₂₀ aliphatic group, a C₆-C₂₀ aromatic group, a C₁-C₂₀ heteroaliphatic group, or a C₄-C₂₀ heteroaromatic group;
Q is Al or B;
t is an integer from 1 to 4 (inclusive); and
each X^{K} is selected independently from: [1] a hydride, a C₁-C₂₀ hydrocarbyl, or a C₁-C₂₀ heterohydrocarbyl; or [2] a hydride, a C₁-C₂₀ aliphatic group, a C₆-C₂₀ aromatic group, a C₁-C₂₀ heteroaliphatic group, or a C₄-C₂₀ heteroaromatic group.

In another aspect, for example, the catalyst composition can further comprise at least one co-catalyst selected from methyllithium, ethyllithium, propyllithium (including n-propyllithium or i-propyllithium), butyllithium (including n-butyllithium, t-butyllithium, sec-butyl lithium, or iso-butyllithium), hexyllithium, or any combination thereof. The co-catalyst of this disclosure can comprise, consist essentially of, or be selected from any metallocene co-catalyst, for example, any co-catalyst disclosed herein.

### Olefins and Polymers

Disclosed herein is a process for polymerizing olefins comprising contacting at least one olefin monomer and the catalyst composition disclosed herein under polymerization conditions to form a polyolefin. The resulting polyolefin can be an olefin homopolymer or an olefin co-polymer, for example, the olefin co-polymer can be a co-polymer of ethylene and an α-olefin monomer. The polyolefin can comprise, consist essentially of, or be selected from an olefin homopolymer, in which the homopolymer comprises an olefin monomer residues having from 2 to about 20 carbon atoms per monomer molecule, or an olefin co-polymer, in which the co-polymer comprises more than one olefin monomer residue, each independently having from 2 to about 20 carbon atoms per monomer molecule.

In an aspect for example, the at least one olefin monomer of the polymerization process can comprise, consist essentially of, or be selected from at least one of ethylene, propylene, 1-butene, 3-methyl-1-butene, 1-pentene, 3-methyl-1-pentene, 4-methyl-1-pentene, 1-hexene, 3-ethyl-1-hexene, 1-heptene, 1-octene, 1-nonene, 1-decene, norborene, vinyl cyclohexane, or combinations thereof. In a further aspect, the at least one olefin monomer of the polymerization process can comprise, consist essentially of, or be selected from: (a) ethylene in combination with at least one of propylene, 1-butene, 3-methyl-1-butene, 1-pentene, 3-methyl-1-pentene, 4-methyl-1-pentene, 1-hexene, 3-ethyl-1-hexene, 1-heptene, 1-octene, 1-nonene, 1-decene, norbornene, and vinyl cyclohexane; or (b) ethylene in combination with 1-butene, 3-methyl-1-butene, 4-methyl-1-pentene, 1-hexene, 1-octene, or vinyl cyclohexane.

In one aspect, the polyolefin comprises, consists essentially of, or is selected from an ethylene-α-olefin co-polymer. For example, the at least one olefin monomer comprises, consists essentially of, or is selected from ethylene and an α-olefin comonomer, and the polyolefin comprising α-olefin comonomer residues having from 3 to about 20 carbon atoms per comonomer molecule. According to another aspect, the at least one olefin monomer can comprise, consist essentially of, or be selected from ethylene and an α-olefin comonomer selected from an aliphatic C3 to C20 olefin, a conjugated or nonconjugated C3 to C20 diolefin, or any mixture thereof.

For example, in the process for polymerizing olefins according to this disclosure, the at least one olefin monomer can comprise, consist essentially of, or be selected from ethylene and an α-olefin comonomer selected from propylene, 1-butene, 2-butene, 3-methyl-1-butene, 1-pentene, 2-pentene, 3-methyl-1-pentene, 4-methyl-1-pentene, 1-hexene, 3-ethyl-1-hexene, 1-heptene, 1-octene, 1-nonene, 1-decene, 1,3-butadiene, isoprene, styrene, piperylene, 2,3-dimethyl-1,3-butadiene, 1,4-pentadiene, 1,7-hexadiene, vinylcyclohexane, or any combination thereof.

### Catalyst Composition and Polymerization Process Conditions

A range of polymerization conditions can be utilized for the polymerization processes described herein. The polymerization conditions can comprise any conditions as described in the specification or any polymerization conditions, as understood by the person of ordinary skill in the art. For example, the process for polymerizing olefins comprising contacting at least one olefin monomer, in which the at least one olefin monomer can comprise ethylene and a catalyst composition under polymerization conditions. The contacting step comprises contacting at least one olefin monomer, the catalyst composition, and (a) hydrogen, or (b) in the absence of hydrogen, under polymerization conditions to form the polyolefin.

For example, in the polymerization processes exemplified herein, which use solid MAO as a convenient metallocene activator but are not limited to this activator, the conditions under which the polymerization processes can be carried out can comprise a metallocene compound to sMAO ratio of from 1×10⁻⁵ to 5×10⁻⁴ mmol metallocene compound per mg sMAO, alternatively from 2×10⁻⁵ to 1×10⁻⁴ mmol metallocene compound per mg sMAO, or alternatively from 3×10⁻⁵ to 1×10⁻⁴ mmol metallocene compound per mg sMAO.

The conditions under which the polymerization can be carried out also can comprise using an organoaluminoxane compound in any concentration, for example, a concentration of from 10 to 1,500 mmol of organoaluminoxane compound per mmol of metallocene compound, alternatively from 50 to 1,250 mmol of organoaluminoxane compound per mmol of metallocene compound, alternatively from 100 to 1,000 mmol of organoaluminoxane compound per mmol of metallocene compound, or alternatively from 200 to 800 mmol of organoaluminoxane compound per mmol of metallocene compound.

In other examples, the catalyst system and the polymerization process can comprise using an alkylaluminum compound. In this aspect the alkylaluminum compound, excluding any alkylaluminum compound used as a scavenger, can be used in the process and the catalyst composition in a concentration of from 10 to 2,500 mmol of alkylaluminum compound per mmol of metallocene compound, alternatively from 50 to 2,000 mmol of alkylaluminoxane compound per mmol of metallocene compound, or alternatively from 100 to 1,500 mmol of alkylaluminoxane compound per mmol of metallocene compound. In another aspect, any organoaluminum, alkylaluminum, or organoaluminoxane co-catalyst can be used in the presence of other metallocene activators, such as clay or treated-clay activators, solid oxides treated with electron-withdrawing anions, clay-heteroadducts, and the like.

In further aspects, the polymerization conditions which can be utilized in the processes disclosed herein can comprise:
(a) conducting the polymerization in the presence of added hydrogen;
(b) conducting the polymerization using a hydrogen/ethylene ratio (H₂ psi/C₂ psi) of from 0.01×10⁻⁰³ to 45.0×10⁻⁰³; alternatively from 0.1×10⁻⁰³ to 30.0×10⁻⁰³; alternatively from 0.50×10⁻⁰³ to 20.0×10⁻⁰³; alternatively from 0.75×10⁻⁰³ to 10.0×10⁻⁰³; alternatively from 1.00×10⁻⁰³ to 5.00×10⁻⁰³; or alternatively from 1.25×10⁻⁰³ to 4.50×10⁻⁰³;
(c) the polymerization is not a solution polymerization;
(d) the polymerization is a slurry polymerization;
(e) the polymerization is conducted at a temperature of less than 125° C., alternatively less than 110° C., alternatively less than 95° C., alternatively less than or equal to 80° C., or alternatively, less than or equal to 75° C.;
(f) the polymerization is carried out in an aliphatic liquid carrier;
(g) the polymerization is carried out in a liquid carrier having an initial boiling point (IBP) temperature at atmospheric pressure of less than or equal to 100° C., alternatively less than or equal to 75° C., alternatively less than or equal to 50° C., or alternatively less than or equal to 25° C.;
(h) the polymerization is conducted in the absence of an ionizing ionic compound;
(i) the polymerization is conducted under conditions which provide an ethylene-co-1-hexene polymer having:
   (1) a MI (melt index) from 0.1-2.0 g/10 min, alternatively from 0.2-1.8 g/10 min, alternatively from 0.3-1.6 g/10 min; or alternatively from 0.35-1.5 g/10 min;
   (2) a HLMI (high load melt index) from 1 g/10 min to 40 g/10 min, alternatively from 2 g/10 min to 37 g/10 min, or alternatively from 3 g/10 min to 35 g/10 min;
   (3) a HLMI/MI ratio (shear response) is (i) from 16 to 60, alternatively from 18 to 50, or alternatively from 20 to 40, or (ii) greater than 19, alternatively greater than 25, or alternatively, greater than 30, and wherein an optional upper limit for any of these lower limit (“greater than”) ratios is 60;
   (4) a density from 0.890 to 0.936 g/mL, alternatively from 0.900 to 0.934 g/mL, alternatively from 0.909 to 0.932 g/mL, or alternatively from 0.910 to 0.929 g/mL;
   (5) a Mw of 50,000 to 175,000 g/mol, alternatively 65,000 to 155,000 g/mol, or alternatively 80,000 to 140,000 g/mol;
   (6) a Mw/Mn ratio (polydispersity index) of from 2.25 to 10, or alternatively 2.50 to 7.0;
   (7) a non-Schultz-Flory molecular weight distribution, for example, (A) Mw/Mn>2.0, Mw/Mn>2.5, Mw/Mn>3.0, or alternatively, Mw/Mn>3.5; or (B) a Mw/Mn reflects no more than 2 or no more than 3 Schulz-Flory distributions; or
   (8) any combination of (1) to (7);
      or
(j) any combination of (a) through (i).

In still further aspects, the polymerization conditions can be selected from any of the following parameters:
(a) conducting the polymerization in the presence or the absence of added hydrogen;
(b) conducting the polymerization using a hydrogen/ethylene ratio (H₂ psi/C₂ psi) of from 0.01×10⁻⁰³ to 40.0×10⁻⁰³; alternatively from 0.1×10⁻⁰³ to 25.0×10⁻⁰³; alternatively from 0.50×10⁻⁰³ to 10.0×10⁻⁰³; alternatively from 0.75×10⁻⁰³ to 7.50×10⁻⁰³; alternatively from 1.00×10⁻⁰³ to 5.00×10⁻⁰³; or alternatively from 1.25×10⁻⁰³ to 4.50×10⁻⁰³;
(c) conducting the polymerization in a gas phase reactor, a slurry loop, dual slurry loops in series, multiple slurry tanks in series, a slurry loop combined with a gas phase reactor, a continuous stirred reactor in a batch process, or combinations thereof,
(d) conducting the polymerization at a temperature of less than 125° C., alternatively less than 110° C., alternatively less than 95° C., alternatively less than or equal to 80° C., or alternatively, less than or equal to 75° C.;
(e) conducting the polymerization in an aliphatic liquid carrier;
(f) conducting the polymerization in a liquid carrier having an initial boiling point (IBP) temperature at atmospheric pressure of less than or equal to 100° C., alternatively less than or equal to 75° C., alternatively less than or equal to 50° C., or alternatively less than or equal to 25° C.;
(g) conducting the polymerization in the presence or the absence of an ionizing ionic compound;
(h) conducting the polymerization in the presence or the absence of an aluminoxane;
(i) conducting the polymerization under conditions which provide an ethylene-co-1-hexene polymer having:
   (1) a MI (melt index) from 0.1-2.0 g/10 min, alternatively from 0.2-1.8 g/10 min, alternatively from 0.3-1.6 g/10 min; or alternatively from 0.35-1.5 g/10 min;
   (2) a HLMI (high load melt index) from 1 g/10 min to 40 g/10 min, alternatively from 2 g/10 min to 37 g/10 min, or alternatively from 3 g/10 min to 35 g/10 min;
   (3) a Mw of 50,000 to 175,000 g/mol, alternatively 65,000 to 155,000 g/mol, or alternatively 80,000 to 140,000 g/mol;
   (4) a Mw/Mn ratio (polydispersity index) of from 2.25 to 10, or alternatively 2.50 to 7.0;
   (5) a non-Schultz-Flory molecular weight distribution, for example, (A) Mw/Mn>2.0, Mw/Mn>2.5, Mw/Mn>3.0, or alternatively, Mw/Mn>3.5, or (B) a Mw/Mn reflects no more than 2 or no more than 3 Schulz-Flory distributions; or
   (6) any combination of (1) to (5);
      or
(j) any combination of (a) through (i).

According to other aspects, in the catalyst composition or in the method of making a catalyst system, the following conditions can be employed. The metallocene compound and the metallocene activator are contacted (a) for a time period from about 1 minute to about 48 hours or from about 5 minutes to about 24 hours and at a temperature from about 10° C. to about 200° C. or from about 15° C. to about 80° C., to form a first mixture, followed by (b) contacting the first mixture with a co-catalyst form the catalyst composition. In other aspects, the following conditions can be employed: (a) the metallocene compound and the activator can be contacted [1] for a time period from about 1 minute to about 24 hours or from about 1 minute to about 1 hour and [2] at a temperature from about 10° C. to about 200° C. or from about 15° C. to about 80° C., to form a first mixture; followed by (b) contacting the first mixture with the support-activator comprising a calcined smectite heteroadduct to form the catalyst system.

In another aspect, the metallocene compound, the activator, and the co-catalyst when present are contacted (“pre-contacted”) [1] for a time period from about 1 minute to about 6 months, from about 1 minute to about 1 week, or from about 1 minute to about 1 hour and [2] at a temperature from about 10° C. to about 200° C. or from about 15° C. to about 80° C., to form the catalyst system. In a further aspect, the metallocene compound and the metallocene activator can be contacted (“pre-contacted”) for a period of from 0.5 day to 90 days, alternatively from 1 day to 75 days, or alternatively from 2 days to 60 days prior to use of the contact product to polymerize olefins. For example, the metallocene compound and the metallocene activator can be contacted (“pre-contacted”) for a period of 0.5 day, 1 day, 2 days, 3 days, 4 days, 5 days, 6 days, 7 days 8 days, 9 days, 10 days, 11 days, 12 days, 13 days, 14 days, 15 days, 16 days, 17 days, 18 days, 19 days, 20 days, 22 days, 25 days, 28 days, 30 days, 35 days, 40 days, 45 days, 50 days, 55 days, 60 days, 75 days, 90 days, or greater than 90 days prior to use of the contact product to polymerize olefins, or any time period between any of these recited time periods.

The catalyst composition prepared as described herein can be characterized by its activity, properties, and the like. In an aspect, the catalyst composition can be characterized by: (i) a first ethylene/1-hexene co-polymerization activity measured within 12 hours of forming the contact product; and (ii) a second ethylene/1-hexene co-polymerization activity measured after the contact product has been stored for 30 days at room temperature (20° C.-23° C.) under an inert atmosphere, that is greater than or equal to 95%, 96%, or 97% of the first polymerization activity. For example, the second ethylene/1-hexene co-polymerization activity is greater than or equal to 98% or 99% of the first polymerization activity.

In the catalyst composition, the polymerization process, or the method of making the catalyst composition, the contact product can comprise the contact product of (a) the metallocene compound, (b) the metallocene activator, and (c) any of, or any combination of, a co-catalyst, hydrogen, ethylene, an α-olefin, and a liquid carrier. For example, the contact product can comprise the contact product of (a) a metallocene compound, (b) a metallocene activator, and (c) a co-catalyst.

In an aspect, the metallocene activator can be solid MAO (sMAO) and the catalyst composition can be characterized by any one of, or any combination of, the following properties:
(a) an ethylene-1-hexene co-polymerization activity measured within 12 hours of forming the contact product of from 1,000-60,000 g polymer/g sMAO activator/hour, alternatively from 2,000-50,000 g polymer/g sMAO activator/hour, or alternatively from 3,000-40,000 g polymer/g sMAO activator/hour;
(b) an ethylene-1-hexene co-polymerization activity measured within 12 hours of forming the contact product of from 10-1,500 kg polymer/mmol metallocene/hour, alternatively, from 20-1,250 kg polymer/mmol metallocene/hour, or alternatively from 30-1,000 kg polymer/mmol metallocene/hour;
(c) an ethylene-1-hexene co-polymerization activity measured after the contact product has been stored for 30 days at room temperature (20° C.-23° C.) under an inert atmosphere which is greater than or equal to 98% of an ethylene-1-hexene co-polymerization activity measured within 12 hours of forming the contact product; or
(d) any combination thereof.

Any polymerization process can be used with the catalyst compositions and methods described herein. For example, the polymerization process can comprise a slurry polymerization, a gas phase polymerization, a solution polymerization, or any multi-reactor combinations thereof. In an aspect, the polymerization process can comprise polymerization in a gas phase reactor, a slurry loop, dual slurry loops in series, multiple slurry tanks in series, a slurry loop combined with a gas phase reactor, a continuous stirred reactor in a batch process, or combinations thereof.

### Polyolefins Prepared Using the Catalyst Compositions

It would be advantageous if catalyst systems were developed to produce linear low-density polyethylene (LLDPE) with high comonomer incorporation efficiency (CIE) such as ansa-metallocenes can deliver, but which are capable of limiting the amount of LCB incorporation. In an aspect, the catalyst systems disclosed herein can provide an ethylene/1-hexene copolymer having any of the following properties:
(a) a 1-hexene comonomer incorporation efficiency (CIE), determined as the [1-hexene]/[ethylene] molar ratio in the polymer divided by the [1-hexene]/[ethylene] molar ratio in the reactor,

$$C I E = \frac{[ C 6 ] / [ C 2 ] polymer}{[ C 6 ] / [ C 2 ] reactor} ,$$

measured under the polymerization conditions, that is greater than a comparative 1-hexene CIE exhibited by a comparative catalyst comprising the contact product of the metallocene activator and a comparative metallocene, wherein:
[i] the comparative metallocene is (n-BuCp)₂ZrCl₂, and the comparative 1-hexene CIE is measured under the same polymerization conditions;
[ii] the comparative metallocene is (n-BuCp)₂ZrCl₂, and the comparative 1-hexene CIE is measured under comparative polymerization conditions that provide a comparative ethylene/1-hexene copolymer having a Melt Index and density that are substantially similar (within 15% of the values) of the Melt Index and density as the ethylene/1-hexene copolymer; or
[iii] the comparative metallocene is an unbridged metallocene having the formula:

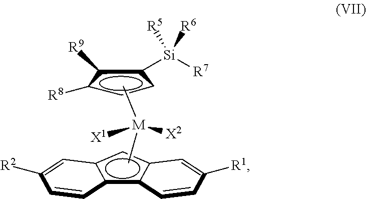

wherein
   M, X¹, X², R¹, R², R⁵, R⁶, R⁷, R⁸, and R⁹ are identical in the metallocene compound as in the comparative unbridged metallocene, under the polymerization conditions;
(b) a Long Chain Branching (LCB) frequency as determined by the Janzen-Colby method (JC-α, 190° C.) of less than about 12 LCB/10⁶ total carbon atoms (that is, from about 0 to about 12 Long Chain Branches per 10⁶ total carbon atoms), or alternatively less than about 10 LCB/10⁶ total carbon atoms as measured for a polymer having a Melt Index (MI) of about 0.5-2.0 g/10 min, alternatively about 0.8-1.5 g/10 min, or alternatively about 0.7-1.3 g/10 min, and having a polymer density of about 0.890-0.932 g/mL, alternatively about 0.900-0.930 g/mL, or alternatively about 0.910-0.928 g/mL;
(c) a Short Chain Branching Distribution (SCBD) profile characterized by a plot of the number of short chain branches per 1000 total carbon atoms versus log₁₀ of the molecular weight of the copolymer over the range from d85 to d15 which has (i) a slope of from about −1.10 to about +2.95 from low molecular weight to high molecular weight, determined by linear regression or (ii) has a slope of about 0 (flat SCBD) or a positive slope (reverse SCBD) from low molecular weight to high molecular weight, determined via linear regression, as measured for a polymer having a Melt Index (MI) of about 0.1-2.0 g/10 min, a high load melt index (HLMI) of about 5-30 g/10 min, a density of about 0.910-0.928 g/mL, and a long LCB content of as defined by Janzen-Colby (JC-α, 190° C.) of ≤7 long chain branches/10⁶ total carbon atoms;
(d) a MI (melt index) of from 0.05 g/15 min to 50 g/10 min;
(e) a HLMI (high load melt index) of from 0.1 g/10 min to 100 g/10 min;
(f) a HLMI/MI ratio (shear response) of from 16 to 100;
(g) a density of from 0.885 g/mL to 0.950 g/mL;
(h) a Mw/Mn ratio (polydispersity index) of from 2.2 to 20; or
(i) any combination thereof.

In a further aspect, the catalyst systems disclosed herein can provide an ethylene/1-hexene copolymer having any of the following properties:
(a) the 1-hexene comonomer incorporation efficiency

$$C I E = \frac{[ C 6 ] / [ C 2 ] polymer}{[ C 6 ] / [ C 2 ] reactor} ,$$

is (i) from 0.02 to 0.30, alternatively from 0.04 to 0.25, or alternatively from 0.1 to 0.20, or (ii) greater than 0.04, alternatively greater than 0.1, or alternatively greater than 0.2, and wherein an optional upper limit for any of these lower limit (“greater than”) values is 0.3;
(b) the Long Chain Branching (LCB) occurrence is less than or equal to 10 (≤10) Long Chain Branches (LCB) per 10⁶ total carbon atoms, alternatively ≤8 LCB per 10⁶ total carbon atoms, alternatively ≤7 LCB per 10⁶ total carbon atoms, alternatively ≤5 LCB per 10⁶ total carbon atoms, alternatively ≤3.5 LCB per 10⁶ total carbon atoms, or alternatively ≤2.5 LCB per 10⁶ total carbon atoms;
(c) the Short Chain Branching Distribution (SCBD) profile over the range from d85 to d15 has a slope of (i) from about −1.10 to about +2.95, alternatively, from about −1.00 to about +2.00, alternatively from about −0.80 to about +1.20, or alternatively from about −0.70 to about +1.00, or (ii) from about −1 to 0, alternatively greater than 0, alternatively greater than 1.0, alternatively greater than 5.0, or alternatively greater than 10.0, from low molecular weight to high molecular weight, determined by linear regression, and wherein an optional upper limit for any of these lower limit (“greater than”) slopes is 15, alternatively 20, alternatively 25, or alternatively 30;
(d) the MI (melt index) is from 0.01 g/10 min to 10 g/10 min, alternatively from 0.02 g/10 min to 5 g/10 min, alternatively from 0.10 g/10 min to 3.0 g/10 min; or alternatively from 0.20 g/10 min to 2.0 g/10 min;
(e) the HLMI (high load melt index) is from 1 g/10 min to 60 g/10 min, alternatively from 2 g/10 min to 50 g/10 min, or alternatively from 3 g/10 min to 40 g/10 min;
(f) the HLMI/MI ratio (shear response) is (i) from 16 to 60, alternatively from 18 to 50, or alternatively from 20 to 40, or (ii) greater than 19, greater than 25, or alternatively, greater than 30, and wherein an optional upper limit for any of these lower limit (“greater than”) ratios is 60;
(g) the density is from 0.885 g/mL to 0.955 g/mL, alternatively from 0.890 g/mL to 0.932 g/mL, alternatively from 0.900 g/mL to 0.930 g/mL, or alternatively from 0.910 g/mL to 0.928 g/mL;
(h) the Mw/Mn ratio (polydispersity index) is from greater than 1.8 to 18, alternatively from 2.0 to 14, alternatively from 2.1 to 12, or alternatively from to 2.2 to 10, or alternatively from to 2.3 to 8; or
(i) any combination thereof.

In another aspect, the ethylene/1-hexene copolymer can have a weight average molecular weight of from 25,000 g/mol to 220,000 g/mol, alternatively from 35,000 g/mol to 210,000 g/mol, alternatively from 50,000 g/mol to 200,000 g/mol, or alternatively from 75,000 g/mol to 175,000 g/mol. The ethylene/1-hexene copolymer also can have the following properties: (a) an analytical temperature rising elution fractionation (aTREF) broadness parameter of from 1.2 to 14, alternatively from 1.5 to 13, alternatively from 2.0 to 12, or alternatively from 2.5 to 10; (b) a solubility distribution breadth index (SDBI) temperature parameter, of 10° C. to 30° C., alternatively from 12° C. to 28° C., alternatively from 14° C. to 27° C., or alternatively from 15° C. to 25° C.; or (c) a combination thereof.

The catalyst system of this disclosure may comprise a single metallocene compound as described herein, or the catalyst system can comprise more than one metallocene at least one of which is disclosed herein. When the catalyst system comprises a single metallocene compound, the single-metallocene catalyst system can be characterized by multiple active catalytic sites under polymerization conditions, as determined from gel permeation chromatography (GPC) or analytical temperature rising elution fractionation (aTREF) data. In an aspect, the catalyst composition can comprise a single metallocene compound which provides 2 or 3 Shulz-Flory active catalytic sites under polymerization conditions, as determined from gel permeation chromatography (GPC) or analytical temperature rising elution fractionation (aTREF) data.

Polyethylenes Prepared from the Disclosed Metallocene Catalysts and Comparative Results

Table 1 lists some of the exemplary (M) and comparative (CM) metallocenes described and examined in this disclosure.

TABLE 1
Exemplary inventive metallocenes (M) and comparative
metallocenes (CM) according to this disclosure.

| Compound | |
|---|---|
| Number | Metallocene |
| M1 | Ph₂C(2,7-t-Bu₂Fl)(Cp-SiMe₂Et)ZrCl₂ |
| M2 | Ph₂C(Fl)(Cp-SiMe₂Et)ZrCl₂ |
| M3 | Ph₂C(2,7-t-Bu₂Fl)(Cp-SiMe₂-n-Pr)ZrCl₂ |
| M4 | Ph₂C(Fl)(Cp-SiMe₂-n-Pr)ZrCl₂ |
| M5 | Ph₂C(Fl)(Cp-SiMe₂-n-Bu)ZrCl₂ |
| M5Bu | Ph₂C(2,7-t-Bu₂Fl)(Cp-SiMe₂-n-Bu)ZrCl₂ |
| M6 | Ph₂C(2,7-t-Bu₂Fl)(Cp-SiMe₂-2-Nor)ZrCl₂ |
| M7 | Ph₂C(Fl)(Cp-SiMe₂-2-Nor)ZrCl₂ |
| M8 | Ph₂C(2,7-t-Bu₂Fl)(Cp-SiEt₃)ZrCl₂ |
| M9 | Ph₂C(Fl)(Cp-SiEt₃)ZrCl₂ |
| M10 | Me₂C(2,7-t-Bu₂Fl)(Cp-SiEt₃)ZrCl₂ |
| M11 | Me₂C(Fl)(Cp-SiEt₃)ZrCl₂ |
| M12 | Ph₂C(2,7-t-Bu₂Fl)(Cp-Si-n-Pr₃)ZrCl₂ |
| M13 | Ph₂C(Fl)(Cp-Si-n-Pr₃)ZrCl₂ |
| M14 | Ph₂C(Fl)(Cp-SiEt₃)HfCl₂ |
| M15 | (cyclopenta-1,1-diyl)(2,7-t-Bu₂Fl)(Cp-SiEt₃)ZrCl₂ |
| M16 | (cyclopenta-1,1-diyl)(Fl)(Cp-SiEt₃)ZrCl₂ |
| M17 | (cyclopenta-1,1-diyl)(Fl)(Cp-SiEt₃)HfCl₂ |
| M18 | (cyclopenta-1,1-diyl)(Fl)(Cp-Si-n-Pr₃)ZrCl₂ |
| M19 | (cyclopenta-1,1-diyl)(Fl)(Cp-Si-n-Pr₃)HfCl₂ |
| CM1 | (n-BuCp)₂ZrCl₂ |
| CM2 | Me₂C(Fl)(Cp)ZrCl₂ |
| CM3 | Me₂C(2,7-t-Bu₂Fl)(Cp)ZrCl₂ |
| CM4 | Ph₂C(2,7-t-Bu₂Fl)(Cp)ZrCl₂ |
| CM5 | Ph₂C(Fl)(Cp-SiMe₃)ZrCl₂ |
| CM6 | Ph₂C(2,7-t-Bu₂Fl)(Cp-SiMe₃)ZrCl₂ |
| CM7 | Ph₂C(Fl)(Cp-SiMe₂allyl)ZrCl₂ |
| CM8 | (cyclopenta-1,1-diyl)(2,7-t-Bu₂Fl)(Cp)ZrCl₂ |
| CM9 | Me(3-buten-1-yl)C(2,7-t-Bu₂Fl)(Cp)ZrCl₂ |

Tables 2-4 present data for the polymerization runs and the resulting polymers for some of the exemplary silyl-substituted ansa-metallocenes (M) examined in this disclosure, as follows. Table 2 presents olefin polymerization conditions and catalyst activities for the respective metallocene catalyst systems. All polymerization runs used 2.7 mmol TNOAl (tri-n-octylaluminum scavenger. Table 3 provides the polyethylene melt index, density, molecular weight and related data for respective metallocene catalyst systems. Table 4 tabulates polyethylene branching, co-monomer incorporation, aTREF (analytical Temperature Rising Elution Fraction) and SDBI (Solubility Distribution Breadth Index) data for inventive and comparative metallocene catalyst systems, respectively.

TABLE 2
Olefin polymerization conditions and catalyst activities for inventive metallocene
catalyst systems. All polymerization runs used 2.7 mmol TNOAl scavenger.^{A}

| | | | | | | | | | | |
|---|---|---|---|---|---|---|---|---|---|---|
| | sMAO | | | | | | | Support | MCN | MCN- |
| | Support | | H₂/C₂ | | Reactor | Reaction | | Activity (g | Activity (kg | sMAO |
| | Charge | MCN | Ratio | 1-hexene | Temp | Time | Yield PE | PE/g | PE/mmol | precontact |
| Ex. No | (mg) | (mmol) | (psi/psi) | (mL) | (° C.) | (min) | (g) | Support/h) | MCN/h) | (days) |

Ph₂C(2,7-t-Bu₂Fl)(Cp-SiMe₂Et)ZrCl₂ (M1)

| | | | | | | | | | | |
|---|---|---|---|---|---|---|---|---|---|---|
| 22 | 6.5 | 2.50E−04 | 4.20E−03 | 50 | 80 | 60 | 106.5 | 16385 | 426 | 44 |

Ph₂C(Fl)(Cp-SiMe₂Et)ZrCl₂ (M2)

| | | | | | | | | | | |
|---|---|---|---|---|---|---|---|---|---|---|
| 20 | 6.5 | 2.50E−04 | 4.13E−03 | 40 | 80 | 60 | 95.9 | 14754 | 384 | 30 |

Ph₂C(2,7-t-Bu₂Fl)(Cp-SiMe₂-n-Pr)ZrCl₂ (M3)

| | | | | | | | | | | |
|---|---|---|---|---|---|---|---|---|---|---|
| 28 | 13.0 | 5.00E−04 | 2.55E−03 | 50 | 80 | 60 | 175.8 | 13523 | 352 | 3 |
| 29 | 6.5 | 2.50E−04 | 2.42E−03 | 50 | 80 | 60 | 51.6 | 7938 | 206 | 43 |

Ph₂C(Fl)(Cp-SiMe₂-n-Pr)ZrCl₂ (M4)

| | | | | | | | | | | |
|---|---|---|---|---|---|---|---|---|---|---|
| 25 | 2.6 | 1.00E−04 | 3.05E−03 | 40 | 80 | 60 | 74.9 | 28808 | 749 | NA |

Ph₂C(2,7-t-Bu₂Fl)(Cp-SiMe₂-n-Bu)ZrCl₂ (M5Bu)

| | | | | | | | | | | |
|---|---|---|---|---|---|---|---|---|---|---|
| 32 | 6.5 | 2.50E−04 | 2.89E−03 | 45 | 80 | 60 | 51.2 | 7877 | 205 | 17 |

Ph₂C(Fl)(Cp-SiMe₂-n-Bu)ZrCl₂ (M5)

| | | | | | | | | | | |
|---|---|---|---|---|---|---|---|---|---|---|
| 30 | 2.6 | 1.00E−04 | 2.98E−03 | 40 | 80 | 60 | 55.2 | 21231 | 552 | 8 |

Ph₂C(2,7-t-Bu₂Fl)(Cp-SiMe₂-2-Nor)ZrCl₂ (M6)

| | | | | | | | | | | |
|---|---|---|---|---|---|---|---|---|---|---|
| 33 | 6.5 | 2.50E−04 | 2.76E−03 | 45 | 80 | 60 | 163.7 | 25185 | 655 | 29 |

Ph₂C(Fl)(Cp-SiMe₂-2-Nor)ZrCl₂ (M7)

| | | | | | | | | | | |
|---|---|---|---|---|---|---|---|---|---|---|
| 31 | 6.5 | 2.50E−04 | 3.53E−03 | 35 | 80 | 60 | 118.4 | 18215 | 474 | 5 |

Ph₂C(2,7-t-Bu₂Fl)(Cp-SiEt₃)ZrCl₂ (M8)

| | | | | | | | | | | |
|---|---|---|---|---|---|---|---|---|---|---|
| 21 | 2.6 | 1.00E−04 | 2.43E−03 | 40 | 80 | 60 | 64.6 | 24846 | 646 | 16 |

Ph₂C(Fl)(Cp-SiEt₃)ZrCl₂ (M9)

| | | | | | | | | | | |
|---|---|---|---|---|---|---|---|---|---|---|
| 15 | 6.5 | 2.50E−04 | 2.71E−03 | 40 | 80 | 60 | 126.1 | 19400 | 504 | 10 |
| 16 | 2.6 | 1.00E−04 | 3.43E−03 | 40 | 80 | 60 | 70.9 | 27269 | 709 | 8 |
| 17 | 6.5 | 2.50E−04 | 4.15E−03 | 80 | 80 | 60 | 120.6 | 18554 | 482 | NA |
| 18 | 6.5 | 2.50E−04 | 4.27E−03 | 80 | 60 | 60 | 147.2 | 22646 | 589 | NA |

Me₂C(2,7-t-Bu₂Fl)(Cp-SiEt₃)ZrCl₂ (M10)

| | | | | | | | | | | |
|---|---|---|---|---|---|---|---|---|---|---|
| 14 | 6.5 | 2.50E−04 | 1.40E−03 | 45 | 80 | 60 | 134.1 | 20631 | 536 | 1 |

Me₂C(Fl)(Cp-SiEt₃)ZrCl₂ (M11)

| | | | | | | | | | | |
|---|---|---|---|---|---|---|---|---|---|---|
| 13 | 6.5 | 2.50E−04 | 3.25E−03 | 35 | 80 | 60 | 64.2 | 9877 | 257 | 4 |

Ph₂C(2,7-t-Bu₂Fl)(Cp-Si-n-Pr₃)ZrCl₂ (M12)

| | | | | | | | | | | |
|---|---|---|---|---|---|---|---|---|---|---|
| 24 | 6.5 | 2.50E−04 | 2.76E−03 | 40 | 80 | 60 | 169.9 | 26138 | 690 | 4 |

Ph₂C(Fl)(Cp-Si-n-Pr₃)ZrCl₂ (M13)

| | | | | | | | | | | |
|---|---|---|---|---|---|---|---|---|---|---|
| 23 | 2.6 | 1.00E−04 | 3.41E−03 | 40 | 80 | 60 | 88.9 | 34192 | 889 | NA |

Ph₂C(Fl)(Cp-SiEt₃)HfCl₂ (M14)

| | | | | | | | | | | |
|---|---|---|---|---|---|---|---|---|---|---|
| 19 | 26.0 | 1.00E−03 | 3.75E−02 | 40 | 80 | 60 | 41.4 | 1592 | 41 | 6 |

(cyclopenta-1,1-diyl)(2,7-t-Bu₂Fl)(Cp-SiEt₃)ZrCl₂ (M15)

| | | | | | | | | | | |
|---|---|---|---|---|---|---|---|---|---|---|
| 36 | 6.5 | 2.50E−04 | 2.13E−03 | 35 | 80 | 60 | 41.7 | 6415 | 167 | 15 |

(cyclopenta-1,1-diyl)(Fl)(Cp-SiEt₃)ZrCl₂ (M16)

| | | | | | | | | | | |
|---|---|---|---|---|---|---|---|---|---|---|
| 35 | 6.5 | 2.50E−04 | 2.13E−03 | 40 | 80 | 60 | 90.2 | 13877 | 361 | 4 |

(cyclopenta-1,1-diyl)(Fl)(Cp-SiEt₃)HfCl₂ (M17)

| | | | | | | | | | | |
|---|---|---|---|---|---|---|---|---|---|---|
| 40 | 6.5 | 2.50E−04 | 2.13E−03 | 40 | 80 | 60 | 9.7 | 1492 | 39 | NA |

(cyclopenta-1,1-diyl)(Fl)(Cp-Si-n-Pr₃)ZrCl₂ (M18)

| | | | | | | | | | | |
|---|---|---|---|---|---|---|---|---|---|---|
| 37 | 6.5 | 2.50E−04 | 2.82E−03 | 40 | 80 | 60 | 26.3 | 4046 | 105 | 6 |
| 38 | 6.5 | 2.50E−04 | 2.10E−03 | 35 | 80 | 60 | 13.1 | 2015 | 52 | 6 |

(cyclopenta-1,1-diyl)(Fl)(Cp-Si-n-Pr₃)HfCl₂ (M19)

| | | | | | | | | | | |
|---|---|---|---|---|---|---|---|---|---|---|
| 41 | 26.0 | 1.00E−03 | 2.13E−03 | 40 | 80 | 60 | 11.7 | 450 | 12 | NA |

^{A}NA, data not available.

TABLE 3
Polyethylene melt index, density, molecular weight and related data for inventive
metallocene catalyst systems.^{A}

| | | | | | | | | |
|---|---|---|---|---|---|---|---|---|
| Ex. No. | MI | HLMI | $\frac{HLMI}{MI}$ | Density (g/mL) | Mn (g/mol) | Mw (g/mol) | $\frac{Mw}{Mn}$ | Mz (g/mol) |

Ph₂C(2,7-t-Bu₂Fl)(Cp-SiMe₂Et)ZrCl₂ (M1)

| | | | | | | | | |
|---|---|---|---|---|---|---|---|---|
| 22 | 1.1 | 22.1 | 20.7 | 0.9161 | 3.83E+04 | 9.83E+04 | 2.57 | 1.93E+05 |

Ph₂C(Fl)(Cp-SiMe₂Et)ZrCl₂ (M2)

| | | | | | | | | |
|---|---|---|---|---|---|---|---|---|
| 20 | 0.9 | 24.3 | 26.6 | 0.9204 | 2.29E+04 | 8.97E+04 | 3.92 | 1.92E+05 |

Ph₂C(2,7-t-Bu₂Fl)(Cp-SiMe₂-n-Pr)ZrCl₂ (M3)

| | | | | | | | | |
|---|---|---|---|---|---|---|---|---|
| 28 | 1.0 | 22.0 | 22.6 | 0.9198 | 3.13E+04 | 1.00E+05 | 3.20 | 2.19E+05 |
| 29 | 0.1 | 5.0 | 35.5 | 0.9191 | 4.72E+04 | 1.50E+05 | 3.19 | 3.32E+05 |

Ph₂C(Fl)(Cp-SiMe₂-n-Pr)ZrCl₂ (M4)

| | | | | | | | | |
|---|---|---|---|---|---|---|---|---|
| 25 | 1.1 | 31.6 | 27.5 | 0.9267 | 2.18E+04 | 8.99E+04 | 4.12 | 2.09E+05 |

Ph₂C(2,7-t-Bu₂Fl)(Cp-SiMe₂-n-Bu)ZrCl₂ (M5Bu)

| | | | | | | | | |
|---|---|---|---|---|---|---|---|---|
| 32 | 1.3 | 32.6 | 24.5 | 0.9312 | 2.95E+04 | 8.97E+04 | 3.04 | 2.04E+05 |

Ph₂C(Fl)(Cp-SiMe₂-n-Bu)ZrCl₂ (M5)

| | | | | | | | | |
|---|---|---|---|---|---|---|---|---|
| 30 | 0.3 | 7.0 | 26.1 | 0.9195 | 4.30E+04 | 1.32E+05 | 3.08 | 2.83E+05 |

Ph₂C(2,7-t-Bu₂Fl)(Cp-SiMe₂-2-Nor)ZrCl₂ (M6)

| | | | | | | | | |
|---|---|---|---|---|---|---|---|---|
| 33 | 0.9 | 19.9 | 22.6 | 0.9284 | 3.11E+04 | 1.02E+05 | 3.27 | 2.15E+-5 |

Ph₂C(Fl)(Cp-SiMe₂-2-Nor)ZrCl₂ (M7)

| | | | | | | | | |
|---|---|---|---|---|---|---|---|---|
| 31 | 1.2 | 29.4 | 25.5 | 0.9262 | 2.95E+04 | 8.85E+04 | 3.00 | 1.91E+05 |

Ph₂C(2,7-t-Bu₂Fl)(Cp-SiEt₃)ZrCl₂ (M8)

| | | | | | | | | |
|---|---|---|---|---|---|---|---|---|
| 21 | 1.0 | 22.1 | 22.5 | 0.9271 | 1.97E+04 | 9.61E+04 | 4.89 | 2.03E+05 |

Ph₂C(Fl)(Cp-SiEt₃)ZrCl₂ (M9)

| | | | | | | | | |
|---|---|---|---|---|---|---|---|---|
| 15 | 1.3 | 23.5 | 18.8 | 0.9221 | 2.47E+04 | 9.27E+04 | 3.76 | 1.84E+05 |
| 16 | 0.7 | 15.4 | 20.8 | 0.9223 | 2.40E+04 | 1.05E+05 | 4.37 | 2.15E+05 |
| 17 | 1.0 | 23.4 | 24.1 | 0.9096 | 3.23E+04 | 8.10E+04 | 2.51 | 1.72E+05 |
| 18 | 2.7 | 123.1 | 45.4 | 0.9234 | 1.37E+04 | 5.26E+04 | 3.85 | 1.31E+05 |

Me₂C(2,7-t-Bu₂Fl)(Cp-SiEt₃)ZrCl₂ (M10)

| | | | | | | | | |
|---|---|---|---|---|---|---|---|---|
| 14 | 1.0 | 20.5 | 20.7 | 0.9159 | 4.11E+04 | 9.54E+04 | 2.32 | 1.77E+05 |

Me₂C(Fl)(Cp-SiEt₃)ZrCl₂ (M11)

| | | | | | | | | |
|---|---|---|---|---|---|---|---|---|
| 13 | 1.0 | 22.1 | 21.8 | 0.9182 | 3.67E+04 | 9.12E+04 | 2.49 | 1.73E+05 |

Ph₂C(2,7-t-Bu₂Fl)(Cp-Si-n-Pr₃)ZrCl₂ (M12)

| | | | | | | | | |
|---|---|---|---|---|---|---|---|---|
| 24 | 1.2 | 27.6 | 22.8 | 0.9243 | 2.84E+04 | 9.39E+04 | 3.31 | 2.00E+05 |

Ph₂C(Fl)(Cp-Si-n-Pr₃)ZrCl₂ (M13)

| | | | | | | | | |
|---|---|---|---|---|---|---|---|---|
| 23 | 1.3 | 25.6 | 19.3 | 0.9258 | 2.17E+04 | 9.31E+04 | 4.30 | 1.96E+05 |

Ph₂C(Fl)(Cp-SiEt₃)HfCl₂ (M14)

| | | | | | | | | |
|---|---|---|---|---|---|---|---|---|
| 19 | 0.9 | 18.6 | 20.0 | 0.9296 | 3.72E+04 | 1.00E+05 | 2.70 | 2.11E+05 |

(cyclopenta-1,1-diyl)(2,7-t-Bu₂Fl)(Cp-SiEt₃)ZrCl₂ (M15)

| | | | | | | | | |
|---|---|---|---|---|---|---|---|---|
| 36 | 1.4 | 29.3 | 21.7 | 0.9283 | 3.21E+04 | 8.97E+04 | 2.79 | 1.95E+05 |

(cyclopenta-1,1-diyl)(Fl)(Cp-SiEt₃)ZrCl₂ (M16)

| | | | | | | | | |
|---|---|---|---|---|---|---|---|---|
| 35 | 1.2 | 22.7 | 19.5 | 0.9215 | 4.29E+04 | 9.69E+04 | 2.26 | 1.75E+05 |

(cyclopenta-1,1-diy1)(Fl)(Cp-SiEt₃)HfCl₂ (M17)

| | | | | | | | | |
|---|---|---|---|---|---|---|---|---|
| 40 | 1.1 | 20.3 | 19.1 | 0.9276 | 3.80E+04 | 1.01E+05 | 2.65 | 1.92E+05 |

(cyclopenta-1,1-diyl)(Fl)(Cp-Si-n-Pr₃)ZrCl₂ (M18)

| | | | | | | | | |
|---|---|---|---|---|---|---|---|---|
| 37 | 1.3 | 26.7 | 21.3 | 0.9253 | 3.41E+04 | 8.72E+04 | 2.56 | 1.64E+05 |
| 38 | 1.1 | 21.6 | 20.2 | 0.9283 | 3.62E+04 | 9.40E+04 | 2.60 | 1.80E+05 |

(cyclopenta-1,1-diyl)(Fl)(Cp-Si-n-Pr₃)HfCl₂ (M19)

| | | | | | | | | |
|---|---|---|---|---|---|---|---|---|
| 41 | 1.1 | NA | NA | 0.9252 | 4.06E+04 | 1.14E+05 | 2.80 | 2.22E+05 |

^{A}NA, data not available.

TABLE 4
Polyethylene branching, co-monomer incorporation, aTREF (analytical Temperature Rising Elution Fraction)
and SDBI (Solubility Distribution Breadth Index) data for inventive metallocene catalyst systems.^{A}

| | | | | | | | | | | | | | |
|---|---|---|---|---|---|---|---|---|---|---|---|---|---|
| | GPC- | | JC-α | | | | | | | | | | |
| | IR | SCB | (190° C.) | | | C6 | | | Solubles | | | | |
| | Hexene | Slope | LCB/ | [C6]/ | [C6]/ | Incor. | aTREF | | Fraction | | | | |
| | in PE | d85 − | 10⁶ | [C2] | [C2] | Eff. | Broad- | SDBI | (% | Peak 1 | Normalized | Peak 2 | Normalized |
| Ex. No. | (wt %) | d15 | Total C | Reactor | Poly | (CIE) | ness | (° C.) | Area) | (° C.) | Height | (° C.) | Height |

Ph₂C(2,7-t-Bu₂Fl)(Cp-SiMe₂Et)ZrCl₂ (M1)

| | | | | | | | | | | | | | |
|---|---|---|---|---|---|---|---|---|---|---|---|---|---|
| 22 | 6.88 | −0.06 | 1.7 | 0.217 | 0.023 | 0.106 | 7.3 | 17.12 | 0.7 | 82 | 8.3 | NA | NA |

Ph₂C(Fl)(Cp-SiMe₂Et)ZrCl₂ (M2)

| | | | | | | | | | | | | | |
|---|---|---|---|---|---|---|---|---|---|---|---|---|---|
| 20 | 6.16 | 1.18 | 6.9 | 0.176 | 0.021 | 0.117 | 8.4 | 17.97 | 0.9 | 84 | 7.7 | NA | NA |

Ph₂C(2,7-t-Bu₂Fl)(Cp-SiMe₂-n-Pr)ZrCl₂ (M3)

| | | | | | | | | | | | | | |
|---|---|---|---|---|---|---|---|---|---|---|---|---|---|
| 28 | 6.68 | 1.06 | 2.0 | 0.217 | 0.022 | 0.103 | 7.6 | 17.93 | 0.7 | 85 | 7.7 | NA | NA |
| 29 | 7.01 | 0.82 | 2.2 | 0.217 | 0.023 | 0.108 | 8.1 | 16.32 | 0.4 | 84 | 7.0 | NA | NA |

Ph₂C(Fl)(Cp-SiMe₂-n-Pr)ZrCl₂ (M4)

| | | | | | | | | | | | | | |
|---|---|---|---|---|---|---|---|---|---|---|---|---|---|
| 25 | 4.75 | 0.26 | 1.6 | 0.176 | 0.016 | 0.090 | 7.9 | 17.9 | 0.5 | 89 | 7.4 | NA | NA |

Ph₂C(2,7-t-Bu₂Fl)(Cp-SiMe₂-n-Bu)ZrCl₂ (M5Bu)

| | | | | | | | | | | | | | |
|---|---|---|---|---|---|---|---|---|---|---|---|---|---|
| 32 | 2.67 | 0.70 | 9.9 | 0.196 | 0.009 | 0.045 | 4.4 | 21.72 | 1 | 92 | 16.5 | NA | NA |

Ph₂C(Fl)(Cp-SiMe₂-n-Bu)ZrCl₂ (M5)

| | | | | | | | | | | | | | |
|---|---|---|---|---|---|---|---|---|---|---|---|---|---|
| 30 | 6.31 | 0.38 | 2.3 | 0.176 | 0.021 | 0.120 | 7.2 | 17.28 | 0.6 | 86 | 8.3 | NA | NA |

Ph₂C(2,7-t-Bu₂Fl)(Cp-SiMe₂-2-Nor)ZrCl₂ (M6)

| | | | | | | | | | | | | | |
|---|---|---|---|---|---|---|---|---|---|---|---|---|---|
| 33 | 2.99 | 0.47 | 2.4 | 0.196 | 0.010 | 0.051 | 6.0 | 19.43 | 0.7 | 93 | 12.2 | NA | NA |

Ph₂C(Fl)(Cp-SiMe₂-2-Nor)ZrCl₂ (M7)

| | | | | | | | | | | | | | |
|---|---|---|---|---|---|---|---|---|---|---|---|---|---|
| 31 | 4.87 | −0.71 | 4.9 | 0.155 | 0.016 | 0.105 | 9.1 | 21.46 | 1.7 | 89 | 6.8 | 94.2 | 5.4 |

Ph₂C(2,7-t-Bu₂Fl)(Cp-SiEt₃)ZrCl₂ (M8)

| | | | | | | | | | | | | | |
|---|---|---|---|---|---|---|---|---|---|---|---|---|---|
| 21 | 3.91 | 0.19 | −0.7 | 0.176 | 0.013 | 0.074 | 8.3 | 19.67 | 1 | 88 | 6.7 | 93.5 | 6.0 |

Ph₂C(Fl)(Cp-SiEt₃)ZrCl₂ (M9)

| | | | | | | | | | | | | | |
|---|---|---|---|---|---|---|---|---|---|---|---|---|---|
| 15 | 5.20 | −1.08 | 1.2 | 0.176 | 0.017 | 0.099 | 10.0 | 16.23 | 0.1 | 85.6 | 5.7 | 93.6 | 4.2 |
| 16 | 5.22 | 0.59 | 1.5 | 0.176 | 0.017 | 0.099 | 8.7 | 18.43 | 0.8 | 84.6 | 6.5 | 94.2 | 3.6 |
| 17 | 10.36 | −0.61 | NA | 0.335 | 0.034 | 0.103 | 5.6 | 19.43 | 1.5 | 74.0 | 4.4 | NA | NA |
| 18 | 7.18 | 2.95 | NA | 0.176 | 0.021 | 0.120 | NA | 19.39 | 1.4 | 82.0 | 4.4 | 95 | 2.5 |

Me₂C(2,7-t-Bu₂Fl)(Cp-SiEt₃)ZrCl₂ (M10)

| | | | | | | | | | | | | | |
|---|---|---|---|---|---|---|---|---|---|---|---|---|---|
| 14 | 7.49 | 0.01 | 1.8 | 0.196 | 0.025 | 0.127 | 8.8 | 16.18 | 0.5 | 81 | 6.6 | NA | NA |

Me₂C(Fl)(Cp-SiEt₃)ZrCl₂ (M11)

| | | | | | | | | | | | | | |
|---|---|---|---|---|---|---|---|---|---|---|---|---|---|
| 13 | 7.52 | 0.77 | 5.8 | 0.155 | 0.025 | 0.162 | 8.5 | 18.31 | 0.9 | 85 | 7.5 | NA | NA |

Ph₂C(2,7-t-Bu₂Fl)(Cp-Si-n-Pr₃)ZrCl₂ (M12)

| | | | | | | | | | | | | | |
|---|---|---|---|---|---|---|---|---|---|---|---|---|---|
| 24 | 5.64 | 0.79 | 0.6 | 0.176 | 0.019 | 0.107 | 8.8 | 19.27 | 1 | 87 | 6.4 | 92.4 | 5.9 |

Ph₂C(Fl)(Cp-Si-n-Pr₃)ZrCl₂ (M13)

| | | | | | | | | | | | | | |
|---|---|---|---|---|---|---|---|---|---|---|---|---|---|
| 23 | 4.11 | 0.05 | 0.8 | 0.176 | 0.014 | 0.078 | 9.1 | 18.42 | 0.6 | 87 | 6.4 | 94.9 | 4.9 |

Ph₂C(Fl)(Cp-SiEt₃)HfCl₂ (M14)

| | | | | | | | | | | | | | |
|---|---|---|---|---|---|---|---|---|---|---|---|---|---|
| 19 | 2.61 | −0.27 | 0.4 | 0.176 | 0.009 | 0.049 | 8.5 | 17.99 | 0.4 | 89 | 5.4 | 96.1 | 11.4 |

(cyclopenta-1,1-diyl)(2,7-t-Bu₂Fl)(Cp-SiEt₃)ZrCl₂ (M15)

| | | | | | | | | | | | | | |
|---|---|---|---|---|---|---|---|---|---|---|---|---|---|
| 36 | 3.12 | 0.81 | 4.9 | 0.155 | 0.010 | 0.067 | 2.9 | 16.75 | 0.2 | 90 | 21.1 | NA | NA |

(cyclopenta-1,1-diyl)(Fl)(Cp-SiEt₃)ZrCl₂ (M16)

| | | | | | | | | | | | | | |
|---|---|---|---|---|---|---|---|---|---|---|---|---|---|
| 35 | 4.48 | 0.40 | 6.5 | 0.176 | 0.015 | 0.085 | 5.5 | 18.51 | 0.6 | 89 | 13.1 | NA | NA |

(cyclopenta-1,1-diyl)(Fl)(Cp-SiEt₃)HfCl₂ (M17)

| | | | | | | | | | | | | | |
|---|---|---|---|---|---|---|---|---|---|---|---|---|---|
| 40 | 5.39 | 0.82 | NA | NA | NA | NA | NA | NA | NA | NA | NA | NA | NA |

(cyclopenta-1,1-diyl)(Fl)(Cp-Si-n-Pr₃)ZrCl₂ (M18)

| | | | | | | | | | | | | | |
|---|---|---|---|---|---|---|---|---|---|---|---|---|---|
| 37 | 4.35 | 0.70 | 2.0 | 0.176 | 0.014 | 0.082 | 4.3 | 20.4 | 1.3 | 88 | 17.6 | NA | NA |
| 38 | 3.12 | 0.77 | 1.9 | 0.155 | 0.010 | 0.067 | 2.9 | 22.15 | 1.6 | 90 | 21.9 | NA | NA |

(cyclopenta-1,1-diyl)(Fl)(Cp-Si-n-Pr₃)HfCl₂ (M19)

| | | | | | | | | | | | | | |
|---|---|---|---|---|---|---|---|---|---|---|---|---|---|
| 41 | 6.25 | 0.91 | −1.8 | NA | NA | NA | NA | NA | NA | NA | NA | NA | NA |

^{A}NA, data not available.

Tables 5-7 provide data for the polymerization runs and the resulting polymers for some of the comparative (CM) metallocenes examined in this disclosure, as follows. Table 5 presents olefin polymerization conditions and catalyst activities for the respective metallocene catalyst systems. All polymerization runs used 2.7 mmol TNOAl (tri-n-octyl aluminum scavenger. Table 6 provides the polyethylene melt index, density, molecular weight and related data for respective metallocene catalyst systems. Table 7 tabulates polyethylene branching, co-monomer incorporation, aTREF (analytical Temperature Rising Elution Fraction) and SDBI (Solubility Distribution Breadth Index) data for inventive and comparative metallocene catalyst systems, respectively.

TABLE 5
Olefin polymerization conditions and catalyst activities for comparative metallocene
catalyst systems. All polymerization runs used 2.7 mmol TNOAl scavenger.

| | | | | | | | | | | |
|---|---|---|---|---|---|---|---|---|---|---|
| | sMAO | | | | | | | Support | MCN | MCN- |
| | Support | | H₂/C₂ | | Reactor | Reaction | | Activity (g | Activity (kg | sMAO |
| | Charge | MCN | Ratio | 1-hexene | Temp | Time | Yield PE | PE/g | PE/mmol | precontact |
| Ex. No. | (mg) | (mmol) | (psi/psi) | (mL) | (° C.) | (min) | (g) | Support/h) | MCN/h) | (days) |

(n-BuCp)₂ZrCl₂ (CM1)

| | | | | | | | | | | |
|---|---|---|---|---|---|---|---|---|---|---|
| 4 | 19.3 | 7.50E−04 | 2.82E−04 | 80 | 80 | 60 | 99.6 | 5167 | 133 | 36 |

Me₂C(Fl)(Cp)ZrCl₂ (CM2)

| | | | | | | | | | | |
|---|---|---|---|---|---|---|---|---|---|---|
| 5 | 13.0 | 5.00E−04 | 2.33E−03 | 50 | 80 | 60 | 63.5 | 4885 | 127 | 32 |
| 6 | 13.0 | 5.00E−04 | 2.43E−03 | 50 | 80 | 60 | 31.7 | 2438 | 63 | 37 |
| 7 | 13.0 | 5.00E−04 | 5.83E−03 | 60 | 80 | 60 | 52.7 | 4054 | 105 | 25 |

Me₂C(2,7-t-Bu₂Fl)(Cp)ZrCl₂ (CM3)

| | | | | | | | | | | |
|---|---|---|---|---|---|---|---|---|---|---|
| 8 | 10.6 | 4.68E−04 | 7.14E−03 | 40 | 80 | 60 | 118.0 | 11180 | 252 | 8 |

Ph₂C(2,7-t-Bu₂Fl)(Cp)ZrCl₂ (CM4)

| | | | | | | | | | | |
|---|---|---|---|---|---|---|---|---|---|---|
| 9 | 13.0 | 5.00E−04 | 1.32E−02 | 50 | 80 | 120 | 97.1 | 3735 | 97 | 28 |
| 10 | 6.5 | 2.50E−04 | 1.55E−02 | 80 | 70 | 60 | 17.9 | 2754 | 72 | 35 |

Ph₂C(Fl)(Cp-SiMe₃)ZrCl₂ (CM5)

| | | | | | | | | | | |
|---|---|---|---|---|---|---|---|---|---|---|
| 11 | 5.2 | 2.00E−04 | 3.53E−03 | 40 | 80 | 60 | 105.0 | 20174 | 525 | 1 |

Ph₂C(2,7-t-Bu₂Fl)(Cp-SiMe₃)ZrCl₂ (CM6)

| | | | | | | | | | | |
|---|---|---|---|---|---|---|---|---|---|---|
| 12 | 13.0 | 5.00E−04 | 4.21E−03 | 50 | 80 | 60 | 167.1 | 12854 | 334 | 2 |

Ph₂C(Fl)(Cp-SiMe₂Allyl)ZrCl₂ (CM7)

| | | | | | | | | | | |
|---|---|---|---|---|---|---|---|---|---|---|
| 26 | 6.5 | 2.50E−04 | 3.54E−03 | 35 | 80 | 60 | 35.6 | 5477 | 142 | 7 |
| 27 | 6.5 | 2.50E−04 | 2.98E−03 | 40 | 80 | 60 | 24.1 | 3708 | 96 | 16 |

(cyclopenta-1,1-diyl)(2,7-t-Bu₂Fl)(Cp)ZrCl₂ (CM8)

| | | | | | | | | | | |
|---|---|---|---|---|---|---|---|---|---|---|
| 34 | 13.0 | 5.00E−04 | 6.37E−03 | 35 | 80 | 60 | 28.5 | 2192 | 57 | 7 |

TABLE 6
Polyethylene melt index, density, molecular weight and related data for comparative
metallocene catalyst systems.

| | | | | | | | | |
|---|---|---|---|---|---|---|---|---|
| Ex. No. | MI | HLMI | $\frac{HLMI}{MI}$ | Density (g/mL) | Mn (g/mol) | Mw (g/mol) | $\frac{Mw}{Mn}$ | Mz (g/mol) |

(n-BuCp)₂ZrCl₂ (CM1)

| | | | | | | | | |
|---|---|---|---|---|---|---|---|---|
| 4 | 1.5 | 15.3 | 16.1 | 0.9248 | 4.37E+04 | 9.05E+04 | 2.08 | 1.56E+05 |

Me₂C(Fl)(Cp)ZrCl₂ (CM2)

| | | | | | | | | |
|---|---|---|---|---|---|---|---|---|
| 5 | 1.0 | 33.7 | 35.5 | 0.9162 | 2.98E+04 | 8.29E+04 | 2.78 | 1.87E+05 |
| 6 | 1.1 | 34.0 | 31.8 | 0.9164 | 2.89E+04 | 8.87E+04 | 3.07 | 2.10E+05 |
| 7 | 1.8 | 52.2 | 28.8 | 0.9165 | 2.72E+04 | 7.66E+04 | 2.81 | 1.65E+05 |

Me₂C(2,7-t-Bu₂Fl)(Cp)ZrCl₂ (CM3)

| | | | | | | | | |
|---|---|---|---|---|---|---|---|---|
| 8 | 3.0 | 86.7 | 28.7 | 0.9220 | 2.60E+04 | 7.01E+04 | 2.70 | 3.42E+05 |

Ph₂C(2,7-t-Bu₂Fl)(Cp)ZrCl₂ (CM4)

| | | | | | | | | |
|---|---|---|---|---|---|---|---|---|
| 9 | 1.3 | 39.9 | 31.4 | 0.9193 | 2.70E+04 | 8.52E+04 | 3.16 | 2.17E+05 |
| 10 | 0.6 | 14.4 | 23.9 | 0.9127 | 3.96E+04 | 1.07E+05 | 2.71 | 2.20E+05 |

Ph₂C(Fl)(Cp-SiMe₃)ZrCl₂(CM5)

| | | | | | | | | |
|---|---|---|---|---|---|---|---|---|
| 11 | 0.9 | 26.9 | 30.2 | 0.9270 | 2.91E+04 | 9.27E+04 | 3.18 | 2.21E+05 |

Ph₂C(2,7-t-Bu₂Fl)(Cp-SiMe₃)ZrCl₂ (CM6)

| | | | | | | | | |
|---|---|---|---|---|---|---|---|---|
| 12 | 5.2 | 105.5 | 20.3 | 0.9376 | 2.23E+04 | 6.56E+04 | 2.95 | 1.42E+05 |

Ph₂C(Fl)(Cp-SiMe₂Allyl)ZrCl₂ (CM7)

| | | | | | | | | |
|---|---|---|---|---|---|---|---|---|
| 26 | 1.3 | 29.6 | 23.1 | 0.9293 | 3.12E+04 | 9.03E+04 | 2.90 | 2.02E+05 |
| 27 | 1.0 | 25.7 | 26.3 | 0.9295 | 3.28E+04 | 9.33E+04 | 2.84 | 2.00E+05 |

(cyclopenta-1,1-diyl)(2,7-t-Bu₂Fl)(Cp)ZrCl₂ (CM8)

| | | | | | | | | |
|---|---|---|---|---|---|---|---|---|
| 34 | 1.2 | 34.7 | 29.4 | 0.9218 | 2.56+04 | 8.51E+04 | 3.33 | 1.85E+05 |

TABLE 7
Polyethylene branching, co-monomer incorporation, aTREF (analytical Temperature Rising Elution Fraction)
and SDBI (Solubility Distribution Breadth Index) data for comparative metallocene catalyst systems.^{A}

| | | | | | | | | | | | | | |
|---|---|---|---|---|---|---|---|---|---|---|---|---|---|
| | GPC- | | JC-α | | | | | | | | | | |
| | IR | SCB | (190° C.) | | | C6 | | | Solubles | | | | |
| | Hexene | Slope | LCB/ | [C6]/ | [C6]/ | Incor. | aTREF | | Fraction | | | | |
| | in PE | d85 − | 10⁶ | [C2] | [C2] | Eff. | Broad- | SDBI | (% | Peak 1 | Normalized | Peak 2 | Normalized |
| Ex. No. | (wt %) | d15 | Total C | Reactor | Poly | (CIE) | ness | (° C.) | Area) | (° C.) | Height | (° C.) | Height |

(n-BuCp)₂ZrCl₂ (CM1)

| | | | | | | | | | | | | | |
|---|---|---|---|---|---|---|---|---|---|---|---|---|---|
| 4 | 3.48 | −0.39 | −0.2 | 0.012 | 0.333 | 0.035 | 2.3 | 25.84 | 2.6 | 88.9 | 27.1 | NA | NA |

Me₂C(Fl)(Cp)ZrCl₂ (CM2)

| | | | | | | | | | | | | | |
|---|---|---|---|---|---|---|---|---|---|---|---|---|---|
| 5 | 8.60 | 1.08 | 51.5 | 0.217 | 0.029 | 0.134 | 7.0 | 16.63 | 0.4 | 81 | 9.6 | NA | NA |
| 6 | 8.80 | 1.21 | 46.1 | 0.217 | 0.029 | 0.133 | 7.0 | 17.64 | 0.9 | 80 | 9.6 | 97.8 | 0.6 |
| 7 | 9.30 | 1.11 | 38.6 | 0.257 | 0.031 | 0.121 | 8.1 | 18.86 | 2 | 79 | 8.7 | NA | NA |

Me₂C(2,7-t-Bu₂Fl)(Cp)ZrCl₂ (CM3)

| | | | | | | | | | | | | | |
|---|---|---|---|---|---|---|---|---|---|---|---|---|---|
| 8 | 5.64 | 0.01 | 36.3 | 0.176 | 0.019 | 0.107 | NA | NA | NA | NA | NA | NA | NA |

Ph₂C(2,7-t-Bu₂Fl)(Cp)ZrCl₂ (CM4)

| | | | | | | | | | | | | | |
|---|---|---|---|---|---|---|---|---|---|---|---|---|---|
| 9 | 8.0 | 1.48 | 44.8 | 0.217 | 0.027 | 0.123 | 6.5 | 17.76 | 1.1 | 82 | 10.2 | NA | NA |
| 10 | 10.40 | 0.60 | −3.9 | 0.260 | 0.035 | 0.260 | 6.1 | 17.26 | 1.1 | 74 | 10.3 | NA | NA |

Ph₂C(Fl)(Cp-SiMe₃)ZrCl₂ (CM5)

| | | | | | | | | | | | | | |
|---|---|---|---|---|---|---|---|---|---|---|---|---|---|
| 11 | 3.99 | 0.36 | 14.5 | 0.176 | 0.013 | 0.076 | 5.3 | 20.8 | 1.2 | 89 | 13.9 | NA | NA |

Ph₂C(2,7-t-Bu₂Fl)(Cp-SiMe₃)ZrCl₂ (CM6)

| | | | | | | | | | | | | | |
|---|---|---|---|---|---|---|---|---|---|---|---|---|---|
| 12 | 4.85 | 1.09 | 1.8 | 0.217 | 0.016 | 0.075 | 6.1 | 19.53 | 0.9 | 90 | 10.0 | NA | NA |

Ph₂C(Fl)(Cp-SiMe₂Allyl)ZrCl₂ (CM7)

| | | | | | | | | | | | | | |
|---|---|---|---|---|---|---|---|---|---|---|---|---|---|
| 26 | 3.46 | 0.97 | 6.5 | 0.155 | 0.012 | 0.074 | 3.0 | 18.39 | 0.7 | 90 | 20.9 | NA | NA |
| 27 | 3.29 | 1.01 | 2.7 | 0.176 | 0.011 | 0.062 | 2.6 | 19.8 | 1 | 89 | 22.1 | NA | NA |

(cyclopenta-1,1-diyl)(2,7-t-Bu₂Fl)(Cp)ZrCl₂ (CM8)

| | | | | | | | | | | | | | |
|---|---|---|---|---|---|---|---|---|---|---|---|---|---|
| 34 | 6.74 | 0.87 | 49.7 | 0.155 | 0.022 | 0.155 | 3.2 | 20.66 | 1.3 | 83 | 20.0 | NA | NA |

^{A}NA, data not available.

Tables 8-9 present data for the polymerization runs and the resulting polymers for the “aging” experiments, which include both exemplary inventive (M) silyl-substituted ansa-metallocenes and comparative (CM) metallocenes. Table 8 presents olefin polymerization conditions and catalyst activities for the aging studies of the respective exemplary and comparative metallocene catalysts. All polymerization runs used 2.7 mmol TNOAl (tri-n-octylaluminum scavenger. Table 9 provides the polyethylene data for respective exemplary and comparative metallocene catalyst systems.

TABLE 8
Aging experiment olefin polymerization conditions and catalyst activities for inventive
and comparative metallocene catalyst systems. Polymerization runs were conducted
at 80° C. and total pressure of 350 psi and used 2.7 mmol TNOAl scavenger.

| | | | | | | | | |
|---|---|---|---|---|---|---|---|---|
| | | | | | | | MCN | |
| | sMAO | | | | | Support | Activity | MCN- |
| | Support | | H₂/C₂ | | | Activity | (kg PE/ | sMAO |
| | Charge | MCN | Ratio | 1-hexene | Yield | (g PE/g | mmol | precontact |
| Ex. No. | (mg) | (mmol) | (psi/psi) | (mL) | PE (g) | Support/h) | MCN/h) | (days) |

Ph₂C(Fl)(Cp-SiEt₃)ZrCl₂ (M9)

| | | | | | | | | |
|---|---|---|---|---|---|---|---|---|
| A22 | 2.6 | 1.00E−04 | 3.36E−03 | 40 | 109.6 | 42154 | 1096 | 0 |
| A23 | 2.6 | 1.00E−04 | 3.36E−03 | 40 | 136.4 | 52462 | 1364 | 2 |
| A24 | 2.6 | 1.00E−04 | 3.35E−03 | 40 | 162.8 | 62615 | 1628 | 3 |
| A25 | 2.6 | 1.00E−04 | 3.38E−03 | 40 | 144.7 | 55654 | 1447 | 6 |
| A26 | 2.6 | 1.00E−04 | 3.34E−03 | 40 | 160.5 | 61731 | 1605 | 20 |
| A27 | 2.6 | 1.00E−04 | 3.35E−03 | 40 | 142.9 | 54962 | 1429 | 28 |

Ph₂C(2,7-t-Bu₂Fl)(Cp-SiMe₂ⁿPr)ZrCl₂ (M3)

| | | | | | | | | |
|---|---|---|---|---|---|---|---|---|
| A30 | 13.0 | 5.00E−04 | 2.55E−03 | 50 | 175.8 | 13523 | 352 | 3 |
| A31 | 6.5 | 2.50E−04 | 2.42E−03 | 50 | 51.6 | 7938 | 206 | 43 |

Me(3-buten-1-yl)C(2,7-t-Bu₂Fl)(Cp)ZrCl₂ (CM9)

| | | | | | | | | |
|---|---|---|---|---|---|---|---|---|
| A6 | 6.5 | 2.50E−04 | 4.35E−03 | 30 | 114.3 | 17585 | 457 | 1 |
| A7 | 6.5 | 2.50E−04 | 4.29E−03 | 30 | 197.7 | 30415 | 791 | 1 |
| A8 | 3.9 | 1.50E−04 | 3.46E−03 | 40 | 42.8 | 10974 | 285 | 6 |
| A9 | 6.5 | 2.5E−04 | 4.01E−03 | 30 | 112.3 | 17277 | 449 | 12 |
| A10 | 3.9 | 1.50E−04 | 3.55E−03 | 40 | 135.0 | 34615 | 900 | 13 |
| A11 | 3.9 | 1.50E−04 | 4.08E−03 | 40 | 57.4 | 14718 | 383 | 20 |
| A12 | 3.9 | 1.50E−04 | 3.62E−03 | 40 | 130.1 | 33359 | 867 | 55 |

Ph₂C(Fl)(Cp-SiMe₂Allyl)ZrCl₂ (CM7)

| | | | | | | | | |
|---|---|---|---|---|---|---|---|---|
| A18 | 6.5 | 2.50E−04 | 3.23E−03 | 35 | 36.0 | 5585 | 145 | 1 |
| A15 | 6.5 | 2.50E−04 | 3.54E−03 | 35 | 35.6 | 5477 | 142 | 7 |
| A16 | 6.5 | 2.50E−04 | 2.98E−03 | 40 | 24.1 | 3708 | 96 | 16 |
| A17 | 6.5 | 2.50E−04 | 3.28E−03 | 35 | 24.6 | 3785 | 98 | 24 |

TABLE 9
Aging experiment data for polyethylenes from inventive and comparative metallocene
catalyst systems.

| | | | | | | | | | | | | | |
|---|---|---|---|---|---|---|---|---|---|---|---|---|---|
| | MCN- | | | | | | | | | | | JC-α | |
| | SMAO | | | | | | | | | GPC-IR | SCB | (190° C.) | C6 |
| | precon | | | | | | | | | Hexene | Slope | LCB/ | Incor. |
| Ex. No. | tact (days) | MI | HLMI | $\frac{HLMI}{MI}$ | Density (g/mL) | Mn (g/mol) | Mw (g/mol) | $\frac{Mw}{Mn}$ | Mz (g/mol) | in PE (wt %) | d85- d15 | 10⁶ Total C | Eff. (CIE) |

Ph₂C(Fl)(Cp-SiEt₃)ZrCl₂ (M9)

| | | | | | | | | | | | | | |
|---|---|---|---|---|---|---|---|---|---|---|---|---|---|
| A22 | 0 | 1.9 | 36.9 | 19.3 | 0.9230 | 2.26E+04 | 8.23E+04 | 3.64 | 1.61E+05 | 5.31 | 0.34 | 1.5 | 0.101 |
| A23 | 2 | 1.9 | 38.1 | 19.7 | 0.9232 | 2.91E+04 | 8.37E+04 | 2.87 | 1.63E+05 | 5.37 | −0.27 | 1.2 | 0.102 |
| A24 | 3 | 2.5 | 49.0 | 19.9 | 0.9275 | 1.74E+04 | 7.69E+04 | 4.42 | 1.57E+05 | 4.94 | 0.05 | 1.8 | 0.094 |
| A25 | 6 | 2.0 | 44.0 | 21.7 | 0.9268 | 1.93E+04 | 7.90E+04 | 4.10 | 1.59E+05 | 4.54 | 0.40 | 1.6 | 0.086 |
| A26 | 20 | 2.2 | 50.1 | 22.4 | 0.9225 | 2.02E+04 | 7.70E+04 | 3.82 | 1.54E+05 | 5.28 | −0.14 | 1.8 | 0.100 |
| A27 | 28 | 2.0 | 37.7 | 18.9 | 0.9234 | 2.07E+04 | 8.12E+04 | 3.92 | 1.62E+05 | 6.53 | −0.65 | 2.2 | 0.124 |

Ph₂C(2,7-t-Bu₂Fl)(Cp-SiMe₂ⁿPr)ZrCl₂ (M3)

| | | | | | | | | | | | | | |
|---|---|---|---|---|---|---|---|---|---|---|---|---|---|
| A30 | 3 | 1.0 | 22.0 | 22.6 | 0.9198 | 3.13E+04 | 1.00E+05 | 3.20 | 2.19E+05 | 6.68 | 1.06 | 2.0 | 0.103 |
| A31 | 43 | 0.1 | 5.0 | 35.5 | 0.9191 | 4.72E+04 | 1.50E+05 | 3.19 | 3.32E+05 | 7.01 | 0.82 | 2.2 | 0.108 |

Me(3-buten-1-y1)C(2,7-t-Bu₂Fl)(Cp)ZrCl₂ (CM9)

| | | | | | | | | | | | | | |
|---|---|---|---|---|---|---|---|---|---|---|---|---|---|
| A6 | 1 | 2.2 | 46.0 | 20.6 | 0.9191 | 3.55E+04 | 8.03E+04 | 2.26 | 1.67E+05 | 5.43 | −0.11 | 12.9 | 0.135 |
| A7 | 1 | 5.7 | 105.6 | 18.4 | 0.9248 | 2.00E+04 | 6.53E+04 | 2.33 | 1.38E+05 | 4.20 | 0.57 | 4.8 | 0.105 |
| A8 | 6 | 4.4 | 86.3 | 19.7 | 0.9190 | 2.66E+04 | 6.65E+04 | 2.50 | 1.41E+05 | 8.20 | 1.02 | 9.2 | 0.156 |
| A9 | 12 | 0.7 | 20.5 | 28.1 | 0.9190 | 3.92E+04 | 1.0E+05 | 2.57 | 2.44E+05 | 5.39 | −0.21 | 96.8 | 0.134 |
| A10 | 13 | 1.2 | 38.5 | 33.2 | 0.9a208 | 2.94E+04 | 8.53E+04 | 2.90 | 2.09E+05 | 6.58 | 0.93 | 99.1 | 0.125 |
| A11 | 20 | 0.7 | 23.2 | 31.4 | 0.9154 | 3.48E+04 | 9.58E+04 | 2.75 | 2.23E+05 | 8.42 | 0.43 | 97.5 | 0.160 |
| A12 | 55 | 0.3 | 13.5 | 46.6 | 0.9158 | 3.29E+04 | 1.14E+05 | 3.47 | 3.05E+05 | 7.05 | 1.41 | 100.0 | 0.134 |

Ph₂C(Fl)(Cp-SiMe₂Allyl)ZrCl₂ (CM7)

| | | | | | | | | | | | | | |
|---|---|---|---|---|---|---|---|---|---|---|---|---|---|
| A18 | 1 | 1.1 | 25.6 | 22.8 | 0.9298 | 3.51E+04 | 9.58E+04 | 2.73 | 2.09E+05 | 2.42 | 0.23 | 6.2 | 0.052 |
| A15 | 7 | 1.3 | 29.6 | 23.1 | 0.9293 | 3.12E+04 | 9.03E+04 | 2.90 | 2.02E+05 | 3.46 | 0.97 | 6.5 | 0.074 |
| A16 | 16 | 1.0 | 25.7 | 26.3 | 0.9295 | 3.28E+04 | 9.33E+04 | 2.84 | 2.00E+05 | 3.29 | 1.01 | 2.7 | 0.062 |
| A17 | 24 | 0.6 | 14.2 | 22.9 | 0.9260 | 3.63E+04 | 1.06E+05 | 2.93 | 2.21E+05 | 3.45 | 0.90 | 2.5 | 0.074 |

### Catalyst Aging Studies for Inventive and Comparative Metallocenes.

One persistent problem with m-LLDPE (LLDPE derived from metallocene catalysts)-type blown film resins made using tightly bridged ansa-metallocene catalysts is that the polyethylene may still incorporate undesirably high levels of long-chain branching (LCB). When using ansa-metallocenes with an olefin tether on the bridge, which may suppress LCB formation and preserve high CIE, the pendent olefin itself may react with co-catalysts and lose its ability to suppress LCB formation. Tables 8 and 9 provide the results of aging studies using inventive metallocene Ph₂C(Fl)(Cp-SiEt₃)ZrCl₂ (M9) and Ph₂C(2,7-t-Bu₂Fl)(Cp-SiMe₂¹¹Pr)ZrCl₂ (M3), and olefin-tethered comparative metallocenes Ph₂C(Fl)(Cp-SiMe₂Allyl)ZrCl₂ (CM7) and Me(3-buten-1-yl)C(2,7-t-Bu₂Fl)(Cp)ZrCl₂ (CM9) as catalysts. Polymerizations were conducted at 80° C. and total pressure of 350 psi and used 2.7 mmol TNOAl scavenger.

Comparative metallocene Me(3-buten-1-yl)C(2,7-t-Bu₂Fl)(Cp)ZrCl₂ (CM9) is examined in Examples A6 through A12. The first two examples, Example A6 and Example A7, were run under nearly identical H₂/C₂ (hydrogen:ethylene) feed ratios, with all other reaction conditions being the same. In both Examples, the metallocene and sMAO (solid MAO) were pre-contacted for one day prior to use, that is, contacted on day one and used on day two. A very large increase is observed in the polymer LCB content as CM9 is aged, which would severely limit its utility under any conditions in which aging is possible or likely. As shown in Table 8, the PE yields and metallocene activities were quite different, with Example A7 providing a much higher yield (197.7 g PE) and a much higher metallocene activity (791 kg PE/mmol metallocene/h) than Example A6 (114.3 g PE, and 457 kg PE/mmol metallocene/h). Even though H₂/C₂ feed ratios were nearly identical, the Mn molecular weights of Example A5 (2.00E+04) was just over half that of Example A4 (3.55E+04).

These results are consistent with in-situ formation of hydrogen from the polymer back bone to afford an internal unsaturation in the chain and incomplete hydrogenolysis, such that not all of the hydrogen added or generated is consumed to terminate a polymer chain, combined with a strong activity response to hydrogen. See, for example, Tosoh, et al., J. of Polymer Science: Part A: Polymer Chemistry, 2000, vol 38, pp. 4641-4648; Busico, et al., Macromolecules, 2005, 38, 6988-6996; and Soares, et al. in Ind. Eng. Chem. Res. 2021, 60, 9739-9754.

The polymers from these two runs of Examples A6 and A7 using metallocene Me(3-buten-1-yl)C(2,7-t-Bu₂Fl)(Cp)ZrCl₂ (CM9) differ in other properties as well, as seen in comparing their polydispersities (Mw/Mn, or PDI). The Mw/Mn of Example A6 of 2.26 broadened slightly to 2.33 in Example A7. The Short Chain Branching Distribution (SCBD) profile slope (measured over the range from d85 to d15) changed from essentially flat (having a slope of 0) or slightly negative in Example A6 (−0.11) to positive in Example A7 (+0.57). The Long Chain Branching (LCB) frequency (LCBf) as determined by the Janzen-Colby method (JC-α, 190° C.) in Example A6 of 12.9 LCB/10⁶ total carbon atoms contrasts with the LCBf of 4.8 LCB/10⁶ total carbon atoms in Example A7.

The following five polymerization comparative Examples A8 through A12 of Tables 8 and 9 also were conducted at 80° C. and total pressure of 350 psi with Me(3-buten-1-yl)C(2,7-t-Bu₂Fl)(Cp)ZrCl₂ (CM9), but using somewhat increased hexene amounts and a decreased H₂/C₂ psi/psi ratio versus Examples A6 and A7. Each subsequent polymerization run of Examples A8-A12 was conducted on a catalyst system with increasing metallocene-sMAO pre-contacted days prior to use in the polymerization reaction. Example A8 used a catalyst having a metallocene-sMAO pre-contact time of 6 days prior to the polymerization run, which was increased to 13, 20, 27, and 55 days in Examples A10-A12, respectively. As seen in Table 9, increasing catalyst system pre-contact times resulted in a significant overall increase of LCBf (JC-α, 190° C.) of 9.2 LCB/10⁶ total carbon atoms for 6-day contact (Example A8) to a LCBf (JC-α, 190° C.) around 100 LCB/10⁶ total carbon atoms for 13- to 55-day pre-contact times in Examples A10-A12, respectively. This dramatic increase in LCBf from JC-α, 190° C., 9 LCB/10⁶ total carbon atoms for 6-day contact to JC-α, 190° C.=100 LCB/10⁶ total carbon atoms for ≥13 days is further manifested in an overall drop in melt index from MI 4.4 in Example A8 to MI 0.3 in Example A12

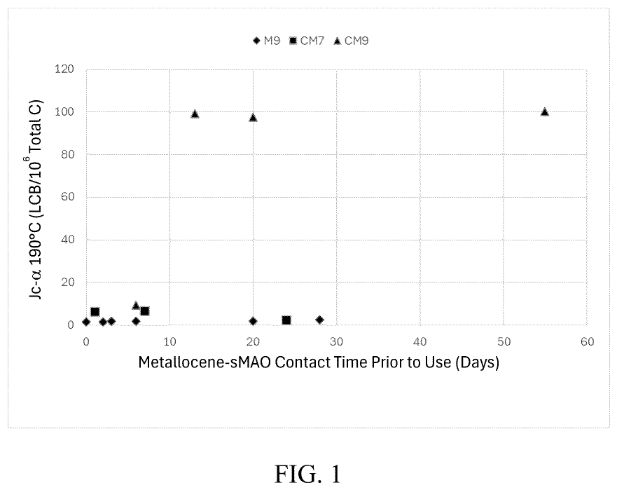

FIG. 1 presents a graph of aging times for various metallocenes, as measured by days pre-contacted for sMAO with the compounds Me(3-buten-1-yl)C(2,7-t-Bu₂Fl)(Cp)ZrCl₂ (CM9, all runs), Ph₂C(Fl)(Cp-SiMe₂allyl)ZrCl₂ (CM7), Ph₂C(Fl)(Cp-SiEt₃)ZrCl₂ (M9), and Ph₂C(2,7-t-Bu₂Fl)(Cp-SiMe₂ⁿPr)ZrCl₂ (M3) versus the Long Chain Branching (LCB) frequency (LCBf) as determined by the Janzen-Colby method (JC-α, 190° C.). Data for these polymerization runs and polymers are recorded in Tables 8 and 9. As illustrated in FIG. 1, the LCBf in the comparative compound Me(3-buten-1-yl)C(2,7-t-Bu₂Fl)(Cp)ZrCl₂ (CM9) dramatically increased to around 100 LCB/10⁶ total carbon atoms for any pre-contacting time of greater than or equal to 12 days, whereas the ansa-metallocenes having a silyl group-substituted cyclopentadienyl ligand and absent a tethered olefin moiety show consistently low LCBf values even after pre-contacting the metallocene and sMAO for up to 55 days. From Example A7 having an LCBf=4.8, to Example A12 having LCBf=100.0 using Me(3-buten-1-yl)C(2,7-t-Bu₂Fl)(Cp)ZrCl₂ (CM9), the LCBf varies more than an order of magnitude.

These observations are consistent with the tethered olefin in compounds such as Me(3-buten-1-yl)C(2,7-t-Bu₂Fl)(Cp)ZrCl₂ (CM9) becoming less effective at controlling LCB over time and possibly undergoing methyl-alumination in the presence of excess MAO and therefore losing any function in mitigating LCB formation, as is illustrated in these FIG. 1 and Table 9 data. These observations also illustrate an unexpected advantage of the present catalyst compositions over those with a tethered olefin metallocene.

Aging of Me(3-buten-1-yl)C(2,7-t-Bu₂Fl)(Cp)ZrCl₂ (CM9)-sMAO contact product was also accompanied by a broadening of the Mw/Mn from 2.3 (Examples A6 and A7 to 3.5 (Example A12) over the period of from one day to 55 days pre-contacting time. The SCBD slope of the polyethylenes ranged from relatively flat (−0.11) for the narrowest Mw/Mn and shortest aging period (Example A6) to +1.41 for the broadest Mw/Mn and longest aging period (Example A12). These results are consistent with the active site transitioning over longer contact times from a single-site-like catalyst for short aging periods, to something more than a single site catalyst for long aging periods, such as might be obtained from a dual or multi-site catalyst.

Referring again to aging Tables 8 and 9, the four polymerization runs from Example A18 through Example A17 show the results of the catalyst based on the metallocene Ph₂C(Fl)(Cp-SiMe₂Allyl)ZrCl₂ (CM7) with a tethered allyl group extending from the silicon atom on the Cp ring. Across all metallocene-sMAO pre-contacting periods, from one day in Example A18 to 24 days in Example A17, the average Co-monomer Incorporation Efficiency (CIE) was 0.066 for Ph₂C(Fl)(Cp-SiMe₂Allyl)ZrCl₂ (CM7), versus metallocene Me(3-buten-1-yl)C(2,7-t-Bu₂Fl)(Cp)ZrCl₂ (CM9) with a pendent olefin on the bridge which produced an average Co-monomer Incorporation Efficiency (CIE) of 0.137. However, the change in the magnitude of LCBf over all the CM7-sMAO pre-contacting periods from one to 24 days of 2.5-6.2 LCB/10⁶ total carbon atoms was far less than the change in LCBf over all the CM9-sMAO pre-contacting periods from one to 55 days of 4.8-100 LCB/10⁶ total carbon atoms. While not intending to be theory-bound, this result suggests that the integrity of the pendent olefinic moiety may be better retained in the CM7-sMAO catalyst system over time, where it is not retained the CM9-sMAO comparative catalyst system over time.

In the polymerization runs using metallocene Ph₂C(Fl)(Cp-SiMe₂Allyl)ZrCl₂ (CM7), although CM7 contains a pendent olefin bonded to the silyl group, aging the CM7-sMAO contact product did not result in an increase in LCBf over aging times, as it did for Me(3-buten-1-yl)C(2,7-t-Bu₂Fl)(Cp)ZrCl₂ (CM9). Rather, a decrease in LCBf with metallocene CM7 was observed by approximately one-half from nominally 6 LCB/10⁶ C atoms to 3 LCB/10⁶ C atoms over only 9 days of the aging period (cf. Example A15 and A16).

Regardless of any metallocene and activator, co-catalyst, or scavenger pre-contacting time, the advantage of the disclosed metallocenes and catalyst systems is also evident from Examples A22 through A27 of the aging data Tables 8 and 9, which use Ph₂C(Fl)(Cp-SiEt₃)ZrCl₂ (M9). These M9 Examples demonstrate that despite long periods of contact of Ph₂C(Fl)(Cp-SiEt₃)ZrCl₂ (M9) with sMAO, the reproducibility of the resin structures with regards to LCBf is virtually independent of pre-contact-time. Within the course of nearly a month of pre-contacting metallocene M9 and sMAO, the ethylene-co-1-hexene polymerization provides polymers with very low levels of LCBf. Though not wishing to be bound by theory, it is thought the low LCBf may be due to the absence of an olefinic moiety in M9. Regardless of the mechanism, the polymerizations using M9-sMAO demonstrated the ability to maintain limited LCB formation over an extended pre-contacting time periods to levels which would not deteriorate blown film properties. The observed low LCBf in the Ph₂C(Fl)(Cp-SiEt₃)ZrCl₂ (M9)-derived polymers is accompanied by better Co-monomer Incorporation Efficiency (CIE) (Examples A22 through A27 average CIE=0.101) than unbridged metallocenes such as relatively active (n-BuCp)₂ZrCl₂ (CM1) (Example 4) of CIE=0.035; see Table 7.

Aging Example A22 employed a Ph₂C(Fl)(Cp-SiEt₃)ZrCl₂ (M9)-sMAO pre-contact time of 0 days, indicating that metallocene M9 and sMAO were contacted and employed for polymerization the same day. Under the conditions of Aging Table 8, a 1.9 MI polyethylene resin with 0.9230 g/cc density was obtained as shown in Table 9. Table 8 illustrates that the Example A22 conditions, including the H₂/C₂ (psi/psi) ratio, were consistent across Examples A23 to A27, except for increasing pre-contacting times. These polymerization runs afforded an ethylene-co-1-hexene polymer having an average JC-α, 190° C. of 1.7 LCB/10⁶ C atoms, with a standard deviation of 0.3 LCB/10⁶ C atoms across these Examples, which is close to the uncertainty in the measurement itself at the Mw molecular weights tested. The CIE varied even less, with a standard deviation of 0.013 (13%) on an average value of 0.101, and interestingly, the Mw/Mn ranged from 2.87 to 4.42 with a standard deviation of 0.5 (14%) for an average value of 3.8. However, the slope varied much more, ranging from negative (−)0.65 to a positive (+)0.40. In the inventive catalyst Tables 2-4, it is seen that varying conditions such as temperature and reagent concentrations using Ph₂C(Fl)(Cp-SiEt₃)ZrCl₂ (M9)-sMAO affords resins with even wider ranges of these characterizations.

The aging data for Example A30 and Example A31 in Tables 8 and 9, using Ph₂C(2,7-t-Bu₂Fl)(Cp-SiMe₂ⁿPr)ZrCl₂ (M3) are representative of the utility of the disclosed catalyst compositions with respect to employing saturated Si-substituents and maintaining LCBf in the resulting polyethylene. Thus, after 3 days (Example A30) and 43 days (Example A31) of pre-contact of metallocene M3 with sMAO, the M3 metallocene catalyst affords a polymer with 2.0 LCB/10⁶ C atoms and 2.2 LCB/10⁶ C atoms, with surprisingly good CIE of 0.103 and 0.108, respectively.

Example A30 uses twice the catalyst charge as Example A31 in Table 8, for both metallocene M3 and support-activator (sMAO), while holding the Zr:Al ratio constant. These M3 aging examples use similar H₂/C₂ psi ratios with Example A30 using a slightly higher (5% higher) H₂/C₂ ratio than Example A31 added to the mix tank with the same amount of hexene (50 mL) added to the reactor. Both of the M3 Examples A30 and A31 afforded resins with very similar LCB (2.0 and 2.2 LCB/10⁶ C, respectively), similar densities (0.9198 and 0.9191 g/cc, respectively), and a nominal polydispersity of 3.2 with Mn values of 3.13E+04 and 4.72E+04, respectively. Assuming that chain termination to monomer and comonomer is the same between these two M3 aging runs, and that all the added hydrogen goes to chain termination, an Mn value of 3.13E+04 g/mol for the Example A30 resin would require the addition of 5.62E-03 moles of H₂ to the mix tank, roughly 2.7 times more than the amount of H₂ actually added, suggesting that in-situ generation of H₂ is occurring. In other words, a 5% difference in mix-tank hydrogen cannot account for a 34% difference in the number average molecular weights. These are consistent with the catalyst increasing 1.7-fold the metallocene activity with [H₂] concentration and the 3.4-fold higher yield. Surprisingly, the resins produced after pre-contacting the M3 with sMAO for 3 and 43 days show that both samples maintain a reverse SCBD with d85-d15 slopes of +1.06 and +0.82 for Example A30 and Example A31, respectively, and nearly identical in LCBf, CIE, and polydispersity.

Accordingly, using the metallocene catalysts of this disclosure provides the surprising and extremely beneficial ability to contact the components of the catalyst, without having to carefully monitor the elapsed time before it is used.

### Inventive and Comparative Metallocene Catalyst Studies

Olefin polymerization and polymer data for the inventive metallocenes appear in Tables 2-4 and for the comparative metallocenes in Tables 5-7.

Comparative Metallocene Studies. In contrast to the metallocene catalysts of this disclosure, the comparative metallocenes included: (a) the unbridged metallocene (ⁿBuCp)₂ZrCl₂ (CM1); (b) ansa-metallocenes absent any alkylsilyl group on the cyclopentadienyl ligand including Me₂C(Fl)(Cp)ZrCl₂ (CM2), Me₂C(2,7-t-Bu₂Fl)(Cp)ZrCl₂ (CM3), Ph₂C(2,7-t-Bu₂Fl)(Cp)ZrCl₂ (CM4), and (cyclopenta-1,1-diyl)(2,7-t-Bu₂Fl)(Cp)ZrCl₂ (CM8); (c) ansa-metallocenes with SiMe₃-substituted cyclopentadienyl ligands Ph₂C(Fl)(Cp-SiMe₃)ZrCl₂ (CM5) and Ph₂C(2,7-t-Bu₂Fl)(Cp-SiMe₃)ZrCl₂ (CM6); and (d) ansa-metallocenes with an alkenyl substituent on the silyl bonded to the cyclopentadienyl, Ph₂C(Fl)(Cp-SiMe₂allyl)ZrCl₂ (CM7) or on the bridge Me(3-buten-1-yl)C(2,7-t-Bu₂Fl)(Cp)ZrCl₂ (CM9). Data for these comparative Examples is found in Tables 5-7.

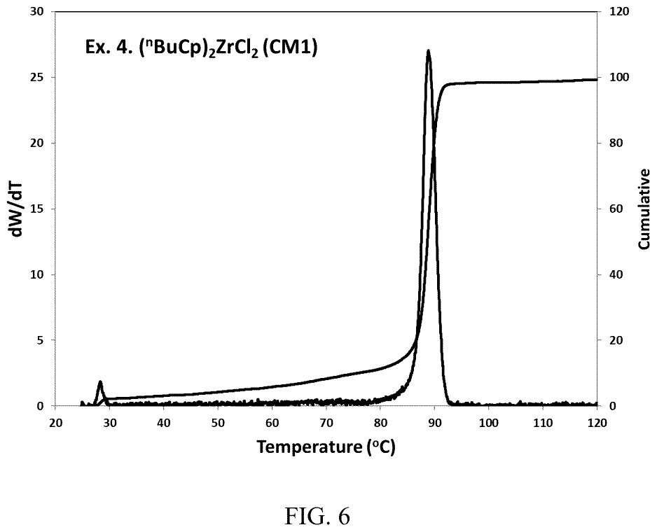

Comparative Example 4 employed the unbridged metallocene (n-BuCp)₂ZrCl₂ (CM1), a relatively active, unbridged metallocene catalyst, which afforded essentially LCB-free polymer, with JC-α, 190° C. values of −0.2 (essentially 0) LCB/10⁶ C. When compared to most bridged metallocenes, including all the other comparative examples in Tables 5-7, the CM1 metallocene CIE value of 0.035 is relatively low. The polymers produced in Example 4 provided a Mw/Mn of 2.08, which is close to the theoretical Mw/Mn of 2 associated with a single site distribution. FIG. 6 presents the aTREF scan showing the narrow composition for the poly(ethylene-co-1-hexene) produced in comparative Example 4 using unbridged metallocene (n-BuCp)₂ZrCl₂ (CM1).

The homogeneity of the SCBf in comparative Example 4 is reflected by the aTREF plot and consistent with a narrow SCBf distribution. comparative Example 4 polymer gave a very narrow peaks with aTREF broadness values of 2.3, and the tallest peak heights of 27.1 at 89° C. Furthermore, at a melt index of approximately 1 and down to roughly 0.2 MI, a shear response of less than 18 may be considered characteristic of resin derived from a single-site or nearly single-site catalyst that is essentially free of long chain branching. The shear response (HLMI/MI) observed for the Example 4 polymer was 16.1.

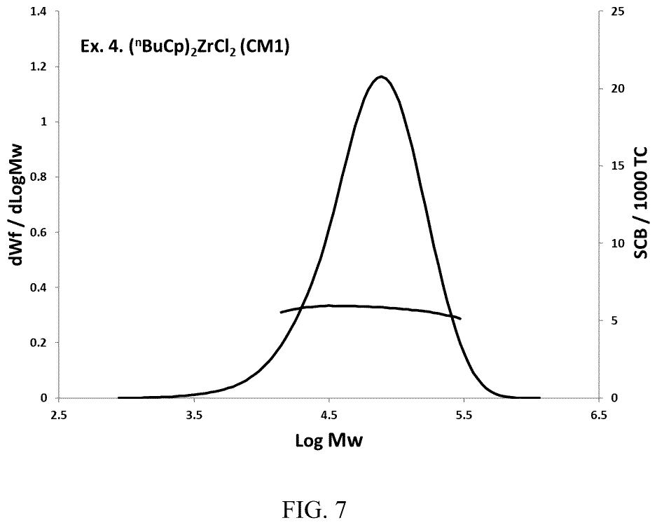

FIG. 7 presents the GPC-IR Molecular Weight Distribution (MWD) scan for the poly(ethylene-co-1-hexene) produced using metallocene (n-BuCp)₂ZrCl₂ (CM1) and the Short Chain Branching Distribution (SCBD) profile across the molecular weight distribution, over the range from d85 to d15. Single-site catalysts would be expected to produce a polymer with a flat SCB slope (d85-d15), however, Example 4 polymer produced using metallocene (n-BuCp)₂ZrCl₂ (CM1) was characterized by a slope of −0.39, which may be attributed to non-steady state conditions encountered in small batch reactor. Nevertheless, the Example 4 polymer represents a benchmark for a low CIE, single-site metallocene catalyst that produces an essentially LCB-free resin, to which other examples in the table may be compared.

Comparative Examples 5 and 6 employed the carbon atom-bridged ansa-metallocene Me₂C(Fl)(Cp)ZrCl₂ (CM2), which is absent any hydrocarbyl-silyl substituent, using similar H₂/C₂ psi/psi ratios of 2.33E-03 and 2.43E-03, respectively, with other conditions held as constant as possible in a small batch reactor (see Table 5). These polymerization runs afforded polyethylenes with JC-α, 190° C. of 51.5 and 46.1 LCB/10⁶ total carbon atoms, respectively, and the other properties shown in Table 6 and Table 7. Using conventional LLDPE film blowing processes, these high levels of LCB would be expected to diminish film properties such as puncture or tear resistance, and the film would be expected to be largely opaque, which is undesirable in many film applications. In Example 7, increasing the 1-hexene concentration in the reactor by about 20% and more than doubling the H₂/C₂ ratio did afford a polyethylene with lower LCB (38.6 LCB/10⁶ total carbon atoms); however, even this value may be too high to be useful for blown film.

In comparison with the Me₂C(Fl)(Cp)ZrCl₂ (CM2) examples, substituting the fluorenyl ring with t-butyl groups in its analog Me₂C(2,7-t-Bu₂Fl)(Cp)ZrCl₂ (CM3) in Example 8 still resulted in high LCB (JC-α, 190° C.=36.3 LCB/10⁶ total carbon atoms), but did reduce the CIE by more than 50% versus its unsubstituted analog Me₂C(Fl)(Cp)ZrCl₂ (CM2).

Comparative Examples 9 and 10, employed Ph₂C(2,7-t-Bu₂Fl)(Cp)ZrCl₂ (CM4) having a diphenyl-substituted bridge versus the dimethyl-substituted bridge of CM3. Example 10 differs from Example 9 by reducing the reactor temperature from 80° C. in Example 9 to 70° C. in Example 10 and increasing hexene concentration from 50 mL in Example 9 to 80 mL for CM4 in Example 10. Under these different conditions, Example 10 produced an essentially LCB-free polymer. The LCBf for CM4 under these lower temperature and higher 1-hexene concentration conditions of Example 10 was essentially zero (JC-α, 190° C.=−3.9 LCB/10⁶ total carbon atoms), whereas under the higher temperature and lower 1-hexene concentration conditions of Example 9, LCBf was determined to be JC-α, 190° C.=44.8 LCB/10⁶ total carbon atoms. However, the low 0.9127 g/cc density for the Ph₂C(2,7-t-Bu₂Fl)(Cp)ZrCl₂ (CM4) polyethylene of Example 10, its more narrow Mw/Mn of 2.71, and the lower SCBD slope (d85-d15) of 0.6 (Example 10 may make this polymer of limited use in film applications requiring puncture resistance and tensile strength.

Comparative Example 11 employing Ph₂C(Fl)(Cp-SiMe₃)ZrCl₂ (CM5) and comparative Example 12 using its t-butyl-substituted fluorenyl analog Ph₂C(2,7-t-Bu₂Fl)(Cp-SiMe₃)ZrCl₂ (CM6) demonstrate the effect on the resulting polyethylene from placing a trimethylsilyl substituent on an otherwise high-CIE unsubstituted cyclopentadienyl moiety. These polymerization runs also may be compared to those of the unsubstituted cyclopentadienyl analog Ph₂C(2,7-t-Bu₂Fl)(Cp)ZrCl₂ (CM4). In both Example 11 and Example 12, the polymer CIE is reduced by approximately 40% to CIE ˜0.076 relative to their unsubstituted cyclopentadienyl analog Ph₂C(2,7-t-Bu₂Fl)(Cp)ZrCl₂ (CM4) in Example 10.

The Example 11 and Example 12 polyethylenes showed similar aTREF peaks at 89.4° C. and 89.5° C., respectively, and peak heights of 13.9 & 10.0, respectively. However, the polymer density differences of 0.9270 g/cc and 0.9376 g/cc for Examples 11 and Example 12, respectively, indicate the composition obtained by introducing t-Bu substituents on the fluorenyl ligand in Ph₂C(2,7-t-Bu₂Fl)(Cp-SiMe₃)ZrCl₂ (CM6) is discernably different from that obtained with the unsubstituted fluorenyl metallocene Ph₂C(Fl)(Cp-SiMe₃)ZrCl₂ (CM5).

Comparing the Example 9 metallocene Ph₂C(2,7-t-Bu₂Fl)(Cp)ZrCl₂ (CM4) and the Example 12 metallocene Ph₂C(2,7-t-Bu₂Fl)(Cp-SiMe₃)ZrCl₂ (CM6), these metallocenes are identical except for the addition of the trimethylsilyl group to the cyclopentadienyl ligand in CM6. The added trimethylsilyl group resulted in metallocene (MCN) activity over 3-fold, from 97 kg PE/mmol MCN/h for CM4 to 334 kg PE/mmol MCN/h for CM6, albeit at a 38% loss of CIE from 0.123 to 0.075, respectively. The addition of a trimethylsilyl group also resulted in a sizeable decrease in LCBf, from 44.8 LCB/10⁶ total carbon atoms in Example 9 with CM4 to 1.8 LCB/10⁶ total carbon atoms in Example 12 with CM6 and provided a higher density polyethylene of 0.9376 g/cc in 12 with CM6 versus 0.9193 g/cc Example 9 with CM4.

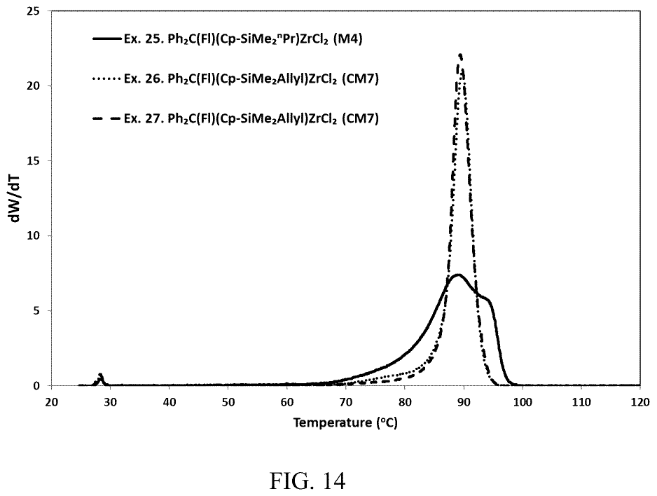

The comparative Examples 26 and 27 use the metallocene Ph₂C(Fl)(Cp-SiMe₂Allyl)ZrCl₂ (CM7) which includes a pendent alkenyl (allyl) group bonded to the silicon atom. Example 26 uses slightly less 1-hexene and more hydrogen than Example 27. The CM7 catalyst exhibits a much lower MCN activity (142 and 96 kg PE/mmol MCN/h, for Examples 26 and 27, respectively) as compared with Ph₂C(Fl)(Cp-SiMe₂-n-Pr)ZrCl₂ (M4) in Example 25 (749 kg PE/mmol MCN/h). Surprisingly, the CM7 polymer polydispersity (Mw/Mn about 2.9 in Examples 26 and 27) is more narrow than the polydispersity of the M4 saturated analog polyethylene (Mw/Mn=4.12), and the CM7 polyethylene exhibits a LCBf (JC-α, 190° C.=6.5 in Example 26; JC-α, 190° C.=2.7 in Example 27) which is higher than the LCBf (JC-α, 190° C.)=1.6) for Example 25 using Ph₂C(Fl)(Cp-SiMe₂-n-Pr)ZrCl₂ (M4), at similar melt index and density. Thus, the pendent allyl group does not appear to mitigate LCB formation to the degree of its saturated homolog. See Tables 2-4. The allyl-substituted silyl group in CM7 gives a much narrower aTREF composition than its saturated analog as evidenced by comparisons of aTREF shapes in FIG. 14. Metallocene CM7 also provides a poorer CIE (0.074 (Example 26) and 0.062 (Example 27) for CM7 versus 0.090 for M4), which underscores an advantage of saturated silyl groups over unsaturated silyl groups in controlling LCB while preserving CIE. See Tables 2-4 and FIG. 14.

Comparative Example 27 also used metallocene Ph₂C(Fl)(Cp-SiMe₂Allyl)ZrCl₂ (CM7) with a slightly higher initial 1-hexene concentration [C6] and a somewhat lower H₂/C₂ (hydrogen:ethylene) ratio than used in the Example 26 run. The 40 mL of 1-hexene in Example 27 is the same as used in Example 25 with Ph₂C(Fl)(Cp-SiMe₂-n-Pr)ZrCl₂ (M4). Upon increasing the 1-hexene concentration [C6] from 35 mL to 40 mL (14% increase) in going from Example 26 to Example 27, respectively, the resulting polymer density slightly increased. Like Example 26, the Example 27 polymer made with CM7 also afforded among the narrowest of aTREF compositions, and an even more narrow polydispersity (Mw/Mn is 2.84 in Example 27 and 2.90 in Example 26) and essentially the same SCB slope. The CIE decreased from 0.0744 (Example 26) to 0.062 (Example 27), and the LCBf decreased. Catalyst CM7 in Example 27 also exhibited a much lower activity (96 kg PE/mmol MCN/h) than its saturated analogue Ph₂C(Fl)(Cp-SiMe₂-n-Pr)ZrCl₂ (M4) in Example 25.

Inventive Metallocene Studies. The inventive metallocene catalysts included a trihydrocarbylsilyl substituent on the cyclopentadienyl ligand having the formula SiR⁵R⁶R⁷, wherein R⁵ and R⁶ are selected independently from a C₁-C₂₀ hydrocarbyl, and R⁷ is selected from a C₂-C₂₀ hydrocarbyl. That is, the inventive catalysts do not include a trimethylsilyl group bonded to the cyclopentadienyl ligand, and the difference in performance between these comparative metallocenes and the claimed metallocene catalysts is demonstrated. Particular examples of trihydrocarbylsilyl substituents examined in this analysis included SiMe₂Et, SiMe₂-n-Pr, SiMe₂-n-Bu, SiEt₃, Si-n-Pr₃, and SiMe₂-n-Hep. A difference in catalyst performance based on the different bridging moieties is also observed. Data for the claimed metallocene catalysts as claimed is found in Tables 2-4.

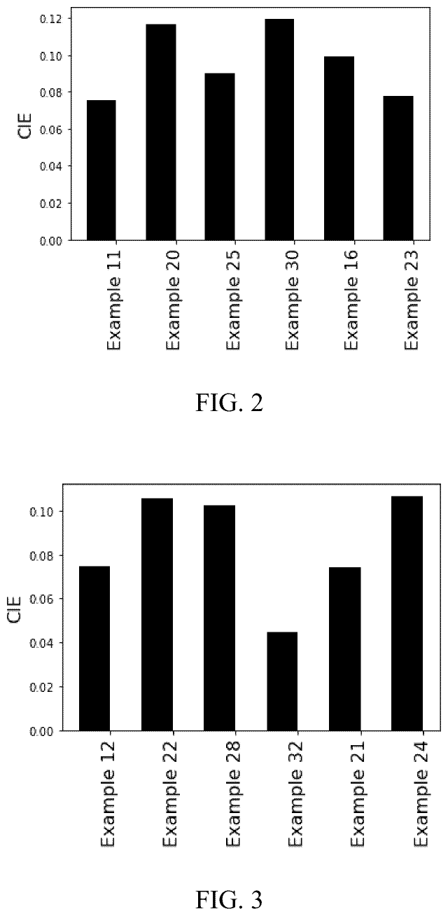

FIG. 2 compares multiple inventive Examples (Examples 20, 25, 30, 16, 23) with comparative Example 11, which features a trimethylsilyl substituents. Surprisingly, despite having bulkier silyl substituents than trimethylsilyl, all inventive examples show improved CIE over the Example 11 trimethylsilyl-containing catalyst. This contrast with the common belief that larger substituents would reduce CIE. Notably, even Example 23, with the very bulky tripropylsilyl substituent, exhibits CIE of 0.078 which is comparable to that of Example 11 trimethylsilyl-containing catalyst which exhibits a CIE of 0.076.

A similar trend was observed for compounds with t-Bu substituents on the fluorenyl ligands as shown in FIG. 3. Despite their higher steric bulkiness, Example 22 using Ph₂C(2,7-t-Bu₂Fl)(Cp-SiMe₂Et)ZrCl₂ (M1) and Example 28 using Ph₂C(2,7-t-Bu₂Fl)(Cp-SiMe₂-n-Pr)ZrCl₂ (M3) still show an increase in CIE. Notably, even metallocenes with the bulky triethylsilyl and tri-n-propylsilyl substituents, provided CIE values of 0.074 and 0.107, respectively, which are comparable to or higher than the CIE of comparative Example 12 (0.075).

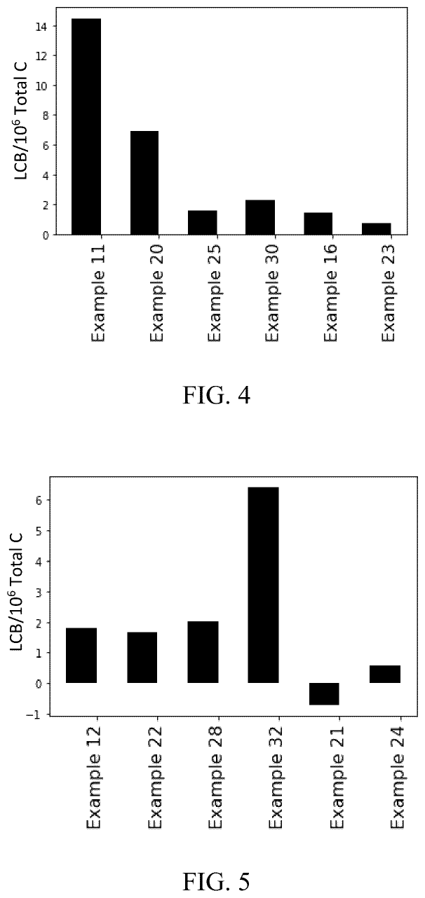

While the inventive Example 20 using Ph₂C(Fl)(Cp-SiMe₂Et)ZrCl₂ (M2) and inventive Example 25 using Ph₂C(Fl)(Cp-SiMe₂-n-Pr)ZrCl₂ (M4) as well as others demonstrated good CIE, they also effectively suppress long-chain branching (LCB). FIG. 4 shows that comparative Example 11 using Ph₂C(Fl)(Cp-SiMe₃)ZrCl₂ (CM5) with its SiMe₃-substituted Cp ligand exhibits a relatively poor ability to suppress LCB (14.5 LCB/10⁶ C). In contrast, inventive Example 20 using M2 with its SiMe₂Et-substituted Cp ligand produces a polymer with a decreased LCB amount of 6.9 LCB/10⁶ C compared to the CIE of Example 11 with CM5. This LCB is further reduced to 2.3 with the SiMe₂-n-Bu-substituted Cp compound M5 in Example 30 and to 1.6 with the SiMe₂-n-Pr-substituted Cp compound M4 in Example 25. Metallocene M5 in Example 30 also shows a slightly higher CIE (0.120) than metallocene M4 (0.090). The bulkier SiEt₃-substituted Cp ligand in M9 and SiPr₃-substituted Cp ligand in M13 metallocenes in Examples 16 (1.5 LCB/10⁶ C) and 23 (0.8 LCB/10⁶ C), respectively, were able to suppress LCB even further, as seen in Table 4. Surprisingly, the effects of changing silyl substituents on the LCB are not replicated with CIE, as can be seen by comparing FIG. 4 with FIG. 2.

The presence of the t-butyl substituents on the fluorenyl ligand afforded polymer with an even lower LCBf than an unsubstituted fluorenyl ligand on the metallocene. FIG. 5 provides the LCB (long chain branching) data for the ethylene-1-hexene polymerizations using Ph₂C(2,7-t-Bu₂Fl)(Cp-SiMe₃)ZrCl₂ (CM6, Example 12), Ph₂C(2,7-t-Bu₂Fl)(Cp-SiMe₂Et)ZrCl₂ (M1, Example 22), Ph₂C(2,7-t-Bu₂Fl)(Cp-SiMe₂-n-Pr)ZrCl₂ (M3, Example 28), Ph₂C(2,7-t-Bu₂Fl)(Cp-SiMe₂-n-Bu)ZrCl₂ (M5Bu, Example 32), Ph₂C(2,7-t-Bu₂Fl)(Cp-SiEt₃)ZrCl₂ (M8, Example 21), and Ph₂C(2,7-t-Bu₂Fl)(Cp-Si-n-Pr₃)ZrCl₂ (M12, Example 24). As shown, in FIG. 5, these metallocene catalysts show a good ability to produce low LCB polymers. While not wishing to be bound by theory, a contributing factor may be the bulker ligand environment resulting from the tert-butyl groups of the fluorenyl ligand in each metallocene. The negative LCB of Example 21 may be interpreted as an LCB frequency of about 0 LCB/10⁶ total carbon atoms. Surprisingly, the effects of changing silyl substituents on the LCB are not replicated with CIE, as can be seen by comparing FIG. 3 with FIG. 5.

It was surprisingly found that inventive Example 13 employing the bulkier triethylsilyl-substituted compound Me₂C(Fl)(Cp-SiEt₃)ZrCl₂ (M11), showed a greater than 2-fold increase in Comonomer Incorporation Efficiency to a CIE of 0.162, relative to the less sterically-bulky trimethylsilyl-substituted compounds of comparative Example 11 using Ph₂C(Fl)(Cp-SiMe₃)ZrCl₂ (CM5) and comparative Example 12 using Ph₂C(2,7-t-Bu₂Fl)(Cp-SiMe₃)ZrCl₂ (CM6), which produced polyethylenes characterized by a Comonomer Incorporation Efficiency of CIE ≤0.076. However, Me₂C(Fl)(Cp-SiEt₃)ZrCl₂ (M11) in Example 13 produced a polyethylene having a lower LCBf (JC-α, 190° C., 5.8 LCB/10⁶ C) under the similar conditions as 11 using Ph₂C(Fl)(Cp-SiMe₃)ZrCl₂ (CM5), which produced a JC-α, 190° C. of 14.5 LCB/10⁶ C polyethylene.

Although the CIE of the Cp-SiEt₃ compound (M11) was somewhat lower than the comparative unsubstituted cyclopentadienyl compound Me₂C(Fl)(Cp)ZrCl₂ (CM2) in Examples 5, Example 6, and Example 7 (CIE of 0.217, 0.217, and 0.257, respectively), the metallocene (MCN) activity of Me₂C(Fl)(Cp-SiEt₃)ZrCl₂ (M11) in 13 of 257 kg PE/mmol MCN/h (density of 0.9182 g/cc) is more than the average MCN activity of 99 kg PE/mmol MCN/h (average density of 0.9164 g/cc) for the Examples 5, 6, and 7 runs, even at the higher density of inventive Example 13.

Also surprisingly, the metallocene Me₂C(2,7-t-Bu₂Fl)(Cp-SiEt₃)ZrCl₂ (M10) of inventive Example 14 showed an approximately 1.7-fold increase in Comonomer Incorporation Efficiency to a CIE of 0.127, relative to the less sterically-bulky trimethylsilyl-substituted MCN compound Ph₂C(Fl)(Cp-SiMe₃)ZrCl₂ (CM5) of comparative Example 11 and Ph₂C(2,7-t-Bu₂Fl)(Cp-SiMe₃)ZrCl₂ (CM6) of comparative Example 12, which produced polyethylenes having a CIE ≤0.076. Unexpectedly, selectivity for macromer vs. ethylene insertion decreases using SiEt₃-substituted Me₂C(2,7-t-Bu₂Fl)(Cp-SiEt₃)ZrCl₂ (M10, Example 14, JC-α, 190° C.=1.8 LCB/10⁶ C) versus the SiMe₃-substituted cyclopentadienyl catalysts Ph₂C(Fl)(Cp-SiMe₃)ZrCl₂ (CM5, Example 11, JC-α, 190° C.=14.5 LCB/10⁶ C).

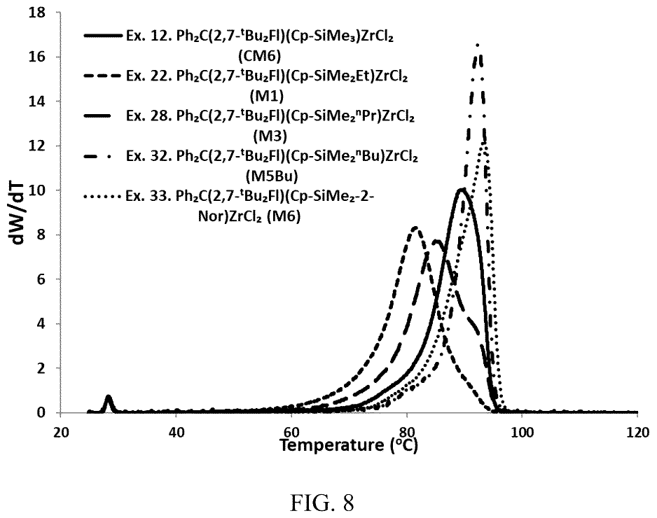

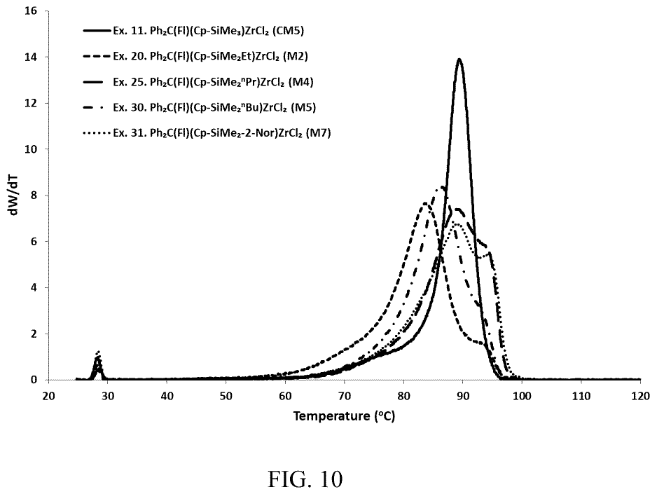

In FIG. 10 and FIG. 8, the effect of increasingly bulky substituents on the SiR⁵R⁶R⁷ group bonded to the cyclopentadienyl ligand is illustrated. FIG. 10 compares the aTREF scans for the polyethylenes produced using a comparative catalyst with a SiMe₃-substituted cyclopentadienyl ligand versus a series of increasingly bulky SiR₃-substituted cyclopentadienyl ligands, all with an unsubstituted fluorenyl ligand. Thus, FIG. 10 presents aTREF scans for polymers made using Ph₂C(Fl)(Cp-SiMe₃)ZrCl₂ (CM5, Example 11, Ph₂C(Fl)(Cp-SiMe₂Et)ZrCl₂ (M2, Example 20), Ph₂C(Fl)(Cp-SiMe₂-n-Pr)ZrCl₂ (M4, Example 25), Ph₂C(Fl)(Cp-SiMe₂-n-Bu)ZrCl₂ (M5, Example 30), and Ph₂C(Fl)(Cp-SiMe₂-2-Norbornyl)ZrCl₂ (M7, Example 31).

The aTREF scans of FIG. 10, which separate a polymer sample into fractions based on crystallinity, reflect the compositional or microstructure differences between polymer chains in a sample. The comparative Cp-SiMe₃-containing metallocene CM5 produces a relatively narrow or homogeneous composition wherein the polymer chains are similar in composition, as exhibited in the aTREF scan of FIG. 10. This contrasts with the substantially broader compositions produced by M2 (SiMe₂Et), M4 (SiMe₂-n-Pr), M5 (SiMe₂-n-Bu), and M7 (2-Norbornyl). The 2-Norbornyl-substituted metallocene (M7) aTREF reveals a minimum between two peaks, reflecting a bimodal microstructural composition, consistent with at least two active sites producing different degrees of short chain branching. The shoulders of the M2, M4, and M5 aTREF scans of FIG. 10 and the overall broadness of these scans are also consistent with catalysts having multiple active sites. These observed differences in polymer compositions are entirely unexpected based on the different trialkylsilyl groups of these metallocenes.

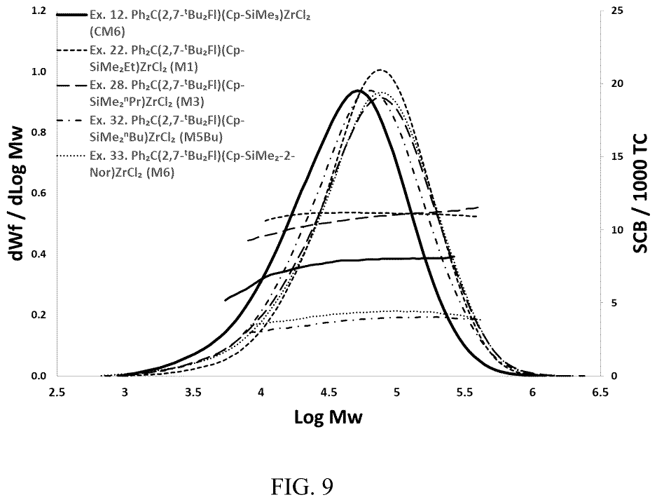

The analogous t-butyl-substituted metallocenes are used to produce the analogous polyethylenes, and FIG. 8 compares the aTREF scans for the polyethylenes polymers produced using a comparative catalyst with a SiMe₃-substituted cyclopentadienyl ligand versus the series of more bulky SiR₃-substituted cyclopentadienyl ligands, all with di-t-butyl-substituted fluorenyl ligand. Thus, FIG. 8 presents aTREF scans for polymers made using Ph₂C(2,7-t-Bu₂Fl)(Cp-SiMe₃)ZrCl₂ (CM6, Example 12), Ph₂C(2,7-t-Bu₂Fl)(Cp-SiMe₂Et)ZrCl₂ (M1, Example 22), Ph₂C(2,7-t-Bu₂Fl)(Cp-SiMe₂-n-Pr)ZrCl₂ (M3, Example 28), Ph₂C(2,7-t-Bu₂Fl)(Cp-SiMe₂-n-Bu)ZrCl₂ (M5Bu, Example 32), and Ph₂C(2,7-t-Bu₂Fl)(Cp-SiMe₂-2-Norbornyl)ZrCl₂ (M6, Example 33). FIG. 9 illustrates the GPC-IR MWD scans for the polymers of FIG. 8 and shows the SCBD profile over the range from d85 to d15.

The aTREF scans of FIG. 8, like those of FIG. 10, reflect the unexpected differences in polymer compositions between polymer fractions but these differences do not follow the same trend as the FIG. 10 polymers generated using the unsubstituted fluorenyl metallocene analogs. Using the aTREF of the comparative Cp-SiMe₃-containing metallocene CM6 as a benchmark, FIG. 8 illustrates that both broader and narrower polymer compositions are generating using the inventive M1 (SiMe₂Et), M3 (SiMe₂-n-Pr), M5Bu (SiMe₂-n-Bu), and M6 (2-Norbornyl) metallocenes. The n-butyl substituted metallocene (M5Bu) and the 2-Norbornyl-substituted metallocene (M6) exhibit more narrow compositions which elute at higher temperatures than the comparative CM6 (Cp-SiMe₃) polymer. In contrast, the inventive ethyl substituted (M1) and n-propyl substituted metallocene (M3) polymers exhibit broader compositions which elute at lower temperatures compared to comparative CM6 (Cp-SiMe₃) polyethylene. A high-temperature shoulder is clearly discernable in the M3 (SiMe₂-n-Pr) polymer, consistent with at least two active catalytic sites differing in CIE and activity. Again, these observed differences in polymer compositions are unexpected based on the different trialkylsilyl groups of these metallocenes.

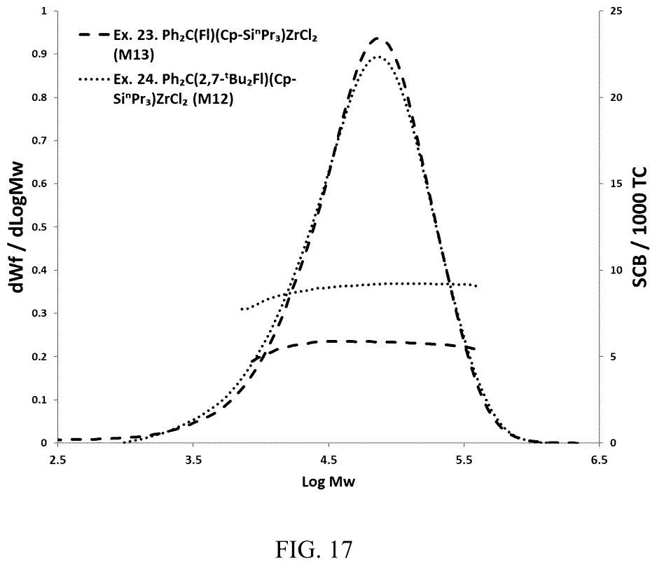

FIG. 16 and FIG. 17 present aTREF and GPC-IR data which illustrate the effect of t-butyl fluorenyl substitution versus an unsubstituted fluorenyl on the polyethylenes. These aTREF and GPC-IR scans are carried out on a nominal melt index of 1 and density of 0.93 g/cm³ polymer compositions, where the FIG. 16 aTREF and the FIG. 17 GPC-IR scan where both figures shown the polymer resulting from a t-butyl fluorenyl substituted metallocene and an unsubstituted fluorenyl metallocene.

As shown in FIG. 16 and FIG. 17, the unsubstituted fluorenyl metallocene Ph₂C(Fl)(Cp-Si-n-Pr₃)ZrCl₂ (M13, Example 23) and the t-butyl-substituted metallocene Ph₂C(2,7-t-Bu₂Fl)(Cp-Si-n-Pr₃)ZrCl₂ (M12, Example 24) resins are both characterized two resolved elution peaks above about 65° C., with the M13 resin showing a broader compositional aTREF scan. See FIG. 16 and Table 4. Again, these TREF profiles suggest relatively wide chemical composition distributions, which are beneficial to mechanical properties of the resulting LLDPE films. The GPC-IR scans of FIG. 17 show very similar molecular weight distributions for the M13 and M12 resins, with the Ph₂C(Fl)(Cp-Si-n-Pr₃)ZrCl₂ (M13) resin exhibiting a near-zero d85-d15 slope of 0.05 (polydispersity index 4.30), and the t-butyl-substituted fluorenyl compound Ph₂C(2,7-t-Bu₂Fl)(Cp-Si-n-Pr₃)ZrCl₂ (M12) exhibiting a d85-d15 slope of 0.79 (polydispersity index 3.31).

It is noteworthy that Example 9, utilizing the comparative metallocene Ph₂C(2,7-t-Bu₂Fl)(Cp)ZrCl₂ (CM4) which is absent any substituent on the Cp ring, exhibits a CIE of 0.123 and LCB of 44.8, Table 7. In comparison, comparative Example 12 using Ph₂C(2,7-t-Bu₂Fl)(Cp-SiMe₃)ZrCl₂ (CM6) which incorporates a SiMe₃-substituted Cp ligand, significantly reduces LCB to 1.8 but at the expense of lowering CIE to 0.075. Conversely, inventive Example 22 using Ph₂C(2,7-t-Bu₂Fl)(Cp-SiMe₂Et)ZrCl₂ (M1), inventive Example 28 using Ph₂C(2,7-t-Bu₂Fl)(Cp-SiMe₂-n-Pr)ZrCl₂ (M3), and inventive Example 24 using Ph₂C(2,7-t-Bu₂Fl)(Cp-Si-n-Pr₃)ZrCl₂ (M12) effectively maintain low LCB levels while achieving comparable CIE to CM4.

Also unexpectedly, inventive Example 15 using metallocene Ph₂C(Fl)(Cp-SiEt₃)ZrCl₂ (M9) produced a polyethylene having a higher CIE (0.099) versus its corresponding SiMe₃-substituted analog. Comparative Example 11 using Ph₂C(Fl)(Cp-SiMe₃)ZrCl₂ (CM5) producing a polyethylene of CIE=0.076.

The CIE of 0.099 of Example 15 using the Ph₂C-bridged Ph₂C(Fl)(Cp-SiEt₃)ZrCl₂ (M9) was also substantially lower than the CIE of 0.162 of the polyethylene of Example 13 produced with the Me₂C-bridged Me₂C(Fl)(Cp-SiEt₃)ZrCl₂ (M11). The Example 15 M9 polymer was characterized with an LCB (JC-α, 190° C.) of 1.2, whereas the Example 11 M11 polymer had an LCB (JC-α, 190° C.) of 5.8. That is, the catalyst selectivity for both 1-hexene and macromer incorporation decreased in the Ph₂C-bridged metallocenes as compared with the Me₂C-bridged compound by differing degrees.

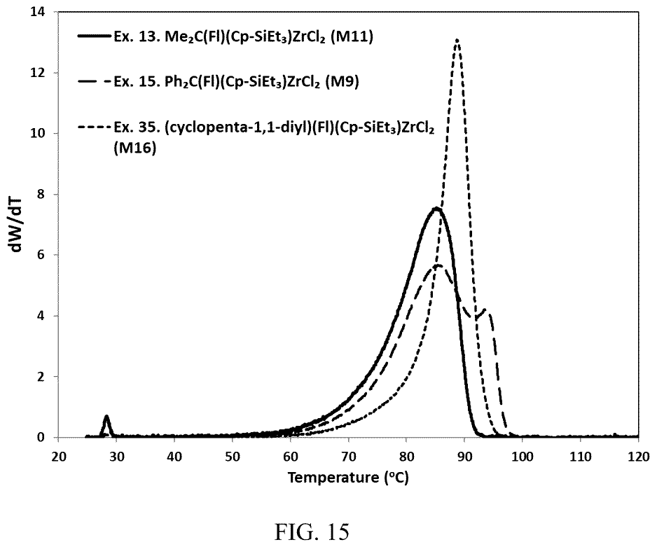

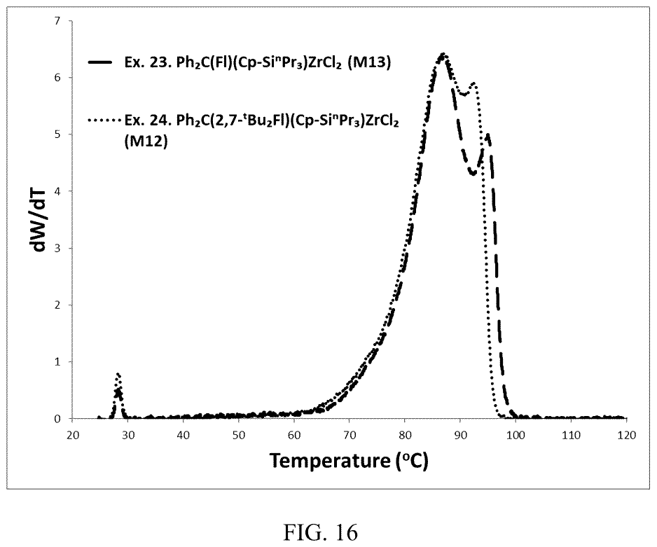

The Ph₂C-bridged metallocene Ph₂C(Fl)(Cp-SiEt₃)ZrCl₂ (M9, Example 15 produced a polyethylene having a broader polymer composition versus its Me₂C-bridged analog Me₂C(Fl)(Cp-SiEt₃)ZrCl₂ (M11, Example 13), as seen in the aTREF scans of FIG. 15 and in the polydispersities of these polymers. See Table 3 and Table 4 data. The Ph₂C-bridged M9 metallocene (Example 15) polymers exhibited an aTREF broadness of 10.0 and a polydispersity index (Mw/Mn) of 3.76, as compared with the Me₂C-bridged compound M11 metallocene (Example 13) polymers having aTREF broadness of 8.5 and a polydispersity index (Mw/Mn) of 2.49. Additionally, the M16 metallocene (cyclopenta-1,1-diyl)(Fl)(Cp-SiEt₃)ZrCl₂ produced an even narrower polymer composition, with an aTREF broadness of 5.5 and a polydispersity index of 2.26, FIG. 15. In addition, SCBf decreased with increasing Mw in the molecular weight distribution to afford a negative SCB d85-d15 slope of −1.08 in Ph₂C(Fl)(Cp-SiEt₃)ZrCl₂ (M9, Example 15), versus the Me₂C(Fl)(Cp-SiEt₃)ZrCl₂ (M11, Example 13), which was characterized by a positive SCB slope of +0.77. The aTREF data for these compounds is seen in FIG. 15.

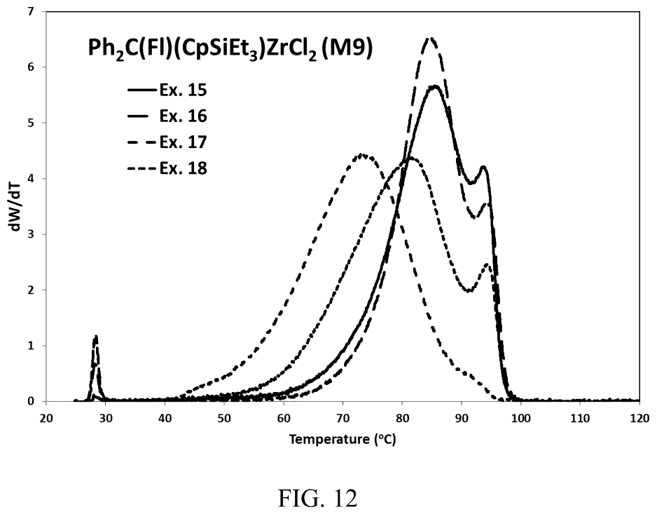

The TREF scans for resins prepared using Ph₂C(Fl)(Cp-SiEt₃)ZrCl₂ (M9), as shown in FIG. 12 reveal some distinctive characteristics. Despite the variations in densities, all resins displayed two prominent elution peaks above 40° C., including a smaller elution peak at around 95° C. and a broad elution peak at a lower temperatures between about 75° C. and about 87° C. These unique TREF profiles suggest relatively broad and bimodal chemical composition distributions, which are beneficial to processing and mechanical properties of the resulting LLDPE resins and films.

Example 16 also employed Ph₂C(Fl)(Cp-SiEt₃)ZrCl₂ (M9) and repeated Example 15), except Example 16 increased the proportion of H₂ in the H₂/C₂ mixture by about 26% over that of Example 15 while maintaining total pressure constant. The Example 16 polymer with higher H₂/C₂ ratio exhibited a comparable LCB and CIE as the Example 15 polymer. However, the increased H₂/C₂ ratio in Example 16 (2.40E+04) barely decreased the Mn by only 3% from the Example 15 polymer (2.47E+04).

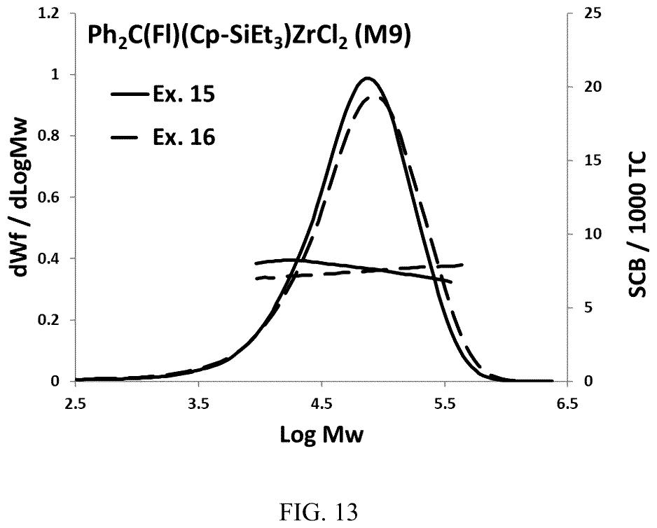

Moreover, the Example 16 polymer Mw/Mn of ˜4.4 is broader than the Mw/Mn of ˜3.8 of Example 15 polymer, and the Example 16 polymer showed an increased SCBf with Mw of the polymer chain to afford a positive SCB slope of +0.59. vs. a negative SCB slope of −1.08 for the Example 15 polymer which used less H₂. See FIG. 13 for the GPC-IR data for Example 15 and Example 16 using Ph₂C(Fl)(Cp-SiEt₃)ZrCl₂ (M9). The compositional breadth of the aTREF in Example 16 is again broad, but the two components, at peaks 85° C. and 94° C., contribute differing amounts to the overall composition, as suggested by a peak height ratios of 1.81 versus 1.36 for the Example 15 polymer. Moreover, the activity of the M9 metallocene Ph₂C(Fl)(Cp-SiEt₃)ZrCl₂ of Example 16 increased approximately 40% over the M9 metallocene activity in Example 15.

In Example 17 also using Ph₂C(Fl)(Cp-SiEt₃)ZrCl₂ (M9), the H₂ concentration was increased once again, by approximately 1.3-fold over previous Example 16, however the 1-hexene addition was doubled to 80 mL. This Example 17 polymerization run afforded a 1.0 MI, 0.9096 density polymer of an apparent broader composition than the prior two examples as evidenced by the aTREF Figures for Example 17, versus the aTREF data for Example 15 and Example 16, as illustrated in FIG. 12, but of narrower composition by their respective broadness values of 10.0 (Example 15), 8.7 (Example 16), and 5.6 (Example 17). The only Example 17 aTREF peak above the so-called “room temperature solubles” appears at 74.0° C. Although there is a shoulder around 92° C., there is not a separate high-density peak separated by a minima from the low-density component peak in Example 17 in FIG. 12.

The apparent compositional broadening of the Example 17 polymer as discerned from the sum of the high and low-density normalized peak heights of 9.9, 10.1, and 4.4 in the aTREF for Examples 15, 16, and 17, respectively (FIG. 12), in which lower peak height represent broader normalized areas, the polydispersity of Example 17 is actually narrowed to a value of Mw/Mn of 2.5, versus Mw/Mn values of 3.8 and 4.4 for Examples 16 and 17, respectively. See FIG. 13 for the GPC-IR scans of the poly(ethylene-co-1-hexene) for Example 15 and Example 16 using metallocene Ph₂C(Fl)(Cp-SiEt₃)ZrCl₂ (M9), also illustrating that the SCBD slope reverses signs from −1.08 (Example 15) to +0.59 (Example 16).

To attempt to suppress any potential artifacts caused by heat and mass transfer effects, the polymerization temperature was lowered from 80° C. in Example 18 using Ph₂C(Fl)(Cp-SiEt₃)ZrCl₂ (M9), with all the other parameters staying the same as Example 17 using M9. At a temperature of 60° C., the ethylene concentration in isobutane increases by approximately 1.6-fold as compared with ethylene concentration at 80° C., which afforded a 1.2-fold increase in metallocene activity in Example 18 versus Example 17; see Table 2. Conventionally, as the polymerization temperature is lowered, catalyst selectivity for ethylene is thought to increase over its selectivity for hexene, and the increase in polymer density of Example 18 to 0.9195 from the Example 17 polymer density of from 0.9096 g/cc consistent with expected increase in ethylene selectivity. However, a slight, though unexpected 14% increase in CIE from Example 17 (CIE=0.103 at 80° C.) to 18 (CIE=0.120 at 60° C.) was observed.

Moreover, this low temperature (60° C.) Example 18 demonstrates the feasibility to achieve good activity with a catalyst such as Ph₂C(Fl)(Cp-SiEt₃)ZrCl₂ (M9) that versatile enough to produce resins with a density below 0.91 and a more positive SCB slope at lower temperatures. The Example 18 resin is further characterized by an essentially 0 LCB/10⁶ total carbon atoms, and a desirable positive SCB slope of 2.95. The Example 18 polymer displays the higher density aTREF component observed in the Example 15 and Example 16 polymers, all made using M9, which Example 17 does not. See Table 4 and FIG. 12.

Unexpectedly, and despite the higher density and a 20° C. difference in the polymerization temperatures, the solubles fraction was fairly constant upon lowering the reaction temperature from that of Example 17 to that of Example 18, both using M9. None of the signs of a density-fouled reactor, such as chunks or molten polymer coating the reactor interior were visible to the naked eye. Surprisingly, the polydispersity of the lower temperature polymer broadened significantly from Mw/Mn of 2.51 for the 80° C. polymerization run of Example 17 to Mw/Mn of 3.85 for the 60° C. polymerization run of Example 18. Also surprising was the change in SCB slope from the more narrow polydispersity (Example 17) to broader polydispersity (Example 18) polymers, which increased substantially from negative (−)0.61 for the 80° C. polymer to almost +3 for the 60° C. polymer. Though not wishing to be bound by theory, it may be possible that this catalyst series (Example 16-19) involves two non-equivalent active catalyst sites with differing rates of ethylene and 1-hexene insertion and termination, and differing responses to hydrogen, both in terms of termination rates and activity.

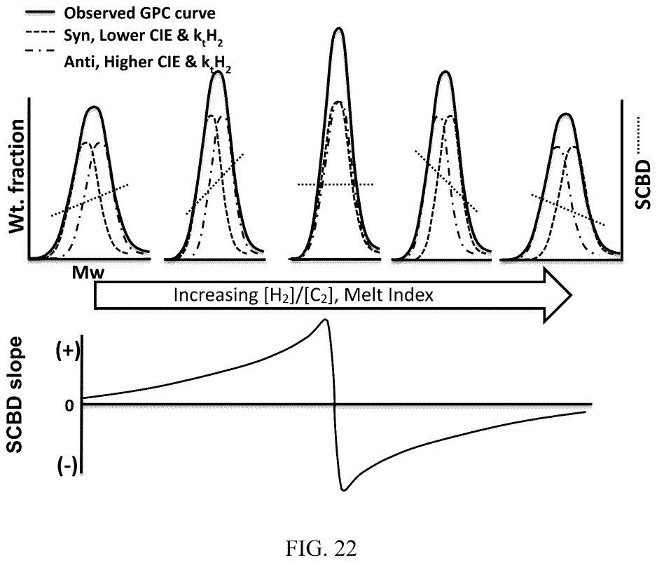

FIG. 22 illustrates an idealized case of two non-equivalent active catalyst sites having equal activity, producing Shultze-Flory distributions that are arbitrarily labeled as a “syn” site representing a lower CIE and hydrogen termination rate kₜH₂, relative to an “anti” site having a higher CIE and hydrogen termination rate kₜH₂. A possible effect of two catalyst sites on the overall polydispersity and SCB slope is illustrated in the sequence of chromatograms, representing five polymerizations in which hydrogen concentration [H₂] increases from left to right with each run. With increasing [H₂], the two sites represented by the deconvoluted dashed curves begin to coalesce and the overall observed MWD becomes narrower until they are overlapping in the middle chromatogram. Under this particular set of conditions, the catalyst could appear to have produced a single-site distribution with a flat SCBD (slope=0). However, upon increasing [H₂] above that apparent (overlapping) “single-site condition”, the observed MWD would begin to broaden as the deconvoluted peaks separate from one another. The effect of coalescing, overlapping and separating of the two sites on SCBD slope is illustrated in the lower section of FIG. 22.

Thus, using such an idealized two-site catalyst, and depending on the H₂/C₂ ratio, the slope would go through a maximum absolute value on either side of a flat SCBD or zero slope when the MWDs are overlapping, and the further the two deconvoluted distributions move apart, the absolute value of the slope decreases. The FIG. 22 idealized scenario assumes that (1) both Shultze-Flory catalytic sites exhibit the same H₂ activity responses and thus afford equal molar mass polymers, and (2) overlapping molecular weight distributions (MWD) with an intercept at Mw/Mn of 2.0, although neither assumption is usually the case. However, FIG. 22 does illustrate how two sites can afford a variety of Mw/Mn, SCBD slopes, aTREF patterns, and LCBf, depending on their reaction to specific polymerization conditions.

Example 19 using metallocene Ph₂C(Fl)(Cp-SiEt₃)HfCl₂ (M14) which was compared with its zirconium analogs, including Ph₂C(Fl)(Cp-SiEt₃)ZrCl₂ (M9) in Examples 15 through Example 18; see Tables 2-4. Under conditions that make similar density and melt index polyethylenes as its zirconium analogs, Ph₂C(Fl)(Cp-SiEt₃)HfCl₂ (M14) afforded roughly an order of magnitude lower metallocene (MCN) activity. However, the CIE of M14 also drops considerably, by roughly 50% (CIE=0.049) versus its Zr analogs in the M9 series of runs (CIE ranges from 0.099-0.120). The aTREF of the M14 polymer again displays two peaks as its zirconium analog; however surprisingly, the peak representing the higher density of the distribution predominates the aTREF scan in the M14 polymer, as can be seen by their normalized peak heights in Table 4.

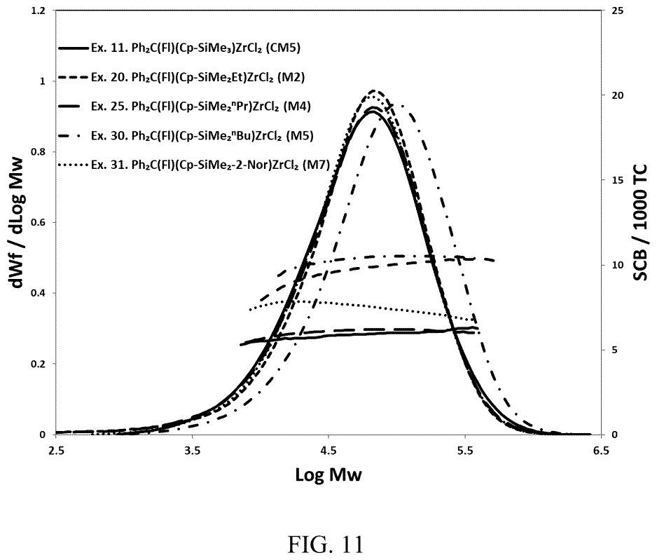

FIG. 11 presents the GPC-IR Molecular Weight Distribution (MWD) scans for the same poly(ethylene-co-1-hexene) polymers shown in FIG. 10, which are produced using CM5 (Example 11), M2, (Example 20), M4 (Example 25), M5 (Example 30), and M7 (Example 31). Surprisingly, Example 20 using metallocene Ph₂C(Fl)(Cp-SiMe₂Et)ZrCl₂ (M2) with the bulkier SiMe₂Et substituent shows an increase in CIE to 0.117 versus the comparative Example 11 using Ph₂C(Fl)(Cp-SiMe₃)ZrCl₂ (CM5) (CIE=0.076) (CM5). The M2 polymer also exhibits a broader MWD (3.92 versus 3.18 for CM5) while improving the desirable reverse SCBD, where the SCBD d85-d15 slope is 1.18 for inventive M2 versus 0.36 for comparative CM5 with the SiMe₃ substituent. The aTREF scan of Ph₂C(Fl)(Cp-SiMe₂Et)ZrCl₂ (M2) in Example 20 (FIG. 10) like that of Ph₂C(Fl)(Cp-SiEt₃)ZrCl₂ (M9) in Example 18 (FIG. 12) reveals a composition composed of a low-density and a high-density component. The aTREF scans of comparative Example 11 and Example 20 appear in FIG. 10. Remarkably, even as the overall CIE in the M2 polymer in Example 11 has increased versus the CM5 polymer of Example 18, the LCBf has decreased by approximately 50% to JC-α, 190° C. of 6.9 in M2 (Example 20) to JC-α, 190° C. of 14.5 for the SiMe₃-substituted CM5 in Example 11. Also noteworthy is that the LCBf (JC-α, 190° C. of 6.9) in M2 is higher than the LCBf in the bulkier SiEt₃-substituted metallocene resins made using Ph₂C(Fl)(Cp-SiEt₃)ZrCl₂ (M9) in Example 15 (JC-α, 190° C.=1.2) and Example 16 (JC-α, 190° C.=1.5).

Example 21 using metallocene Ph₂C(2,7-t-Bu₂Fl)(Cp-SiEt₃)ZrCl₂ (M8) gave the broadest MWD obtained (Mw/Mn=4.89), very high catalyst activity (646 kg PE/mmol MCN/h), and a LCBf (JC-α, 190° C.) of −0.7. This LCBf using M8 is lower than its unsubstituted fluorene (t-Bu-free) analog Ph₂C(Fl)(Cp-SiEt₃)ZrCl₂ (M9) at Example 15 (JC-α, 190° C.=1.2) and Example 16, with JCa=1.2 and 1.5, respectively, and the M8 CIE (0.074) is also about 25% lower than the unsubstituted fluorenyl metallocenes. The M8 polymer of Example 21 exhibits an even at higher density(0.9271 g/cc) versus the unsubstituted fluorene Ph₂C(Fl)(Cp-SiEt₃)ZrCl₂ (M9) polymer at Example 15 (0.9221 g/cc) and Example 16 (0.9223 g/cc). Like the M9 polymer at Examples 15 and 16, the aTREF of the Ph₂C(2,7-t-Bu₂Fl)(Cp-SiEt₃)ZrCl₂ (M8) polymer of Example 21 implicates two polymer components of more evenly matched contribution as ascertained by their peak heights and shapes as compared with the M9 polymer at Example 15. The M8 Example 21 polymer exhibits an SCBD slope of 0.19.

The metallocene Ph₂C(2,7-t-Bu₂Fl)(Cp-SiMe₂Et)ZrCl₂ (M1) (Example 22) with its somewhat smaller Cp substituent SiMe₂Et was compared with Ph₂C(2,7-t-Bu₂Fl)(Cp-SiEt₃)ZrCl₂ (M8) having the bulkier SiEt₃ substituent (Example 21). Surprisingly, the less bulky Ph₂C(2,7-t-Bu₂Fl)(Cp-SiMe₂Et)ZrCl₂ (M1) increased the polyethylene CIE to 0.106, approximately 40% greater than the M8 CIE of 0.074, while increasing the LCBf from JC-α, 190° C.=−0.7 in M8 to a JC-α, 190° C. of 1.7 in M1, even with the M1 polyethylene having a lower density (0.9161) versus the M8 polymer (0.9271). The M1 polymer polydispersity of 2.57 was significantly more narrow than the M8 polymer polydispersity of 4.89. While Applicants do not intend to be +

bound by theory, this example appears to show that a narrower aTREF composition as evidenced by a single peak can be obtained by decreasing the steric bulk of the substituent at this position on the cyclopentadienyl ring. The aTREF broadness values and SBDI values of the M1 polymer and M8 polymers were comparable; see Table 4.

Example 23 using Ph₂C(Fl)(Cp-Si-n-Pr₃)ZrCl₂ (M13) increased the steric bulk of the cyclopentadienyl substituent from SiEt₃ in Ph₂C(Fl)(Cp-SiEt₃)ZrCl₂ (M9) to Si-n-Pr₃ in M13 (Examples 15 and 16), which afforded a broad polydispersity polymer (Mw/Mn=4.30) and a bimodal like aTREF composition (Table 4). The Cp-Si-n-Pr₃ substituted M13 provided approximately 21% lower CIE (0.078) than the CIE (0.099) of Cp-SiEt₃ substituted M9 in both Examples 15 and 16). The bulkier M13 catalyst also produced a polyethylene (JC-α, 190° C. is 0.8) with a similar or slightly lower LCBf than the M9 polyethylenes with JC-α, 190° C. of 1.2 (Example 15 and JC-α, 190° C. of 1.5 (Example 16). However, the lower CIE of the M13 metallocene is compensated for by the highest metallocene activity exhibited amongst those tested (889 kg PE/mmol MCN/h), and a relatively flat SCB d85-d15 slope (0.05).

Surprisingly, inventive Example 24 using Ph₂C(2,7-t-Bu₂Fl)(Cp-Si-n-Pr₃)ZrCl₂ (M12) with its t-butyl-substituted fluorene has an approximately 1.4-times (1.4×) better CIE (0.107) as compared to Example 23 which uses Ph₂C(Fl)(Cp-Si-n-Pr₃)ZrCl₂ (M13) (CIE of 0.078). The activity of M12 (690 kg PE/mmol MCN/h) remains high as compared with that of Ph₂C(Fl)(Cp-Si-n-Pr₃)ZrCl₂ (M13) (889 kg PE/mmol MCN/h), and the polydispersity becomes somewhat more narrow in the M12 polymer (Mw/Mn=3.31) versus the polydispersity of the M13 polymer (Mw/Mn=4.30), with M12 exhibiting the higher SCB slope (0.79 versus 0.05 for M13) while the LCBf remains low (JC-α, 190° C. is 0.6 for M12 versus 0.8 for M13). Examination of the aTREF reveals a dual or bimodal composition in the M12 polymer, possibly with a slightly more equal contribution from each component than the polymer obtained in the t-Bu-free M13 polymer.

Example 25 using the unsubstituted fluorenyl compound Ph₂C(Fl)(Cp-SiMe₂-n-Pr)ZrCl₂ (M4) afforded the second highest metallocene activity observed (749 kg PE/mmol MCN/h; see Table 2), with a higher CIE (0.090) as compared to Ph₂C(Fl)(Cp-Si-n-Pr₃)ZrCl₂ (M13) CIE (0.078) in Example 23), which surprisingly was 16% lower than the CIE (0.107) of Example 24 metallocene Ph₂C(2,7-t-Bu₂Fl)(Cp-Si-n-Pr₃)ZrCl₂ (M12) with its bulkier Si-n-Pr₃ substituent. Ph₂C(Fl)(Cp-SiMe₂-n-Pr)ZrCl₂ (M4) at Example 25 also provided a desirable polydispersity Mw/Mn of 4.30 indicating better processing than many conventional metallocene resins with lower Mw/Mn, while increasing the SCBD d85-d15 slope to 0.26 from 0.05 in the M13 polymer. The greater Mw/Mn polymers such as produced by M4 impart better processing characteristics and may allow the polymers to be used with lower concentrations of processing aid (slip & antiblock) conventionally needed to blow film at high rates and may allow these polymers to be used in the absence of conventional processing aids.

The aTREF scan of the M4 polymer (Example 25) revealed a primary lower density peak centered at 89° C., with a substantial and discernable shoulder on the higher density side around 94° C., FIG. 10. The exact location of the higher density peak in the M4 polymer is difficult to ascertain and is therefore indicated as “NA” (Not Available) in Table 4, as there is no minimum which could be identified between about 87° C. and 95° C. such as observed in the Ph₂C(Fl)(Cp-Si-n-Pr₃)ZrCl₂ (M13) polymer. Ph₂C(Fl)(Cp-SiMe₂-n-Pr)ZrCl₂ (M4) also provided only a slightly higher LCBf (JC-α, 190° C.=1.6) versus that provided by the bulkier silyl in Ph₂C(Fl)(Cp-Si-n-Pr₃)ZrCl₂ (M13) (JC-α, 190° C.=0.8) at similar melt index (MI) and density.

Inventive Example 28 using Ph₂C(2,7-t-Bu₂Fl)(Cp-SiMe₂-n-Pr)ZrCl₂ (M3) afforded lower activity (352 kg PE/mmol MCN/h) than either its unsubstituted fluorenyl analog Ph₂C(Fl)(Cp-SiMe₂-n-Pr)ZrCl₂ (M4, 749 kg PE/mmol MCN/h) in Example 25, or its more sterically encumbered analog Ph₂C(2,7-t-Bu₂Fl)(Cp-Si-n-Pr₃)ZrCl₂ (M12) of Example 24 (680 Kg/mmol/h). The M3 polyethylene MWD as measured by the polydispersity was narrowed somewhat to Mw/Mn=3.20 from the unsubstituted fluorenyl catalyst M4 polydispersity (Mw/Mn=4.12) but was similar to the Mw/Mn=3.31 of the Ph₂C(2,7-t-Bu₂Fl)(Cp-Si-n-Pr₃)ZrCl₂ (M12) polymer (Example 24). These metallocenes provided polymers with similar molecular weight broadness and SCB d85-d15 slopes. The Ph₂C(2,7-t-Bu₂Fl)(Cp-SiMe₂-n-Pr)ZrCl₂ (M3) polymer aTREF shape resembled that of the Ph₂C(Fl)(Cp-SiMe₂-n-Pr)ZrCl₂ (M4) polymer, but with a somewhat less prominent high-density shoulder. Ph₂C(2,7-t-Bu₂Fl)(Cp-SiMe₂-n-Pr)ZrCl₂ (M3) provided a higher CIE of 0.103 (Example 28) versus the Ph₂C(Fl)(Cp-SiMe₂-n-Pr)ZrCl₂ (M4) CIE of 0.090 (Example 25), and a higher SCB d85-d15 slope of 1.06 as compared to the d85-d15 slope of 0.26 for M4. Both the t-butyl-substituted fluorenyl catalyst M3 (JC-α, 190° C.=2.0) and the unsubstituted fluorenyl catalyst M4 (JC-α, 190° C.=1.6) exhibited similar LCBf.

Example 29 using Ph₂C(2,7-t-Bu₂Fl)(Cp-SiMe₂-n-Pr)ZrCl₂ (M3) repeated Example 28 except that Example 29, used slightly (5%) less hydrogen than Example 28, used half the metallocene and sMAO charges of Example 28, and the Example 29 metallocene-sMAO combination was subjected to more “aging” (43 days as compared with 3 days for Example 28). Despite these differences, Examples 28 and 29 afforded almost identical aTREF compositions, the same Mw/Mn of 3.2, and similar LCBf of 2.0 and 2.2, respectively. Both Examples 28 and 29 runs yielded a favorable SCBD, characterized by d85-d15 slopes of 1.06 and 0.82, respectively.

These Examples 28 and 29 data contrast with the variation in LCBf observed in the aging Examples A15, A16, and A17 using Ph₂C(Fl)(Cp-SiMe₂Allyl)ZrCl₂ (CM7), in which LCBf ranges from JC-α, 190° C. of 2.5 (Example A17) to JC-α, 190° C. of 6.5 (Example A15), as seen in Tables 8-9 and FIG. 1, and the LCBf variation observed in Examples A6-A12 using Me(3-buten-1-yl)C(2,7-t-Bu₂Fl)(Cp)ZrCl₂ (CM9), in which JC-α, 190° C. varies more than an order of magnitude from 4.8 (Example A7) to 100.0 (Example A12). While not intending to be bound by any particular theory, if the function of the pendent olefin is to mitigate LCB formation, an in-situ reaction such as alkylalumination of the olefin with excess trimethylaluminum in MAO might mitigate its function, and result in a high frequency of LCB formation, which is observed.

Regardless of the time it has been contacted with a co-catalyst or a scavenger, one unexpected and surprising advantage of the methods of this disclosure, as well-illustrated in aging data Table 9 by Examples A22 to A27 using Ph₂C(Fl)(Cp-SiEt₃)ZrCl₂ (M9), is the relative reproducibility of the resin structure, especially LCBf, over the aging time. Though not wishing to be bound by any particular theory, this result may be due to the lack of an olefinic moiety in the Si substituents of the claimed method. Thus, by whatever mechanism, the inventive examples maintain their ability to limit LCB formation to levels that do not cause a deterioration of blown film properties, while affording better CIE as seen in the Ph₂C(Fl)(Cp-SiEt₃)ZrCl₂ (M9) five-run average of aged samples A23-A27 (CIE=0.101). This CIE performance can be compared with the CIE of the unbridged metallocenes such as (n-BuCp)₂ZrCl₂ (CM1) in Example 4 of 0.035, or surprisingly, even bridged metallocenes with sterically less-encumbered substituents, such as comparative Ph₂C(Fl)(Cp-SiMe₃)ZrCl₂ (CM5) as in Example 11 with a CIE of 0.076.

Inventive Example 30 using Ph₂C(Fl)(Cp-SiMe₂-n-Bu)ZrCl₂ (M5) was run under nearly identical conditions as Example 25 using Ph₂C(Fl)(Cp-SiMe₂-n-Pr)ZrCl₂ (M4). Surprisingly, and despite its larger n-Bu substituent, catalyst M5 made lower density polyethylene (0.9195 g/cc versus 0.0.9267 g/cc for the M4 polymer), consistent with the higher CIE of M5 (CIE=0.120) compared with M4 (CIE=0.090). Some of this difference may be due to density suppression by the higher Mw of the M5 polymer (1.32E+05) versus the M4 polymer (8.99E+04). The aTREF curves of the M4 and M5 polymers of Example 25 and Example 30, respectively, resemble one another in having a main low-density peak with a shoulder on the high-density side, which occurs at much lower temperature for the M5 n-butyl homolog polymer than the M4 n-propyl polymer, as seen FIG. 10. The LCBf was similar for these polymers, (M5 JC-α, 190° C.=2.3 and M4 JC-α, 190° C.=1.6), both exhibited favorable SCBD profiles (M5 d85-d15 slope=0.38 and M4 d85-d15 slope=0.26). The Mw/Mn of the M5 n-butyl-substituted silyl compound was observed to be 3.08, while the M4 n-propyl-substituted silyl compound had Mw/Mn of 4.12.

Catalysts containing the bulky SiMe₂-n-Bu substituent on the cyclopentadienyl ring such as Ph₂C(2,7-t-Bu₂Fl)(Cp-SiMe₂-n-Bu)ZrCl₂ (M5Bu) of Example 32 and its unsubstituted fluorenyl analog Ph₂C(Fl)(Cp-SiMe₂-n-Bu)ZrCl₂ (M5) of Example 30 produced polyethylenes having an aTREF broadness of 4.4 (M5Bu) and 7.2 (M5), respectively, more narrow than the M8 (SiEt₃-substituted) Example 21 polyethylene (aTREF broadness 8.3). The polydispersities of 3.04 for M5Bu and 3.08 for M5 are significantly more narrow than the polydispersity of 4.89 for the M8 polyethylene (Example 21). The Example 22 catalyst Ph₂C(2,7-t-Bu₂Fl)(Cp-SiMe₂Et)ZrCl₂ (M1), with its more bulky t-Bu₂Fl fluorenyl ligand but less bulky SiMe₂Et group, produced polymer having an aTREF broadness of 7.3, nearly identical to the aTREF broadness of 7.2 of the Ph₂C(Fl)(Cp-SiMe₂-n-Bu)ZrCl₂ (M5) polyethylene (Example 30) with its less bulky unsubstituted fluorenyl ligand but more bulky SiMe₂-n-Bu group. However, the polydispersity of M1 polyethylene (Mn/Mw=2.57) was lower than the polydispersity of M5 polyethylene (Mn/Mw=3.08).

Polymerization runs using the Cp-SiMe₂-n-Bu-containing catalysts, Ph₂C(2,7-t-Bu₂Fl)(Cp-SiMe₂-n-Bu)ZrCl₂ (M5Bu, Example 32) and its unsubstituted fluorenyl analog Ph₂C(Fl)(Cp-SiMe₂-n-Bu)ZrCl₂ (M5, Example 30), were run under similar reactor conditions; see Table 2. From the M5 conditions to the M5Bu conditions, 1-hexene concentration [C6] was increased from 40 mL (M5) to 45 mL (M5Bu), which produced resin densities of 0.9195 (M5) and 0.9312 g/cc (M5Bu), with a substantial corresponding drop in CIE of 0.120 (M5) to a CIE of 0.045 (M5Bu). The main aTREF peak at 93° C. for the Ph₂C(2,7-t-Bu₂Fl)(Cp-SiMe₂-n-Bu)ZrCl₂ (M5Bu, Example 32) had no discernable shoulder at higher temperatures, but a very small shoulder on the low temperature side at around 89° C. The M5Bu main aTREF peak had a normalized height (16.5) nearly twice the height of the peak (8.3) in the Ph₂C(Fl)(Cp-SiMe₂-n-Bu)ZrCl₂ (M5) polymer (Example 30), indicating that a more homogeneous polymer composition was produced using M5Bu rather than M5.

While Applicant does not intend to be bound by any theory, it is reasonable to suppose that there are two active sites with each of catalysts M5Bu and M5, and if the one producing a higher SCBf (peak <90° C.) is arbitrarily labeled anti, it appears that the lower CIE site designated syn, (peak >90° C.) is almost exclusively active or expressed in this sample, thus accounting for the overall 60% drop in CIE in M5Bu, as compared to M5 which is absent the fluorenyl t-butyl groups. The di-t-butyl-fluorenyl catalyst M5Bu also exhibited a higher LCBf (JC-α, 190° C.=9.9) as compared to the unsubstituted fluorenyl catalyst M5 (JC-α, 190° C.=2.3), consistent with the selectivity for 1-hexene decreasing in M5Bu while macromer incorporation increases in the presence of the t-butyl moieties on the fluorenyl.

Unexpectedly, even though Example 33 polymerization using Ph₂C(2,7-t-Bu₂Fl)(Cp-SiMe₂-2-Nor)ZrCl₂ (M6) with its 2-norbornyl-silyl group was run under similar conditions as that of Example 32 using Ph₂C(2,7-t-Bu₂Fl)(Cp-SiMe₂-n-Bu)ZrCl₂ (M5Bu), the activity of M6 of 655 kg PE/mmol MCN/h is over 3 times (3 x) higher than the activity of M5Bu of 205 kg PE/mmol MCN/h. Further upon replacing the n-butyl group in M5Bu with the norbornyl group to provide M6, the catalyst CIE actually increased from 0.045 for M5Bu to 0.051 for M6, to afford a lower density polymer for M6 (0.9284 g/cc) versus M5Bu (0.9312 g/cc). Although the Short Chain Branching frequency (SCBf) in M6 polyethylene was greater than the M5Bu polyethylene, the Long Chain Branching frequency (abbreviated LCBf or fLCB) was lower in M6 (JC-α, 190° C.=2.4) than in M5Bu (JC-α, 190° C.=9.9). Both catalysts afforded polymers with positive SCB (d85-d15) slopes (0.7 for M5Bu and 0.47 for M6), the latter perhaps diminished by the broader Mw/Mn in M6 (3.27 versus 3.04 for M5Bu).

With respect to the metallocene ligands Cp-SiMe₂R themselves, it is surprising that there appeared to be no straightforward explanations for the trends or lack thereof in catalyst activity, CIE, LCBf, and the like. For example, for the catalyst series Ph₂C(2,7-t-Bu₂Fl)(Cp-SiMe₂R)ZrCl₂, wherein R is Me (CM6, Example 12), Et (M1, Example 22), n-Pr (M3, Example 28), n-Bu (M5Bu, Example 32), and 2-norbornyl (M6, Example 33), are characterized by metallocene activities (kg PE/mmol MCN/h) of 334 (Me), 426 (Et), 352 (n-Pr), 205 (n-Bu), and 655 (2-norbornyl), respectively.

Comparative Example 34 employing (cyclopenta-1,1-diyl)(2,7-t-Bu₂Fl)(Cp)ZrCl₂ (CM8) which contains no silyl substituent on the cyclopentadienyl ring and is a comparative metallocene to Examples 36, 35, 37, and 38, which also contain a single carbon-atom bridge that is part of a cyclopenta-1,1-diyl ring. As with other comparative catalysts lacking a Cp-silyl substituent, for example Me₂C(2,7-t-Bu₂Fl)(Cp)ZrCl₂ (CM3, Example 8) and Ph₂C(2,7-t-Bu₂Fl)(Cp)ZrCl₂ (CM4, Example 9, this CM8 cyclopenta-1,1-diyl-bridged metallocene afforded only a modest activity of 57 kg PE/mmol MCN/h. The CM3 catalyst and the CM4 catalyst exhibited activities of 252 kg PE/mmol MCN/h and 97 kg PE/mmol MCN/h, respectively.

The polyethylene prepared using a comparative metallocene absent any trihydrocarbyl silyl group, (cyclopenta-1,1-diyl)(2,7-t-Bu₂Fl)(Cp)ZrCl₂ (CM8, Example 34), contained too high a concentration of long chain branches (LCB) to be useful for most blown film applications (JC-α, 190° C.=49.7). This LCB frequency for CM8 can be compared to the JC-α, 190° C.=44.8 for the CM4 catalyst of Example 9. The CM8 cyclopenta-1,1-diyl-bridged metallocene polymer also exhibited a narrow aTREF (broadness is 3.2) with a normalized peak height of 20.0, reminiscent of the polyethylenes produced using Ph₂C(Fl)(Cp-SiMe₂Allyl)ZrCl₂ (CM7) in Examples 26 and 27 which exhibited single aTREF peaks with normalized peak heights of 20.9 and 22.1, respectively.

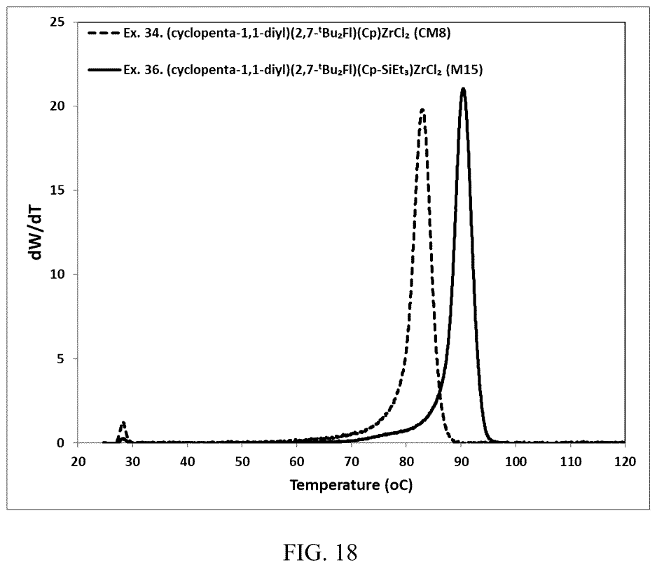

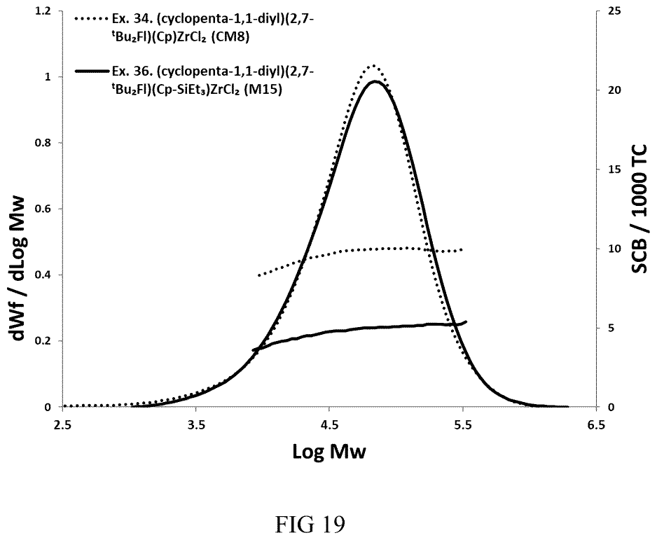

These CM8 data are consistent with a similarly homogeneous SCBf and composition, only showing different peak temperatures. The lowest peak temperature of these three examples is recorded in the Example 34 CM8 polymer due to the higher CIE of 0.155 for CM8, as compared with the CM7 CIE values for Examples 26 and 27 of 0.074 and 0.062, respectively. An apparent, relatively homogeneous polymer composition, as implied by a narrowly shaped aTREF trace and high normalized peak height of CM8, is a common trait among the inventive cyclopenta-1,1-diyl-bridged metallocenes M15, M16, and M18 disclosed here. See Table 4 and FIG. 18. For example, FIG. 18 compares the aTREF scans for the polyethylenes produced using (cyclopenta-1,1-diyl)(2,7-t-Bu₂Fl)(Cp)ZrCl₂ (CM8, Example 34) versus the polyethylene produced using using (cyclopenta-1,1-diyl)(2,7-t-Bu₂Fl)(Cp-SiEt₃)ZrCl₂ (M15, Example 36). FIG. 19 illustrates GPC-IR Molecular Weight Distribution (MWD) scans for the same poly(ethylene-co-1-hexene) polymers of FIG. 18, produced using CM8 (comparative Example 34) and M15 (Example 36), along with the SCBD.

Example 35 using (cyclopenta-1,1-diyl)(Fl)(Cp-SiEt₃)ZrCl₂ (M16) afforded a polymer with the shortest aTREF normalized peak height of those containing a cyclopenta-1,1-diyl bridge of (normalized height is 13.1) at a temp of 89° C. The M16 overall CIE was 0.085, compared with the CIE of 0.155 for the unsubstituted cyclopentadienyl control catalyst (cyclopenta-1,1-diyl)(2,7-t-Bu₂Fl)(Cp)ZrCl₂ (CM8, Example 34). However, lower CIE is compensated for by the greater than six-fold activity of (cyclopenta-1,1-diyl)(Fl)(Cp-SiEt₃)ZrCl₂ (M16, Example 35) of 361 kg PE/mmol MCN/h versus an activity of 57 kg PE/mmol MCN/h for the CM8 polymerization. Therefore, while not theory bound, it appears that at a nominal 1.2 Melt Index and 0.922 g/cc density, it appears that the triethylsilyl substitution of Cp-SiEt₃ broadens the left (low temperature) side of the aTREF trace, representing a higher SCBf. The SiEt₃ group also appears to reduce LCBf by almost 8-fold in (cyclopenta-1,1-diyl)(Fl)(Cp-SiEt₃)ZrCl₂ (M16) where JC-α, 190° C.=6.5, as compared to comparative metallocene (cyclopenta-1,1-diyl)(2,7-t-Bu₂Fl)(Cp)ZrCl₂ (CM8) where JC-α, 190° C.=49.7, but at a 40% lower CIE.

Inventive Example 36 using (cyclopenta-1,1-diyl)(2,7-t-Bu₂Fl)(Cp-SiEt₃)ZrCl₂ (M15) containing a t-butyl-substituted fluorenyl group and a Cp-SiEt₃ group and provides a CIE of 0.067, compared with the CIE of 0.085 for the (cyclopenta-1,1-diyl)(Fl)(Cp-SiEt₃)ZrCl₂ (M16) polymer (Example 35). Surprisingly, the M15 CIE of 0.067 is significantly less than the Me₂C(2,7-t-Bu₂Fl)(Cp-SiEt₃)ZrCl₂ (M10) CIE of 0.127 (Example 14). The M15 polymer also displays a narrow aTREF trace with a single peak height at 90° C. of 21.1, as compared with the broader aTREF scan for Example 35 using M16 (peak height at 89° C. of 13.1). Notably, the M15 polymer peak is much more symmetrical than the M16 polymer peak.

The cyclopenta-1,1-diyl bridged M15 catalyst is also significantly less active (167 kg PE/mmol MCN/h) than its Me₂C-bridged analog Me₂C(2,7-t-Bu₂Fl)(Cp-SiEt₃)ZrCl₂ (M10) (536 kg PE/mmol MCN/h). The M15 aTREF composition narrowed dramatically from that in M10, from an aTREF broadness of 8.8 (normalized peak height 6.6 at 81° C.) in M10 to an aTREF broadness of 2.9 (normalized peak height 21.1 at 90° C.) in M15. Unexpectedly, the molecular weight distribution in the M15 polymer was in fact broader (Mw/Mn=2.9) than that of the M10 polymer (Mw/Mn=2.3), but M15 exhibited an SCBf (d85-d15) slope of 0.81 versus the significantly flatter SCBf (d85-d15) slope of M10 of 0.01.

This is consistent with the dual site nature of the inventive metallocenes, generally, and that changing from the M10 propan-2,2-diyl bridge (Me₂C) to the M15 cyclopenta-1,1-diyl bridge changed the selectivity from a predominantly anti to almost exclusively syn site, in which the anti site CIE is greater than the syn site CIE and is more active than the syn site. (Again, the designation of a catalytic site as “syn” or “anti” are arbitrary labels to distinguish the sites.) Therefore, these data support the general observation that when an aTREF normalized peak height is ≥16.5, the metallocene activity is lower than 205 kg PE/mmol MCN/h. Alternatively, when the aTREF broadness is ≤4.4, the metallocene activity may be less than 205 kg PE/mmol MCN/h, and when the aTREF broadness is ≤3.2, the metallocene activity can be less than 167 kg PE/mmol MCN/h.

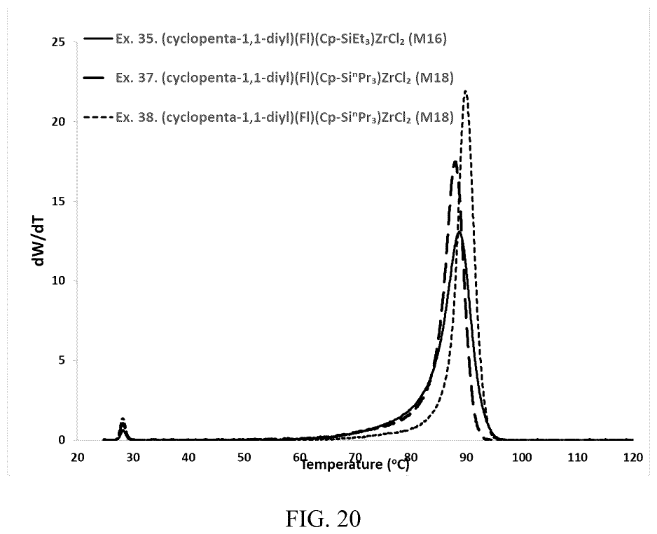

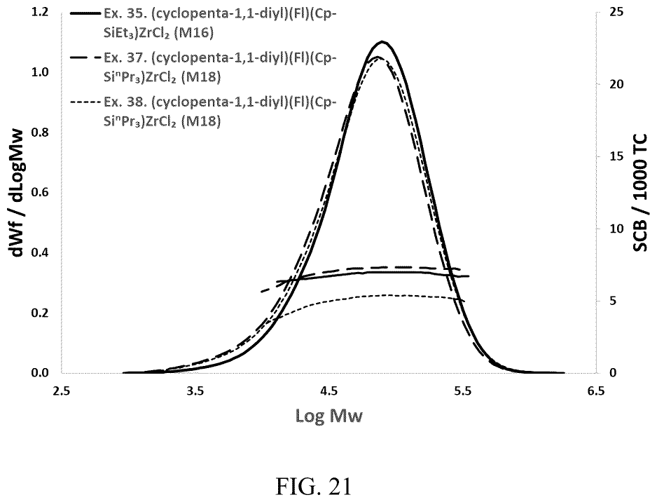

Additional cyclopenta-1,1-diyl bridged catalyst results are reported in Tables 2-4 for Examples 37 and 38 with (cyclopenta-1,1-diyl)(Fl)(Cp-Si-n-Pr₃)ZrCl₂ (M18) compared with Example 35 using cyclopenta-1,1-diyl)(Fl)(Cp-SiEt₃)ZrCl₂ (M16). The aTREF and GPC IR data are presented in FIG. 20 and FIG. 21, respectively. Polymerization with the Cp-Si-n-Pr₃-substituted metallocene M18 in Example 37 was run under the same conditions used in its Cp-SiEt₃-substituted analog of Example 35 (cyclopenta-1,1-diyl)(Fl)(Cp-SiEt₃)ZrCl₂ (M16), except that the H₂/C₂ ratio was increased by 24 percent in the Example 37 run. As compared to the M16 polymerization of Example 35, the M18 Example 37 polymer provided a similar melt index (1.3 for M18 and 1.2 for M16), a slightly higher density (0.9253 for M18 versus 0.9215 for M16) which is likely a consequence of the slightly lower CIE (0.082 for M18 versus 0.085 for M16), but a 71% reduction in catalyst activity, from 361 kg PE/mmol MCN/h for M16 to 105 kg PE/mmol MCN/h for M18. The reduced activity for M18 in Example 37 was accompanied by an increase in the normalized height of its aTREF peak to 17.6 at 88° C. in M18 from 13.1 at 89° C. in M16, and a greater than 3-fold reduction in LCBf from JC-α, 190° C.=6.5 for the Cp-SiEt₃ M16 catalyst to JC-α, 190° C.=2.0 for the Si-n-Pr₃ M18 catalyst. While not bound by any particular theory, it is believed that the greater M18 aTREF peak height, despite the higher density (0.9253 in M18 versus 0.9215 for M16) may be reflective of a more uniform SCBf obtained from the Si-n-Pr₃ M18 catalyst.

Inventive Example 38 also using (cyclopenta-1,1-diyl)(Fl)(Cp-Si-n-Pr₃)ZrCl₂ (M18) and repeated Example 37, with a slight decrease in the 1-hexene [C₆] and H₂/C₂ ratio. Decreasing the 1-hexene concentration raised the polymer density from 0.9253 g/cc (Example 37) to 0.9283 g/cc (Example 38), and decreasing the H₂/C₂ ratio in Example 38 afforded a slightly lower melt index (MI) polymer having MI=1.1 (versus MI=1.3 in Example 37) and an increase in polymer Mn. Changes in the polymer properties from 37 to Example 38 such as polydispersity, SCB d85-d15 SCB slope, and Long Chain Branching frequency LCBf were fairly small.

At first glance the aTREF shapes of Example 37 and Example 38 appear similar, with only a single, rather sharp peak. However, the higher temperature Example 38 aTREF peak occurred at 90° C. reflect the higher density and a lower overall CIE. The Example 38 normalized aTREF peak height increased to 21.9 (from 17.6 in Example 37), accompanied by a lower aTREF broadness of 2.9 (from 4.3 for Example 37). Lastly, the Example 38 polymer exhibited the second highest SDBI of 22.15° C., outside of the SDBI temperature for comparative metallocene (n-BuCp)₂ZrCl₂ (CM1) of 25.84° C. (Example 4).

It is thought that these differences may signify a more homogeneous composition in Example 38 than in the 37 polymer. Within the context of considering dual active sites, with different activity responses to [H₂] and/or 1-hexene [C₆] concentrations, it may be possible that the higher-CIE, anti site may contribute less to the compositional mass in Example 38 than in 37, consistent with the more symmetrical peak shape in Example 38 and perhaps reflecting the lesser contribution from a higher CIE site in Example 38 than in 37. While not bound by any theory, this difference would be consistent with the lower overall activity and lower overall CIE in Example 38 as compared with 37.

### Examples

The foregoing description is intended to illustrate and not limit the scope of the present disclosure, which is further illustrated by the following examples. The examples are not to be construed as imposing limitations upon the scope of the disclosure. Rather, it is to be understood that recourse can be had to various other embodiments, aspects, modifications, and equivalents thereof which, in view of the written description, may suggest themselves to the person of ordinary skill in the art without departing from the spirit of the present invention or the scope of the appended claims. Therefore, the following examples are put forth to provide those skilled in the art with a more detailed disclosure and description.

### General Considerations

All anhydrous solvents were purchased from Sigma-Aldrich and were degassed and dried over molecular sieves prior to use. Deuterated solvents were purchased from Cambridge Isotope Laboratories and dried over molecular sieves prior to use. n-Butyllithium solution (2.5 M in hexane) was purchased from Sigma-Aldrich. Zirconium tetrachloride was purchased from Alfa-Aeser. Hafnium tetrachloride was purchased from Sigma-Aldrich. Triethylsilyl trifluoromethanesulfonate, triisopropylchlorosilane, n-propyldimethylchlorosilane, ethyldimethylchlorosilane, n-butyldimethylchlorosilane, dimethyl(allyl)chlorosilane, and (5-bicyclo[2.2.1]heptyl)dimethylchlorosilane were obtained from Gelest and were used as received. Bis(n-butylcyclopentadienyl)zirconium dichloride (n-BuCp)₂ZrCl₂ (CM1) was purchased from Boulder Scientific Company. The metallocene Me(3-buten-1-yl)C(2,7-t-Bu₂Fl)(Cp)ZrCl₂ (CM9) was prepared according to the method set out in U.S. Pat. No. 7,064,225. The use of endo and exo designations in this application applies only to the 2-norbornyl metallocenes and not to the comparative metallocene Me(3-buten-1-yl)C(2,7-t-Bu₂Fl)(Cp)ZrCl₂.

The following standard abbreviations are used. THF, Tetrahydrofuran; Na₂SO₄, Sodium sulfate; n-BuLi, n-Butyllithium; ZrCl₄(THF)₂, zirconium(IV) chloride tetrahydrofuran complex; ZrCl₄, zirconium tetrachloride; HfCl₄, hafnium tetrachloride; (n-BuCp)₂ZrCl₂, bis(n-butylcyclopentadienyl) zirconium dichloride; CDCl₃, deuterated chloroform.

### Catalyst and Polymer Characterization

### General Testing Procedures

Reaction products were analyzed by ¹H NMR spectroscopy using a 400 MHz Bruker spectrometer. Chemical shifts are reported in ppm and referenced to residual solvent resonance peaks.

Melt index (MI, g/10 min) was determined in accordance with ASTM D1238 condition F at 190° C. with a 2,160-gram weight.

High load melt index (HLMI, g/10 min) was determined in accordance with ASTM D1238 condition E at 190° C. with a 21,600-gram weight.

Polymer density was determined in grams per cubic centimeter (g/cc) on a compression molded sample, cooled at about 15° C. per hour, and conditioned for about 40 hours at room temperature in accordance with ASTM D1505 and ASTM D1928, procedure C.

The GPC-IR (gel permeation chromatography, Infrared detection) data were collected on samples in TCB (1,2,4-tricholorobenzene), and the aTREF (analytical Temperature Rising Elution Fractionation) scans were collected using samples in o-DCB (ortho- or 1,2-dichlorobenzene).

### Molecular Weight and Molecular Weight Distributions

Molecular weight and molecular weight distributions were obtained using a PL-GPC 220 (Polymer Labs, UK) system equipped with a differential refractive index detector and three 7.5 mm×300 mm 20 um Mixed A-LS columns (Polymer Labs) running at 145° C. The flow rate of the mobile phase, 1,2,4-trichlorobenzene (TCB) containing 0.5 g/L 2,6-di-t-butyl-4-methylphenol (BHT), was set at 1 mL/min and the concentration of polymer solutions was generally kept in the range of 1.0-1.5 mg/mL, depending on the molecular weights. Sample preparation was conducted at 150° C. for 4 h with occasional and gentle agitation before the solutions being transferred to sample vials for injection. To minimize unbalanced solvent peak, solvent with the same composition as the mobile phase was used for solution preparation. The integral calibration method was employed to deduce molecular weights and molecular weight distributions using a Chevron Phillips Chemicals Company's broad linear polyethylene, Marlex® BHB5003, as the broad standard. The integral table of the broad standard was pre-determined in a separate experiment with SEC-MALS.

### Long Chain Branching (LCB) Determination

Long-chain branching (LCB) was assessed in terms of the parameter JC-α, determined from zero-shear viscosity η₀ and weight-average molecular weight M_{w} (J. Janzen, R. H. Colby, 1999, J. Mol. Structure 485-486: 569-584) with a molecular weight correction (Qing Yang, Michael D. Jensen, Max P. McDaniel, 2010. Macromolecules. 43: 8836-8852) according to the theoretical contribution of the molecular weight distribution (MWD) to zero-shear viscosity per Wallace Yau (Wallace Yau, 2007. Polymer 48: 2362-2370). Specifically, the η₀ is calculated from the dynamic viscosity η*(ω) data based on the following Carreau-Yasuda model (R. B. Bird, R. C. Armstrong, O. Hassager, 1987. Dynamics of Polymeric Liquids, Vol. 1, Fluid Mechanics; John Wiley & Sons: New York.) in the following form:

$$η * ( ω ) = {η}_{0} / {( 1 + {( τω )}^{a} )}^{( 1 - n ) / a} ,$$

where the frequency ω is in unit of rad/sec, τ is the characteristics time, and a is the Dispersion Parameter. The parameter n is fixed at 0.1818 when solving η₀, τ and a with the model. The LCB measure JC-α is then solved from the Equations 2 and 9-12 of Janzen and Colby 1999 J. Mol. Structure reference, based on η₀ and M_{w}(M_{z}/M_{w})\hat{ }x, where M_{z} is the z-average molecular weight and x is the Yau exponent for MWD correction determined from a range of linear polymers of various molecular weights made from the same bench reactors. Model parameters are used as in Table 2 in the original Janzen-Colby reference.

The dynamic viscosity data are measured by the frequency sweep experiments run on TA Instruments' ARES G2 rheometer with the steel parallel plates of 25 m diameter at 190° C. in nitrogen environment. The sample gap is 1.0 mm. Each test is run from 100 to 0.01 rad/sec at 5 points per decade with the strain amplitude of 5%. When needed, the tests are run at lower temperatures in some cases and the data are shifted to 190° C. for calculating η₀ and then JC-α.

The JC-α as the LCB thus determined is the number of branches per 10\hat{ }6TC (10⁶ total carbon atoms) based on the assumption that the LCB topology follows the Carley-tree model and the only tertiary branching. As the Janzen-Colby model predicts an increase in η₀ up to a maximum value at a JC-a level on the order of 100 branches per 10\hat{ }6 (10⁶) CH2 units, the JC-α measure properly reflects the branching architecture where there is on average less than one branch per molecule, which is the case for majority of commercial polyolefin other than the LDPE polymers. At higher branching level, the higher value of the two possible solutions in the JC equations is taken as the value of JC-α based on the comparison between the rheology data and the values of melt index or high-load melt index. The model parameters are not adjusted for the Janzen-Colby model unless otherwise stated.

### Short Chain Branch Distribution

The short chain branch (or “branching”) distribution (SCBD) data to determine the short chain branch content of a polymer were obtained using a SEC-FTIR high temperature heated flow cell (Polymer Laboratories) as reported in P. J. DesLauriers, D. C. Rohlfing, and E. T. Hsieh, Polymer, 2002, 43, 159, which is incorporated herein by reference. Short chain branching content and SCBD were determined using the intensity ratio of CH₃ (I_{CH3}) to CH₂ (I_{CH2}) in combination with a calibration curve. The calibration curve was a plot of SCB content as a function of the intensity ratio of I_{CH3}/I_{CH2}. To obtain a calibration curve, a group of polyethylene resin standards of known SCB levels were used. All the SCB standard polymers have known SCB levels as determined by ¹³C NMR. The procedure used herein for calculating GPC-IR hexene in PE (wt %) is described in U.S. Pat. No. 10,590,212, which is incorporated herein by reference in pertinent part.

The SCBD of the polymers disclosed herein also may be characterized by comparing the number of SCB per 1000 total carbon atoms of the polymer at d85 to the number of SCB per 1000 total carbon atoms of the polymer at d15 and determining the slope of the number of SCB per 1000 total carbon atoms from d85 to d15. Thus, d85 is the molecular weight at which 85% of the polymer by weight has higher molecular weight, and d15 is the molecular weight at which 15% of the polymer by weight has higher molecular weight. The SCB distribution (SCBD) profile can be measured by the slope of the SCB per 1000 total carbon atoms over the range from d85 to d15.

### Absolute Molecular Weight as Determined by Light Scattering

Molecular weight data were determined using SEC-MALS, which combines the methods of size exclusion chromatography (SEC) with multi-angle light scattering (MALS) detection. A DAWN EOS 18-angle light scattering photometer (Wyatt Technology, Santa Barbara, CA) was attached to a PL-210 SEC system (Polymer Labs, UK) or a Waters 150 CV Plus system (Milford, MA) through a hot transfer line, thermally controlled at the same temperature as the SEC columns and its differential refractive index (DRI) detector (145° C.). At a flow rate setting of 0.7 mL/min, the mobile phase, 1,2,4-trichlorobenzene (TCB), was eluted through three, 7.5 mm×300 mm, 20 μm Mixed A-LS columns (Polymer Labs). Polyethylene (PE) solutions with concentrations of ˜1.2 mg/mL, depending on samples, were prepared at 150° C. for 4 h before being transferred to the SEC injection vials sitting in a carousel heated at 145° C. For polymers of higher molecular weight, longer heating times were necessary in order to obtain true homogeneous solutions. In addition to acquiring a concentration chromatogram, seventeen light-scattering chromatograms at different angles were also acquired for each injection using Wyatt's Astra® software. At each chromatographic slice, both the absolute molecular weight (M) and root mean square (RMS) radius, also known as radius of gyration (R_{g}) were obtained from a Debye plot's intercept and slope, respectively. Methods for this process are detailed in Wyatt, P. J., Anal. Chim. Acta, 272, 1 (1993), which is hereby incorporated herein by reference in its entirety. The linear PE control employed was a linear, high-density broad MWD polyethylene sample (Chevron Phillips Chemical Co.). The weight average molecular weight (M_{w}), number average molecular weight (Mₙ), z-average molecular weight (M_{z}) and molecular weight distribution (Mw/Mn) were computed from this data and are presented in various Tables.

The Zimm-Stockmayer approach was used to determine the amount of LCB in ethylene polymers. Since SEC-MALS measures M and R_{g} at each slice of a chromatogram simultaneously, the branching indices, g_{M}, as a function of M could be determined at each slice directly by determining the ratio of the mean square R_{g} of branched molecules to that of linear ones, at the same M, as shown in equation 1:

$${g}_{M} = \frac{{〈 {R}_{g} 〉}_{br}^{2}}{{〈 {R}_{g} 〉}_{lin}^{2}} \qquad ( 1 )$$

where the subscripts br and lin represent branched and linear polymers, respectively.

At a given g_{M}, the weight-averaged number of LCB per molecule (B_{3w}) was computed using Zimm-Stockmayer's equation, shown in equation 2, where the branches were assumed to be trifunctional, or Y-shaped.

$${g}_{M} = \frac{6}{{B}_{3 w}} \{ \frac{1}{2} {( \frac{2 + {B}_{3 w}}{{B}_{3 w}} )}^{1 / 2} ln [ \frac{{( 2 + {B}_{3 w} )}^{1 / 2} + {( {B}_{3 w} )}^{1 / 2}}{{( 2 + {B}_{3 w} )}^{1 / 2} - {( {B}_{3 w} )}^{1 / 2}} ] - 1 \} \qquad ( 2 )$$

LCB frequency (LCB_{M}_{ᵢ}),the number of LCB per 1 000 C, of the i^{th} slice was then computed straightforwardly using equation 3:

$${LCB}_{Mi} = 1000 * 14 * {B}_{3 w} / {M}_{i} \qquad ( 3 )$$

where Mᵢ is the MW of the i^{th} slice. The LCB content across the molecular weight distribution (MWD) was thus established for a full polymer.

A Quantachrome Autosorb-6 Nitrogen Pore Size Distribution Instrument was used to determine specific surface area (“surface area”) and specific pore volume (“pore volume”). This instrument was acquired from the Quantachrome Corporation, Syosset, N.Y.

Analytical Temperature Rising Elution Fractionation (aTREF)

The Analytical Temperature Rising Elution Fractionation (aTREF) measurements were carried out on a PolyChar TREF 200+ instrument. A 40 mg polymer sample and 20 mL of 1,2-dichlorobenzene were sequentially charged into the vessel to dissolve the polymer at 150° C. An aliquot of the resulting polymer solution was then loaded on the column and stabilized at 95° C. for 45 min and then cooled at 0.5° C./min from 95° C. to 35° C. Afterward, the elution began using a 0.5 mL/min flow rate and heating rate at 1° C./min up to 140° C. The concentration of the eluted species was measured using the instrument's Polymer Char's IR4 detector. Soluble fraction percentage (%) is defined as any resin in solution below 35° C. to which the solution is cooled.

The aTREF broadness was determined as the difference of the elution temperature at which 25% and the temperature at which 75% of the polymer elutes. Normalized heights are reported using a plot of dW/dT versus T, with the area under the curve normalized to 100.

### Solubility Distribution Breadth Index (SDBI)

The solubility distribution breadth index (SDBI) was used as a measure of the breadth of the solubility distribution curve for a particular polymer. SDBI can be calculated by the data obtained from aTREF. The procedure used herein for calculating SDBI was described in U.S. Pat. No. 5,322,728, which is incorporated herein by reference in pertinent part.

### Ligand and Metallocene Synthesis

The following ligands illustrated below were prepared according to literature methods and were used as precursors for the silyl-substituted ligands of this disclosure. The ligand precursors 1-cyclopentadienyl-1-(fluoren-9-yl)-1,1-diphenyl-methane (LP1) and 1-cyclopentadienyl-1-(2,7-di-tert-butylfluoren-9-yl)-1,1-diphenyl-methane (LP2) were prepared by the method described in U.S. Pat. No. 7,468,452(B1), which is incorporated herein by reference. The ligand precursors 1-cyclopentadienyl-1-(fluoren-9-yl)-1,1-dimethyl-methane (LP3) and 1-cyclopentadienyl-1-(2,7-di-tert-butylfluoren-9-yl)-1,1-dimethyl-methane (LP4) were prepared by the method described in Ewen, J. A.; Jones, R. L.; Razavi, A.; Ferrara, J. D. J. Am. Chem. Soc. 1988, 110, 6255, which is incorporated herein by reference. Each of these ligand precursors LP1, LP2, LP3, and LP4 is a mixture of isomers, and the structure of one isomer is shown below. As will be recognized by those skilled in the art, the other two isomers not depicted consist of tautomers or double bond isomers of the monosubstituted cyclopentadienyl moiety, and that these isomers may be obtained as mixtures in various ratios to one another.

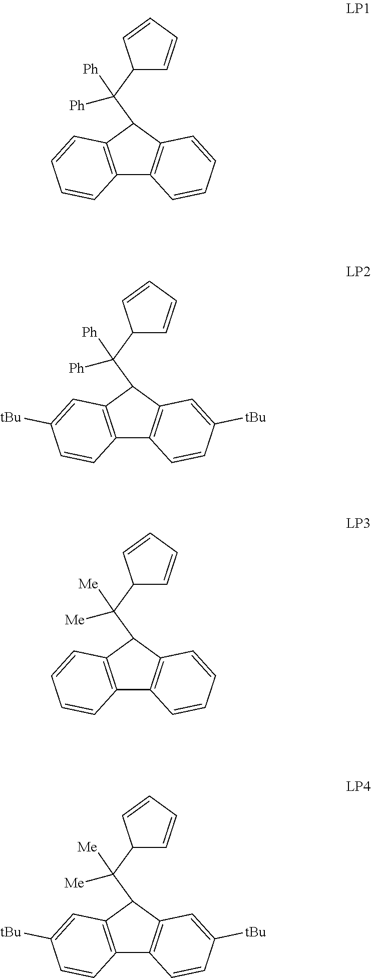

The synthetic methods for preparing the following ligand precursors LP5 and LP6 are presented in this disclosure. Each of these ligand precursors LP5 and LP6 is a mixture of isomers, and the structure of one isomer is shown below.

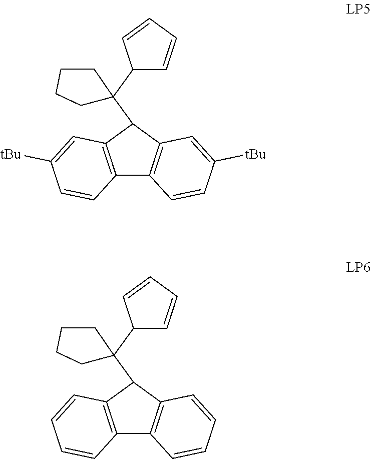

Synthesis of 6,6-Cyclopentylfulvene (Fl). The structure of F1 is illustrated.

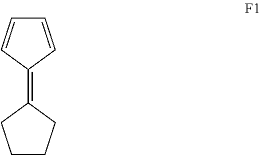

Freshly distilled cyclopentadiene (11.91 g, 180 mmol) was dissolved in a mixture of methanol (80 mL) and H₂O (20 mL) at 0° C. Cyclopentanone (12.62 g, 150 mmol) was added in one portion. Pyrrolidine (712 mg, 10 mmol) was added to the reaction mixture dropwise over a course of 15 minutes. The mixture was slowly warmed up to room temperature and stirred at room temperature for 3 hours. The crude product was extracted with hexane and the solution was dried over Na₂SO₄. The solution was filtered, and hexane was removed from the filtrate under vacuum. 6,6-Cyclopentylfulvene (Fl) (15.0 g, 114 mmol) was obtained as orange liquid.

Synthesis of 9-([1,1′-bi(cyclopentane)]-2,4′-dien-1-yl)-2,7-di-tert-butyl-9H-fluorene (LP5). 2,7-Di-tert-butylfluorene (2.78 g, 10.0 mmol) was dissolved in anhydrous THF (10 mL) under a nitrogen atmosphere. The solution was cooled to 0° C., and n-BuLi (4.0 mL, 2.5 M in hexane) was added dropwise. The resulting mixture was warmed up to room temperature and stirred for 2 hours. The mixture was then cooled to 0° C. 6,6-Cyclopentylfulvene (Fl) (1.32 g, 10.0 mmol) was added dropwise, and the mixture was stirred at room temperature overnight. Methanol (10 mL) was then added to the reaction mixture. This mixture was stirred for 1 hour, extracted with hexane, and filtered. Organic solvents were removed under reduced pressure to afford the crude product. LP5 (2.68 g, 0.65 mmol) was obtained as white powders after recrystallization from methanol.

Synthesis of 9-([1,1′-bi(cyclopentane)]-2′,4′-dien-1-yl)-9H-fluorene (LP6). Fluorene (3.32 g, 20.0 mmol) was dissolved in anhydrous THF (20 mL) under a nitrogen atmosphere. The solution was cooled to 0° C., and n-BuLi (8.0 mL, 2.5 M in hexane) was added dropwise. The mixture was warmed up to room temperature and stirred for 2 hours. The mixture was then cooled to 0° C. 6,6-Cyclopentylfulvene (Fl) (2.64 g, 20.0 mmol) was added dropwise, and this mixture was stirred at room temperature overnight. Methanol (20 mL) was added to the reaction mixture, and the mixture was stirred for 1 hour, extracted with hexane, and filtered. Organic solvents were removed under reduced pressure to afford the crude product. LP6 (2.85 g, 9.56 mmol) was obtained as white powders after recrystallization in methanol.

The above-described ligand precursors LP1-LP6 were used to synthesis the ligands and metallocenes as set out below.

As understood by the skilled artisan, there may be more than one name for a compound, and at least one descriptive name is presented for the compounds shown below. In some cases, more than one name is presented. The names presented may be the name for the isomer shown or a related isomer, or it may be a more generic name encompassing multiple isomers. As will be recognized by those skilled in the art, the other four isomers not depicted include tautomers or double bond isomers of the disubstituted cyclopentadienyl moiety, and these isomers may be obtained as mixtures in various ratios.

Synthesis of (((2,7-di-tert-butyl-9H-fluoren-9-yl)diphenylmethyl)cyclopenta-dienyl)dimethylethylsilane (L1). The (L1) ligand is a mixture of isomers, and the structure of one isomer is shown. This ligand may be abbreviated or written as Ph₂C(2,7-t-Bu₂FlH)(CpH-SiMe₂Et). An alternative name for L1 is (4-((2,7-di-tert-butyl-9H-fluoren-9-yl)diphenylmethyl)cyclopenta-1,3-dien-1-yl)(ethyl)dimethylsilane.

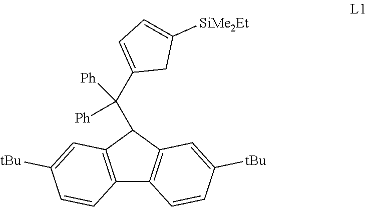

To a solution of 1-cyclopentadienyl-1-(2,7-di-tert-butylfluoren-9-yl)-1,1-diphenyl-methane (LP2) (868 mg, 1.71 mmol) in anhydrous THF (10 mL) was added n-BuLi (0.75 mL, 2.5 M in hexane, 1.71 mmol) at −95° C. and the color of the solution turned orange. The mixture was stirred for 1 h before a solution of ethyldimethylchlorosilane (251 mg, 2.0 mmol) in THF (10 mL) was added at −95° C. The mixture was slowly allowed to warm to room temperature and stirred overnight. The reaction was quenched with saturated ammonium chloride aqueous solutions. THF was evaporated and the product was extracted with dichloromethane and dried over Na₂SO₄. The mixture was filtered and concentrated to yield red viscous oil. The product was purified by passing the oil through silica gel with hexane as the eluent. Organic solvent was removed under vacuum. The product was obtained as a yellow powder (860 mg, 1.45 mmol, yield: 85%).

Synthesis of Ph₂C(2,7-t-Bu₂Fl)(Cp-SiMe₂Et)ZrCl₂ (M1). To a solution of L1 (774 mg, 1.30 mmol) in anhydrous diethyl ether (10 mL) was added n-BuLi (1.0 mL, 2.5 M in hexane, 2.60 mmol) at −35° C. The reaction was stirred at room temperature for 24 hours, during which time a large amount of orange precipitate formed. The resulting suspension was treated with ZrCl₄ (303 mg, 1.30 mmol) −35° C. The solution turned dark upon addition of ZrCl₄ and bright pink precipitates slowly formed. The mixture was stirred at room temperature for another 24 hours and the volatiles were removed under vacuum. The residues were dissolved in anhydrous dichloromethane and the solution was filtered through Celite®. To the filtered solution 2 mL of anhydrous diethyl ether was added. This solution was concentrated to minimum and filtered, yielding bright pink solids (507 mg, 0.68 mmol, yield: 52%). ¹H NMR (400 MHz, CDCl₃) δ 8.06-7.94 (m, 4H), 7.87 (d, J=8.0 Hz, 2H), 7.64-7.56 (m, 2H), 7.51-7.44 (m, 2H), 7.37-7.32 (m, 2H), 7.31-7.27 (m, 2H), 6.40 (t, J=2.8 Hz, 1H), 6.32 (br s, 1H), 6.28 (br s, 1H), 5.86 (t, J=2.8 Hz, 1H), 5.62 (t, J=2.8 Hz, 1H), 1.03 (s, 18H), 0.90 (t, J=7.6 Hz, 3H), 0.61 (q, J=7.6 Hz, 2H), 0.13 (s, 3H), 0.07 (s, 3H).

Synthesis of (((9H-fluoren-9-yl)diphenylmethyl)cyclopentadienyl)ethyldimethyl-silane (L2). The L2 ligand is a mixture of isomers, and the structure of one isomer is shown. This ligand may be abbreviated or written as Ph₂C(FlH)(CpH-SiMe₂Et) and may also be named (4-((9H-fluoren-9-yl)diphenylmethyl)cyclopenta-1,3-dien-1-yl)(ethyl)dimethylsilane.

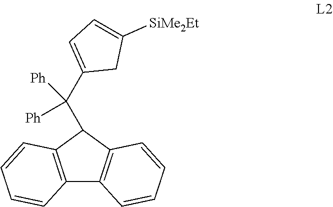

To a solution of 1-cyclopentadienyl-1-(fluoren-9-yl)-1,1-diphenyl-methane (LP1) (921 mg, 2.32 mmol) in anhydrous THF (10 mL) was added n-BuLi (0.9 mL, 2.5 M in hexane, 2.32 mmol) at −95 C. The mixture was stirred for 1 h min before a solution of ethyldimethylchlorosilane (285 mg, 2.78 mmol) in THF (10 mL) was added at −95° C. The mixture was slowly allowed to warm to room temperature and stirred overnight. The reaction was quenched with saturated ammonium chloride aqueous solutions. THF was evaporated and the product was extracted with dichloromethane and dried over Na₂SO₄. The mixture was filtered and concentrated to yield red viscous oil. The product was purified by passing the oil through silica gel with hexane/dichloromethane (3:1) as the eluent. Organic solvent was removed under vacuum. The product was obtained as a yellow solid (556 mg, 1.14 mmol, yield: 49%).

Synthesis of Ph₂C(Fl)(Cp-SiMe₂Et)ZrCl₂ (M2). To a solution of L2 (556 mg, 1.14 mmol) in anhydrous diethyl ether (10 mL) was added n-BuLi (0.9 mL, 2.5 M in hexane, 2.3 mmol) at −35° C. The reaction was stirred at room temperature for 24 hours, and the resulting red solution was treated with ZrCl₄(THF)₂ (434 mg, 1.14 mmol) −35° C. The solution turned dark red upon addition of ZrCl₄(THF)₂ and bright pink precipitates slowly formed in the next hour. The mixture was stirred at room temperature for another 24 hours and the volatiles were removed under vacuum. The residues were dissolved in anhydrous dichloromethane and the solution was filtered through Celite®. To the filtered solution 2 mL of anhydrous Diethyl ether was added. This solution was concentrated to minimum and filtered, yielding bright pink solids (431 mg, 0.66 mmol, yield: 58%). ¹H NMR (400 MHz, CDCl₃) δ 8.24-8.09 (m, 2H), 7.99-7.91 (m, 2H), 7.90-7.79 (m, 2H), 7.61-7.54 (m, 2H), 7.50-7.39 (m, 2H), 7.39-7.27 (m, 4H), 7.08-6.91 (m, 2H), 6.45-6.36 (m, 3H), 6.00 (t, J=2.6 Hz, 1H), 5.68 (t, J=2.6 Hz, 1H), 0.90 (t, J=7.6 Hz, 3H), 0.63 (q, J=7.6 Hz, 2H), 0.14 (s, 3H), 0.09 (s, 3H).

Synthesis of (((2,7-di-tert-butyl-9H-fluoren-9-yl)diphenylmethyl)cyclopenta-dienyl)dimethyl-n-propylsilane (L3). The L3 ligand is a mixture of isomers, and the structure of one isomer is shown. This ligand may be abbreviated or written as Ph₂C(2,7-t-Bu₂FlH)(CpH-SiMe₂-n-Pr) and may also be named (4-((2,7-di-tert-butyl-9H-fluoren-9-yl)diphenylmethyl)cyclopenta-1,3-dien-1-yl)dimethyl(propyl)silane.

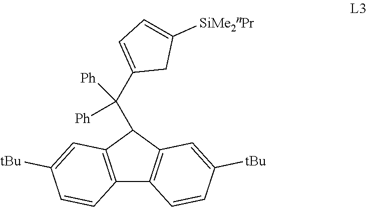

To a solution of 1-cyclopentadienyl-1-(2,7-di-tert-butylfluoren-9-yl)-1,1-diphenyl-methane (LP2) (1.0645 g, 2.1 mmol) in anhydrous THF (10 mL) was added n-BuLi (0.84 mL, 2.5 M in hexane, 2.1 mmol) at −95° C. The mixture was stirred for 30 min before a solution of n-propyldimethylchlorosilane (429 mg, 3.1 mmol) in THF (10 mL) was added at −95° C. The mixture was slowly allowed to warm to room temperature and stirred overnight. The reaction was quenched with saturated ammonium chloride aqueous solutions. THF was evaporated and the product was extracted with dichloromethane and dried over Na₂SO₄. The mixture was filtered and concentrated to yield red viscous oil. The product was purified by passing the oil through silica gel with hexane solvent as the eluent. Organic solvent was removed under vacuum. The product was obtained as a yellow powder (1.045 g, 1.79 mmol, yield: 82%).

Synthesis of Ph₂C(2,7-t-Bu₂Fl)(Cp-SiMe₂-n-Pr)ZrCl₂ (M3). To a solution of L3 (1.045 g, 1.72 mmol) in anhydrous diethyl ether (10 mL) was added n-BuLi (1.4 mL, 2.5 M in hexane, 1.72 mmol) at −35° C. The reaction was stirred at room temperature for 24 hours, during which time a large amount of orange precipitate formed. The resulting suspension was treated with ZrCl₄ (479 mg, 2.0 mmol) −35° C. The solution turned dark upon addition of ZrCl₄ and bright pink precipitates slowly form. The mixture was stirred at room temperature for another 24 hours and the volatiles were removed under vacuum. The residues were dissolved in anhydrous dichloromethane and the solution was filtered through Celite®. To the filtered solution 2 mL of anhydrous diethyl ether was added. This solution was concentrated to minimum and filtered, yielding bright pink solids (756 mg, 0.98 mmol, yield: 57%). ¹H NMR (400 MHz, CDCl₃) δ 8.08-7.93 (m, 4H), 7.87 (d, J=7.6 Hz, 2H), 7.64-7.59 (m, 2H), 7.54-7.40 (m, 2H), 7.35 (t, J=7.0, 2H), 7.31-7.26 (m, 2H), 6.40 (t, J=2.6 Hz, 1H), 6.32 (br s, 1H), 6.28 (br s, 1H), 5.86 (t, J=2.6 Hz, 1H), 5.62 (t, J=2.6 Hz, 1H), 1.38-1.24 (m, 2H), 1.04 (s, 18H), 0.91 (t, J=7.2 Hz, 3H), 0.73-0.54 (m, 2H), 0.14 (s, 3H), 0.08 (s, 3H).

Synthesis of (((9H-fluoren-9-yl)diphenylmethyl)cyclopentadienyl)dimethyl-n-propylsilane (L4). The L4 ligand is a mixture of isomers, and the structure of one isomer is shown. This ligand may be abbreviated or written as Ph₂C(FlH)(CpH-SiMe₂-n-Pr) and may be named (4-((9H-fluoren-9-yl)diphenylmethyl)cyclopenta-1,3-dien-1-yl)dimethyl(propyl)silane.

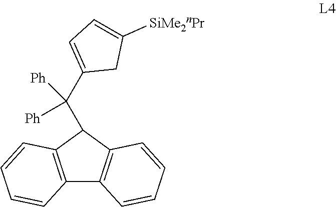

To a solution of 1-cyclopentadienyl-1-(fluoren-9-yl)-1,1-diphenyl-methane (LP1) (720 mg, 1.81 mmol) in anhydrous THF (10 mL) was added n-BuLi (0.7 mL, 2.5 M in hexane, 1.81 mmol) at −95° C. The mixture was stirred for 1 h before a solution of n-propyldimethylchlorosilane (611 mg, 2.0 mmol) in THF (10 mL) was added at −95° C. The mixture was slowly allowed to warm to room temperature and stirred overnight. The reaction was quenched with saturated ammonium chloride aqueous solutions. THF was evaporated and the product was extracted with dichloromethane and dried over Na₂SO₄. The mixture was filtered and concentrated to yield red viscous oil. The product was purified by passing the oil through silica gel with hexane/dichloromethane (3:1) as the eluent. Organic solvent was removed under vacuum. The product was obtained as a yellow solid (650 mg, 1.25 mmol, yield: 69%).

Synthesis of Ph₂C(Fl)(Cp-SiMe₂Pr)ZrCl₂ (M4). To a solution of L4 (689 mg, 1.39 mmol) in anhydrous diethyl ether (10 mL) was added n-BuLi (1.10 mL, 2.5 M in hexane, 2.7 mmol) at −35° C. The reaction was stirred at room temperature for 24 hours, and the resulting red solution was treated with ZrCl₄(THF)₂ (523 mg, 1.39 mmol) −35° C. The solution turned dark red upon addition of ZrCl₄(THF)₂ and bright pink precipitated slowly formed in the next hour. The mixture was stirred at room temperature for another 24 hours and the volatiles were removed under vacuum. The residues were dissolved in anhydrous dichloromethane and the solution was filtered through Celite®. To the filtered solution 2 mL of anhydrous diethyl ether was added. This solution was concentrated to minimum and filtered, yielding bright pink solids (385 mg, 0.58 mmol, yield: 42%). ¹H NMR (400 MHz, CDCl₃) δ 8.19-8.14 (m, 2H), 7.98-7.91 (m, 2H), 7.87-7.83 (m, 2H), 7.62-7.51 (m, 2H), 7.51-7.38 (m, 2H), 7.38-7.27 (m, 4H), 7.03-6.95 (m, 2H), 6.45-6.36 (m, 3H), 5.99 (t, J=2.6 Hz, 1H), 5.67 (t, J=2.6 Hz, 1H), 1.39-1.23 (m, 2H), 0.92 (t, J=7.2 Hz, 3H), 0.70-0.57 (m, 2H), 0.15 (s, 3H), 0.09 (s, 3H).

Synthesis of (((9H-fluoren-9-yl)diphenylmethyl)cyclopentadienyl)-n-butyldimethylsilane (L5). The L5 ligand is a mixture of isomers, and the structure of one isomer is shown. This ligand may be abbreviated or written as Ph₂C(FlH)(CpH-SiMe₂-n-Bu) and may also be named (4-((9H-fluoren-9-yl)diphenylmethyl)cyclopenta-1,3-dien-1-yl)(butyl)dimethylsilane.

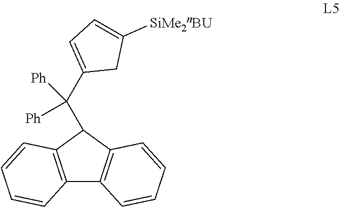

To a solution of 1-cyclopentadienyl-1-(fluoren-9-yl)-1,1-diphenyl-methane (LP1) (882.3 mg, 2.23 mmol) in anhydrous THF (10 mL) was added n-BuLi (0.9 mL, 2.5 M in hexane, 2.23 mmol) at −95° C. The mixture was stirred for 30 min before a solution of n-butyldimethyl-silyl trifluoromethanesulfonate (1.25 g, 2.45 mmol) in THF (10 mL) was added at −95° C. The mixture was kept at low temperature for 1.5 h before moving to room temperature. The reaction was quenched with saturated ammonium chloride aqueous solutions. THF was evaporated and the product was extracted with dichloromethane and dried over Na₂SO₄. The mixture was filtered and concentrated to yield red viscous oil. The product was purified by passing the oil through silica gel with hexane/dichloromethane (4:1) as the eluent. Organic solvent was removed under vacuum. The product was obtained as a yellow solid (701 mg, 0.94 mmol, yield: 42%).

Synthesis of Ph₂C(Fl)(Cp-SiMe₂-n-Bu) (M5). To a solution of L5 (701 mg, 0.93 mmol) in anhydrous diethyl ether (10 mL) was added n-BuLi (0.8 mL, 2.5 M in hexane, 1.8 mmol) at −35° C. The solution turned from yellow to orange. The reaction was stirred at room temperature for 24 hours, and the resulting red solution was treated with ZrCl₄(THF)₂ (350 mg, 0.93 mmol) −35° C. The solution turned dark red upon addition of ZrCl₄(THF)₂ and orange precipitates slowly formed in the next hour. The mixture was stirred at room temperature for another 24 hours and the volatiles were removed under vacuum. The residues were dissolved in anhydrous dichloromethane and the solution was filtered through Celite®. To the filtered solution 2 mL of DCM/Diethyl ether was added. This solution was concentrated to minimum and filtered, yielding bright pink solids (98 mg, 0.14 mmol, yield: 15%). ¹H NMR (400 MHz, CDCl₃) δ 8.23-8.15 (m, 2H), 8.01-7.93 (m, 2H), 7.85 (d, J=7.4 Hz, 2H), 7.63-7.53 (m, 2H), 7.51-7.43 (m, 2H), 7.35-7.26 (m, 4H), 7.04-6.97 (m, 2H), 6.45-6.33 (m, 3H), 5.99 (t, J=2.6 Hz, 1H), 5.68 (t, J=2.6 Hz, 1H), 1.41-1.13 (m, 4H), 0.85 (t, J=6.4 Hz, 3H), 0.67-0.59 (m, 2H), 0.15 (s, 3H), 0.09 (s, 3H).

Synthesis of (((2,7-di-tert-butyl-9H-fluoren-9-yl) diphenylmethyl)cyclopenta-dienyl)dimethyl-n-butylsilane (L5Bu). The L5Bu ligand is a mixture of isomers, and the structure of one isomer is shown. This ligand may be abbreviated or written as Ph₂C(2,7-t-Bu₂FlH)(CpH-SiMe₂-n-Bu) and may also be named butyl(4-((2,7-di-tert-butyl-9H-fluoren-9-yl)diphenylmethyl)cyclopenta-1,3-dien-1-yl)dimethylsilane.

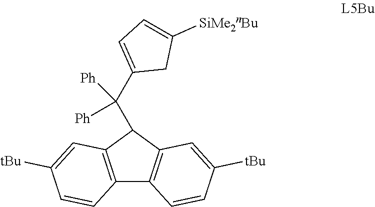

To a solution of 1-cyclopentadienyl-1-(2,7-di-tert-butylfluoren-9-yl)-1,1-diphenyl-methane (LP2) (1.2 g, 2.36 mmol) in anhydrous THF (20 mL) was added n-BuLi (0.94 mL, 2.5 M in hexane, 2.36 mmol) at −95° C. The mixture was stirred for 30 min before a solution of n-butyldimethylchlorosilane (354 mg, 2.36 mmol) in THF (10 mL) was added at −95° C. After 6 hours, the reaction was quenched with saturated ammonium chloride aqueous solutions. THF was evaporated and the product was extracted with dichloromethane and dried over Na₂SO₄. The mixture was filtered and concentrated to yield red viscous oil. The product was purified by passing the oil through silica gel with hexane as the eluent. Organic solvent was removed under vacuum. The product was obtained as a yellow powder (650 mg, 1.04 mmol, yield: 44%).

Synthesis of Ph₂C(2,7-t-Bu₂Fl)(Cp-SiMe₂-n-Bu)ZrCl₂ (MSBu). To a solution of L5Bu (650 mg, 1.04 mmol) in anhydrous diethyl ether (10 mL) was added n-BuLi (0.83 mL, 2.5 M in hexane, 2.4 mmol) at −35° C. The reaction was stirred at room temperature for 24 hours. The resulting suspension was treated with ZrCl₄ (243 mg, 1.04 mmol) −35° C. The solution turned dark upon addition of ZrCl₄ and orange precipitates slowly form. The mixture was stirred at room temperature for another 24 hours and the volatiles were removed under vacuum. The residues were dissolved in anhydrous dichloromethane and the solution was filtered through Celite®. To the filtered solution 2 mL of anhydrous Diethyl ether was added. This solution was concentrated to minimum and filtered, yielding bright pink solids (230 mg, 0.36 mmol, yield: 35%). ¹H NMR (400 MHz, CDCl₃) δ 8.05-7.94 (m, 4H), 7.87 (d, J=7.8 Hz, 2H), 7.63-7.56 (m, 2H), 7.52-7.42 (m, 2H), 7.38-7.32 (m, 2H), 7.31-7.27 (m, 2H), 6.40 (t, J=2.6 Hz, 1H), 6.32 (br s, 1H), 6.28 (br s, 1H), 5.86 (t, J=2.6 Hz, 1H), 5.61 (t, J=2.6 Hz, 1H), 1.32-1.23 (m, 4H), 1.03 (s, 18H), 0.86 (t, J=6.8 Hz, 3H), 0.66-0.60 (m, 2H), 0.11 (s, 3H), 0.08 (s, 3H).

Synthesis of (((2,7-di-tert-butyl-9H-fluoren-9-yl)diphenylmethyl)cyclopenta-dienyl)dimethyl-2-norbornylsilane (L6). The L6 ligand is a mixture of isomers, and the structure of one isomer is shown. This ligand may be abbreviated or written as Ph₂C(2,7-t-Bu₂FlH)(CpH-SiMe₂-2-Nor) and may also be named ((1R,2R,4S)-bicyclo[2.2.1]heptan-2-yl)(4-((2,7-di-tert-butyl-9H-fluoren-9-yl)diphenylmethyl)cyclopenta-1,3-dien-1-yl)dimethylsilane.

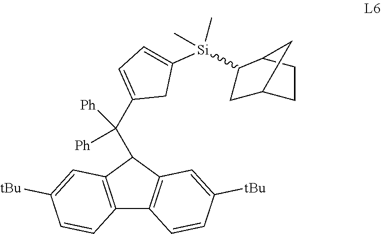 [SMILES: CC(C)(C)c1ccc2c(c1)C(C(C1=CC=C([Si](C)(C)C3CC4CCC3C4)C1)(c1ccccc1)c1ccccc1)c1cc(C(C)(C)C)ccc1-2]

To a solution of 1-cyclopentadienyl-1-(2,7-di-tert-butylfluoren-9-yl)-1,1-diphenyl-methane (LP2) (1.44 g, 2.83 mmol) in anhydrous THF (20 mL) was added n-BuLi (1.13 mL, 2.5 M in hexane, 3.10 mmol) at −95° C. The mixture was stirred for 30 min before a solution of (5-bicyclo[2.2.1]heptyl)dimethylchlorosilane (587 mg, 3.1 mmol, obtained from Gelest) in THF (10 mL) was added at −95° C. A ¹H NMR spectrum of the Gelest starting material indicated a mixture of exo and endo isomers were present in the sample, with the majority (approximately 9:1) being the exo diastereomer. The mixture was slowly allowed to warm to room temperature and stirred overnight. The reaction was quenched with saturated ammonium chloride aqueous solutions. THF was evaporated and the product was extracted with dichloromethane and dried over Na₂SO₄. The mixture was filtered and concentrated to yield red viscous oil. The product was purified by passing the oil through silica gel with hexane as the eluent. Organic solvent was removed under vacuum. The product was obtained as a yellow powder (1.53 g, 2.29 mmol, yield: 81%).

Synthesis of Ph₂C(2,7-t-Bu₂Fl)(Cp-SiMe₂-2-Nor)ZrCl₂ (M6). To a solution of L6 (825 mg, 1.25 mmol) in anhydrous diethyl ether (10 mL) was added n-BuLi (1.00 mL, 2.5 M in hexane, 2.50 mmol) at −35° C. The reaction was stirred at room temperature for 24 hours. The resulting suspension was treated with ZrCl₄ (560 mg, 1.25 mmol) −35° C. The solution turned dark upon addition of ZrCl₄ and pink precipitates slowly form. The mixture was stirred at room temperature for another 24 hours and the volatiles were removed under vacuum. The residues were dissolved in anhydrous dichloromethane and the solution was filtered. To the filtered solution 2 mL of anhydrous Diethyl ether was added. This solution was concentrated to minimum and filtered, yielding bright pink solids (462 mg, 0.54 mmol, yield: 43%). ¹H NMR (400 MHz, CDCl₃) δ 8.06-7.91 (m, 4H), 7.88 (d, J=7.8 Hz, 2H), 7.60 (m, 2H), 7.53-7.42 (m, 2H), 7.40-7.31 (m, 2H), 7.29-7.26 (m, 2H), 6.42 (t, J=2.4 Hz, 1H), 6.31 (br s, 1H), 6.28 (br d, J=3.8 Hz, 1H), 5.86 (t, J=2.4 Hz, 1H), 5.61 (t, J=2.4 Hz, 1H), 2.23 (s, 1H), 2.16 (d, J=10.0 Hz, 1H), 1.58-1.31 (m, 4H), 1.22-1.08 (m, 3H), 1.03 (s, 18H), 0.99-0.93 (m, 1H), 0.73-0.64 (m, 1H), 0.13 (s, 3H), 0.03 (d, J=8.0 Hz, 3H).

Synthesis of (((9H-fluoren-9-yl)diphenylmethyl)cyclopentadienyl)di-methyl-2-norbornylsilane (L7). The L7 ligand is a mixture of isomers, and the structure of one isomer is shown. This ligand may be abbreviated or written as Ph₂C(FlH)(CpH-SiMe₂-2-Nor).

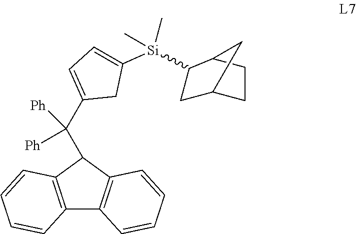 [SMILES: C[Si](C)(C1=CC=C(C(c2ccccc2)(c2ccccc2)C2c3ccccc3-c3ccccc32)C1)C1CC2CCC1C2]

To a solution of 1-cyclopentadienyl-1-(fluoren-9-yl)-1,1-diphenyl-methane (LP1) (1.116 g, 2.81 mmol) in anhydrous THF (20 mL) was added n-BuLi (1.24 mL, 2.5 M in hexane, 3.10 mmol) at −95° C. The mixture was stirred for 30 min before a solution of (5-bicyclo[2.2.1]heptyl)-dimethylchlorosilane (638 mg, 3.38 mmol, obtained from Gelest) in THF (10 mL) was added at −95° C. The ¹H NMR spectrum of the Gelest starting material indicated the presence of both exo and endo isomers, with the majority (approximately 9:1) being the exo diastereomer. The mixture was slowly allowed to warm to room temperature and stirred overnight. The reaction was quenched with saturated ammonium chloride aqueous solutions. THF was evaporated and the product was extracted with dichloromethane and dried over Na₂SO₄. The mixture was filtered and concentrated to yield red viscous oil. The product was purified by passing the oil through silica gel with hexane as the eluent. Organic solvent was removed under vacuum. The product was obtained as a yellow powder (960 mg, 1.74 mmol, yield: 62%).

Synthesis of Ph₂C(Fl)(Cp-SiMe₂-2-Nor)ZrCl₂ (M7). To a solution of L7 (960 mg, 1.75 mmol) in anhydrous diethyl ether (10 mL) was added n-BuLi (1.40 mL, 2.5 M in hexane, 3.50 mmol) at −35° C. The reaction was stirred at room temperature for 24 hours. The resulting suspension was treated with ZrCl₄ (448 mg, 1.9 mmol) −35° C. The solution turned dark upon addition of ZrCl₄ and pink precipitates slowly form. The mixture was stirred at room temperature for another 24 hours and the volatiles were removed under vacuum. The residues were dissolved in anhydrous dichloromethane and the solution was filtered through Celite®. To the filtered solution 2 mL of anhydrous Diethyl ether was added. This solution was concentrated to minimum and filtered, yielding bright pink solids (456 mg, 0.65 mmol, yield: 37%). ¹H NMR (400 MHz, CDCl₃) δ 8.26-8.08 (m, 2H), 7.96-7.82 (m, 4H), 7.61-7.51 (m, 2H), 7.51-7.40 (m, 2H), 7.38-7.27 (m, 4H), 6.99 (br t, J=7.2 Hz, 2H), 6.46-6.42 (m, 1H), 6.42-6.35 (m, 2H), 5.99-5.96 (m, 1H), 5.68 (br s, 1H), 2.23 (br s, 1H), 2.14 (d, J=12.8 Hz, 1H), 1.55-1.46 (m, 2H), 1.43-1.33 (m, 2H), 1.19-1.15 (m, 2H), 1.12-1.05 (m, 1H), 1.01-0.91 (m, 1H), 0.70-0.63 (m, 1H), 0.14 (s, 3H), 0.03 (d, J=2.2 Hz, 3H).

Synthesis of (((2,7-di-tert-butyl-9H-fluoren-9-yl)diphenylmethyl)cyclopenta-dienyl)triethylsilane (L8). The L8 ligand is a mixture of isomers, and the structure of one isomer is shown. This ligand may be abbreviated or written as Ph₂C(2,7-t-Bu₂FlH)(CpH-SiEt₃) and may also be named (4-((2,7-di-tert-butyl-9H-fluoren-9-yl)diphenylmethyl)cyclopenta-1,3-dien-1-yl)triethylsilane.

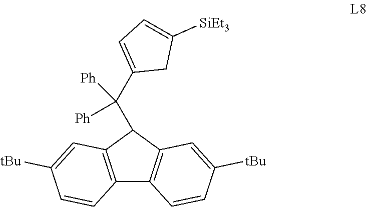

To a solution of 1-cyclopentadienyl-1-(2,7-di-tert-butylfluoren-9-yl)-1,1-diphenyl-methane (LP2) (1.132 g, 2.22 mmol) in anhydrous THF (10 mL) was added n-BuLi (0.98 mL, 2.5 M in hexane, 2.45 mmol) at −95° C. The mixture was stirred for 1 h before a solution of triethylsilyl trifluoromethanesulfonate (701 mg, 2.67 mmol) in anhydrous THF (10 mL) was added at −95° C. The mixture was slowly allowed to warm to room temperature and stirred overnight. The reaction was then quenched with saturated ammonium chloride aqueous solutions. THF was evaporated and the product was extracted with dichloromethane and dried over Na₂SO₄. The mixture was concentrated to yield red viscous oil. The product was purified by passing the oil through silica gel with hexane/dichloromethane (2:1) as the eluent. Organic solvent was removed under vacuum. The product was obtained as a white powder (507.3 mg, 0.80 mmol, yield: 36%).

Synthesis of Ph₂C(2,7-t-Bu₂Fl)(Cp-SiEt₃)ZrCl₂ (M8). To a solution of L8 (504 mg, 0.8 mmol) in diethyl ether (5 mL) was added n-BuLi (0.65 mL, 2.5 M in hexane, 1.6 mmol) at −35° C. The reaction was stirred at room temperature for 24 hours, and the resulting red suspension was treated with ZrCl₄(THF)₂ (305 mg, 0.8 mmol) at −35° C. The solution turned dark red upon addition of ZrCl₄(THF)₂ and bright pink precipitates slowly formed during the course of 1 hour. The mixture was stirred at room temperature for another 24 hours and the volatiles were removed under vacuum. The residues were dissolved in anhydrous dichloromethane and the solution was filtered through Celite®. To the filtered solution 2 mL of hexane was added. This solution was concentrated to minimum and filtered, yielding bright pink solids (225 mg, 0.58 mmol, yield: 36%). ¹H NMR (400 MHz, CDCl₃) δ 8.01-7.98 (m, 2H), 7.99-7.94 (m 2H), 7.90-7.85 (m, 2H), 7.63-7.56 (m, 2H), 7.50-7.41 (m, 2H), 7.38-7.31 (m, 2H), 7.30-7.27 (m, 2H), 6.42 (t, J=2.4 Hz, 1H), 6.31 (d, J=0.8 Hz, 1H), 6.27 (d, J=0.8 Hz, 1H), 5.85 (t, J=2.4 Hz, 1H), 5.65 (t, J=2.4 Hz, 1H), 1.03 (s, 9H), 1.02 (s, 9H), 0.91 (t, J=7.8 Hz, 9H), 0.73-0.63 (q, J=7.8 Hz, 6H).

Synthesis of (((9H-fluoren-9-yl)diphenylmethyl)cyclopentadienyl)triethylsilane (L9). The L9 ligand is a mixture of isomers, and the structure of one isomer is shown. This ligand may be abbreviated or written as Ph₂C(FlH)(CpH-SiEt₃) and may also be named (4-((9H-fluoren-9-yl)diphenylmethyl)cyclopenta-1,3-dien-1-yl)triethylsilane.

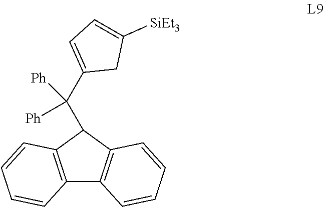

To a solution of 1-cyclopentadienyl-1-(fluoren-9-yl)-1,1-diphenyl-methane (LP1) (987.2 mg, 2.50 mmol) in anhydrous THF (10 mL) was added n-BuLi (1.1 mL, 2.5 M in hexane, 2.75 mmol) at −95° C. The mixture was stirred for 1 h before a solution of triethylsilyl trifluoromethanesulfonate (726.9 mg, 2.75 mmol) in diethyl ether (10 mL) was added at −95° C. The mixture was slowly allowed to warm to room temperature and stirred overnight. The reaction was quenched with saturated ammonium chloride aqueous solutions. The THF was evaporated and the product was extracted with dichloromethane and dried over Na₂SO₄. The mixture was filtered and concentrated to yield red viscous oil. The product was purified by passing the oil through silica gel with hexane/dichloromethane (2:1) as the eluent. The organic solvent was removed under vacuum. The product L9 was obtained as a white powder (656.7 mg, 1.3 mmol, yield: 52%).

Synthesis of Ph₂C(Fl)(Cp-SiEt₃)ZrCl₂ (M9). To a solution of the ligand L9 (656 mg, 1.3 mmol) in anhydrous diethyl ether (5 mL) was added n-BuLi (1.0 mL, 2.5 M in hexane, 2.6 mmol) at −35° C. The reaction mixture was stirred at room temperature for 24 hours, and the resulting red suspension was treated with ZrCl₄(THF)₂ (485 mg, 1.3 mmol) at −35° C. The solution turned dark red upon addition of ZrCl₄(THF)₂ and bright pink precipitates slowly formed during the course of 1 hour. The mixture was stirred at room temperature for another 24 hours and the volatiles were removed under vacuum. The residues were dissolved in anhydrous dichloromethane and the solution was filtered through Celite®. To the filtered solution, 2 mL of hexane was added. This solution was concentrated to a minimum volume and filtered, yielding bright pink solids (480 mg, 0.72 mmol, yield: 55%). ¹H NMR (400 MHz, CDCl₃) δ 8.22-8.11 (m, 2H), 7.92 (br t, J=8.8 Hz, 2H), 7.87-7.83 (m, 2H), 7.61-7.52 (m, 2H), 7.49-7.40 (m, 2H), 7.37-7.27 (m, 4H), 7.02-6.95 (m, 2H), 6.45 (t, J=2.6 Hz, 1H), 6.39 (t, J=8.4 Hz, 2H), 5.98 (t, J=2.6 Hz, 1H), 5.70 (t, J=2.6 Hz, 1H), 0.92 (t, J=7.8 Hz, 9H), 0.80-0.60 (q, J=7.8 Hz, 6H).

Synthesis of (((2,7-di-tert-butyl-9H-fluoren-9-yl)(dimethyl)methyl)cyclopenta-dienyl)dimethyl-n-propylsilane (L10). The L10 ligand is a mixture of isomers, and the structure of one isomer is shown. This ligand may be abbreviated or written as Me₂C(2,7-t-Bu₂FlH)(CpH-SiEt₃) and may also be named (4-(2-(2,7-di-tert-butyl-9H-fluoren-9-yl)propan-2-yl)cyclopenta-1,3-dien-1-yl)triethylsilane.

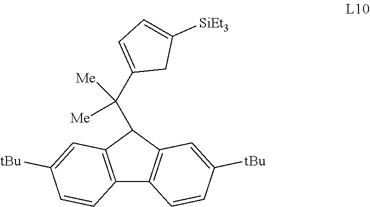

To a solution of 1-cyclopentadienyl-1-(2,7-di-tert-butylfluoren-9-yl)-1,1-dimethyl-methane (LP4) (1.12 g, 2.92 mmol) in anhydrous THF (20 mL) was added n-BuLi (1.30 mL, 2.5 M in hexane, 3.21 mmol) at −95° C. The mixture was stirred for 30 min before a solution of triethylsilyl trifluoromethanesulfonate (1.15 g, 4.375 mmol) in THF (10 mL) was added at −95° C. The mixture was slowly allowed to warm to room temperature and stirred overnight. The reaction was quenched with saturated ammonium chloride aqueous solutions. THF was evaporated and the product was extracted with dichloromethane and dried over Na₂SO₄. The mixture was filtered and concentrated to yield red viscous oil. The product was purified by passing the oil through silica gel with hexane as the eluent. Organic solvent was removed under vacuum. The product was obtained as a yellow powder (0.96 g, 1.98 mmol, yield: 68%).

Synthesis of Me₂C(2,7-t-Bu₂Fl)(Cp-SiEt₃)ZrCl₂ (M10). To a solution of L10 (995 mg, 2.0 mmol) in anhydrous diethyl ether (10 mL) was added n-BuLi (1.6 mL, 2.5 M in hexane, 4.0 mmol) at −35° C. The reaction was stirred at room temperature for 24 hours, during which time a large amount of orange precipitate formed. The resulting suspension was treated with ZrCl₄ (465 mg, 2.0 mmol) −35° C. The solution turned dark upon addition of ZrCl₄ and orange precipitates slowly form. The mixture was stirred at room temperature for another 24 hours and the volatiles were removed under vacuum. The residues were dissolved in anhydrous dichloromethane and the solution was filtered through Celite®. To the filtered solution 2 mL of anhydrous Diethyl ether was added. This solution was concentrated to minimum and filtered, yielding bright orange solids (450 mg, 0.66 mmol, yield: 33%). ¹H NMR (400 MHz, CDCl₃) δ 7.95 (dd, J=8.8 Hz, J=2.8 Hz, 2H), 7.68 (d, J=12.8 Hz, 2H), 7.61 (dd, J=12.8 Hz, J=8.8 Hz, 2H), 6.37 (t, J=2.4 Hz, 1H), 5.84 (t, J=2.4 Hz, 1H), 5.63 (t, J=2.4 Hz, 1H), 2.40 (s, 3H), 2.39 (s, 3H), 1.34 (s, 18H), 0.89 (t, J=7.8 Hz, 9H), 0.73-0.64 (q, J=7.8 Hz, 6H).

Synthesis of (((9H-fluoren-9-yl)(dimethyl)methyl)cyclopentadienyl)-triethylsilane (L11). The L11 ligand is a mixture of isomers, and the structure of one isomer is shown. This ligand may be abbreviated or written as Me₂C(FlH)(CpH-SiEt₃) and may also be named (4-(2-(9H-fluoren-9-yl)propan-2-yl)cyclopenta-1,3-dien-1-yl)triethylsilane.

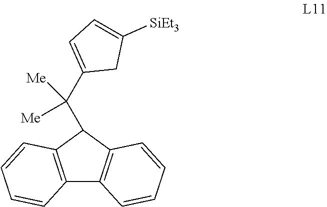

To a solution of 1-cyclopentadienyl-1-(fluoren-9-yl)-1,1-dimethyl-methane (LP3) (1.2 g, 4.4 mmol) in anhydrous THF (20 mL) was added n-BuLi (1.9 mL, 2.5 M in hexane, 4.4 mmol) at −95° C. The mixture was stirred for 30 min before a solution of triethylsilyl trifluoromethanesulfonate (1.75 g, 6.6 mmol) in THF (10 mL) was added at −95° C. The mixture was slowly allowed to warm to room temperature and stirred overnight. The reaction was quenched with saturated ammonium chloride aqueous solutions. THF was evaporated and the product was extracted with dichloromethane and dried over Na₂SO₄. The mixture was filtered and concentrated to yield red viscous oil. The product was purified by passing the oil through silica gel with hexane as the eluent. Organic solvent was removed under vacuum. The product was obtained as a yellow powder (0.91 g, 2.33 mmol, yield: 53%).

Synthesis of Me₂C(Fl)(Cp-SiEt₃)ZrCl₂ (M11). To a solution of L11 (909 mg, 2.35 mmol) in anhydrous diethyl ether (10 mL) was added n-BuLi (1.9 mL, 2.5 M in hexane, 4.7 mmol) at −35° C. The reaction was stirred at room temperature for 24 hours, during which time a large amount of red precipitate formed. The resulting suspension was treated with ZrCl₄ (548 mg, 2.35 mmol) −35° C. The solution turned dark upon addition of the ZrCl₄, and bright pink precipitates slowly form. The mixture was stirred at room temperature for another 24 hours and the volatiles were removed under vacuum. The residues were dissolved in anhydrous dichloromethane and the solution was filtered. To the filtered solution 2 mL of anhydrous Diethyl ether was added. This solution was concentrated to minimum and filtered, yielding bright pink solids (450 mg, 0.80 mmol, yield: 34%). ¹H NMR (400 MHz, CDCl₃) δ 8.09 (d, J=8.4 Hz, 2H), 7.85-7.78 (m, 2H), 7.55-7.51 (m, 2H), 7.30-7.19 (m, 2H), 6.38 (t, J=2.6 Hz, 1H), 5.98 (t, J=2.6 Hz, 1H), 5.67 (t, J=2.6 Hz, 1H), 2.40 (s, 3H), 2.39 (s, 3H), 0.88 (t, J=7.8 Hz, 9H), 0.73-0.63 (q, J=7.8 Hz, 6H).

Synthesis of (((2,7-di-tert-butyl-9H-fluoren-9-yl) diphenylmethyl)cyclopenta-dienyl)tri-n-propylsilane (L12). The L12 ligand is a mixture of isomers, and the structure of one isomer is shown. This ligand may be abbreviated or written as Ph₂C(2,7-t-Bu₂FlH)(CpH-Si-n-Pr₃) and may also be named (4-((2,7-di-tert-butyl-9H-fluoren-9-yl)diphenylmethyl)cyclopenta-1,3-dien-1-yl)tripropylsilane.

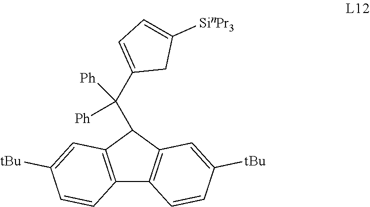

To a solution of 1-cyclopentadienyl-1-(2,7-di-tert-butylfluoren-9-yl)-1,1-diphenyl-methane (LP2) (880 mg, 1.73 mmol) in anhydrous THF (20 mL) was added n-BuLi (0.70 mL, 2.5 M in hexane, 1.73 mmol) at −95° C. The mixture was stirred for 30 min before a solution of tri-n-propylsilyl trifluoromethanesulfonate (630 mg, 2.1 mmol) in THF (10 mL) was added at −95° C. The mixture was slowly allowed to warm to room temperature and stirred overnight. The reaction was quenched with saturated ammonium chloride aqueous solutions. THF was evaporated and the product was extracted with dichloromethane and dried over Na₂SO₄. The mixture was filtered and concentrated to yield red viscous oil. The product was purified by passing the oil through silica gel with hexane as the eluent. Organic solvent was removed under vacuum. The product was obtained as a yellow powder (794 mg, 1.19 mmol, yield: 69%).

Synthesis of Ph₂C(2,7-t-Bu₂Fl)(Cp-Si-n-Pr₃)ZrCl₂ (M12). To a solution of L12 (794 mg, 1.20 mmol) in anhydrous diethyl ether (10 mL) was added n-BuLi (1.0 mL, 2.5 M in hexane, 2.4 mmol) at −35° C. The reaction was stirred at room temperature for 24 hours. The resulting suspension was treated with ZrCl₄ (278 mg, 1.2 mmol) −35° C. The solution turned dark upon addition of ZrCl₄ and orange precipitates slowly form. The mixture was stirred at room temperature for another 24 hours and the volatiles were removed under vacuum. The residues were dissolved in anhydrous dichloromethane and the solution was filtered. To the filtered solution 2 mL of anhydrous Diethyl ether was added. This solution was concentrated to minimum and filtered, yielding bright pink solids (282 mg, 0.36 mmol, yield: 30%). ¹H NMR (400 MHz, CDCl₃) δ 8.03-7.99 (m, 2H), 7.96 (br t, J=7.8 Hz, 2H), 7.88 (d, J=7.8 Hz, 2H), 7.64-7.55 (m, 2H), 7.54-7.42 (m, 2H), 7.38-7.31 (m, 2H), 7.31-7.25 (m, 2H), 6.41 (t, J=2.4 Hz, 1H), 6.31 (d, J=0.8 Hz, 1H), 6.27 (d, J=0.8 Hz, 1H), 5.84 (t, J=2.4 Hz, 1H), 5.62 (t, J=2.4 Hz, 1H), 1.38-1.25 (m, 6H), 1.04 (s, 9H), 1.03 (s, 9H), 0.88 (t, J=7.2 Hz, 9H), 0.74-0.59 (m, 6H).

Synthesis of (((9H-fluoren-9-yl)diphenylmethyl)cyclopentadienyl)tri-n-propylsilane (L13). The L13 ligand is a mixture of isomers, and the structure of one isomer is shown. This ligand may be abbreviated or written as Ph₂C(FlH)(CpH-Si-n-Pr₃) and may also be named (4-((9H-fluoren-9-yl)diphenylmethyl)cyclopenta-1,3-dien-1-yl)tripropylsilane.

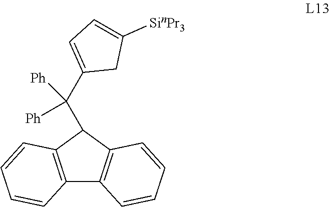

To a solution of 1-cyclopentadienyl-1-(fluoren-9-yl)-1,1-diphenyl-methane (LP1) (720 mg, 1.81 mmol) in anhydrous THF (10 mL) was added n-BuLi (0.7 mL, 2.5 M in hexane, 1.81 mmol) at −95° C. The mixture was stirred for 30 min before a solution of tri-n-propylsilyl trifluoromethanesulfonate (611 mg, 2.0 mmol) in THF (10 mL) was added at −95° C. The mixture was slowly allowed to warm to room temperature and stirred overnight. The reaction was quenched with saturated ammonium chloride aqueous solutions. THF was evaporated and the product was extracted with dichloromethane and dried over Na₂SO₄. The mixture was filtered and concentrated to yield red viscous oil. The product was purified by passing the oil through silica gel with hexane/dichloromethane (3:1) as the eluent. Organic solvent was removed under vacuum. The product was obtained as a yellow solid (650 mg, 1.25 mmol, yield: 69%).

Synthesis of Ph₂C(Fl)(Cp-Si-n-Pr₃)ZrCl₂ (M13). To a solution of L13 (652 mg, 1.18 mmol) in anhydrous diethyl ether (10 mL) was added n-BuLi (0.9 mL, 2.5 M in hexane, 2.3 mmol) at −35° C. The reaction was stirred at room temperature for 24 hours, and the resulting red solution was treated with ZrCl₄(THF)₂ (445 mg, 1.18 mmol) −35° C. The solution turned dark red upon addition of ZrCl₄(THF)₂ and bright pink precipitates slowly formed in the next hour. The mixture was stirred at room temperature for another 24 hours and the volatiles were removed under vacuum. The residues were dissolved in anhydrous dichloromethane and the solution was filtered through Celite®. To the filtered solution 2 mL of anhydrous Diethyl ether was added. This solution was concentrated to minimum and filtered, yielding bright pink solids (532 mg, 0.74 mmol yield: 63%). ¹H NMR (400 MHz, CDCl₃) δ 8.18-8.13 (m, 2H), 7.92 (br t, J=7.8 Hz, 2H), 7.85 (br d, J=7.8 Hz, 2H), 7.61-7.51 (m, 2H), 7.51-7.39 (m, 2H), 7.39-7.28 (m, 4H), 7.03-6.93 (m, 2H), 6.42 (t, J=2.8 Hz, 1H), 6.38 (t, J=8.6 Hz, 2H), 5.96 (t, J=2.8 Hz, 1H), 5.68 (t, J=2.8 Hz, 1H), 1.34-1.24 (m, 6H), 0.90 (t, J=7.2 Hz, 9H), 0.75-0.58 (m, 6H).

Synthesis of Ph₂C(Fl)(Cp-SiEt₃)HfCl₂ (M14). To a solution of L9 (1.097 g, 2.15 mmol) in anhydrous diethyl ether (10 mL) was added n-BuLi (1.9 mL, 2.5 M in hexane, 4.30 mmol) at −35° C. The reaction was stirred at room temperature for 4 hours. The resulting suspension was treated with HfCl₄ (688 mg, 2.15 mmol) −35° C. The solution turned dark red upon addition of HfCl₄ and yellow precipitates slowly formed. The mixture was stirred at room temperature for another 24 hours and the volatiles were removed under vacuum. The residues were dissolved in anhydrous dichloromethane and the solution was filtered through Celite®. To the filtered solution, 2 mL of anhydrous diethyl ether was added. This solution was concentrated to a minimum volume and filtered, yielding yellow solids (720 mg, 0.95 mmol, yield: 44%). ¹H NMR (400 MHz, CDCl₃) δ 8.16-8.11 (m, 2H), 7.93 (br t, J=7.6 Hz, 2H), 7.85 (br d, J=7.6 Hz, 2H), 7.58-7.50 (m, 2H), 7.49-7.38 (m, 2H), 7.38-7.27 (m, 4H), 7.03-6.92 (m, 2H), 6.51-6.40 (m, 2H), 6.38 (t, J=2.4 Hz, 1H), 5.94 (t, J=2.4 Hz, 1H), 5.66 (t, J=2.4 Hz, 1H), 0.91 (t, J=8.0 Hz, 9H), 0.69 (q, J=7.9 Hz, 6H).

Synthesis of (1′-(2,7-di-tert-butyl-9H-fluoren-9-yl)-[1,1′-bi(cyclopentane)]-2,4-dien-3-yl)triethylsilane (L15). The L15 ligand is a mixture of isomers, and the structure of one isomer is shown. This ligand may be abbreviated or written as (cyclopenta-1,1-diyl)(2,7-t-Bu₂FlH)(CpH-SiEt₃) and may also be named (1′-(2,7-di-tert-butyl-9H-fluoren-9-yl)-[1,1′-bi(cyclopentane)]-3,5-dien-3-yl)triethylsilane.

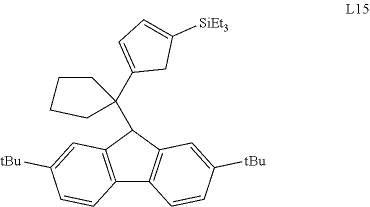

To a solution 9-([1,1′-bi(cyclopentane)]-2′,4′-dien-1-yl)-2,7-di-tert-butyl-9H-fluorene (LP5) (1.24 g, 3.0 mmol) in anhydrous THF (20 mL) was added n-BuLi (1.5 mL, 2.5 M in hexane, 3.75 mmol) at −95° C. The mixture was stirred at −78° C. for 4 hours. Triethylsilyl trifluoromethanesulfonate (376 mg, 2.2 mmol) was added in one portion. The mixture was slowly allowed to warm up to room temperature and stirred at room temperature overnight. The reaction was quenched with saturated ammonium chloride. The crude product was extracted with hexane and the solution was dried over Na₂SO₄. The product was purified via column chromatography using hexane as the eluent. Hexane was removed under vacuum. (1′-(2,7-di-tert-butyl-9H-fluoren-9-yl)-[1,1′-bi(cyclopentane)]-2,4-dien-3-yl)triethylsilane (1.18 g, 2.2 mmol, yield: 75%) was obtained as a yellow solid.

Synthesis of (cyclopenta-1,1-diyl)(2,7-t-Bu₂Fl)(Cp-SiEt₃)ZrCl₂ (M15). L15 (392 mg, 0.74 mmol) was dissolved in anhydrous diethyl ether (10 mL) at −35° C. n-BuLi (0.75 mL, 2.5 M in hexane) was added dropwise. The mixture was warmed up to room temperature and stirred overnight. The mixture was cooled down to −35° C. ZrCl₄ (210 mg, 0.9 mmol) was added portion wise. The mixture was stirred at room temperature for 2 days. Organic solvent was removed under vacuum. The crude product was dissolved in dichloromethane and filtered through a frit to remove LiCl. Dichloromethane was removed under vacuum. The crude product was washed three times with anhydrous hexane. This solution was concentrated to minimum and filtered, yielding bright pink solids (330 mg, 0.48 mmol, yield: 65%). ¹H NMR (400 MHz, CDCl₃) δ 7.96 (dd, J=8.8, 1.6 Hz, 2H), 7.61 (dd, J=13.4, 8.8 Hz, 2H), 7.55 (d, J=13.4 Hz, 2H), 6.35 (t, J=2.6 Hz, 1H), 5.78 (t, J=2.6 Hz, 1H), 5.58 (t, J=2.6 Hz, 1H), 3.25-3.15 (m, 2H), 2.83-2.69 (m, 2H), 2.08 (br s, 4H), 1.35 (s, 18H), 0.89 (t, J=8.0 Hz, 9H), 0.68 (q, J=8.0 Hz, 6H).

Synthesis of (1′-(9H-fluoren-9-yl)-[1,1′-bi(cyclopentane)]-2,4-dien-3-yl)triethylsilane Ligand (L16). The L16 ligand is a mixture of isomers, and the structure of one isomer is shown. This ligand may be abbreviated or written as (cyclopenta-1,1-diyl)(FlH)(CpH-SiEt₃) and may be named (1′-(9H-fluoren-9-yl)-[1,1′-bi(cyclopentane)]-3,5-dien-3-yl)triethylsilane.

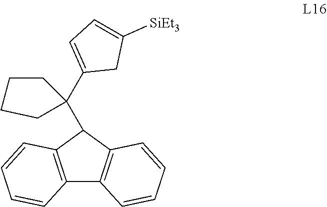

To a solution of 9-([1,1′-bi(cyclopentane)]-2′,4′-dien-1-yl)-9H-fluorene (LP6) (1.2 g, 4.0 mmol) in anhydrous THF (20 mL) was added n-BuLi (1.7 mL, 2.5 M in hexane, 4.2 mmol) at −95° C. The mixture was stirred at −78° C. for 4 hours. Triethylsilyl trifluoromethanesulfonate (2.11 g, 8.0 mmol) was added in one portion. The mixture was slowly allowed to warm up to room temperature and stirred at room temperature overnight. The reaction was quenched with saturated ammonium chloride. The crude product was extracted with hexane and the solution was dried over Na₂SO₄. The product was purified via column chromatography using hexane as the eluent. Hexane was removed under vacuum. (1′-(9H-fluoren-9-yl)-[1,1′-bi(cyclopentane)]-2,4-dien-3-yl)triethylsilane (1.47 g, 3.56 mmol, yield: 89%) was obtained as pale yellow oil.

Synthesis of (cyclopenta-1,1-diyl)(Fl)(Cp-SiEt₃)ZrCl₂ (M16). The ligand L16 (440 mg, 1.1 mmol) was dissolved in anhydrous diethyl ether (10 mL) at −35° C. n-BuLi (0.85 mL, 2.5 M in hexane) was added dropwise. The mixture was warmed up to room temperature and stirred overnight. The mixture was cooled down to −35° C. ZrCl₄ (261 mg, 1.1 mmol) was added portion wise. The mixture was stirred at room temperature for 2 days. Organic solvent was removed under vacuum. The crude product was dissolved in dichloromethane and filtered through a frit to remove LiCl. Dichloromethane was removed under vacuum. The crude product was washed three times with anhydrous hexane. This solution was concentrated to minimum and filtered, yielding bright pink solids (330 mg, 0.58 mmol, yield: 52%). ¹H NMR (400 MHz, CDCl₃) δ 8.09 (d, J=8.7 Hz, 2H), 7.73-7.66 (m, 2H), 7.58-7.53 (m, 2H), 7.25-7.22 (m, 2H), 6.36 (t, J=2.4 Hz, 1H), 5.92 (t, J=2.4 Hz, 1H), 5.63 (t, J=2.4 Hz, 1H), 3.24-3.19 (m, 2H), 2.79-2.72 (m, 2H), 2.07 (br s, 4H), 0.88 (t, J=8.0 Hz, 9H), 0.66 (q, J=8.0 Hz, 6H).

Synthesis of (cyclopenta-1,1-diyl)(Fl)(Cp-SiEt₃)HfCl₂ (M17). The ligand L16 (430 mg, 1.0 mmol) was dissolved in anhydrous diethyl ether (10 mL) at −35° C. n-BuLi (0.8 mL, 2.5 M in hexane) was added dropwise. The mixture was warmed up to room temperature and stirred overnight. The mixture was cooled down to −35° C. HfCl₄ (330 mg, 1.1 mmol) was added portion wise. The mixture was stirred at room temperature for 2 days. Organic solvent was removed under vacuum. The crude product was dissolved in dichloromethane and filtered through a frit to remove LiCl. Dichloromethane was removed under vacuum. The crude product was washed three times with anhydrous hexane. This solution was concentrated to minimum and filtered, yielding bright pink solids (360 mg, 0.55 mmol, yield: 55%). ¹H NMR (400 MHz, CDCl₃) δ 8.06 (m, 2H), 7.73 (m, 2H), 7.51 (m, 2H), 7.24 (m, 2H), 6.30 (t, J=2.4 Hz, 1H), 5.89 (t, J=2.8 Hz, 1H), 5.58 (t, J=2.4 Hz, 1H), 3.23 (m, 2H), 2.74 (m, 2H), 2.06 (m, 4H), 0.87 (t, J=8.0 Hz, 9H), 0.65 (q, J=8.0 Hz, 6H).

Synthesis of (1′-(9H-fluoren-9-yl)-[1,1′-bi(cyclopentane)]-2,4-dien-3-yl)tripropylsilane Ligand (L18). The L18 ligand is a mixture of isomers, and the structure of one isomer is shown. This ligand may be abbreviated or written as (cyclopenta-1,1-diyl)(FlH)(CpH-Si-n-Pr₃) and may also be named (1′-(9H-fluoren-9-yl)-[1,1′-bi(cyclopentane)]-3,5-dien-3-yl)tripropylsilane.

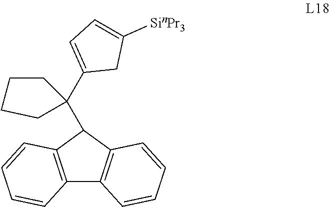

To a solution of 9-([1,1′-bi(cyclopentane)]-2′,4′-dien-1-yl)-9H-fluorene (LP6) (1.05 g, 3.5 mmol) in anhydrous THF (20 mL) was added n-BuLi (1.5 mL, 2.5 M in hexane, 3.75 mmol) at −95° C. The mixture was stirred at −78° C. for 4 hours. Tri-n-proylsilylchloride (1.45 g, 7.5 mmol) was added in one portion. The mixture was slowly allowed to warm up to room temperature and stirred at room temperature overnight. The reaction was quenched with saturated ammonium chloride. The crude product was extracted with hexane and the solution was dried over Na₂SO₄. The product was purified via column chromatography using hexane as the eluent. Hexane was removed under vacuum. (1′-(9H-fluoren-9-yl)-[1,1′-bi(cyclopentane)]-2,4-dien-3-yl)tripropylsilane (0.80 g, 1.75 mmol, yield: 50%) was obtained as a pale yellow oil.

Synthesis of (cyclopenta-1,1-diyl)(Fl)(Cp-Si-n-Pr₃)ZrCl₂ (M18). The ligand L18 (390 mg, 0.87 mmol) was dissolved in anhydrous diethyl ether (10 mL) at −35° C. n-BuLi (0.8 mL, 2.5 M in hexane) was added dropwise. The mixture was warmed up to room temperature and stirred overnight. The mixture was cooled down to −35° C. ZrCl₄ (210 mg, 0.9 mmol) was added portion wise. The mixture was stirred at room temperature for 2 days. Organic solvent was removed under vacuum. The crude product was dissolved in dichloromethane and filtered through a frit to remove LiCl. Dichloromethane was removed under vacuum. The crude product was washed three times with anhydrous hexane. This solution was concentrated to minimum and filtered, yielding bright pink solids (346 mg, 0.56 mmol, yield: 64%). ¹H NMR (400 MHz, CDCl₃) δ 8.10 (d, J=8.4 Hz, 2H), 7.73-7.66 (m, 2H), 7.58-7.53 (m, 2H), 7.25-7.22 (m, 2H), 6.34 (t, J=2.4 Hz, 1H), 5.90 (t, J=2.4 Hz, 1H), 5.62 (t, J=2.4 Hz, 1H), 3.21 (br s, 2H), 2.80-2.71 (m, 2H), 2.07 (br s, 4H), 1.28-1.24 (m, 6H), 0.89 (t, J=6.8 Hz, 9H), 0.68-0.63 (m, 6H).

Synthesis of (cyclopenta-1,1-diyl)(Fl)(Cp-Si-n-Pr₃)HfCl₂ (M19). The ligand L18 (400 mg, 0.875 mmol) was dissolved in anhydrous diethyl ether (10 mL) at −35° C. n-BuLi (0.8 mL, 2.5 M in hexane) was added dropwise. The mixture was warmed up to room temperature and stirred overnight. The mixture was cooled down to −35° C. HfCl₄ (288 mg, 0.9 mmol) was added portion wise. The mixture was stirred at room temperature for 2 days. Organic solvent was removed under vacuum. The crude product was dissolved in dichloromethane and filtered through a frit to remove LiCl. Dichloromethane was removed under vacuum. The crude product was washed three times with anhydrous hexane. This solution was concentrated to minimum and filtered, yielding bright pink solids (412 mg, 0.58 mmol, yield: 67%). ¹H NMR (400 MHz, CDCl₃) δ 8.05 (m, 2H), 7.73 (m, 2H), 7.51 (m, 2H), 7.22 (m, 2H), 6.28 (t, J=2.4 Hz, 1H), 5.87 (t, J=2.8 Hz, 1H), 5.58 (t, J=2.4 Hz, 1H), 3.24 (m, 2H), 2.75 (m, 2H), 2.06 (m, 4H), 1.27 (m, 6H), 0.90 (t, J=6.8 Hz, 9H), 0.65 (m, 6H).

Synthesis of (Me₂C(Fl)(Cp)ZrCl₂ (CM2). To a solution of 1-cyclopentadienyl-1-(fluoren-9-yl)-1,1-dimethyl-methane (LP3) (390 mg, 1.42 mmol) in diethylether (10 mL) was added n-BuLi (1.2 mL, 2.5 M in hexane, 3.00 mmol) at −35° C. The reaction was stirred at room temperature for 18 hours. The resulting dark red solution was mixed with ZrCl₄ (320 mg 1.43 mmol) at −35° C. The red mixture was stirred at room temperature for another 24 hours and the volatiles were removed under vacuum (Yield 47%, 0.67 mmol). ¹H NMR (CDCl₃, 400 MHz): δ 8.17 (d, J=8.1 Hz, 2H), 7.87 (d, J=8.4 Hz, 2H), 7.60 (m, 2H), 7.30 (m, 2H), 6.36 ppm(s, 2H), 5.80 (s, 2H), 2.42 (s, 6H) ppm.

Synthesis of Me₂C(2,7-(t-Bu)₂Fl)(Cp)ZrCl₂ (CM3). To a solution of 1-cyclopentadienyl-1-(2,7-di-tert-butylfluoren-9-yl)-1,1-dimethyl-methane (LP4) (314 mg, 0.70 mmol) in Et₂O (5 mL) was added n-BuLi (0.56 mL, 2.5 M in hexane, 1.40 mmol) at −35° C. The reaction was stirred at room temperature for 12 hours, and the resulting orange suspension was treated with ZrCl₄ (156 mg, 0.70 mmol). The mixture was stirred at room temperature for another 24 hours and the solution was filtered. After removal of solvent, the product was washed with pentane, collected on an “M” frit, and dried under vacuum, yielding an orange powder. 68.01 (d, 2H, J=8.3 Hz), 7.72 (s, 2H), 7.63 (d, 2H, J=8.3 Hz), 6.31 (s, 2H), 5.67 (s, 2H), 2.40 (s, 6H), 1.28 (s, 18H) ppm.

Synthesis of Ph₂C(2,7-tBu₂Fl)(Cp)(ZrCl₂) (CM4). To a solution of 1-cyclopentadienyl-1-(2,7-di-tert-butylfluoren-9-yl)-1,1-diphenyl-methane (LP2) (510 mg, 1.00 mmol) in diethylether(10 mL) was added n-BuLi (0.85 mL, 2.5 M in hexane, 2.1 mmol) at −35° C. The reaction was stirred at room temperature for 18 hours. The resulting dark red solution was mixed with ZrCl₄ (235 mg 1.00 mmol) at −35° C. The red mixture was stirred at room temperature for another 24 hours and the volatiles were removed under vacuum. (Yield 53%, 0.53 mmol). ¹H NMR (C₆D₆, 400 MHz): δ 7.94 (d, J=8.8 Hz, 1H), 7.70 (d, 7.9 Hz, 1H), 7.58 (m, 2H), 7.11 (t, J=7.6 Hz, 1H), 7.04 (t, J=7.6 Hz, 1H), 6.95 (m, 1H), 6.46 (s, 1H), 6.19 (t, J=2.6 Hz, 1H), 5.69 (t, J=2.6 Hz, 1H), 1.1 (m, 9H) ppm.

Synthesis of (4-((9H-fluoren-9-yl)diphenylmethyl)cyclopenta-1,3-dien-1-yl)trimethylsilane (LC5). The LC5 ligand is a mixture of isomers, and the structure of one isomer is shown. This ligand may be abbreviated or written as Ph₂C(FlH)(CpH-SiMe₃).

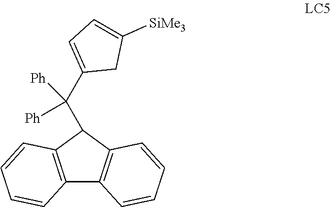 [SMILES: C[Si](C)(C)C1=CC=C(C(c2ccccc2)(c2ccccc2)C2c3ccccc3-c3ccccc32)C1]

The LC5 ligand was prepared in a manner analogous to that used in the preparation of the L9 ligand, using 1-cyclopentadienyl-1-(fluoren-9-yl)-1,1-diphenyl-methane (LP1) and chlorotrimethylsilane.

Synthesis of Ph₂C(Fl)(Cp-SiMe₃)ZrCl₂ (CM5). This metallocene was prepared in a manner analogous to that used in the preparation of M9, using the LC5 ligand and ZrCl₄.

Synthesis of (4-((2,7-di-tert-butyl-9H-fluoren-9-yl)diphenylmethyl)cyclopenta-1,3-dien-1-yl)trimethylsilane (LC6). The LC6 ligand is a mixture of isomers, and the structure of one isomer is shown. This ligand may be abbreviated or written as Ph₂C(2,7-t-Bu₂FlH)(CpH-SiMe₃).

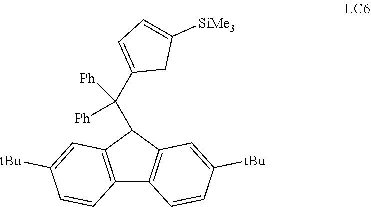 [SMILES: CC(C)(C)c1ccc2c(c1)C(C(C1=CC=C([Si](C)(C)C)C1)(c1ccccc1)c1ccccc1)c1cc(C(C)(C)C)ccc1-2]

The LC6 ligand was prepared in a manner analogous to that used in the preparation of the L8 ligand, using 1-cyclopentadienyl-1-(2,7-di-tert-butylfluoren-9-yl)-1,1-diphenyl-methane (LP2) and chlorotrimethylsilane.

Synthesis of Ph₂C(2,7-t-Bu₂Fl)(Cp-SiMe₃)ZrCl₂ (CM6). This metallocene was prepared in a manner analogous to that used in the preparation of M8, using the LC6 ligand and ZrCl₄.

Synthesis of (4-((9H-fluoren-9-yl)diphenylmethyl)cyclopenta-1,3-dien-1-yl)(allyl)dimethylsilane (LC7). The LC7 ligand is a mixture of isomers, and the structure of one isomer is shown. This ligand may be abbreviated or written as Ph₂C(FlH)(CpH-SiMe₂(allyl)).

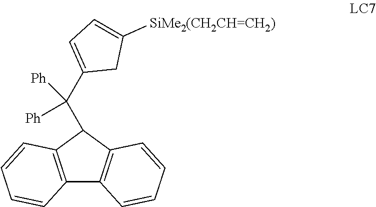

The LC7 ligand was prepared in a manner analogous to that used in the preparation of the L9 ligand, using 1-cyclopentadienyl-1-(fluoren-9-yl)-1,1-diphenyl-methane (LP1) and allyl(chloro)dimethylsilane.

Synthesis of Ph₂C(Fl)(Cp-SiMe₂(allyl))ZrCl₂ (CM7). This metallocene was prepared in a manner analogous to that used in the preparation of M9, using the LC7 ligand and ZrCl₄.

Synthesis of (cyclopenta-1,1-diyl)(2,7-t-Bu₂Fl)(Cp)ZrCl₂ (CM8). This metallocene was prepared in a manner analogous to that used in the preparation of M15, using the LP5 ligand and ZrCl₄, as follows. The ligand LP5 (410 mg, 1.0 mmol) was dissolved in anhydrous diethyl ether (10 mL) at −35° C., and a portion of n-BuLi (0.8 mL, 2.5 M in hexane) was added dropwise while stirring. This mixture was warmed up to room temperature and stirred overnight, after which the mixture was cooled down to −35° C. ZrCl₄ (233 mg, 1.0 mmol) was added to this cooled mixture portion wise. The resulting mixture was stirred at room temperature for 2 days, after which the organic solvent was removed under vacuum. The crude product was dissolved in dichloromethane and filtered through a glass frit to remove LiCl. Dichloromethane was removed from the filtrate under vacuum. The crude product was washed three times with anhydrous hexane. After washing, the product was dried thoroughly under vacuum, yielding a bright pink solid (360 mg, 0.55 mmol, yield: 55%). ¹H NMR (400 MHz, CDCl₃) δ 8.00 (d, J=8.8 Hz, 2H), 7.64 (d, J=8.8 Hz, 2H), 7.60 (s, 2H), 6.29 (s, 2H), 5.63 (s, 2H), 3.21 (m, 2H), 2.79 (m, 2H), 2.06 (m, 4H), 1.36 (s, 18H).

### Preparation of Metallocene-Activator Mixtures for Polymerization Studies

General methods for preparing mixtures of inventive or comparative metallocenes with solid methylaluminoxane (sMAO) are described here. The ratios of metallocene to activator for inventive Examples are set out in Table 2 (inventive examples), Table 5 (comparative examples), and Table 8 (aging examples). The examples in these tables use a mmol metallocene/mg sMAO ratio between about 3.85×10⁻⁵ and 4.42×10⁻⁵, whereas the following preparations use different metallocene/aluminum ratios as indicated.

Preparation of inventive examples metallocene/sMAO slurry. The metallocene/sMAO stock solutions (0.5 μmol/mL) were prepared by dissolving 0.01 mmol of the metallocene in a mixture of toluene (1 mL) and heptane (10 mL). The resultant solution was combined with solid MAO (sMAO), either as a decane slurry (2.17 g sMAO slurry with 12 wt % sMAO, 41.5 wt % Al in solid, 3.68 mmol Al) or a hexane/Isopar-E slurry (2.0 g sMAO slurry with 13 wt % sMAO, 41.5 wt % Al in solid, 3.68 mmol Al), to deliver a metallocene:aluminum (MCN:Al) ratio of 400:1. This resulting mixture was diluted with heptane to a total volume of 20 mL. This mixture provided a mmol metallocene/mg sMAO ratio of 3.84×10⁻⁵.

### Preparation of Comparative Examples Metallocene/sMAO Slurries.

Preparation of Me₂C(2,7-t-Bu₂Fl)(Cp)ZrCl₂ sMAO slurry. Me₂C(2,7-t-Bu₂Fl)(Cp)ZrCl₂ (CM3) (5.7 mg, 0.01 mmol) was combined with 20 mL heptanes in a vial. A 10 mL portion of the resulting solution was transferred to another vial and combined with sMAO in decane slurry (1 g, 12 wt. % sMAO, 41.5 wt % Al in solid, 2.02 mmol Al). This mixture provided a mmol metallocene/mg sMAO ratio of 4.2×10⁻⁵.

Preparation of(n-BuCp)₂ZrCl₂ sMAO slurry. An initial (n-BuCp)₂ZrCl₂ (CM1) stock solution (0.0046 M) was prepared by combining commercially obtained (n-BuCp)₂ZrCl₂ (93 mg, 0.23 mmol) with 50 mL of heptanes. To a sMAO slurry in decane (3.05 g, 12 wt. % sMAO, 41.5 wt % Al in solid, 6.17 mmol Al) was added 3.11 mL of the (n-BuCp)₂ZrCl₂ stock solution and 8.14 mL heptanes. The mmol metallocene/mg sMAO ratio is 3.9×10⁻⁵.

### Polymerization Reactions

Polymerizations were conducted in a dry, 2 L stainless steel Parr autoclave reactor using 1 L of isobutane diluent.

Prior to conducting a polymerization run, moisture was first removed from the reactor interior by pre-heating the reactor to at least 115° C. under a dry nitrogen flow, which was maintained for at least 15 minutes. Stirring was provided by an impellor and Magnadrive™ with a set point of, for example, 600 rpm. Unless otherwise indicated, polymerization runs were conducted at 80° C. and total pressure of 350 psi and used 2.7 mmol TNOAl scavenger. (One run was conducted at 60° C.)

The post-contacted catalyst components, that is the composition containing all the listed catalyst system components that were previously contacted to form the composition, were prepared in an inert atmosphere glove box under dry nitrogen and transferred to a catalyst charge tube or vessel as described above. The catalyst charge vessel contents were then charged to the reactor by flushing them in with 1 L of isobutane. The reactor temperature control system was then turned on and is allowed to reach several (5-10 Centigrade) degrees lower than the temperature set-point, which typically took about 7 minutes. The reactor was brought to run pressure by opening a manual feed valve for the ethylene, and polymerization runs were continued for 1 hour to provide the polymer and data in the Tables. The selected pressures (H₂/C₂ ratio, psi/psi), temperature, reaction times, and component amounts are provided in the Tables. Activity data in the tables were typically obtained from polymerizations conducted at 350 total psi, 80° C., and 60 minute reaction times, unless otherwise indicated. For example, Example 18 using M9 was conducted at 60° C. A pre-mixed gas feed tank (“mixtank”) of purified hydrogen and ethylene was used to maintain the desired total reactor pressure, with a large enough volume and a high enough pressure in the feed tank so as not to significantly change the ratio of hydrogen-to-ethylene in the feed to the reactor.

Alternatively, the contents of the catalyst charge tube can be pushed into the reaction vessel with ethylene at several degrees below the set point temperature of the run, for example, about 10 degrees centigrade below the set point temperature. In this method, two charge tubes were used. When the run pressure was reached, the reactor pressure was controlled by an in-line regulator placed between the mix tank and the reactor, providing a constant feed at a constant pressure to the reactor. The consumption of ethylene and the temperature were monitored electronically. During the course of the polymerization, with the exception of the initial charge of catalyst during the first few minutes of the run, the reactor temperature was maintained at the set point temperature ±3° C. After a designated run time (for example, 1 hour), the polymerization was stopped by shutting off the ethylene inlet valve and venting the isobutane. The reactor was returned to ambient temperature. The polymer produced in the reaction was then removed from the reactor and dried, and the polymer weight was used to calculate the activity of the particular polymerization.

### ASPECTS OF THE DISCLOSURE

The disclosure is described above with reference to numerous aspects and embodiments, and specific examples. These and other aspects, embodiments, and features of the disclosure can include, but are not limited to, the following list of Aspects of the Disclosure.

Aspect 1. A catalyst composition comprising the contact product of:
(a) a metallocene compound having the formula:

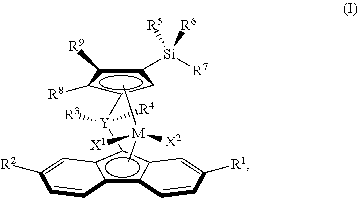

wherein
   (i) M is Zr or Hf;
   (ii) X¹ and X² are selected independently from a monoanionic ligand or X¹ and X² together are a dianionic ligand (including, for example, a conjugated diene ligand bound to M by delocalized π-electrons, also referred to as a 1,4-diyl-2-ene ligand);
   (iii) R¹ and R² are selected independently from H or a C₁-C₂₀ hydrocarbyl;
   (iv) Y is C or Si;
   (v)(A) R³ and R⁴ are selected independently from a C₁ to C₂₀ hydrocarbyl, or (B) when Y is C, YR³R⁴ is a substituted or an unsubstituted C₃ to C₇ monocyclic hydrocarbylidene moiety, wherein any substituent comprises an independently selected C₁ to C₁₅ hydrocarbyl group, C₁ to C₁₅ heterohydrocarbyl group, C₁ to C₁₅ organoheteryl group, or halide;
   (vi) R⁵ and R⁶ are selected independently from a C₁-C₂₀ hydrocarbyl;
   (vii) R⁷ is selected from a C₂-C₂₀ hydrocarbyl, and wherein optionally (A) any two of R⁵, R⁶, and R⁷, along with Si to which they are bonded form a ring having from 2 to 7 carbon atoms, or (B) R⁵, R⁶, and Si to which they are bonded form a ring having from 2 to 7 carbon atoms; and
   (viii) R⁸ and R⁹ are H₂, fused C₄H₄, or fused C₄H₈;
wherein each of R⁵, R⁶, and R⁷ is independently a non-alkenyl, a non-alkynyl, or a non-alkadienyl hydrocarbyl;
   and
(b) a metallocene activator.

Aspect 2. A process for polymerizing olefins comprising contacting at least one olefin monomer, which can comprise ethylene, and a catalyst composition under polymerization conditions to form a polyolefin, wherein the catalyst composition comprises the contact product of:
(a) a metallocene compound having the formula:

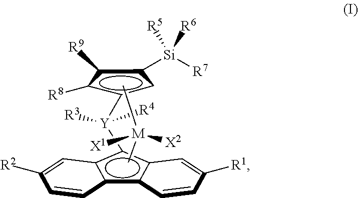

wherein
   (i) M is Zr or Hf;
   (ii) X¹ and X² are selected independently from a monoanionic ligand or X¹ and X² together are a dianionic ligand (including, for example, a conjugated diene ligand bound to M by delocalized π-electrons, also referred to as a 1,4-diyl-2-ene ligand);
   (iii) R¹ and R² are selected independently from H or a C₁-C₂₀ hydrocarbyl;
   (iv) Y is C or Si;
   (v)(A) R³ and R⁴ are selected independently from a C₁ to C₂₀ hydrocarbyl, or (B) when Y is C, YR³R⁴ is a substituted or an unsubstituted C₃ to C₇ monocyclic hydrocarbylidene moiety, wherein any substituent comprises an independently selected C₁ to C₁₅ hydrocarbyl group, C₁ to C₁₅ heterohydrocarbyl group, C₁ to C₁₅ organoheteryl group, or halide;
   (vi) R⁵ and R⁶ are selected independently from a C₁-C₂₀ hydrocarbyl;
   (vii) R⁷ is selected from a C₂-C₂₀ hydrocarbyl, and wherein optionally (A) any two of R⁵, R⁶, and R⁷, along with Si to which they are bonded form a ring having from 2 to 7 carbon atoms, or (B) R⁵, R⁶, and Si to which they are bonded form a ring having from 2 to 7 carbon atoms; and
   (viii) R⁸ and R⁹ are H₂, fused C₄H₄, or fused C₄H₈;
wherein each of R⁵, R⁶, and R⁷ is selected independently from a non-alkenyl, a non-alkynyl, or a non-alkadienyl hydrocarbyl;
   and
(b) a metallocene activator.

Aspect 3. A method of making a catalyst composition comprising contacting:
(a) a metallocene compound having the formula:

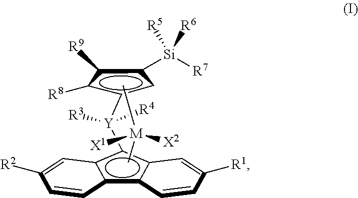

wherein
   (i) M is Zr or Hf;
   (ii) X¹ and X² are selected independently from a monoanionic ligand or X¹ and X² together are a dianionic ligand (including, for example, a conjugated diene ligand bound to M by delocalized π-electrons, also referred to as a 1,4-diyl-2-ene ligand);
   (iii) R¹ and R² are selected independently from H or a C₁-C₂₀ hydrocarbyl;
   (iv) Y is C or Si;
   (v)(A) R³ and R⁴ are selected independently from a C₁ to C₂₀ hydrocarbyl, or (B) when Y is C, YR³R⁴ is a substituted or an unsubstituted C₃ to C₇ monocyclic hydrocarbylidene moiety, wherein any substituent comprises an independently selected C₁ to C₁₅ hydrocarbyl group, C₁ to C₁₅ heterohydrocarbyl group, C₁ to C₁₅ organoheteryl group, or halide;
   (vi) R⁵ and R⁶ are selected independently from a C₁-C₂₀ hydrocarbyl;
   (vii) R⁷ is selected from a C₂-C₂₀ hydrocarbyl, and wherein optionally (A) any two of R⁵, R⁶, and R⁷, along with Si to which they are bonded form a ring having from 2 to 7 carbon atoms, or (B) R⁵, R⁶, and Si to which they are bonded form a ring having from 2 to 7 carbon atoms; and
   (viii) R⁸ and R⁹ are H₂, fused C₄H₄, or fused C₄H₈;
wherein each of R⁵, R⁶, and R⁷ is selected independently from a non-alkenyl, a non-alkynyl, or a non-alkadienyl hydrocarbyl;
   and
(b) a metallocene activator.

Aspect 4. The catalyst composition, the process for polymerizing olefins, or the method of making a catalyst composition according to any of the preceding Aspects, wherein: (a) none of R⁵ and R⁶ is methyl group; (b) one of R⁵ and R⁶ is methyl group; or (c) both R⁵ and R⁶ are methyl groups.

Aspect 5. The catalyst composition, the process for polymerizing olefins, or the method of making a catalyst composition according to any of the preceding Aspects, wherein all three of R⁵, R⁶, and R⁷ are selected independently from a C₂-C₂₀ hydrocarbyl.

Aspect 6. The catalyst composition, the process for polymerizing olefins, or the method of making a catalyst composition according to any of the preceding Aspects, wherein all three of R⁵, R⁶, and R⁷ are the same.

Aspect 7. The catalyst composition, the process for polymerizing olefins, or the method of making a catalyst composition according to any of the preceding Aspects, wherein any two of R⁵, R⁶, and R⁷ are the same and are different from the other one of the R⁵, R⁶, and R⁷ groups.

Aspect 8. The catalyst composition, the process for polymerizing olefins, or the method of making a catalyst composition according to any of the preceding Aspects, wherein each of R⁵, R⁶, and R⁷ is different from the other two of the R⁵, R⁶, and R⁷, that is, none of R⁵, R⁶, and R⁷ is the same.

Aspect 9. The catalyst composition, the process for polymerizing olefins, or the method of making a catalyst composition according to any of the preceding Aspects, wherein SiR⁵R⁶R⁷ is selected from SiMe₂Et, SiMe₂(n-Pr), SiMe₂(n-Bu), SiMe₂(n-hexyl), SiMe₂(n-heptyl), SiMe₂(n-octyl), SiMe₂(cyclohexyl), SiMe₂(2-norbornyl), SiMe₂(bicyclo[2.2.2]octanyl), SiMe₂(adamantyl), SiEt₃, SiEt₂(n-Pr), SiEt₂(n-Bu), SiEt₂(n-hexyl), SiEt₂(n-heptyl), SiEt₂(n-octyl), SiEt₂(cyclohexyl), SiEt₂(2-norbornyl), SiEt₂(bicyclo[2.2.2]octanyl), SiEt₂(adamantyl), Si(n-Pr)₃, Si(n-Bu)₃, or Si(n-hexyl)₃.

Aspect 10. The catalyst composition, the process for polymerizing olefins, or the method of making a catalyst composition according to any of the preceding Aspects, wherein R⁷ is a substituted or an unsubstituted cyclic C₃-C₁₈ hydrocarbyl group, a bicyclic C₅-C₁₈ hydrocarbyl group, or a tricyclic C₈-C₂₀ hydrocarbyl group, wherein any substituent is selected independently from a C₁ to C₁₅ hydrocarbyl group, a C₁ to C₁₅ heterohydrocarbyl group, a C₁ to C₁₅ organoheteryl group, or halide.

Aspect 11. The catalyst composition, the process for polymerizing olefins, or the method of making a catalyst composition according to any of the preceding Aspects, wherein (a) at least one of R⁵, R⁶, and R⁷ is halide-substituted, C₁-C₆ alkoxide-substituted, or C₁-C₆ alkylamide-substituted, or (b) none of R⁵, R⁶, and R⁷ is substituted.

Aspect 12. The catalyst composition, the process for polymerizing olefins, or the method of making a catalyst composition according to any of the preceding Aspects, wherein:
(a) none of R⁵, R⁶, and R⁷ is aryl, that is, each of R⁵, R⁶, and R⁷ is selected independently from a non-aryl moiety;
(b) none of R³ and R⁴ is alkenyl, that is, each of R³ and R⁴ is selected independently from a non-alkenyl moiety;
(c) none of R¹ and R² is alkenyl, that is, each of R¹ and R² is selected independently from a non-alkenyl moiety;
(d) none of R⁸ and R⁹ is alkenyl, that is, each of R⁸ and R⁹ is selected independently from a non-alkenyl moiety; or
(e) any combination of (a), (b), (c), and (d).

Aspect 13. The catalyst composition, the process for polymerizing olefins, or the method of making a catalyst composition according to any of the preceding Aspects, wherein:
R⁵ and R⁶ are selected independently from a C₁ to C₁₂ alkyl, a substituted or an unsubstituted C₃ to C₇ cycloalkyl, a C₆ to C₁₂ aryl, a C₇ to C₁₅ aralkyl (also termed “arylalkyl”), or a C₇ to C₁₅ alkaryl (also termed “alkylaryl”); and
R⁷ is selected from a C₂ to C₁₂ alkyl, a substituted or an unsubstituted C₃ to C₇ cycloalkyl, a C₆ to C₁₂ aryl, a C₇ to C₁₅ aralkyl, or a C₇ to C₁₅ alkaryl.

Aspect 14. The catalyst composition, the process for polymerizing olefins, or the method of making a catalyst composition according to any of the preceding Aspects, wherein Y is Si.

Aspect 15. The catalyst composition, the process for polymerizing olefins, or the method of making a catalyst composition according to any of the preceding Aspects, wherein: (a) R³ and R⁴ are selected independently from a C₁ to C₂₀ aliphatic group or a C₆ to C₂₀ aromatic group, a C₁ to C₁₅ aliphatic group or a C₆ to C₁₅ aromatic group, or a C₁ to C₁₀ aliphatic group or a C₆ to C₁₀ aromatic group; or (b) when Y is C, R³ and R⁴ are selected independently from a C₁ to C₂₀ aliphatic group or a C₆ to C₂₀ aromatic group, a C₁ to C₁₅ aliphatic group or a C₆ to C₁₅ aromatic group, or a C₁ to C₁₀ aliphatic group or a C₆ to C₁₀ aromatic group.

Aspect 16. The catalyst composition, the process for polymerizing olefins, or the method of making a catalyst composition according to any of the preceding Aspects, wherein (a) R³ and R⁴ are selected independently from a C₁ to C₂₀ hydrocarbyl other than an aryl group, or (b) when Y is C, R³ and R⁴ are selected independently from a C₁ to C₂₀ hydrocarbyl other than an aryl group.

Aspect 17. The catalyst composition, the process for polymerizing olefins, or the method of making a catalyst composition according to any of the preceding Aspects, wherein (a) R³ and R⁴ are selected independently from a C₁ to C₂₀ aliphatic group, or (b) when Y is C, R³ and R⁴ are selected independently from a C₁ to C₂₀ aliphatic group.

Aspect 18. The catalyst composition, the process for polymerizing olefins, or the method of making a catalyst composition according to any of the preceding Aspects, wherein: (a) R³ and R⁴ are selected independently from a C₁ to C₂₀ alkyl or cycloalkyl group; or (b) when Y is C, R³ and R⁴ are selected independently from a C₁ to C₂₀ alkyl or cycloalkyl group.

Aspect 19. The catalyst composition, the process for polymerizing olefins, or the method of making a catalyst composition according to any of the preceding Aspects, wherein: (a) R³ and R⁴ are selected independently from a C₁ to C₁₅ alkyl or a C₆ to C₁₅ aryl; or (b) when Y is C, R³ and R⁴ are selected independently from a C₁ to C₁₅ alkyl or a C₆ to C₁₂ aryl.

Aspect 20. The catalyst composition, the process for polymerizing olefins, or the method of making a catalyst composition according to any of the preceding Aspects, wherein R³ and R⁴ are selected independently from a C₁ to C₁₂ alkyl, a C₃ to C₇ cycloalkyl, a C₆ to C₁₂ aryl, a C₇ to C₁₅ aralkyl (also termed “arylalkyl”), or a C₇ to C₁₅ alkaryl (also termed “alkylaryl”).

Aspect 21. The catalyst composition, the process for polymerizing olefins, or the method of making a catalyst composition according to any of the preceding Aspects, wherein (a) neither R³ or R⁴ is alkenyl, or (b) the metallocene compound comprises no alkenyl substituent, that is, is absent an alkenyl substituent.

Aspect 22. The catalyst composition, the process for polymerizing olefins, or the method of making a catalyst composition according to any of the preceding Aspects, wherein:
X¹ and X² are selected independently from H, a halide, a C₁-C₂₅ hydrocarbyl, a C₁-C₂₅ heterohydrocarbyl, a C₁-C₂₅ organoheteryl, or X¹ and X² together are a substituted or unsubstituted C₄-C₂₅ 1,4-diyl-2-ene dianionic ligand.

Aspect 23. The catalyst composition, the process for polymerizing olefins, or the method of making a catalyst composition according to any of the preceding Aspects, wherein:
X¹ and X² are selected independently from H, a halide, a C₁-C₂₀ alkyl, a C₆-C₂₀ aryl, a C₁-C₂₀ hydrocarbyloxide, a C₃-C₂₃ organosilyl, a C₂-C₂₀ alkoxyalkyl, a C₇-C₂₀ alkoxyaryl, a C₄-C₂₅ trihydrocarbylsilyl-substituted alkyl, or X¹ and X² together are a C₄-C₂₀ or a C₄-C₁₅ substituted or unsubstituted 1,4-diyl-2-ene dianionic ligand.

Aspect 24. The catalyst composition, the process for polymerizing olefins, or the method of making a catalyst composition according to any of the preceding Aspects, wherein any substituent on the C₃ to C₇ monocyclic hydrocarbylidene moiety comprises an independently selected:
C₂ to C₁₅ hydrocarbyl group, C₂ to C₁₅ heterohydrocarbyl group, or C₂ to C₁₅ organoheteryl group;
C₂ to C₁₂ hydrocarbyl group, C₂ to C₁₂ heterohydrocarbyl group, or C₂ to C₁₂ organoheteryl group; or
C₁ to C₁₂ hydrocarbyl group, C₁ to C₁₂ heterohydrocarbyl group, or C₁ to C₁₂ organoheteryl group.

Aspect 25. The catalyst composition, the process for polymerizing olefins, or the method of making a catalyst composition according to any of the preceding Aspects, wherein the C₃ to C₇ monocyclic hydrocarbylidene is selected from cyclobutylidene, cyclopentylidene, and cyclohexylidene.

Aspect 26. The catalyst composition, the process for polymerizing olefins, or the method of making a catalyst composition according to any of the preceding Aspects, wherein the metallocene compound has the formula:

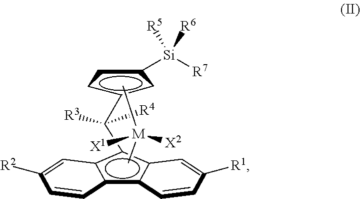

wherein
(i) M is Zr or Hf;
(ii) X¹ and X² are selected independently from H, a halide, a C₁-C₁₂ hydrocarbyl, a C₁-C₁₂ hydrocarbyloxide, or X¹ and X² together are a C₄-C₁₅ 1,4-diyl-2-ene ligand;
(iii) R¹ and R² are selected independently from H or a C₁-C₁₂ hydrocarbyl;
(iv)(A) R³ and R⁴ are selected independently a C₁ to C₁₂ alkyl, a C₃ to C₇ cycloalkyl, a C₆ to C₁₂ aryl, a C₇ to C₁₅ aralkyl, or a C₇ to C₁₅ alkaryl, or (B) CR³R⁴ is a substituted or an unsubstituted C₃ to C₇ monocyclic hydrocarbylidene moiety; wherein any substituent comprises an independently selected C₁ to C₁₂ hydrocarbyl group, C₁ to C₁₂ heterohydrocarbyl group, or C₁ to C₁₂ organoheteryl group;
(v) R⁵ and R⁶ are selected independently from a C₁-C₁₂ hydrocarbyl; and
(vi) R⁷ is selected from a C₂-C₁₂ hydrocarbyl.

Aspect 27. The catalyst composition, the process for polymerizing olefins, or the method of making a catalyst composition according to any of the preceding Aspects, wherein the metallocene compound has the formula:

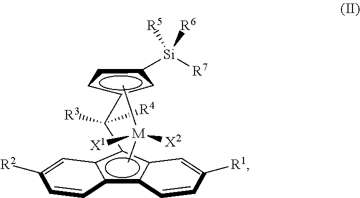

wherein
(i) M is Zr or Hf;
(ii) X¹ and X² are selected independently from a halide, a C₁-C₁₂ hydrocarbyl, or a C₁-C₁₂ hydrocarbyloxide;
(iii) R¹ and R² are selected independently from H or a C₁-C₆ hydrocarbyl;
(iv)(A) R³ and R⁴ are selected independently from a C₁ to C₁₂ alkyl, a C₃ to C₇ cycloalkyl, or a C₆ to C₁₂ aryl, or (B) CR³R⁴ is a C₃ to C₆ monocyclic hydrocarbylidene moiety;
(v) R⁵ and R⁶ are selected independently from a C₁-C₈ alkyl or C₃ to C₇ cycloalkyl; and
(vi) R⁷ is selected from a C₂-C₈ hydrocarbyl.

Aspect 28. The catalyst composition, the process for polymerizing olefins, or the method of making a catalyst composition according to any of the preceding Aspects, wherein the metallocene compound has the formula:

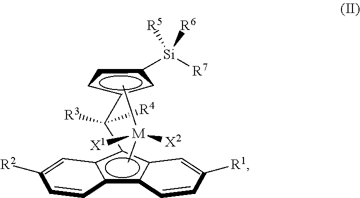

wherein
(i) M is Zr or Hf;
(ii) X¹ and X² are selected independently from a halide, a C₁-C₈ hydrocarbyl, or a C₁-C₈ hydrocarbyloxide;
(iii) R¹ and R² are selected independently from H or a C₁-C₆ hydrocarbyl;
(iv)(A) R³ and R⁴ are selected independently from a C₁ to C₁₀ alkyl, a C₃ to C₇ cycloalkyl, or a C₆ to C₁₂ aryl, or (B) CR³R⁴ is a C₃ to C₆ monocyclic hydrocarbylidene moiety;
(v) R⁵ and R⁶ are selected independently from a C₁-C₈ alkyl or C₃ to C₇ cycloalkyl; and
(vi) R⁷ is selected from a C₂-C₈ hydrocarbyl.

Aspect 29. The catalyst composition, the process for polymerizing olefins, or the method of making a catalyst composition according to any of the preceding Aspects, wherein the metallocene compound has the formula:

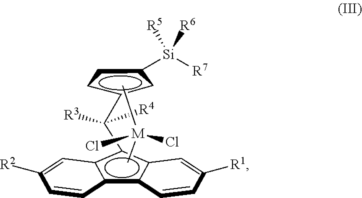

wherein
(i) M is Zr or Hf;
(ii) R¹ and R² are both H or t-butyl;
(iii)(A) R³ and R⁴ are both Me or Ph, or (B) CR³R⁴ is a cyclobutylidene, cyclopentylidene, or cyclohexylidene;
(iv) R⁵ and R⁶ are both Me, Et, or n-Pr; and
(v) R⁷ is Et, n-Pr, n-Bu, n-hexyl, n-heptyl, cyclohexyl, or 2-norbornyl.

Aspect 30. The catalyst composition, the process for polymerizing olefins, or the method of making a catalyst composition according to any of the preceding Aspects, wherein the metallocene compound has the formula:

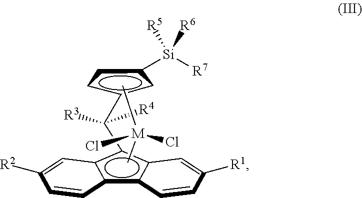

wherein
(i) M is Zr or Hf;
(ii) R¹ and R² are both H or t-butyl;
(iii) R³ and R⁴ are both Me or Ph;
(iv) R⁵ and R⁶ are both Me, Et, n-Pr, or n-Bu; and
(v) R⁷ is Et, n-Pr, n-Bu, n-hexyl, n-heptyl, cyclohexyl, or 2-norbornyl.

Aspect 31. The catalyst composition, the process for polymerizing olefins, or the method of making a catalyst composition according to any of the preceding Aspects, wherein the metallocene compound has the formula:

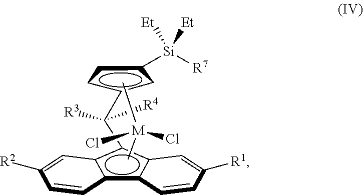

wherein
(i) M is Zr or Hf;
(ii) R¹ and R² are both H or t-butyl;
(iii) R³ and R⁴ are both methyl or phenyl, or R³ and R⁴ together are cyclopentylidene; and
(iv) R⁷ is Et, n-Pr, n-Bu, n-hexyl, n-heptyl, cyclohexyl, or 2-norbornyl.

Aspect 32. The catalyst composition, the process for polymerizing olefins, or the method of making a catalyst composition according to any of the preceding Aspects, wherein the metallocene compound has the formula:

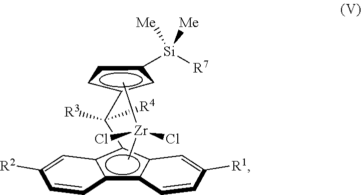

wherein
(i) R¹ and R² are both H or t-butyl;
(ii) R³ and R⁴ are both methyl or phenyl; and
(iii) R⁷ is Et, n-Pr, n-Bu, n-hexyl, n-heptyl, cyclohexyl, or 2-norbornyl.

Aspect 33. The catalyst composition, the process for polymerizing olefins, or the method of making a catalyst composition according to any of the preceding Aspects, wherein the metallocene compound has the formula:

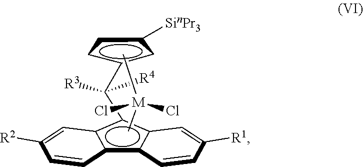

wherein
(i) M is Zr or Hf;
(ii) R¹ and R² are both H or t-butyl; and
(iii) R³ and R⁴ are both methyl or phenyl, or R³ and R⁴ together are cyclopentylidene.

Aspect 34. The catalyst composition, the process for polymerizing olefins, or the method of making a catalyst composition according to any of the preceding Aspects, wherein any of the C₁-C₂₀₋ hydrocarbyl, C₂-C₂₀₋ hydrocarbyl, fused C₄H₄, fused C₄H₈, C₁ to C₁₂₋ alkyl, C₃ to C₇ cycloalkyl, C₆ to C₂₀₋ aryl, C₇ to C₁₅ aralkyl, C₇ to C₁₅ alkaryl, cyclobutylidene, cyclopentylidene, or cyclohexylidene is optionally substituted with one or more C₁ to C₁₅ heterohydrocarbyl group, C₁ to C₁₅ organoheteryl group, or halide.

Aspect 35. The catalyst composition, the process for polymerizing olefins, or the method of making a catalyst composition according to any of the preceding Aspects, wherein the metallocene compound has the formula:

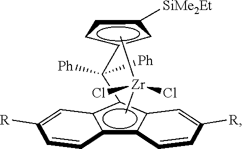

wherein R=^{t}Bu (M1) or H (M2);

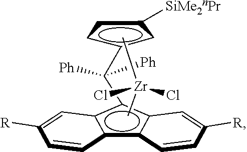

wherein R=^{t}Bu (M3) or R=H (M4);

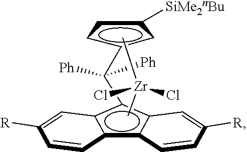

wherein R=^{t}Bu (M5Bu) or H (M5);

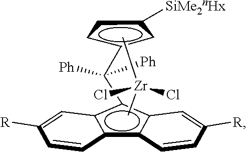

wherein R=^{t}Bu (M22) or H (M23);

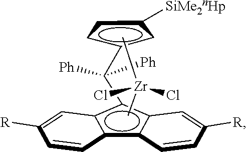

wherein R=^{t}Bu (M24) or H (M25);

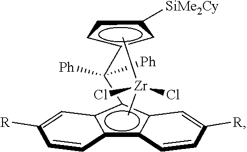

wherein R=^{t}Bu (M20) or H (M21);

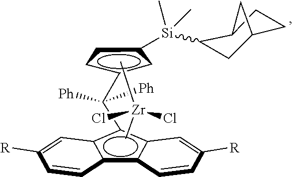

wherein R=^{t}Bu (M6) or H (M7);

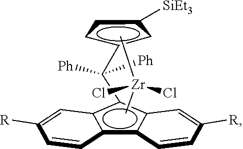

wherein R=^{t}Bu (M8) or H (M9);

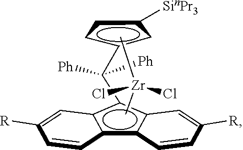

wherein R=^{t}Bu (M12) or R (M13);

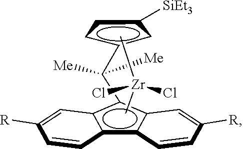

wherein R=^{t}Bu (M10) or H (M11);

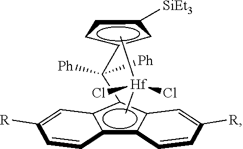

wherein R=^{t}Bu (M14Bu) or H (M14);

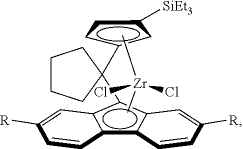

wherein R=^{t}Bu (M15) or H (M16);

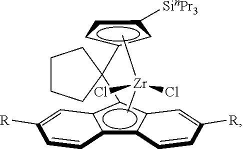

wherein R=^{t}Bu (M18Bu) or H (M18);

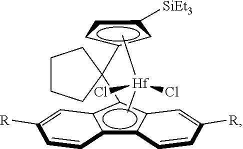

wherein R=^{t}Bu (M17Bu) or H (M17); or

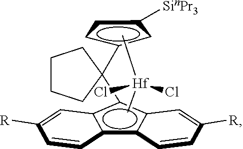

wherein R=^{t}Bu (M19Bu) or H (M19); and any combinations thereof.

Aspect 36. The catalyst composition, the process for polymerizing olefins, or the method of making a catalyst composition according to any of the preceding Aspects, wherein the catalyst composition comprises a single metallocene compound.

Aspect 37. The catalyst composition, the process for polymerizing olefins, or the method of making a catalyst composition according to any of the preceding Aspects, wherein the catalyst composition comprises more than one metallocene compound.

Aspect 38. The catalyst composition, the process for polymerizing olefins, or the method of making a catalyst composition according to any of the preceding Aspects, wherein the metallocene compound, the metallocene activator, and optionally a co-catalyst are contacted for a time period from about 1 minute to about 6 months, from about 1 minute to about 1 month, from about 1 minute to about 2 days, or from about 1 minute to about 2 hours and at a temperature from about 10° C. to about 200° C. or from about 15° C. to about 80° C., to form the catalyst composition.

Aspect 39. The catalyst composition, the process for polymerizing olefins, or the method of making a catalyst composition according to any of the preceding Aspects, wherein the metallocene compound and the metallocene activator are contacted (a) for a time period from about 1 minute to about 48 hours or from about 5 minutes to about 24 hours and at a temperature from about 10° C. to about 200° C. or from about 15° C. to about 80° C., to form a first mixture, followed by (b) contacting the first mixture with a co-catalyst form the catalyst composition.

Aspect 40. The catalyst composition, the process for polymerizing olefins, or the method of making a catalyst composition according to any of the preceding Aspects, wherein the metallocene compound and the metallocene activator are contacted (“pre-contacted”) for a period of from 0.5 day to 90 days, alternatively from 1 day to 75 days, or alternatively from 2 days to 60 days prior to use of the contact product to polymerize olefins.

Aspect 41. The catalyst composition, the process for polymerizing olefins, or the method of making a catalyst composition according to any of the preceding Aspects, wherein the metallocene compound and the metallocene activator are contacted (“pre-contacted”) for a period of 0.5 day, 1 day, 2 days, 3 days, 4 days, 5 days, 6 days, 7 days 8 days, 9 days, 10 days, 11 days, 12 days, 13 days, 14 days, 15 days, 16 days, 17 days, 18 days, 19 days, 20 days, 22 days, 25 days, 28 days, 30 days, 35 days, 40 days, 45 days, 50 days, 55 days, 60 days, 75 days, 90 days, or greater than 90 days prior to use of the contact product to polymerize olefins, or any time period between any of these recited time periods.

Aspect 42. The catalyst composition, the process for polymerizing olefins, or the method of making a catalyst composition according to any of the preceding Aspects, wherein the contact product comprises the contact product of (a) the metallocene compound, (b) the metallocene activator, and (c) any of, or any combination of, a co-catalyst, hydrogen, ethylene, an α-olefin, and a liquid carrier.

Aspect 43. The catalyst composition, the process for polymerizing olefins, or the method of making a catalyst composition according to any of the preceding Aspects, wherein the contact product comprises the contact product of (a) the metallocene compound, (b) the metallocene activator, and (c) a co-catalyst.

Aspect 44. The catalyst composition, the process for polymerizing olefins, or the method of making a catalyst composition according to any of the preceding Aspects, wherein the contact product comprises:
a first contact product of any two or more components selected from the metallocene compound, the metallocene activator, a co-catalyst, hydrogen, ethylene, an α-olefin, and a liquid carrier which are contacted for a first time period;
wherein after the first time period, the first contact product is contacted with any one or more components of the metallocene compound, the metallocene activator, a co-catalyst, hydrogen, ethylene, an α-olefin, and a liquid carrier not contacted in the first contact product, which are contacted for a second time period, to form a second contact product;
wherein the combined first time period and second time period is from 0.5 day to 90 days, alternatively from 1 day to 75 days, or alternatively from 2 days to 60 days prior to use of the contact product to polymerize olefins.

Aspect 45. The catalyst composition, the process for polymerizing olefins, or the method of making a catalyst composition according to any of the preceding Aspects, wherein the metallocene activator comprises, consists essentially of, or is selected from:
an aluminoxane;
an organoaluminum compound;
an aluminate compound;
an isolated smectite heterocoagulate comprising the contact product in a liquid carrier of [1] a colloidal smectite clay and [2] a heterocoagulation reagent comprising at least one cationic polymetallate;
a smectite heteroadduct comprising or consisting essentially of a contact product of a colloidal smectite clay and a surfactant;
an ion-exchanged clay;
a protic-acid-treated clay;
a pillared clay;
an organoboron or organoborate compound;
an ionizing ionic compound;
a solid oxide treated with an electron withdrawing anion, or any combination thereof; or
any combination of these metallocene activators.

Aspect 46. The catalyst composition, the process for polymerizing olefins, or the method of making a catalyst composition according to any of the preceding Aspects, wherein the metallocene activator comprises, consists essentially of, or is selected from (a) a cyclic aluminoxane compound having the formula (R—Al—O)ₙ, wherein R is a linear or branched alkyl having from 1 to about 12 carbon atoms, and n is an integer from 3 to about 12; or (b) an aluminoxane having the formula R(R—Al—O)ₙAlR₂, wherein R is a linear or branched alkyl having from 1 to about 12 carbon atoms, and n is an integer from 1 to about 75.

Aspect 47. The catalyst composition, the process for polymerizing olefins, or the method of making a catalyst composition according to any of the preceding Aspects, wherein the metallocene activator comprises, consists essentially of, or is selected from an aluminoxane, and the aluminoxane is selected from methylaluminoxane, ethylaluminoxane, n-propylaluminoxane, iso-propyl-aluminoxane, n-butylaluminoxane, t-butylaluminoxane, sec-butylaluminoxane, iso-butylaluminoxane, 1-pentylaluminoxane, 2-pentylaluminoxane, 3-pentyl-aluminoxane, iso-pentylaluminoxane, neopentylaluminoxane, or combinations thereof.

Aspect 48. The catalyst composition, the process for polymerizing olefins, or the method of making a catalyst composition according to any of the preceding Aspects, wherein the metallocene activator comprises, consists essentially of, or is selected from solid methylaluminoxane.

Aspect 49. The catalyst composition, the process for polymerizing olefins, or the method of making a catalyst composition according to any of the preceding Aspects, wherein the metallocene activator comprises, consists essentially of, or is selected from an organoaluminum compound having the formula:

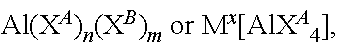

wherein
n+m=3, wherein n and m are not limited to integers;
X^{A} is selected independently from: [1] a hydride, a C₁-C₂₀ hydrocarbyl, or a C₁-C₂₀ heterohydrocarbyl; [2] a hydride, a C₁-C₂₀ aliphatic group, a C₆-C₂₀ aromatic group, a C₁-C₂₀ heteroaliphatic group, or a C₄-C₂₀ heteroaromatic group; or [3] two X^{A} together comprise a C₄-C₅ hydrocarbylene group and the remaining X^{A} is/are selected independently from a hydride, a C₁-C₂₀ hydrocarbyl, or a C₁-C₂₀ heterohydrocarbyl;
X^{B} is selected independently from: [1] a halide or a C₁-C₂₀ organoheteryl; or [2] a halide, a C₁-C₁₂ alkoxide group, or a C₆-C₁₀ aryloxide group; and
M^{x} is selected from Li, Na, or K.

Aspect 50. The catalyst composition, the process for polymerizing olefins, or the method of making a catalyst composition according to any of the preceding Aspects, wherein the metallocene activator comprises, consists essentially of, or is selected from an organoaluminum compound having the formula:

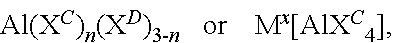

wherein
n is 1, 2, or 3;
X^{C} is selected independently from a hydride or a C₁-C₂₀ hydrocarbyl;
X^{D} is a formal anionic species selected independently from: fluoride; chloride; bromide; iodide; bromate; chlorate; perchlorate; hydrocarbylsulfate; hydrocarbylsulfite; sulfamate; hydrocarbylsulfide, hydrocarbylcarbonate; hydrogen-carbonate (bicarbonate); carbamate; nitrite; nitrate; hydrocarbyloxalate; dihydrocarbylphosphate; hydrocarbylselenite; sulfate; sulfite; carbonate; oxalate; phosphate; phosphite; selenite; selenide; sulfide; oxide; sulfamate; azide; alkoxide; amido; hydrocarbylamido; or dihydrocarbylamido; and
M^{x} is selected from Li, Na, or K.

Aspect 51. The catalyst composition, the process for polymerizing olefins, or the method of making a catalyst composition according to any of the preceding Aspects, wherein the metallocene activator comprises, consists essentially of, or is selected from trimethylaluminum, triethylaluminum (TEA), tripropylaluminum, tributylaluminum (for example, tri-n-butylaluminum, tri-t-butylaluminum, tri-sec-butyaluminum), trihexylaluminum, trioctylaluminum, ethyl-(3-alkylcyclopentadiyl)aluminum, diethylaluminum ethoxide, diisobutylaluminum hydride, triisobutylaluminum (TIBAL), diethylaluminum chloride, ethyl-(3-alkylcyclopentadiyl)aluminum, trioctylaluminum, or any combination thereof.

Aspect 52. The catalyst composition, the process for polymerizing olefins, or the method of making a catalyst composition according to any of the preceding Aspects, wherein the metallocene activator comprises, consists essentially of, or is selected from an isolated smectite heterocoagulate comprising the contact product in a liquid carrier of [1] a colloidal smectite clay and [2] a heterocoagulation reagent comprising at least one cationic polymetallate and in an amount sufficient to provide a slurry of the smectite heteroadduct having a zeta potential in a range of from about positive (+)25 mV (millivolts) to about negative (−)25 mV prior to isolation of the smectite heterocoagulate from the slurry, as quantified from the Electrokinetic Sonic Amplitude (ESA) Effect.

Aspect 53. The catalyst composition, the process for polymerizing olefins, or the method of making a catalyst composition of the Aspect 35, wherein:
(a) the smectite clay comprises montmorillonite, sauconite, nontronite, hectorite, beidellite, saponite, bentonite, or any combination thereof; and
(b) the cationic polymetallate comprises a cationic polyaluminate selected from polyaluminum chloride, aluminum chlorhydrate, aluminum sesquichlorohydrate, or polyaluminum oxyhydroxychloride, or any combination thereof.

Aspect 54. The catalyst composition, the process for polymerizing olefins, or the method of making a catalyst composition according to any of the preceding Aspects, wherein the metallocene activator comprises, consists essentially of, or is selected from an isolated smectite heterocoagulate as disclosed in U.S. Pat. No. 11,339,229, which is incorporated herein by reference in its entirety.

Aspect 55. The catalyst composition, the process for polymerizing olefins, or the method of making a catalyst composition according to any of the preceding Aspects, wherein the metallocene activator comprises, consists essentially of, or is selected from a smectite heteroadduct comprising or consisting essentially of a contact product of a colloidal smectite clay and a surfactant, wherein:
(a) the smectite clay is [1] natural or synthetic, and/or [2] a dioctahedral smectite clay; or [3] the smectite clay is selected from montmorillonite, sauconite, nontronite, hectorite, beidellite, saponite, bentonite, or any combination thereof, and
(b) the surfactant comprises or is selected from a cationic surfactant, a nonionic surfactant, an amphoteric surfactant, or any combination thereof.

Aspect 56. The catalyst composition, the process for polymerizing olefins, or the method of making a catalyst composition of the Aspect 38, wherein the contact product occurs or is [i] in the absence of: [A] a cationic polymetallate; [B] a non-layered silicate, a soluble silicate (for example, sodium silicate), a charged inorganic component, a metal oxide, an organic amide, an anionic surfactant, an inorganic acid, an organic acid, an inorganic base, an organic base, an oxidizing agent, or any combination thereof; [C] any one or any two of a cationic surfactant, a nonionic surfactant, or an amphoteric surfactant; or [D] any combination thereof, or [ii] in the absence of any other reactant, except for the surfactant.

Aspect 57. The catalyst composition, the process for polymerizing olefins, or the method of making a catalyst composition according to any of the preceding Aspects, wherein the metallocene activator comprises, consists essentially of, or is selected from a smectite heteroadduct as disclosed in U.S. Patent Application Publication No. 2023/0399420, published Dec. 14, 2024, which is incorporated herein by reference in its entirety.

Aspect 58. The catalyst composition, the process for polymerizing olefins, or the method of making a catalyst composition according to any of the preceding Aspects, wherein the metallocene activator comprises, consists essentially of, or is selected from an aluminum pillared clay.

Aspect 59. The catalyst composition, the process for polymerizing olefins, or the method of making a catalyst composition according to any of the preceding Aspects, wherein the metallocene activator comprises, consists essentially of, or is selected from an organoboron compound having the formula:

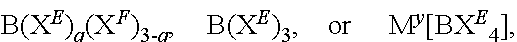

wherein
q is 1, 2, or 3;
X^{E} is selected independently from: [1] a hydride, a C₁-C₂₀ hydrocarbyl, or a C₁-C₂₀ heterohydrocarbyl; [2] a hydride, a C₁-C₂₀ aliphatic group, a C₆-C₂₀ aromatic group, a C₁-C₂₀ heteroaliphatic group, or a C₄-C₂₀ heteroaromatic group; [3] a fluorinated C₁-C₂₀ hydrocarbyl, or a fluorinated C₁-C₂₀ heterohydrocarbyl; or [4] a fluorinated C₁-C₂₀ aliphatic group, a fluorinated C₆-C₂₀ aromatic group, a fluorinated C₁-C₂₀ heteroaliphatic group, or a fluorinated C₄-C₂₀ heteroaromatic group;
X^{F} is selected independently from: [1] a halide or a C₁-C₂₀ organoheteryl; or [2] a halide, a C₁-C₁₂ alkoxide group, or a C₆-C₁₀ aryloxide group; and
M^{y} is selected from Li, Na, or K.

Aspect 60. The catalyst composition, the process for polymerizing olefins, or the method of making a catalyst composition according to any of the preceding Aspects, wherein the metallocene activator comprises, consists essentially of, or is selected from
(a) trimethylboron, triethylboron, tripropylboron, tributylboron, trihexylboron, trioctylboron, diethylboron ethoxide, diisobutylboron hydride, triisobutylboron, diethylboron chloride, di-3-pinanylborane, pinacolborane, catecholborane, lithium borohydride, lithium triethylborohydride, a Lewis base adduct thereof, or any combination thereof;
(b) tris(pentafluorophenyl)boron, tris[3,5-bis(trifluoromethyl)phenyl]boron, N,N-dimethylanilinium tetrakis(pentafluorophenyl)borate, triphenylcarbenium tetrakis(pentafluorophenyl)borate, lithium tetrakis-(pentafluorophenyl)borate, N,N-dimethylanilinium tetrakis [3,5-bis(trifluoro-methyl)phenyl]borate, triphenylcarbenium tetrakis[3,5-bis(trifluoromethyl)-phenyl]borate, and any combination thereof; or
(c) any combination or mixture of (a) and (b).

Aspect 61. The catalyst composition, the process for polymerizing olefins, or the method of making a catalyst composition according to any of the preceding Aspects, wherein the metallocene activator comprises, consists essentially of, or is selected from an ionizing ionic compound selected from tri(n-butyl)ammonium tetrakis(p-tolyl)borate, trimethylammonium tetraphenylborate, triethylammonium tetraphenylborate, tripropylammonium tetraphenylborate, tri(n-butyl)ammonium tetraphenylborate, tri(t-butyl)ammonium tetraphenylborate, N,N-dimethylanilinium tetraphenylborate, N,N-diethylanilinium tetraphenylborate, N,N-dimethyl-(2,4,6-trimethylanilinium) tetraphenylborate, tropillium tetraphenylborate, triphenylcarbenium tetraphenylborate, triphenylphosphonium tetraphenylborate triethylsilylium tetraphenylborate, benzene(diazonium)tetraphenylborate, trimethylammonium tetrakis(pentafluorophenyl)borate, triethylammonium tetrakis(pentafluorophenyl)borate, tripropylammonium tetrakis(pentafluorophenyl)borate, tri(n-butyl)ammonium tetrakis(pentafluorophenyl)borate, tri(sec-butyl)ammonium tetrakis(pentafluorophenyl)borate, N,N-dimethylanilinium tetrakis(pentafluorophenyl)borate, N,N-diethylanilinium tetrakis(pentafluorophenyl)borate, N,N-dimethyl-(2,4,6-trimethylanilinium) tetrakis(pentafluorophenyl)borate, tropillium tetrakis(pentafluorophenyl)borate, triphenylcarbenium tetrakis(pentafluorophenyl)borate, triphenylphosphonium tetrakis(pentafluorophenyl)borate, triethylsilylium tetrakis(pentafluorophenyl)borate, benzene(diazonium) tetrakis(pentafluorophenyl)borate, trimethylammonium tetrakis-(2,3,4,6-tetrafluorophenyl) borate, triethylammonium tetrakis-(2,3,4,6-tetrafluorophenyl)borate, tripropylammonium tetrakis-(2,3,4,6-tetrafluorophenyl)borate, tri(n-butyl)ammonium tetrakis-(2,3,4,6-tetrafluoro-phenyl)borate, dimethyl(t-butyl)ammonium tetrakis-(2,3,4,6-tetrafluorophenyl)borate, N,N-dimethylanilinium tetrakis-(2,3,4,6-tetrafluorophenyl)borate, N,N-diethylanilinium tetrakis-(2,3,4,6-tetrafluorophenyl)borate, N,N-dimethyl-(2,4,6-trimethylanilinium) tetrakis-(2,3,4,6-tetrafluorophenyl)borate, tropillium tetrakis-(2,3,4,6-tetrafluorophenyl)borate, triphenylcarbenium tetrakis-(2,3,4,6-tetrafluorophenyl)borate, triphenylphosphonium tetrakis-(2,3,4,6-tetrafluorophenyl)borate, triethylsilylium tetrakis-(2,3,4,6-tetrafluorophenyl)borate, benzene(diazonium) tetrakis-(2,3,4,6-tetrafluorophenyl)borate, trimethylammonium tetrakis(perfluoronapthyl)borate, triethylammonium tetrakis(perfluoronapthyl)borate, tripropylammonium tetrakis(perfluoronapthyl)borate, tri(n-butyl)ammonium tetrakis(perfluoronapthyl)borate, tri(t-butyl)ammonium tetrakis(perfluoronapthyl)borate, N,N-dimethylanilinium tetrakis(perfluoronapthyl)borate, N,N-diethylanilinium tetrakis(perfluoronapthyl)borate, N,N-dimethyl-(2,4,6-trimethylanilinium) tetrakis(perfluoronapthyl)borate, tropillium tetrakis(perfluoronapthyl)borate, triphenylcarbenium tetrakis(perfluoronapthyl)borate, triphenylphosphonium tetrakis(perfluoronapthyl)borate, triethylsilylium tetrakis(perfluoronapthyl)borate, benzene(diazonium) tetrakis(perfluoronapthyl)borate, trimethylammonium tetrakis(perfluorobiphenyl)borate, triethylammonium tetrakis(perfluorobiphenyl)borate, tripropylammonium tetrakis(perfluorobiphenyl)borate, tri(n-butyl)ammonium tetrakis(perfluorobiphenyl)borate, tri(t-butyl)ammonium tetrakis(perfluorobiphenyl)borate, N,N-dimethylanilinium tetrakis(perfluorobiphenyl)borate, N,N-diethylanilinium tetrakis(perfluorobiphenyl)borate, N,N-dimethyl-(2,4,6-trimethylanilinium) tetrakis(perfluorobiphenyl)borate, tropillium tetrakis(perfluorobiphenyl)borate, triphenylcarbenium tetrakis(perfluorobiphenyl)borate, triphenylphosphonium tetrakis(perfluorobiphenyl)borate, triethylsilylium tetrakis(perfluorobiphenyl)borate, benzene(diazonium) tetrakis(perfluorobiphenyl)borate, trimethylammonium tetrakis(3,5-bis(trifluoromethyl)phenyl)borate, triethylammonium tetrakis(3,5-bis(trifluoromethyl)phenyl)borate, tripropylammonium tetrakis(3,5-bis(trifluoromethyl)phenyl)borate, tri(n-butyl)ammonium tetrakis(3,5-bis(trifluoromethyl)phenyl)borate, tri(t-butyl)ammonium tetrakis(3,5-bis(trifluoromethyl)phenyl)borate, N,N-dimethylanilinium tetrakis(3,5-bis(trifluoromethyl)phenyl)borate, N,N-diethylanilinium tetrakis(3,5-bis(trifluoromethyl)phenyl)borate, N,N-dimethyl-(2,4,6-trimethylanilinium) tetrakis(3,5-bis(trifluoromethyl)phenyl)borate, tropillium tetrakis(3,5-bis(trifluoromethyl)phenyl)borate, triphenylcarbenium tetrakis(3,5-bis(trifluoromethyl)phenyl)borate, triphenylphosphonium tetrakis(3,5-bis(trifluoromethyl)phenyl)borate, triethylsilylium tetrakis(3,5-bis(trifluoromethyl)phenyl)borate, benzene(diazonium) tetrakis(3,5-bis(trifluoromethyl)phenyl)borate, and dialkyl ammonium salts such as: di-(i-propyl)ammonium tetrakis(pentafluorophenyl)borate, and dicyclohexylammonium tetrakis(pentafluorophenyl)borate; and additional tri-substituted phosphonium salts such as tri(o-tolyl)phosphonium tetrakis(pentafluorophenyl)borate, tri(2,6-dimethylphenyl)phosphonium tetrakis(pentafluorophenyl)borate, any aluminate analogs thereof, or any combination thereof.

Aspect 62. The catalyst composition, the process for polymerizing olefins, or the method of making a catalyst composition according to any of the preceding Aspects, wherein the metallocene activator comprises, consists essentially of, or is selected from a solid oxide treated with an electron withdrawing anion, and wherein:
(a) the solid oxide comprises, consists essentially of, or is selected from silica, alumina, silica-alumina, silica-coated alumina, silica-zirconia, silica-titania, aluminum phosphate, heteropolytungstates, titania, zirconia, magnesia, boria, zinc oxide, mixed oxides thereof, or any combination thereof; and
(b) the electron-withdrawing anion comprises, consists essentially of, or is selected from fluoride, chloride, bromide, phosphate, triflate, bisulfate, sulfate, fluorophosphate, fluorosulfate, or any combination thereof.

Aspect 63. The catalyst composition, the process for polymerizing olefins, or the method of making a catalyst composition according to any of the preceding Aspects, wherein the metallocene activator comprises, consists essentially of, or is selected from a solid oxide treated with an electron withdrawing anion selected from fluorided alumina, chlorided alumina, bromided alumina, sulfated alumina, fluorided silica-alumina, chlorided silica-alumina, bromided silica-alumina, sulfated silica-alumina, fluorided silica-zirconia, chlorided silica-zirconia, bromided silica-zirconia, sulfated silica-zirconia, fluorided silica-titania, or any combinations thereof.

Aspect 64. The catalyst composition, the process for polymerizing olefins, or the method of making a catalyst composition according to any of the preceding Aspects, wherein the metallocene activator comprises, consists essentially of, or is selected from any metallocene activator, for example, any metallocene activator disclosed herein, any combination of metallocene activators, or any metallocene activator or combination of metallocene activators in combination with any co-catalyst or alkylating agent.

Aspect 65. The catalyst composition, the process for polymerizing olefins, or the method of making a catalyst composition according to any of the preceding Aspects, wherein the catalyst composition further comprises at least one co-catalyst.

Aspect 66. The catalyst composition, the process for polymerizing olefins, or the method of making a catalyst composition according to any of the preceding Aspects, wherein the catalyst composition further comprises at least one co-catalyst comprising, consisting essentially of, or selected from an alkylating agent, a hydriding agent, or a silylating agent.

Aspect 67. The catalyst composition, the process for polymerizing olefins, or the method of making a catalyst composition according to any of the preceding Aspects, wherein the catalyst composition further comprises at least one co-catalyst selected from an organoaluminum compound, an organoboron compound, an organozinc compound, an organomagnesium compound, an organolithium compound, or any combination thereof.

Aspect 68. The catalyst composition, the process for polymerizing olefins, or the method of making a catalyst composition according to any of the preceding Aspects, wherein the catalyst composition further comprises at least one co-catalyst selected from any organoaluminum compound disclosed herein or any organoboron compound disclosed herein.

Aspect 69. The catalyst composition, the process for polymerizing olefins, or the method of making a catalyst composition according to any of the preceding Aspects, wherein the catalyst composition further comprises at least one co-catalyst comprising, consisting essentially of, or selected from an organoaluminum compound having the formula:

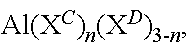

wherein
n is 1, 2, or 3;
X^{C} is selected independently from a hydride or a C₁-C₂₀ hydrocarbyl; and
X^{D} is a formal anionic species selected independently from: fluoride; chloride; bromide; iodide; hydrocarbyloxide, bromate; chlorate; perchlorate; hydrocarbylsulfate; hydrocarbylsulfite; sulfamate; hydrocarbylsulfide, hydrocarbylcarbonate; hydrogen-carbonate (bicarbonate); carbamate; nitrite; nitrate; hydrocarbyloxalate; dihydrocarbylphosphate; hydrocarbylselenite; sulfate; sulfite; carbonate; oxalate; phosphate; phosphite; selenite; selenide; sulfide; oxide; sulfamate; azide; alkoxide; aryloxide, amido; hydrocarbylamido; or dihydrocarbylamido.

Aspect 70. The catalyst composition, the process for polymerizing olefins, or the method of making a catalyst composition according to any of the preceding Aspects, wherein the catalyst composition further comprises at least one co-catalyst selected from trimethylaluminum, triethylaluminum (TEA), tripropylaluminum, tributylaluminum (for example, tri-n-butylaluminum, tri-t-butylaluminum, tri-sec-butyaluminum), trihexylaluminum, trioctylaluminum, ethyl-(3-alkylcyclopentadiyl)aluminum, diethylaluminum ethoxide, diisobutylaluminum hydride, triisobutylaluminum (TIBAL), diethylaluminum chloride, ethyl-(3-alkylcyclopentadiyl)aluminum, trioctylaluminum, or any combination thereof.

Aspect 71. The catalyst composition, the process for polymerizing olefins, or the method of making a catalyst composition according to any of the preceding Aspects, wherein the catalyst composition further comprises at least one co-catalyst selected from an organozinc compound or an organomagnesium compound having the formula:

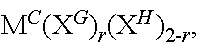

wherein
M^{C} is zinc or magnesium;
r is 1 or 2;
X^{G} is selected independently from: [1] a hydride, a C₁-C₂₀ hydrocarbyl, or a C₁-C₂₀ heterohydrocarbyl; or [2] a hydride, a C₁-C₂₀ aliphatic group, a C₆-C₂₀ aromatic group, a C₁-C₂₀ heteroaliphatic group, or a C₄-C₂₀ heteroaromatic group; and
X^{H} is selected independently from: [1] a halide or a C₁-C₂₀ organoheteryl; or [2] a halide, a C₁-C₁₂ alkoxide group, or a C₆-C₁₀ aryloxide group.

Aspect 72. The catalyst composition, the process for polymerizing olefins, or the method of making a catalyst composition according to any of the preceding Aspects, wherein the catalyst composition further comprises at least one co-catalyst selected from: [1]dimethylzinc, diethylzinc, diisopropylzinc, dicyclohexylzinc, diphenylzinc, or any combination thereof; [2]butylethylmagnesium, dibutylmagnesium, n-butyl-sec-butylmagnesium, dicyclopentadienylmagnesium, or any combination thereof, or [3] any combination of any organozinc co-catalyst from group [1] and any organomagnesium co-catalyst from group [2].

Aspect 73. The catalyst composition, the process for polymerizing olefins, or the method of making a catalyst composition according to any of the preceding Aspects, wherein the catalyst composition further comprises at least one co-catalyst selected from an organolithium compound or lithium hydride compound having the formula:

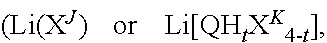

wherein
X^{J} is selected from: [1] a hydride, a C₁-C₂₀ hydrocarbyl, or a C₁-C₂₀ heterohydrocarbyl; or [2] a hydride, a C₁-C₂₀ aliphatic group, a C₆-C₂₀ aromatic group, a C₁-C₂₀ heteroaliphatic group, or a C₄-C₂₀ heteroaromatic group;
Q is Al or B;
t is an integer from 1 to 4 (inclusive); and
each X^{K} is selected independently from: [1] a hydride, a C₁-C₂₀ hydrocarbyl, or a C₁-C₂₀ heterohydrocarbyl; or [2] a hydride, a C₁-C₂₀ aliphatic group, a C₆-C₂₀ aromatic group, a C₁-C₂₀ heteroaliphatic group, or a C₄-C₂₀ heteroaromatic group.

Aspect 74. The catalyst composition, the process for polymerizing olefins, or the method of making a catalyst composition according to any of the preceding Aspects, wherein the catalyst composition further comprises at least one co-catalyst selected from methyllithium, ethyllithium, propyllithium (including n-propyllithium or i-propyllithium), butyllithium (including n-butyllithium, t-butyllithium, sec-butyl lithium, or iso-butyllithium), hexyllithium, or any combination thereof.

Aspect 75. The catalyst composition, the process for polymerizing olefins, or the method of making a catalyst composition according to any of the preceding Aspects, wherein the co-catalyst comprises, consists essentially of, or is selected from any metallocene co-catalyst, for example, any co-catalyst disclosed herein.

Aspect 76. The process for polymerizing olefins according to any of the preceding Aspects, wherein the polyolefin comprises, consists essentially of, or is selected from an olefin homopolymer or an olefin co-polymer.

Aspect 77. The process for polymerizing olefins according to any of the preceding Aspects, wherein the polyolefin comprises, consists essentially of, or is selected from an olefin homopolymer, the homopolymer comprising olefin monomer residues having from 2 to about 20 carbon atoms per monomer molecule.

Aspect 78. The process for polymerizing olefins according to any of the preceding Aspects, wherein the at least one olefin monomer comprises, consists essentially of, or is selected from ethylene, propylene, 1-butene, 3-methyl-1-butene, 1-pentene, 3-methyl-1-pentene, 4-methyl-1-pentene, 1-hexene, 3-ethyl-1-hexene, 1-heptene, 1-octene, 1-nonene, 1-decene, vinyl cyclohexane, or combinations thereof.

Aspect 79. The process for polymerizing olefins according to any of the preceding Aspects, wherein the at least one olefin monomer comprises, consists essentially of, or is selected from: (a) ethylene in combination with at least one of propylene, 1-butene, 3-methyl-1-butene, 1-pentene, 3-methyl-1-pentene, 4-methyl-1-pentene, 1-hexene, 3-ethyl-1-hexene, 1-heptene, 1-octene, 1-nonene, 1-decene, norbornene, and vinyl cyclohexane; or (b) ethylene in combination with 1-butene, 3-methyl-1-butene, 4-methyl-1-pentene, 1-hexene, 1-octene, norbornene, or vinyl cyclohexane.

Aspect 80. The process for polymerizing olefins according to any of the preceding Aspects, wherein the polyolefin comprises, consists essentially of, or is selected from an ethylene-α-olefin co-polymer.

Aspect 81. The process for polymerizing olefins according to any of the preceding Aspects, wherein the at least one olefin monomer comprises, consists essentially of, or is selected from ethylene and an α-olefin comonomer, and the polyolefin comprising α-olefin comonomer residues having from 3 to about 20 carbon atoms per comonomer molecule.

Aspect 82. The process for polymerizing olefins according to any of the preceding Aspects, wherein the at least one olefin monomer comprises, consists essentially of, or is selected from ethylene and an α-olefin comonomer selected from an aliphatic C₃ to C₂₀ olefin, a conjugated or nonconjugated C₃ to C₂₀ diolefin, or any mixture thereof.

Aspect 83. The process for polymerizing olefins according to any of the preceding Aspects, wherein the at least one olefin monomer comprises, consists essentially of, or is selected from ethylene and an α-olefin comonomer selected from propylene, 1-butene, 2-butene, 3-methyl-1-butene, 1-pentene, 2-pentene, 3-methyl-1-pentene, 4-methyl-1-pentene, 1-hexene, 3-ethyl-1-hexene, 1-heptene, 1-octene, 1-nonene, 1-decene, 1,3-butadiene, isoprene, styrene, piperylene, 2,3-dimethyl-1,3-butadiene, 1,4-pentadiene, 1,7-hexadiene, vinylcyclohexane, or any combination thereof.

Aspect 84. The process for polymerizing olefins according to any preceding Aspect, wherein the contacting step comprises contacting at least one olefin monomer, the catalyst composition, and (a) hydrogen, or (b) in the absence of hydrogen, under polymerization conditions to form the polyolefin.

Aspect 85. The process for polymerizing olefins according to any preceding Aspect, wherein the polymerization conditions comprise:
(a) conducting the polymerization in the presence of added hydrogen;
(b) conducting the polymerization using a hydrogen/ethylene ratio (H₂ psi/C₂ psi) of from 0.01×10⁻⁰³ to 45.0×10⁻⁰³; alternatively from 0.1×10⁻⁰³ to 30.0×10⁻⁰³; alternatively from 0.50×10⁻⁰³ to 20.0×10⁻⁰³; alternatively from 0.75×10⁻⁰³ to 10.0×10⁻⁰³; alternatively from 1.00×10⁻⁰³ to 5.00×10⁻⁰³; or alternatively from 1.25×10⁻⁰³ to 4.50×10⁻⁰³
(c) the polymerization is not a solution polymerization;
(d) the polymerization is a slurry polymerization;
(e) the polymerization is conducted at a temperature of less than 125° C., alternatively less than 110° C., alternatively less than 95° C., alternatively less than or equal to 80° C., or alternatively, less than or equal to 75° C.;
(f) the polymerization is carried out in an aliphatic liquid carrier;
(g) the polymerization is carried out in a liquid carrier having an initial boiling point (IBP) temperature at atmospheric pressure of less than or equal to 100° C., alternatively less than or equal to 75° C., alternatively less than or equal to 50° C., or alternatively less than or equal to 25° C.;
(h) the polymerization is conducted in the absence of an ionizing ionic compound;
(i) the polymerization is conducted under conditions which provide an ethylene-co-1-hexene polymer having:
   (1) a MI (melt index) from 0.1-2.0 g/10 min, alternatively from 0.2-1.8 g/10 min, alternatively from 0.3-1.6 g/10 min; or alternatively from 0.35-1.5 g/10 min;
   (2) a HLMI (high load melt index) from 1 g/10 min to 40 g/10 min, alternatively from 2 g/10 min to 37 g/10 min, or alternatively from 3 g/10 min to 35 g/10 min;
   (3) a HLMI/MI ratio (shear response) (i) from 16 to 60, alternatively from 18 to 50, alternatively from 20 to 40, or (ii) greater than 19, alternatively greater than 25, or alternatively, greater than 30, and wherein an optional upper limit for any of these lower limit (“greater than”) ratios is 60;
   (4) a density from 0.890 to 0.936 g/mL, alternatively from 0.900 to 0.934 g/mL, alternatively from 0.909 to 0.932 g/mL, or alternatively from 0.910 to 0.929 g/mL;
   (5) a Mw of 50,000 to 175,000 g/mol, alternatively 65,000 to 155,000 g/mol, or alternatively 80,000 to 140,000 g/mol;
   (6) a Mw/Mn ratio (polydispersity index) of from 2.25 to 10, or alternatively 2.50 to 7.0;
   (7) a non-Schultz-Flory molecular weight distribution, for example, (A) Mw/Mn>2.0, Mw/Mn>2.5, Mw/Mn>3.0, or alternatively, Mw/Mn>3.5, or (B) a Mw/Mn reflects no more than 2 or no more than 3 Schulz-Flory distributions; or
   (8) any combination of (1) to (7);
      or
(j) any combination of (a) through (i).

Aspect 86. The process for polymerizing olefins according to any preceding Aspect, wherein the at least one olefin monomer comprises, consists essentially of, or is selected from (a) ethylene or (b) ethylene and an α-olefin comonomer having from 3 to about 20 carbon atoms per comonomer molecule.

Aspect 87. The process for polymerizing olefins according to any of the preceding Aspects, wherein the polymerization conditions comprise a metallocene compound to sMAO ratio of from 1×10⁻⁵ to 5×10⁻⁴ mmol metallocene compound per mg sMAO, alternatively from 2×10⁻⁵ to 1×10⁻⁴ mmol metallocene compound per mg sMAO, or alternatively from 3×10⁻⁵ to 1×10⁻⁴ mmol metallocene compound per mg sMAO.

Aspect 88. The process for polymerizing olefins according to any of the preceding Aspects, wherein the polymerization conditions comprise any conditions as described in the specification.

Aspect 89. The process for polymerizing olefins according to any of the preceding Aspects, wherein the catalyst composition comprises an organoaluminoxane compound in a concentration of from 10 to 1,500 mmol of organoaluminoxane compound per mmol of metallocene compound, alternatively from 50 to 1,250 mmol of organoaluminoxane compound per mmol of metallocene compound, alternatively from 100 to 1,000 mmol of organoaluminoxane compound per mmol of metallocene compound, or alternatively from 200 to 800 mmol of organoaluminoxane compound per mmol of metallocene compound.

Aspect 90. The process for polymerizing olefins according to any of the preceding Aspects, wherein the catalyst composition comprises an alkylaluminum compound, excluding any alkylaluminum compound used as a scavenger, in a concentration of from 10 to 2,500 mmol of alkylaluminum compound per mmol of metallocene compound, alternatively from 50 to 2,000 mmol of alkylaluminoxane compound per mmol of metallocene compound, or alternatively from 100 to 1,500 mmol of alkylaluminoxane compound per mmol of metallocene compound.

Aspect 91. The catalyst composition prepared according to any of the preceding methods of making a catalyst composition.

Aspect 92. The process for polymerizing olefins comprising contacting at least one olefin monomer and a catalyst composition under polymerization conditions to form a polyolefin, wherein the catalyst composition is prepared according to any of the preceding methods of making a catalyst composition.

Aspect 93. The process for polymerizing olefins according to any of the preceding Aspects, wherein the process comprises a slurry polymerization, a gas phase polymerization, a solution polymerization, or any multi-reactor combinations thereof.

Aspect 94. The process for polymerizing olefins according to any of the preceding Aspects, wherein the process comprises polymerization in a gas phase reactor, a slurry loop, dual slurry loops in series, multiple slurry tanks in series, a slurry loop combined with a gas phase reactor, a continuous stirred reactor in a batch process, or combinations thereof.

Aspect 95. The catalyst composition, the process for polymerizing olefins, or the method of making a catalyst composition according to any of the preceding Aspects, wherein the catalyst composition is characterized by:
(i) a first ethylene/1-hexene co-polymerization activity measured within 12 hours of forming the contact product; and
(ii) a second ethylene/1-hexene co-polymerization activity measured after the contact product has been stored for 30 days at room temperature (20° C.-23° C.) under an inert atmosphere, that is greater than or equal to 95% (≥95%), 96%, or 97% of the first polymerization activity.

Aspect 96. The catalyst composition, the process for polymerizing olefins, or the method of making a catalyst composition of Aspect 76, wherein the second ethylene/1-hexene co-polymerization activity is greater than or equal to 98% (≥98%), or 99% of the first polymerization activity.

Aspect 97. The catalyst composition, the process for polymerizing olefins, or the method of making a catalyst composition according to any of the preceding Aspects, wherein the metallocene activator is solid MAO (sMAO) and the catalyst composition are characterized by any of the following properties:
(a) an ethylene-1-hexene co-polymerization activity measured within 12 hours of forming the contact product of from 1,000-60,000 g polymer/g sMAO activator/hour, alternatively from 2,000-50,000 g polymer/g sMAO activator/hour, or alternatively from 3,000-40,000 g polymer/g sMAO activator/hour;
(b) an ethylene-1-hexene co-polymerization activity measured within 12 hours of forming the contact product of from 10-1,500 kg polymer/mmol metallocene/hour, alternatively, from 20-1,250 kg polymer/mmol metallocene/hour, or alternatively from 30-1,000 kg polymer/mmol metallocene/hour;
(c) an ethylene-1-hexene co-polymerization activity measured after the contact product has been stored for 30 days at room temperature (20° C.-23° C.) under an inert atmosphere which is greater than or equal to 98% of an ethylene-1-hexene co-polymerization activity measured within 12 hours of forming the contact product; or
(d) any combination thereof.

Aspect 98. A process for polymerizing olefins according to any of the preceding Aspects, wherein the polyolefin is an ethylene/1-hexene copolymer, and the process or the ethylene/1-hexene copolymer have any of the following properties:
(a) a 1-hexene comonomer incorporation efficiency (CIE), determined as the [1-hexene]/[ethylene] molar ratio in the polymer divided by the [1-hexene]/[ethylene] molar ratio in the reactor,

$$C I E = \frac{[ C 6 ] / [ C 2 ] polymer}{[ C 6 ] / [ C 2 ] reactor} ,$$

measured under the polymerization conditions, that is greater than a comparative 1-hexene CIE exhibited by a comparative catalyst comprising the contact product of the metallocene activator and a comparative metallocene, wherein:
[i] the comparative metallocene is (n-BuCp)₂ZrCl₂, and the comparative 1-hexene CIE is measured under the same polymerization conditions;
[ii] the comparative metallocene is (n-BuCp)₂ZrCl₂, and the comparative 1-hexene CIE is measured under comparative polymerization conditions that provide a comparative ethylene/1-hexene copolymer having a Melt Index and density that are substantially similar (within 15% of the values) of the Melt Index and density as the ethylene/1-hexene copolymer; or
[iii] the comparative metallocene is an unbridged metallocene having the formula:

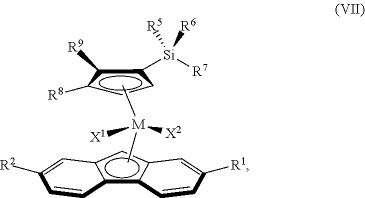

wherein
   M, X¹, X², R¹, R², R⁵, R⁶, R⁷, R⁸, and R⁹ are identical in the metallocene compound as in the comparative unbridged metallocene, under the polymerization conditions;
(b) a Long Chain Branching (LCB) frequency as determined by the Janzen-Colby method (JC-α, 190° C.) of less than about 12 LCB/10⁶ total carbon atoms (that is, from about 0 to about 12 Long Chain Branches per 10⁶ total carbon atoms), or alternatively less than about 10 LCB/10⁶ total carbon atoms as measured for a polymer having a Melt Index (MI) of about 0.5-2.0 g/10 min, alternatively about 0.8-1.5 g/10 min, or alternatively about 0.7-1.3 g/10 min, and having a polymer density of about 0.890-0.932 g/mL, alternatively about 0.900-0.930 g/mL, or alternatively about 0.910-0.928 g/mL;
(c) a Short Chain Branching Distribution (SCBD) profile characterized by a plot of the number of short chain branches per 1000 total carbon atoms versus log₁₀ of the molecular weight of the copolymer over the range from d85 to d15 which has (i) a slope of from about −1.10 to about +2.95 from low molecular weight to high molecular weight, determined by linear regression or (ii) has a slope of about 0 (flat SCBD) or a positive slope (reverse SCBD) from low molecular weight to high molecular weight, determined via linear regression, as measured for a polymer having a Melt Index (MI) of about 0.1-2.0 g/10 min, a high load melt index (HLMI) of about 5-30 g/10 min, a density of about 0.910-0.928 g/mL, and a long LCB content of as defined by Janzen-Colby (JC-α, 190° C.) of ≤7 long chain branches/10⁶ total carbon atoms;
(d) a MI (melt index) of from 0.05 g/15 min to 50 g/10 min;
(e) a HLMI (high load melt index) of from 0.1 g/10 min to 100 g/10 min;
(f) a HLMI/MI ratio (shear response) of from 16 to 100;
(g) a density of from 0.885 g/mL to 0.950 g/mL;
(h) a Mw/Mn ratio (polydispersity index) of from 2.2 to 20; or
(i) any combination thereof.

Aspect 99. A process for polymerizing olefins according to any of the preceding Aspects, wherein the polyolefin is an ethylene/1-hexene copolymer, and the process or the ethylene/1-hexene copolymer have any one or more of the following properties:
(a) the 1-hexene comonomer incorporation efficiency

$$C I E = \frac{[ C 6 ] / [ C 2 ] polymer}{[ C 6 ] / [ C 2 ] reactor} ,$$

is (i) from 0.02 to 0.30, alternatively from 0.04 to 0.25, or alternatively from 0.1 to 0.20, or (ii) greater than 0.04, alternatively greater than 0.1, or alternatively greater than 0.2, and wherein an optional upper limit for any of these lower limit (“greater than”) values is 0.3;
(b) the Long Chain Branching (LCB) occurrence is less than or equal to 10 (≤10) Long Chain Branches (LCB) per 10⁶ total carbon atoms, alternatively ≤8 LCB per 10⁶ total carbon atoms, alternatively ≤7 LCB per 10⁶ total carbon atoms, alternatively ≤5 LCB per 10⁶ total carbon atoms, alternatively ≤3.5 LCB per 10⁶ total carbon atoms, or alternatively ≤2.5 LCB per 10⁶ total carbon atoms;
(c) the Short Chain Branching Distribution (SCBD) profile over the range from d85 to d15 has a slope of (i) from about −1.10 to about +2.95, alternatively, from about −1.00 to about +2.00, alternatively from about −0.80 to about +1.20, or alternatively from about −0.70 to about +1.00, or (ii) from about −1 to 0, alternatively greater than 0, alternatively greater than 1.0, alternatively greater than 5.0, or alternatively greater than 10.0, from low molecular weight to high molecular weight, determined by linear regression, and wherein an optional upper limit for any of these lower limit (“greater than”) slopes is 15, alternatively 20, alternatively 25, or alternatively 30;
(d) the MI (melt index) is from 0.01 g/10 min to 10 g/10 min, alternatively from 0.02 g/10 min to 5 g/10 min, alternatively from 0.10 g/10 min to 3.0 g/10 min; or alternatively from 0.20 g/10 min to 2.0 g/10 min;
(e) the HLMI (high load melt index) is from 1 g/10 min to 60 g/10 min, alternatively from 2 g/10 min to 50 g/10 min, or alternatively from 3 g/10 min to 40 g/10 min;
(f) the HLMI/MI ratio (shear response) is (i) from 16 to 60, alternatively from 18 to 50, alternatively from 20 to 40, or (ii) greater than 19, greater than 25, or alternatively, greater than 30, and wherein an optional upper limit for any of these lower limit (“greater than”) ratios is 60;
(g) the density is from 0.885 g/mL to 0.955 g/mL, alternatively from 0.890 g/mL to 0.932 g/mL, alternatively from 0.900 g/mL to 0.930 g/mL, or alternatively from 0.910 g/mL to 0.928 g/mL;
(h) the Mw/Mn ratio (polydispersity index) is from greater than 1.8 to 18, alternatively from 2.0 to 14, alternatively from 2.1 to 12, or alternatively from to 2.2 to 10, or alternatively from 2.3 to 8; or
(i) any combination thereof.

Aspect 100. The ethylene/1-hexene copolymer or the process for polymerizing olefins of any of Aspects 98-99, wherein the polyolefin is an ethylene/1-hexene copolymer having a weight average molecular weight of from 25,000 g/mol to 220,000 g/mol, alternatively from 35,000 g/mol to 210,000 g/mol, alternatively from 50,000 g/mol to 200,000 g/mol, or alternatively from 75,000 g/mol to 175,000 g/mol.

Aspect 101. The ethylene/1-hexene copolymer or the process for polymerizing olefins of any of Aspects 98-100, wherein the polyolefin is an ethylene/1-hexene copolymer having the following properties:
(a) an analytical temperature rising elution fractionation (aTREF) broadness parameter of from 1.2 to 14, alternatively from 1.5 to 13, alternatively from 2.0 to 12, or alternatively from 2.5 to 10;
(b) a solubility distribution breadth index (SDBI) temperature parameter, of 10° C. to 30° C., alternatively from 12° C. to 28° C., alternatively from 14° C. to 27° C., or alternatively from 15° C. to 25° C.; or
(c) a combination thereof.

Aspect 102. The catalyst composition, the process for polymerizing olefins, or the method of making a catalyst composition according to any of the preceding Aspects, wherein the catalyst composition comprises a single metallocene compound.

Aspect 103. The catalyst composition, the process for polymerizing olefins, or the method of making a catalyst composition according to any of the preceding Aspects, wherein the catalyst composition comprises a single metallocene compound which provides multiple active catalytic sites under polymerization conditions, as determined from gel permeation chromatography (GPC) or analytical temperature rising elution fractionation (aTREF) data.

Aspect 104. The catalyst composition, the process for polymerizing olefins, or the method of making a catalyst composition according to any of the preceding Aspects, wherein the catalyst composition comprises a single metallocene compound which provides 2 or 3 Shulz-Flory active catalytic sites under polymerization conditions, as determined from gel permeation chromatography (GPC) or analytical temperature rising elution fractionation (aTREF) data.

Aspect 105. The process for polymerizing olefins according to any preceding Aspect, wherein the polymerization conditions are selected to provide an ethylene/1-hexene copolymer polyolefin, having any of the following properties:
(a) (i) a HLMI/MI ratio (shear response) from 23 to 40 at a Mw/Mn ratio (polydispersity index) of from 2.5 to 3.5, or (ii) a HLMI/MI ratio from 18 to 30 at a Mw/Mn ratio (polydispersity index) of from greater than 3.5 to 6.0;
(b) (i) a comonomer incorporation efficiency (CIE) greater than 0.07 for a polymer having a density of less than or equal to 0.9230 g/mL, or (ii) a comonomer incorporation efficiency (CIE) greater than 0.10 for a polymer having a density from greater than 0.9230 g/mL to 0.9270 g/mL;
(c) a short chain branching profile plotted as the number of short chain branches per 1000 total carbon atoms versus log₁₀ of the molecular weight of the copolymer over the range from d85 to d15 has slope (a “d85 to d15 slope”) from +0.5 to 3.0 for a polymer having a density of from 0.9125 g/mL to 0.9215 g/mL; or
(d) any combination of (a), (b), and (c).

Aspect 106. The process for polymerizing olefins according to any preceding Aspect, wherein the polymerization conditions are selected from any of the following parameters or any combination of the following parameters:
(a) conducting the polymerization in the presence or the absence of added hydrogen;
(b) conducting the polymerization using a hydrogen/ethylene ratio (H₂ psi/C₂ psi) of from 0.01×10⁻⁰³ to 40.0×10⁻⁰³; alternatively from 0.1×10⁻⁰³ to 25.0×10⁻⁰³; alternatively from 0.50×10⁻⁰³ to 10.0×10⁻⁰³; alternatively from 0.75×10⁻⁰³ to 7.50×10⁻⁰³; alternatively from 1.00×10⁻⁰³ to 5.00×10⁻⁰³; or alternatively from 1.25×10⁻⁰³ to 4.50×10⁻⁰³;
(c) conducting the polymerization in a gas phase reactor, a slurry loop, dual slurry loops in series, multiple slurry tanks in series, a slurry loop combined with a gas phase reactor, a continuous stirred reactor in a batch process, or combinations thereof,
(d) conducting the polymerization at a temperature of less than 125° C., alternatively less than 110° C., alternatively less than 95° C., alternatively less than or equal to 80° C., or alternatively, less than or equal to 75° C.;
(e) conducting the polymerization in an aliphatic liquid carrier;
(f) conducting the polymerization in a liquid carrier having an initial boiling point (IBP) temperature at atmospheric pressure of less than or equal to 100° C., alternatively less than or equal to 75° C., alternatively less than or equal to 50° C., or alternatively less than or equal to 25° C.;
(g) conducting the polymerization in the presence or the absence of an ionizing ionic compound;
(h) conducting the polymerization in the presence or the absence of an aluminoxane;
(i) conducting the polymerization under conditions which provide an ethylene-co-1-hexene polymer having:
   (1) a MI (melt index) from 0.1-2.0 g/10 min, alternatively from 0.2-1.8 g/10 min, alternatively from 0.3-1.6 g/10 min; or alternatively from 0.35-1.5 g/10 min;
   (2) a HLMI (high load melt index) from 1 g/10 min to 40 g/10 min, alternatively from 2 g/10 min to 37 g/10 min, or alternatively from 3 g/10 min to 35 g/10 min;
   (3) a Mw of 50,000 to 175,000 g/mol, alternatively 65,000 to 155,000 g/mol, or alternatively 80,000 to 140,000 g/mol;
   (4) a Mw/Mn ratio (polydispersity index) of from 2.25 to 10, or alternatively 2.50 to 7.0;
   (5) a non-Schultz-Flory molecular weight distribution, for example, (A) Mw/Mn>2.0, Mw/Mn>2.5, Mw/Mn>3.0, or alternatively, Mw/Mn>3.5, or (B) a Mw/Mn reflects no more than 2 or no more than 3 Schulz-Flory distributions; or
   (6) any combination of (1) to (5);
      or
(j) any combination of (a) through (i).

Aspect 107. A metallocene compound having the formula:

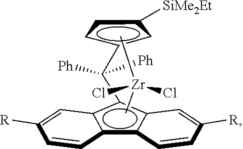

wherein R=^{t}Bu (M1) or H (M2);

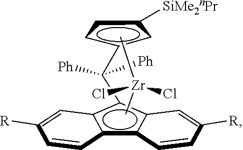

wherein R=^{t}Bu (M3) or R=H (M4);

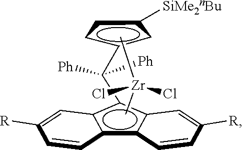

wherein R=^{t}Bu (M5Bu) or H (M5);

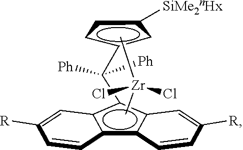

wherein R=^{t}Bu (M22) or H (M23);

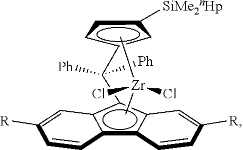

wherein R=^{t}Bu (M24) or H (M25);

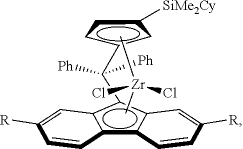

wherein R=^{t}Bu (M20) or H (M21);

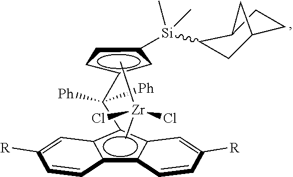

wherein R=^{t}Bu (M6) or H (M7);

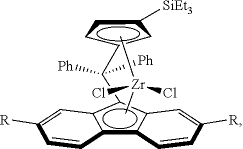

wherein R=^{t}Bu (M8) or H (M9);

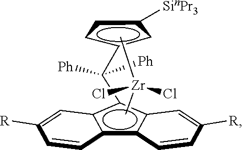

wherein R=^{t}Bu (M12) or R (M13);

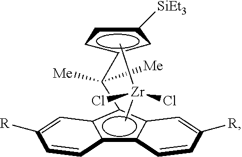

wherein R=^{t}Bu (M10) or H (M11);

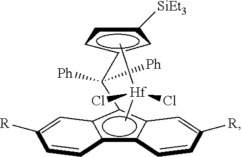

wherein R=^{t}Bu (M14Bu) or H (M14);

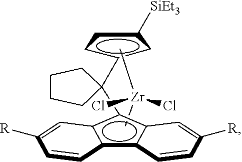

wherein R=^{t}Bu (M15) or H (M16);

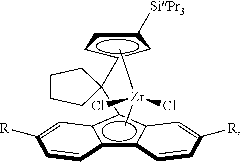

wherein R=^{t}Bu (M18Bu) or H (M18);

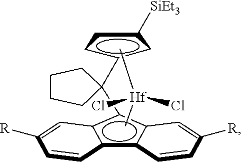

wherein R=^{t}Bu (M17Bu) or H (M17); or

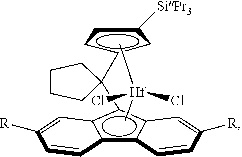

wherein R=^{t}Bu (M19Bu) or H (M19).

We claim:

1. A catalyst composition comprising the contact product of:
(a) a metallocene compound having the formula: 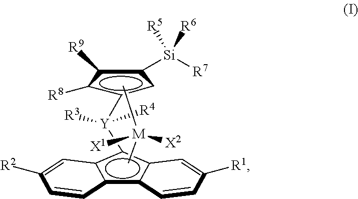
wherein
(i) M is Zr or Hf;
(ii) X¹ and X² are selected independently from a monoanionic ligand, or X¹ and X² together are a dianionic ligand;
(iii) R¹ and R² are selected independently from H or a C₁-C₂₀ hydrocarbyl;
(iv) Y is C or Si;
(v)(A) R³ and R⁴ are selected independently from a C₁ to C₂₀ hydrocarbyl, or (B) when Y is C, YR³R⁴ is a substituted or an unsubstituted C₃ to C₇ monocyclic hydrocarbylidene moiety, wherein any substituent comprises an independently selected C₁ to C₁₅ hydrocarbyl group, C₁ to C₁₅ heterohydrocarbyl group, C₁ to C₁₅ organoheteryl group, or halide;
(vi) R⁵ and R⁶ are selected independently from a C₁-C₂₀ hydrocarbyl;
(vii) R⁷ is selected from a C₂-C₂₀ hydrocarbyl, and wherein optionally (A) any two of R⁵, R⁶, and R⁷, along with Si to which they are bonded form a ring having from 2 to 7 carbon atoms, or (B) R⁵, R⁶, and Si to which they are bonded form a ring having from 2 to 7 carbon atoms; and
(viii) R¹ and R⁹ are H₂, fused C₄H₄, or fused C₄H₈;
wherein each of R⁵, R⁶, and R⁷ is independently a non-alkenyl, a non-alkynyl, or a non-alkadienyl hydrocarbyl;
and
(b) a metallocene activator.

2. The catalyst composition according to claim 1, wherein all three of R⁵, R⁶, and R⁷ are selected independently from a C₂-C₂₀ hydrocarbyl.

3. The catalyst composition according to claim 1, wherein SiR⁵R⁶R⁷ is selected from SiMe₂Et, SiMe₂(n-Pr), SiMe₂(n-Bu), SiMe₂(n-hexyl), SiMe₂(n-heptyl), SiMe₂(n-octyl), SiMe₂(cyclohexyl), SiMe₂(2-norbornyl), SiMe₂(bicyclo[2.2.2]octanyl), SiMe₂(adamantyl), SiEt₃, SiEt₂(n-Pr), SiEt₂(n-Bu), SiEt₂(n-hexyl), SiEt₂(n-heptyl), SiEt₂(n-octyl), SiEt₂(cyclohexyl), SiEt₂(2-norbornyl), SiEt₂(bicyclo[2.2.2]octanyl), SiEt₂(adamantyl), Si(n-Pr)₃, Si(n-Bu)₃, or Si(n-hexyl)₃.

4. The catalyst composition according to claim 1, wherein:
(a) each of R⁵, R⁶, and R⁷ is selected independently from a non-aryl moiety;
(b) each of R³ and R⁴ is selected independently from a non-alkenyl moiety;
(c) each of R¹ and R² is selected independently from a non-alkenyl moiety;
(d) each of R¹ and R⁹ is selected independently from a non-alkenyl moiety; or
(e) any combination of (a), (b), (c), and (d).

5. The catalyst composition according to claim 1, wherein:
R⁵ and R⁶ are selected independently from a C₁ to C₁₂ alkyl, a substituted or an unsubstituted C₃ to C₇ cycloalkyl, a C₆ to C₁₂ aryl, a C₇ to C₁₅ aralkyl, or a C₇ to C₁₅ alkaryl; and
R⁷ is selected from a C₂ to C₁₂ alkyl, a substituted or an unsubstituted C₃ to C₇ cycloalkyl, a C₆ to C₁₂ aryl, a C₇ to C₁₅ aralkyl, or a C₇ to C₁₅ alkaryl.

6. The catalyst composition according to claim 1, wherein R³ and R⁴ are selected independently from a C₁ to C₁₂ alkyl, a C₃ to C₇ cycloalkyl, a C₆ to C₁₂ aryl, a C₇ to C₁₅ aralkyl, or a C₇ to C₁₅ alkaryl.

7. The catalyst composition according to claim 1, wherein X¹ and X² are selected independently from H, a halide, a C₁-C₂₅ hydrocarbyl, a C₁-C₂₅ heterohydrocarbyl, a C₁-C₂₅ organoheteryl, or X¹ and X² together are a substituted or unsubstituted C₄-C₂₅ 1,4-diyl-2-ene dianionic ligand.

8. The catalyst composition according to claim 1, wherein the metallocene compound has the formula: 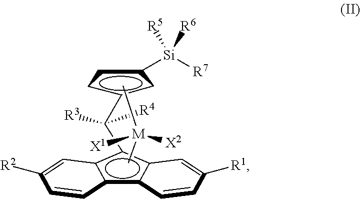
wherein
(i) M is Zr or Hf;
(ii) X¹ and X² are selected independently from H, a halide, a C₁-C₁₂ hydrocarbyl, a C₁-C₁₂ hydrocarbyloxide, or X¹ and X² together are a C₄-C₁₅ 1,4-diyl-2-ene ligand;
(iii) R¹ and R² are selected independently from H or a C₁-C₁₂ hydrocarbyl;
(iv)(A) R³ and R⁴ are selected independently a C₁ to C₁₂ alkyl, a C₃ to C₇ cycloalkyl, a C₆ to C₁₂ aryl, a C₇ to C₁₅ aralkyl, or a C₇ to C₁₅ alkaryl, or (B) CR³R⁴ is a substituted or an unsubstituted C₃ to C₇ monocyclic hydrocarbylidene moiety;
wherein any substituent comprises an independently selected C₁ to C₁₂ hydrocarbyl group, C₁ to C₁₂ heterohydrocarbyl group, or C₁ to C₁₂ organoheteryl group;
(v) R⁵ and R⁶ are selected independently from a C₁-C₁₂ hydrocarbyl; and
(vi) R⁷ is selected from a C₂-C₁₂ hydrocarbyl.

9. The catalyst composition according to claim 1, wherein the metallocene compound has the formula: 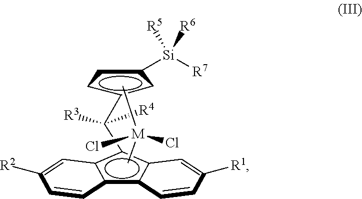
wherein
(i) M is Zr or Hf;
(ii) R¹ and R² are both H or t-butyl;
(iii)(A) R³ and R⁴ are both Me or Ph, or (B) CR³R⁴ is a cyclobutylidene, cyclopentylidene, or cyclohexylidene;
(iv) R⁵ and R⁶ are both Me, Et, or n-Pr; and
(v) R⁷ is Et, n-Pr, n-Bu, n-hexyl, n-heptyl, cyclohexyl, or 2-norbornyl.

10. The catalyst composition according to claim 1, wherein the metallocene compound has the formula: 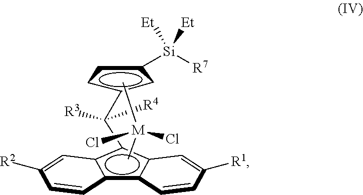
wherein
M is Zr or Hf;
R¹ and R² are both H or t-butyl;
R³ and R⁴ are both methyl or phenyl, or R³ and R⁴ together are cyclopentylidene; and
R⁷ is Et, n-Pr, n-Bu, n-hexyl, n-heptyl, cyclohexyl, or 2-norbornyl.

11. The catalyst composition according to claim 1, wherein the contact product comprises the contact product of (a) the metallocene compound, (b) the metallocene activator, and (c) any of, or any combination of, a co-catalyst, hydrogen, ethylene, an α-olefin, and a liquid carrier.

12. The catalyst composition according to claim 1, wherein the contact product comprises the metallocene compound and the metallocene activator which are pre-contacted for a period of from 0.5 day to 90 days prior to contacting the contact product with an olefin monomer.

13. The catalyst composition according to claim 1, wherein the metallocene activator comprises:
an aluminoxane;
an organoaluminum compound;
an aluminate compound;
an isolated smectite heterocoagulate comprising the contact product in a liquid carrier of [1] a colloidal smectite clay and [2] a heterocoagulation reagent comprising at least one cationic polymetallate;
a smectite heteroadduct comprising or consisting essentially of a contact product of a colloidal smectite clay and a surfactant;
an ion-exchanged clay;
a protic-acid-treated clay;
a pillared clay;
an organoboron or organoborate compound;
an ionizing ionic compound;
a solid oxide treated with an electron withdrawing anion, or any combination thereof; or
any combination thereof.

14. The catalyst composition according to claim 1, wherein the metallocene activator comprises trimethylaluminum, triethylaluminum (TEA), tripropylaluminum, tributylaluminum (for example, tri-n-butylaluminum, tri-t-butylaluminum, tri-sec-butyaluminum), trihexylaluminum, trioctylaluminum, ethyl-(3-alkylcyclopentadiyl)aluminum, diethylaluminum ethoxide, diisobutylaluminum hydride, triisobutylaluminum (TIBAL), diethylaluminum chloride, ethyl-(3-alkylcyclopentadiyl)aluminum, trioctylaluminum, or any combination thereof.

15. The catalyst composition according to claim 1, wherein the catalyst composition further comprises at least one co-catalyst selected from an organoaluminum compound, an organoboron compound, an organozinc compound, an organomagnesium compound, an organolithium compound, or any combination thereof.

16. The catalyst composition according to claim 1, wherein the metallocene activator is solid MAO (sMAO) and the catalyst composition is characterized by any of the following properties:
(a) an ethylene-1-hexene co-polymerization activity measured within 12 hours of forming the contact product of from 1,000-60,000 g polymer/g sMAO activator/hour;
(b) an ethylene-1-hexene co-polymerization activity measured within 12 hours of forming the contact product of from 10-1,500 kg polymer/mmol metallocene/hour;
(c) an ethylene-1-hexene co-polymerization activity measured after the contact product has been stored for 30 days at room temperature (20° C.-23° C.) under an inert atmosphere which is greater than or equal to 98% of an ethylene-1-hexene co-polymerization activity measured within 12 hours of forming the contact product; or
(d) a combination thereof.

17. A process for polymerizing olefins comprising contacting at least one olefin monomer comprising ethylene, and a catalyst composition under polymerization conditions to form a polyolefin, wherein the catalyst composition comprises the contact product of:
(a) a metallocene compound having the formula: 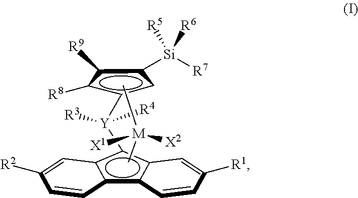
wherein
(i) M is Zr or Hf;
(ii) X¹ and X² are selected independently from a monoanionic ligand, or X¹ and X² together are a dianionic ligand;
(iii) R¹ and R² are selected independently from H or a C₁-C₂₀ hydrocarbyl;
(iv) Y is C or Si;
(v)(A) R³ and R⁴ are selected independently from a C₁ to C₂₀ hydrocarbyl, or (B) when Y is C, YR³R⁴ is a substituted or an unsubstituted C₃ to C₇ monocyclic hydrocarbylidene moiety, wherein any substituent comprises an independently selected C₁ to C₁₅ hydrocarbyl group, C₁ to C₁₅ heterohydrocarbyl group, C₁ to C₁₅ organoheteryl group, or halide;
(vi) R⁵ and R⁶ are selected independently from a C₁-C₂₀ hydrocarbyl, wherein optionally R⁵, R⁶, and Si to which they are bonded form a ring having from 2 to 7 carbon atoms;
(vii) R⁷ is selected from a C₂-C₂₀ hydrocarbyl; and
(viii) R⁸ and R⁹ are H₂, fused C₄H₄, or fused C₄H₈;
wherein each of R⁵, R⁶, and R⁷ is selected independently from a non-alkenyl, a non-alkynyl, or a non-alkadienyl hydrocarbyl;
and
(b) a metallocene activator.

18. The process for polymerizing olefins according to claim 17, wherein all three of R⁵, R⁶, and R⁷ are selected independently from a C₂-C₂₀ hydrocarbyl.

19. The process for polymerizing olefins according to claim 17, wherein SiR⁵R⁶R⁷ is selected from SiMe₂Et, SiMe₂(n-Pr), SiMe₂(n-Bu), SiMe₂(n-hexyl), SiMe₂(n-heptyl), SiMe₂(n-octyl), SiMe₂(cyclohexyl), SiMe₂(2-norbornyl), SiMe₂(bicyclo[2.2.2]octanyl), SiMe₂(adamantyl), SiEt₃, SiEt₂(n-Pr), SiEt₂(n-Bu), SiEt₂(n-hexyl), SiEt₂(n-heptyl), SiEt₂(n-octyl), SiEt₂(cyclohexyl), SiEt₂(2-norbornyl), SiEt₂(bicyclo[2.2.2]octanyl), SiEt₂(adamantyl), Si(n-Pr)₃, Si(n-Bu)₃, or Si(n-hexyl)₃.

20. The process for polymerizing olefins according to claim 17, wherein R³ and R⁴ are selected independently from a C₁ to C₂₀ aliphatic group or a C₆ to C₂₀ aromatic group, a C₁ to C₁₅ aliphatic group or a C₆ to C₁₅ aromatic group, or a C₁ to C₁₀ aliphatic group or a C₆ to C₁₀ aromatic group.

21. The process for polymerizing olefins according to claim 17, wherein X¹ and X² are selected independently from H, a halide, a C₁-C₂₅ hydrocarbyl, a C₁-C₂₅ heterohydrocarbyl, a C₁-C₂₅ organoheteryl, or a substituted or unsubstituted C₄-C₂₅ 1,4-diyl-2-ene dianionic ligand.

22. The process for polymerizing olefins according to claim 17, wherein the metallocene compound has the formula: 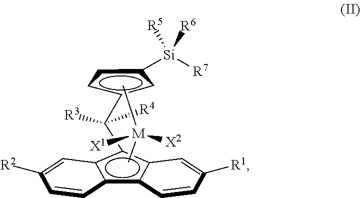
wherein
(i) M is Zr or Hf;
(ii) X¹ and X² are selected independently from H, a halide, a C₁-C₁₂ hydrocarbyl, a C₁-C₁₂ hydrocarbyloxide, or a C₄-C₁₅ 1,4-diyl-2-ene ligand;
(iii) R¹ and R² are selected independently from H or a C₁-C₁₂ hydrocarbyl;
(iv)(A) R³ and R⁴ are selected independently a C₁ to C₁₂ alkyl, a C₃ to C₇ cycloalkyl, a C₆ to C₁₂ aryl, a C₇ to C₁₅ aralkyl, or a C₇ to C₁₅ alkaryl, or (B) CR³R⁴ is a substituted or an unsubstituted C₃ to C₇ monocyclic hydrocarbylidene moiety;
wherein any substituent comprises an independently selected C₁ to C₁₂ hydrocarbyl group, C₁ to C₁₂ heterohydrocarbyl group, or C₁ to C₁₂ organoheteryl group;
(v) R⁵ and R⁶ are selected independently from a C₁-C₁₂ hydrocarbyl; and
(vi) R⁷ is selected from a C₂-C₁₂ hydrocarbyl.

23. The process for polymerizing olefins according to claim 17, wherein the metallocene compound has the formula: 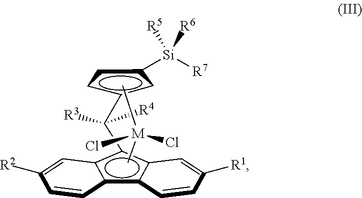
wherein
(i) M is Zr or Hf;
(ii) R¹ and R² are both H or t-butyl;
(iii)(A) R³ and R⁴ are both Me or Ph, or (B) CR³R⁴ is a cyclobutylidene, cyclopentylidene, or cyclohexylidene;
(iv) R⁵ and R⁶ are both Me, Et, or n-Pr; and
(v) R⁷ is Et, n-Pr, n-Bu, n-hexyl, n-heptyl, cyclohexyl, or 2-norbornyl.

24. The process for polymerizing olefins according to claim 17, wherein the metallocene compound has the formula: 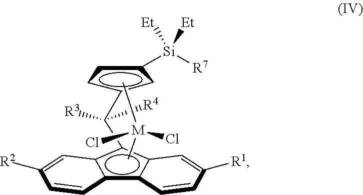
wherein
M is Zr or Hf;
R¹ and R² are both H or t-butyl;
R³ and R⁴ are both methyl or phenyl, or R³ and R⁴ together are cyclopentylidene; and
R⁷ is Et, n-Pr, n-Bu, n-hexyl, n-heptyl, cyclohexyl, or 2-norbornyl.

25. The process for polymerizing olefins according to claim 17, wherein the process further comprises pre-contacting (a) the metallocene compound, (b) the metallocene activator, and (c) any of, or any combination of, a co-catalyst and a liquid carrier, for a period of from 0.5 day to 90 days prior to contacting the contact product with an olefin monomer.

26. The process for polymerizing olefins according to claim 17, wherein the contact product comprises the contact product of (a) the metallocene compound, (b) the metallocene activator, and (c) a co-catalyst.

27. The process for polymerizing olefins according to claim 17, wherein the metallocene activator comprises:
an aluminoxane;
an organoaluminum compound;
an aluminate compound;
an isolated smectite heterocoagulate comprising the contact product in a liquid carrier of [1] a colloidal smectite clay and [2] a heterocoagulation reagent comprising at least one cationic polymetallate;
a smectite heteroadduct comprising or consisting essentially of a contact product of a colloidal smectite clay and a surfactant;
an ion-exchanged clay;
a protic-acid-treated clay;
a pillared clay;
an organoboron or organoborate compound;
an ionizing ionic compound;
a solid oxide treated with an electron withdrawing anion, or any combination thereof; or
any combination thereof.

28. The process for polymerizing olefins according to claim 17, wherein the metallocene activator comprises an organoaluminum compound having the formula: 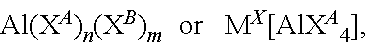
wherein
n+m=3, wherein n and m are not limited to integers;
X^{A} is selected independently from: [1] a hydride, a C₁-C₂₀ hydrocarbyl, or a C₁-C₂₀ heterohydrocarbyl; [2] a hydride, a C₁-C₂₀ aliphatic group, a C₆-C₂₀ aromatic group, a C₁-C₂₀ heteroaliphatic group, or a C₄-C₂₀ heteroaromatic group; or [3] two X^{A} together comprise a C₄-C₅ hydrocarbylene group and the remaining X^{A} is/are selected independently from a hydride, a C₁-C₂₀ hydrocarbyl, or a C₁-C₂₀ heterohydrocarbyl;
X^{B} is selected independently from: [1] a halide or a C₁-C₂₀ organoheteryl; or [2] a halide, a C₁-C₁₂ alkoxide group, or a C₆-C₁₀ aryloxide group; and
M^{x} is selected from Li, Na, or K.

29. The process for polymerizing olefins according claim 17, wherein the at least one olefin monomer comprises ethylene and an α-olefin comonomer selected from an aliphatic C₃ to C₂₀ olefin, a conjugated or nonconjugated C₃ to C₂₀ diolefin, or any mixture thereof.

30. The process for polymerizing olefins according to claim 17, wherein the metallocene activator comprises solid MAO (sMAO) and the polymerization conditions comprise a metallocene compound to sMAO ratio of from 1×10⁻⁵ to 5×10⁻⁴ mmol metallocene compound per mg sMAO.

31. The process for polymerizing olefins according to claim 17, wherein the catalyst composition further comprises an organoaluminum compound in a concentration of from 10 to 2,500 mmol of alkylaluminum compound per mmol of metallocene compound excluding any alkylaluminum compound used as a scavenger.

32. The process for polymerizing olefins according to claim 17, wherein the catalyst composition or the polyolefin are characterized by:
(a) a 1-hexene comonomer incorporation efficiency
$$C I E = \frac{[ C 6 ] / [ C 2 ] polymer}{[ C 6 ] / [ C 2 ] reactor}$$
from 0.005 to 0.300;
(b) a Long Chain Branching (LCB) occurrence in the polyolefin of less than or equal to 10 (≤10) Long Chain Branches (LCB) per 10⁶ total carbon atoms;
(c) a Short Chain Branching Distribution (SCBD) profile in the polyolefin over the range from d85 to d15 has a slope of from about −1.10 to about +2.95, from low molecular weight to high molecular weight, determined by linear regression;
(d) a MI (melt index) of the polyolefin of from 0.01 g/10 min to 10 g/10 min;
(e) a HLMI (high load melt index) of the polyolefin of from 1 g/10 min to 60 g/10 min;
(f) a HLMI/MI ratio (shear response) of the polyolefin of from 16 to 65;
(g) a density of the polyolefin of from 0.885 g/mL to 0.955 g/mL;
(h) a Mw/Mn ratio (polydispersity index) of the polyolefin of from greater than 1.8 to 18;
or
(i) any combination thereof.
